(19) United States
(12) Patent Application Publication
(10) Pub. No.: US 2013/0318351 A1
(43) Pub. Date: Nov. 28, 2013

(54) SIMILARITY DEGREE CALCULATION SYSTEM, SIMILARITY DEGREE CALCULATION APPARATUS, COMPUTER PROGRAM, AND SIMILARITY DEGREE CALCULATION METHOD

(71) Applicants: Takato Hirano, Tokyo (JP); Nori Matsuda, Tokyo (JP); Takashi Ito, Tokyo (JP); Mitsuhiro Hattori, Tokyo (JP); Takumi Mori, Tokyo (JP)

(72) Inventors: Takato Hirano, Tokyo (JP); Nori Matsuda, Tokyo (JP); Takashi Ito, Tokyo (JP); Mitsuhiro Hattori, Tokyo (JP); Takumi Mori, Tokyo (JP)

(73) Assignee: Mitsubishi Electric Corporation, Chiyoda-ku (JP)

(21) Appl. No.: 13/982,546

(22) PCT Filed: Feb. 22, 2011
(86) PCT No.: PCT/JP2011/053797

§ 371 Date: Jul. 30, 2013

(51) Int. Cl. H04L 9/32

(52) U.S. Cl. CPC H04L 9/32
USPC 713/168

(57) ABSTRACT

Based on an encrypted feature vector (comparison ciphertext) encrypted with a public key of a decryption apparatus and an encrypted feature vector (target ciphertext) encrypted with the public key of the decryption apparatus, and a random number (temporary key) generated by a random number generation unit (temporary key generation unit), an encrypted random similarity degree calculation unit (interim similarity degree ciphertext calculation unit) performs calculation for calculating a similarity degree in a first stage, with two encrypted feature vectors kept encrypted, thereby calculating a second challenge. The decryption apparatus decrypts the second challenge with a secret key sk of the decryption apparatus, and performs calculation for calculating the similarity degree in a second stage with a result of the decryption kept encrypted with the temporary key, thereby calculating a second response. A plaintext similarity degree extraction unit (similarity degree calculation unit) decrypts the second response with the temporary key, thereby calculating a similarity degree.

### TECHNICAL FIELD

The present invention relates to a similarity degree calculation system for calculating a similarity degree between encrypted data.

### BACKGROUND ART

There is a technology in which confidential data such as biometric information is stored in an encrypted state, and then a similarity degree indicating to what degree the data in the encrypted state is similar to different data is calculated. If an additive homomorphic encryption system is used, for example, an arithmetic operation using data that is kept encrypted becomes possible. As the additive homomorphic encryption system, the Okamoto-Takashima encryption system (in Patent Literature 3 and Non-Patent Literature 1), the BGN encryption system (in Non-Patent Literature 2), the Gentry encryption system (in Non-Patent Literature 3), the Paillier encryption system, or the like is known. The BGN encryption system and the Gentry encryption algorithm are multiplicative homomorphic as well as additive homomorphic. Thus, these systems are referred to as doubly homomorphic encryption. In the Gentry encryption system, the number of multiplications is not limited. Thus, the Gentry encryption system is referred to as fully homomorphic encryption or ring-homomorphic encryption. There is also an encryption system having only a multiplicative homomorphism such as the RSA (trade mark) encryption system.

### CITATION LIST

### Patent Literature

Patent Literature 1: JP 2008-521025
Patent Literature 2: JP 2009-129210
Patent Literature 3: JP 2010-54875
Patent Literature 4: JP 2006-262333
Patent Literature 5: JP 2001-7802

### Non Patent Literature

Non-Patent Literature 1: Mitsuhiro Hattori, Yoichi Shibata, Takashi Ito, Nori Matsuda, Katsuyuki Takashima, Takeshi Yoneda, “Secure Biometric Authentication Using 2-DNF Homomorphic Encryption”, IEICE Technical report 109(272), pp. 113-120, 2009.
Non-Patent Literature 2: D. Boneh, E.-J. Goh, K, Nissim, “Evaluating 2-DNF Formulas on Ciphertests”, Theory of Cryptography Conference, Lecture Notes in Computer Science, Vol. 3378, pp. 325-341, 2005.
Non-Patent Literature 3: C. Genrty, “Fully Homomorphic Encryption Using Ideal Lattices”, ACM Symposium on Theory of Computing, pp. 169-178, 2009.
Non-Patent Literature 4: M. Upmanyu, A. M. Namboodiri, K. Srinathan, C. V. Jawahar, “Blind Authentication: A Secure Crypto-Biometric Verification Protocol”, IEEE Transactions on Information Forensics and Security, Vol. 5, No. 2, 2010.

### SUMMARY OF INVENTION

### Technical Problem

When using an encryption system such as the additive homomorphic encryption system where an arithmetic operation using data that is kept encrypted is possible, a homomorphism is applied to information to be exchanged between apparatuses in a system or information stored in each apparatus. By doing so, the system may suffer an unexpected attack.

In an authentication system for authenticating a user in particular, it is unsatisfactory to keep secret of original data alone. It is necessary to prevent leakage of information, with which it is possible to spoof a user, from the information to be exchanged between the apparatuses in the system and the information stored in each apparatus.

The present invention has been made to solve the problem as mentioned above, for example. An object of the present invention is to calculate a similarity degree between data that is kept encrypted while preventing leakage of information on original data and information to be used for spoofing.

### Solution to Problem

A similarity degree calculation apparatus according to the present invention is a similarity degree calculation apparatus that calculates a similarity degree between comparison data and target data. The similarity degree calculation apparatus may include:

a storage device that stores data, a processing device that processes the data, a comparison ciphertext storage unit, a target ciphertext acquisition unit, a temporary key generation unit, an interim similarity degree ciphertext calculation unit, an interim similarity degree ciphertext notification unit, an interim similarity degree decrypted text acquisition unit, and a similarity degree calculation unit;

using the storage device, the comparison ciphertext storage unit storing a comparison ciphertext obtained by transforming the comparison data by encryption transformation using a public key corresponding to a secret key stored by a decryption apparatus;

using the processing device, the target ciphertext acquisition unit acquiring a target ciphertext obtained by transforming the target data by the encryption transformation using the public key;

using the processing device, the temporary key generation unit generating a temporary key;

using the processing device, based on the comparison ciphertext stored by the comparison ciphertext storage unit, the target ciphertext acquired by the target ciphertext acquisition unit, and the temporary key generated by the temporary key generation unit, the interim similarity degree ciphertext calculation unit performing calculation for calculating the similarity degree in a first stage with the comparison cirphertext and the target ciphertext kept encrypted, and then calculating an interim similarity degree ciphertext by encrypting a result of the calculation with the temporary key;

using the processing device, the interim similarity degree ciphertext notification unit notifying to the decryption apparatus the interim similarity degree ciphertext calculated by the interim similarity degree ciphertext calculation unit;

using the processing device, the interim similarity degree decrypted text acquisition unit acquiring an interim similarity degree decrypted text calculated and notified by the decryption apparatus, based on the interim similarity degree ciphertext notified by the interim similarity degree ciphertext notification unit; and

using the processing device, the similarity degree calculation unit decrypting the interim similarity degree decrypted text with the temporary key, based on the temporary key generated by the temporary key generation unit and the interim similarity degree decrypted text acquired by the interim similarity degree decrypted text acquisition unit, thereby calculating the similarity degree between the comparison data and the target data.

### ADVANTAGEOUS EFFECTS OF INVENTION

According to the similarity calculation system of the present invention, a similarity degree between data may be calculated with the data kept encrypted, and leakage of information on the original data and leakage of information to be used for spoofing may also be prevented during the course of the calculation of the similarity degree.

### BRIEF DESCRIPTION OF DRAWINGS

FIG. 1 is a system configuration diagram showing an example of an overall configuration of a biometric authentication system 100 in a first embodiment.

FIG. 2 is a diagram showing an example of a hardware configuration of each of a certification apparatus 101, an authentication apparatus 102, a decryption apparatus 103, and a registration apparatus 104 in the first embodiment.

FIG. 3 is a block configuration diagram showing an example of a functional block configuration of the registration apparatus 104 in the first embodiment.

FIG. 4 is a block configuration diagram showing an example of a functional block configuration of the certification apparatus 101 in the first embodiment.

FIG. 5 is a block configuration diagram showing an example of a functional block configuration of the authentication apparatus 102 in the first embodiment.

FIG. 6 is a block configuration diagram showing an example of a functional block configuration of the decryption apparatus 103 in the first embodiment.

FIG. 7 is a flow chart diagram showing an example of an overall operation of the biometric authentication system 100 in the first embodiment.

FIG. 8 is a flow chart diagram showing an example of a flow of a setup process S500 in the first embodiment.

FIG. 9 is a flow chart diagram showing an example of a flow of a registration process S600 in the first embodiment.

FIG. 10 is a flow chart diagram showing an example of a flow of an authentication process S700 in the first embodiment.

FIG. 11 is a flow chart diagram showing an example of a flow of a vector decomposition process S540 for solving a vector decomposition problem using a regular matrix X.

FIG. 12 is a detailed block diagram showing an example of a configuration of a key generation unit 401 in the first embodiment.

FIG. 13 is a flow chart diagram showing an example of a flow of processes of a key generation step S501 in the first embodiment.

FIG. 14 is a flow chart diagram showing an example of a flow of processes of a feature vector encryption step S603 in the first embodiment.

FIG. 15 is a flow chart diagram showing an example of a flow of processes of a first challenge generation step S701 in the first embodiment.

FIG. 16 is a detailed block diagram showing an example of a configuration of an encrypted data embedding unit 217 in the first embodiment.

FIG. 17 is a flow chart diagram showing an example of a flow of processes of a first response generation step S707 in the first embodiment.

FIG. 18 is a detailed block diagram showing an example of a configuration of an encrypted data extraction unit 305 in the first embodiment.

FIG. 19 is a flow chart diagram showing an example of a flow of processes of an encrypted biometric information extraction step S710 in the first embodiment.

FIG. 20 is a detailed block diagram showing an example of a configuration of an encrypted random similarity degree calculation unit 314 in the first embodiment.

FIG. 21 is a flow chart diagram showing an example of a flow of processes of a second challenge generation step S712 in the first embodiment.

FIG. 22 is a detailed block diagram showing an example of a configuration of a decryption unit 404 in the first embodiment.

FIG. 23 is a flow chart diagram showing an example of a flow of processes of a second response generation step S716 in the first embodiment.

FIG. 24 is a detailed block diagram showing an example of a configuration of a plaintext similarity degree extraction unit 315 in the first embodiment.

FIG. 25 is a flow chart diagram showing an example of a flow of processes of a plaintext similarity degree calculation step S719 in the first embodiment.

FIG. 26 is a flow chart diagram showing a calculation procedure for calculating a similarity degree in the biometric authentication system 100 in the first embodiment.

FIG. 27 is a system configuration diagram showing an example of an overall configuration of the biometric authentication system 100 in a second embodiment.

FIG. 28 is a flow chart diagram showing an example of a flow of processes of the second challenge generation step S712 in a third embodiment.

FIG. 29 is a flow chart diagram showing an example of a flow of processes of the second response generation step S716 in the third embodiment.

FIG. 30 is a flow chart diagram showing a calculation procedure for calculating a similarity degree in the biometric authentication system 100 in the third embodiment.

FIG. 31 is a detailed block diagram showing an example of a configuration of the key generation unit 401 in a fourth embodiment.

FIG. 32 is a flow chart diagram showing an example of a flow of processes of the key generation step S501 in the fourth embodiment.

FIG. 33 is a flow chart diagram showing an example of a flow of processes of the feature vector encryption step S603 in the fourth embodiment.

FIG. 34 is a flow chart diagram showing an example of a flow of processes of the first challenge generation step S701 in the fourth embodiment.

FIG. 35 is a detailed block diagram showing an example of a configuration of the encrypted data embedding unit 217 in the fourth embodiment.

FIG. 36 is a flow chart diagram showing an example of a flow of processes of the first response generation step S707 in the fourth embodiment.

FIG. 37 is a detailed block diagram showing an example of a configuration of the encrypted data extraction unit 305 in the fourth embodiment.

FIG. 38 is a flow chart diagram showing an example of a flow of processes of the encrypted biometric information extraction step S710 in the fourth embodiment.

FIG. 39 is a detailed block diagram showing an example of a configuration of the encrypted random similarity degree calculation unit 314 in the fourth embodiment.

FIG. 40 is a flow chart diagram showing an example of a flow of processes of the second challenge generation step S712 in the fourth embodiment.

FIG. 41 is a detailed block diagram showing another example of the configuration of the encrypted random similarity degree calculation unit 314 in the fourth embodiment.

FIG. 42 is a flow chart diagram showing another example of the flow of processes of the second challenge generation step S712 in the fourth embodiment.

FIG. 43 is a flow chart diagram showing an example of a flow of processes of the second response generation step S716 in the fourth embodiment.

FIG. 44 is a flow chart diagram showing an example of a flow of processes of the second response generation step S716 in the fourth embodiment.

FIG. 45 is a flow chart diagram showing a calculation procedure for calculating a similarity degree in the biometric authentication system 100 in the fourth embodiment.

FIG. 46 is a detailed block diagram showing an example of a configuration of the encrypted random similarity degree calculation unit 314 in a fifth embodiment.

FIG. 47 is a flow chart diagram showing an example of a flow of processes of the second challenge generation step S712 in the fifth embodiment.

FIG. 48 is a flow chart diagram showing a calculation procedure for calculating a similarity degree in the biometric authentication system 100 in the fifth embodiment.

FIG. 49 is a detailed block diagram showing an example of a configuration of the key generation unit 401 in a sixth embodiment.

FIG. 50 is a flow chart diagram showing an example of a flow of processes of the key generation step S501 in the sixth embodiment.

FIG. 51 is a flow chart diagram showing an example of a flow of processes of the feature vector encryption step S603 in the sixth embodiment.

FIG. 52 is a flow chart diagram showing an example of a flow of processes of the first challenge generation step S701 in the sixth embodiment.

FIG. 53 is a detailed block diagram showing an example of a configuration of the encrypted data embedding unit 217 in the sixth embodiment.

FIG. 54 is a flow chart diagram showing an example of a flow of processes of the first response generation step S707 in the sixth embodiment.

FIG. 55 is a flow chart diagram showing an example of a flow of processes of the encrypted biometric information extraction step S710 in the sixth embodiment.

FIG. 56 is a detailed block diagram showing an example of a configuration of the encrypted random similarity degree calculation unit 314 in the sixth embodiment.

FIG. 57 is a flow chart diagram showing an example of a flow of processes of the second challenge generation step S712 in the sixth embodiment.

FIG. 58 is a detailed block diagram showing an example of a configuration of the decryption unit 404 in the sixth embodiment.

FIG. 59 is a flow chart diagram showing an example of a flow of processes of the second response generation step S716 in the sixth embodiment.

FIG. 60 is a flow chart diagram showing an example of a flow of processes of the plaintext similarity degree calculation step S719 in the sixth embodiment.

FIG. 61 is a flow chart diagram showing a calculation procedure for calculating a similarity degree in the biometric authentication system 100 in the sixth embodiment.

FIG. 62 is a detailed block diagram showing an example of a configuration of an encrypted random number generation unit 304 in a seventh embodiment.

FIG. 63 is a flow chart diagram showing an example of a flow of processes of the first challenge generation step S701 in the seventh embodiment.

FIG. 64 is a detailed block diagram showing an example of a configuration of the encrypted random similarity degree calculation unit 314 in the seventh embodiment.

FIG. 65 is a flow chart diagram showing an example of a flow of processes of the second challenge generation step S712 in the seventh embodiment.

FIG. 66 is a detailed block diagram showing an example of a configuration of the decryption unit 404 in the seventh embodiment.

FIG. 67 is a flow chart diagram showing an example of a flow of processes of the second response generation step S716 in the seventh embodiment.

FIG. 68 is a flow chart diagram showing a calculation procedure for calculating a similarity degree in the biometric authentication system 100 in the seventh embodiment.

FIG. 69 is a detailed block diagram showing an example of the encrypted random similarity degree calculation unit 314 in an eighth embodiment.

FIG. 70 is a flow chart diagram showing an example of a flow of processes the second challenge generation step S712 in the eighth embodiment.

FIG. 71 is a flow chart diagram showing an example of a flow of processes of the second response generation step S716.

FIG. 72 is a flow chart diagram showing a calculation procedure for calculating a similarity degree in the biometric authentication system 100 in the eighth embodiment.

FIG. 73 is a detailed block diagram showing an example of a configuration of the encrypted random similarity degree calculation unit 314 in a ninth embodiment.

FIG. 74 is a flow chart diagram showing an example of a flow of processes of the second challenge generation step S712 in a ninth embodiment.

FIG. 75 is a detailed block diagram showing an example of a configuration of the decryption unit 404 in the ninth embodiment.

FIG. 76 is a flow chart diagram showing an example of a flow of processes of the second response generation step S716 in the ninth embodiment.

FIG. 77 is a flow chart diagram showing a calculation procedure for calculating a similarity degree in the biometric authentication system 100 in the ninth embodiment.

FIG. 78 is a system configuration diagram showing an example of an overall configuration of the image search system 100 in a tenth embodiment.

FIG. 79 is a block configuration diagram showing an example of a functional block configuration of the registration apparatus 104 in the tenth embodiment.

FIG. 80 is a block configuration diagram showing an example of a functional block configuration of the terminal apparatus 111 in the tenth embodiment.

FIG. 81 is a block configuration diagram showing an example of a functional block configuration of the search apparatus 112 in the tenth embodiment.

### DESCRIPTION OF EMBODIMENTS

### First Embodiment

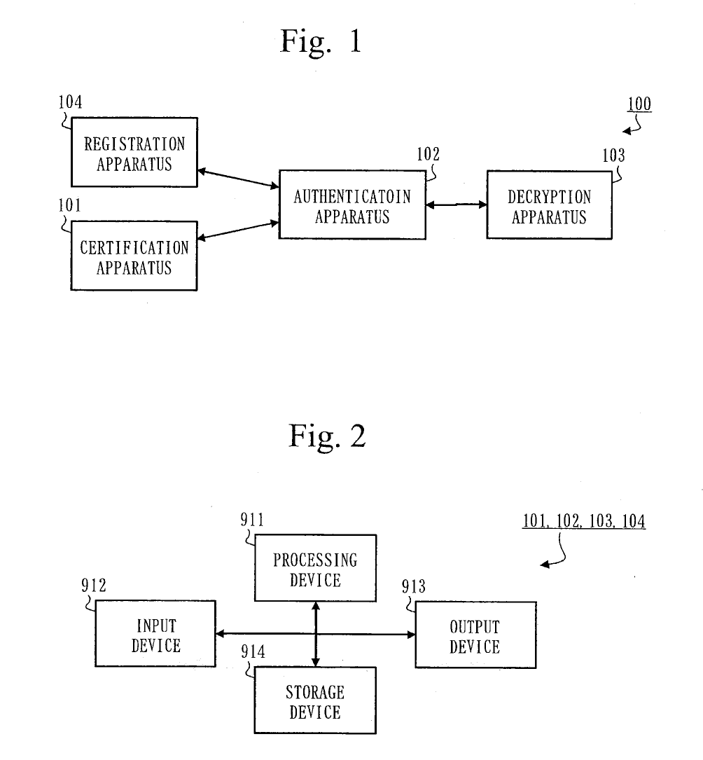

A first embodiment will be described using FIGS. 1 to 26.

FIG. 1 is a system configuration diagram showing an example of an overall configuration of a biometric authentication system 100 in this embodiment.

The biometric authentication system 100 is a system in which biometric information such as a fingerprint of a user is input and the input information is matched against biometric information registered in advance, thereby authenticating the user.

The biometric authentication system 100 (similarity degree calculation system) includes a certification apparatus 101, an authentication apparatus 102, a decryption apparatus 103, and a registration apparatus 104, for example.

The registration apparatus 104 extracts biometric information from each user, encrypts the extracted biometric information, and registers the encrypted biometric information in the authentication apparatus 102.

The certification apparatus 101 (encryption apparatus) extracts biometric information from a user and then encrypts the extracted biometric information. The certification apparatus 101 also communicates with the authentication apparatus 102 to perform authentication.

The authentication apparatus 102 (similarity degree calculation apparatus) stores the encrypted biometric information of each user registered by the registration apparatus 104. The authentication apparatus 102 communicates with each of the certification apparatus 101 and the decryption apparatus 103 to perform the authentication.

The decryption apparatus 103 communicates with the authentication apparatus 102 and decrypts encrypted data related to a similarity degree transmitted from the authentication apparatus.

A plurality of the certification apparatuses 101 and a plurality of the registration apparatuses 104 may be provided. Physically, the certification apparatus 101 and the registration apparatus 104 may be one apparatus. Physically, the certification apparatus 101 and the decryption apparatus 103 may be one apparatus. Physically, the authentication apparatus 102 and the registration apparatus 104 may be one apparatus.

FIG. 2 is a diagram showing an example of a hardware configuration of each of the certification apparatus 101, the authentication apparatus 102, the decryption apparatus 103, and the registration apparatus 104 in this embodiment.

Each of the certification apparatus 101, the authentication apparatus 102, the decryption apparatus 103, and the registration apparatus 104 is a computer, for example, and includes a processing device 911, an input device 912, an output device 913, and a storage device 914.

The storage device 914 stores a program executed by the processing device 911 and data processed by the processing device 911. To take an example, the storage device 914 is a volatile memory, a non-volatile memory, a hard disk drive, or the like.

The processing device 911 executes the program stored in the storage device 914, thereby processing data and controlling the apparatus as a whole.

The input device 912 converts information from an outside into data capable of being processed by the processing device 911. The data obtained by the conversion by the input device 912 may be directly processed by the processing device 911, or may be stored by the storage device 914. To take an example, the input device 912 is an operation input device such as a keyboard, mouse, or the like for inputting a user operation, a biometric information input device for extracting and inputting biometric information such as a user's fingerprint or iris, a receiving device (communication device) for receiving a signal transmitted by a different device, or a reading device for reading data from a recording medium.

The output device 913 is a device for converting the data processed by the processing device 911 and the data stored by the storage device 914 and then outputting the converted data to the outside. To take an example, the output device 913 is a display device for displaying an image, a transmitting device (communication device) for transmitting a signal to a different device, a writing device for writing data into a recording medium, or the like.

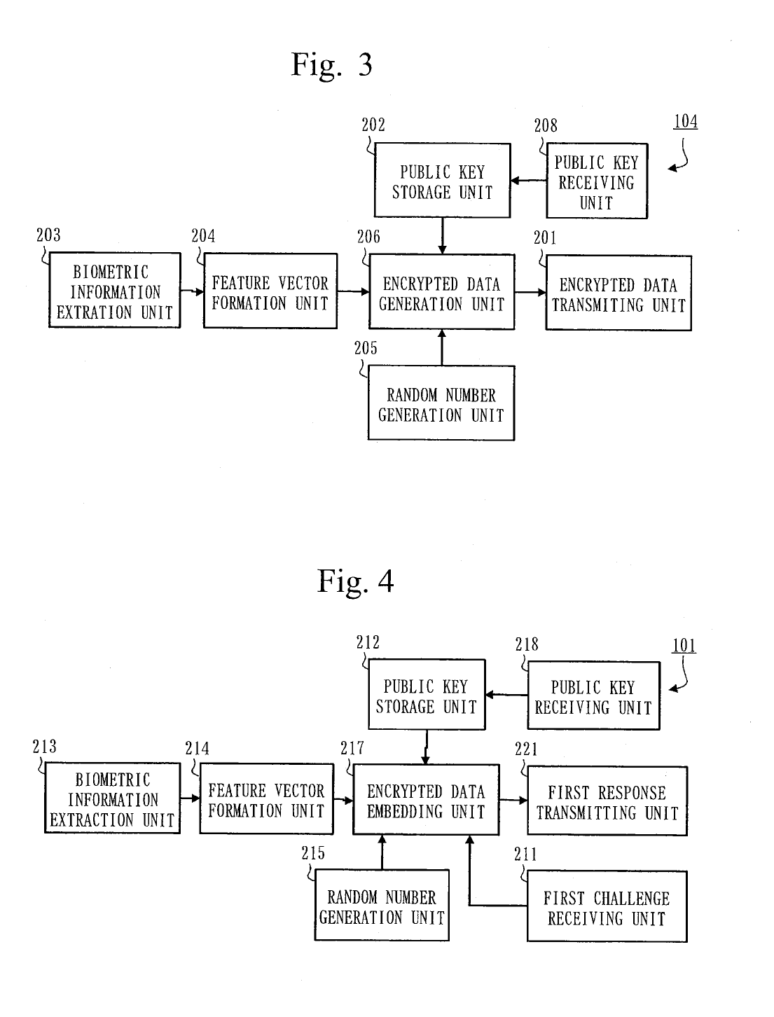

FIG. 3 is a block configuration diagram showing an example of a functional block configuration of the registration device 104 in this embodiment.

The registration apparatus 104 includes a public key receiving unit 208, a public key storage unit 202, a biometric information extraction unit 203, a feature vector formation unit 204, a random number generation unit 205, an encrypted data generation unit 206, and an encrypted data transmitting unit 201.

The public key receiving unit 208 (public key acquisition unit) receives a public key generated by the decryption apparatus 103 using the input device 912 such as the communication device. The communication device (communication unit) exchanges data with a different device such as the authentication apparatus 102 or the decryption apparatus 103.

The encrypted data transmitting unit 201 (comparison ciphertext notification unit) transmits the encrypted biometric information (comparison ciphertext) to the authentication device 102, using the output device 913 such as the communication device.

The public key storage unit 202 stores the public key received by the public key receiving unit 208, using the storage device 914. The storage device 914 (storage unit) stores various data such as the public key transmitted from the decryption device 103.

The biometric information extraction unit 203 extracts the biometric information necessary for performing individual identification from each user, using the input device 912 such as an optical camera, an infrared camera, or the other variety of sensor.

The feature vector formation unit 204 (comparison data acquisition unit) forms a feature vector (comparison data) indicating a personal feature from the biometric information extracted by the biometric information extraction unit 203, using the processing device 911.

The random number generation unit 205 generates random numbers, based on a part of the public key stored by the public key storage unit 202 or the like, using the processing device 911. The random numbers generated by the random number generation unit 205 are used by the encrypted data generation unit 206 or the like.

The encrypted data generation unit 206 (encryption unit, comparison ciphertext generation unit) encrypts the feature vector formed by the feature vector forming device 204, based on the random numbers generated by the random number generation unit 205, thereby generating encrypted biometric information (encrypted feature vector), using the processing device 911.

FIG. 4 is a block configuration diagram showing an example of a functional block of the certification apparatus 101 in this embodiment.

The certification apparatus 101 includes a public key receiving unit 218, a public key storage unit 212, a biometric information extraction unit 213, a feature vector formation unit 214, a random number generation unit 215, a first challenge receiving unit 211, an encrypted data embedding unit 217, and a first response transmitting unit 221, for example.

The public key receiving unit 218 (public key acquisition unit) receives the public key generated by the decryption apparatus 103, using the input device 912 such as the communication device. The communication device (communication unit) exchanges data with a different device such as the authentication apparatus 102 or the decryption apparatus 103.

The first challenge receiving unit 211 (temporary public key acquisition unit) receives a first challenge (temporary public key) from the authentication apparatus 102, using the input device 102 such as the communication device.

The first response transmitting unit 221 (target dual encryption text notification unit) returns a first response (target dual encryption text) corresponding to the first challenge to the authentication apparatus 102, using the input device 912 such as the communication device.

The public key storage unit 212 stores the public key received by the public key receiving unit 218, using the storage device 914. The storage device 914 (storage unit) stores various data such as the public key transmitted from the decryption apparatus 103.

The biometric information extraction unit 213 extracts from the user the biometric information necessary for performing individual identification, using the input device 912 such as an optical camera, an infrared camera, or the other variety of sensor.

The feature vector formation unit 214 (target data acquisition unit) forms a feature vector (target data) indicating a personal feature from the biometric information extracted by the biometric information extraction unit 213, using the processing device 911.

The random number generation unit 215 generates random numbers, based on a part of the public key stored by the public key storage unit 212, using the processing device 911. The random numbers generated by the random number generation unit 215 are used by the encrypted data embedding unit 217 or the like.

The encrypted data embedding unit 217 (response generation unit, target dual encryption text calculation unit) processes the first challenge transmitted from the authentication apparatus 102, according to the value of the feature vector formed by the feature vector formation unit 214, using the processing device 911. That is, the encrypted data embedding unit 217 embeds the encrypted biometric information into the first challenge. The encrypted data embedding unit 217 calculates the first response to be returned to the authentication apparatus 102.

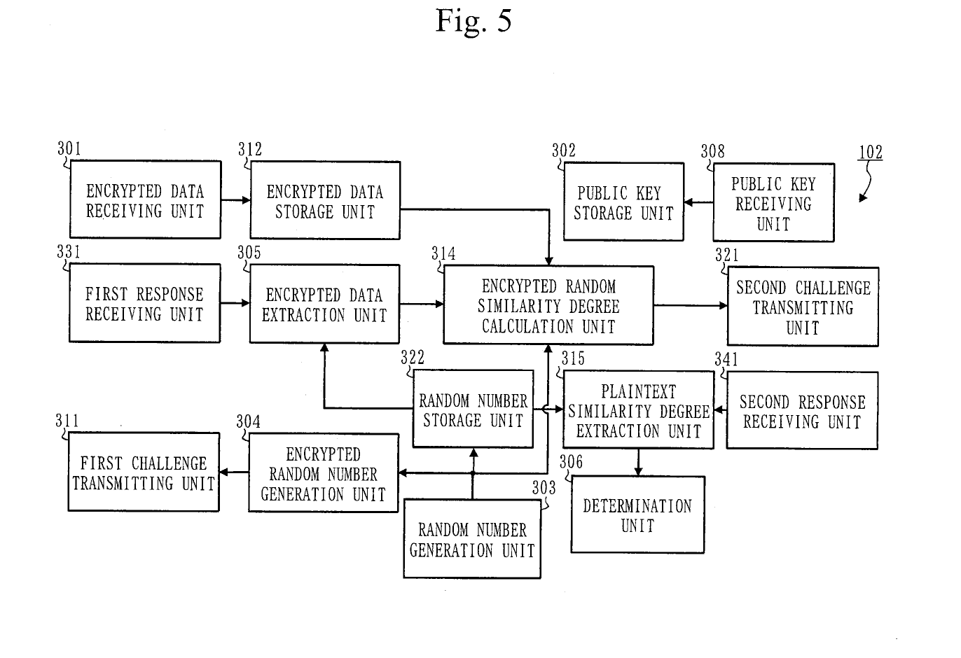

FIG. 5 is a block configuration diagram showing an example of a functional block configuration of the authentication apparatus 102 in this embodiment.

The authentication apparatus 102 includes a public key receiving unit 308, a public key storage unit 302, an encrypted data receiving unit 301, an encrypted data storage unit 312, a random number generation unit 303, a random number storage unit 322, an encrypted random number generation unit 304, a first challenge transmitting unit 311, a first response receiving unit 331, an encrypted data extraction unit 305, an encrypted random similarity degree calculation unit 314, a second challenge transmitting unit 321, a second response receiving unit 341, a plaintext similarity degree extraction unit 315, and a determination unit 306, for example.

The public key receiving unit 308 (public key acquisition unit) receives the public key generated by the decryption apparatus 103, using the input device 912 such as the communication device (communication unit).

The encrypted data receiving unit 301 (comparison ciphertext acquisition unit) receives the encrypted feature vector (comparison ciphertext) from the certification apparatus 101, using the input device 912 such as the communication device.

The first challenge transmitting unit 311 (temporary public key notification unit) transmits the first challenge (temporary public key) to the certification apparatus 101, using the output device 913 such as the communication device.

The first response receiving unit 331 (target dual encryption text acquisition unit) receives the first response (target dual encryption text) corresponding to the first challenge from the certification apparatus 101, using the input device 912 such as the communication device.

The second challenge transmitting unit 321 (interim similarity degree ciphertext notification unit) transmits a second challenge (interim similarity degree ciphertext) to the decryption apparatus 103, using the output device 913 such as the communication device.

The second response receiving unit 341 (interim similarity degree decrypted text acquisition unit) receives a second response (interim similarity degree decrypted text) from the decryption apparatus 103, using the input device 912 such as the communication device.

The public key storage unit 302 stores the public key transmitted from the decryption apparatus 103, using the storage device 914 (storage unit).

The encrypted data storage unit 312 (comparison ciphertext storage unit) stores the encrypted feature vector transmitted from the certification apparatus 101, using the storage device 914. The encrypted data storage unit 312 stores a plurality of the encrypted feature vectors associated with user identifiers, for example.

The random number storage unit 322 (temporary secret key storage unit, temporary key storage unit) stores a part of random numbers (temporary secret key, temporary key) out of the random numbers generated by the random number generation unit 303, using the storage device 914.

The random number generation unit 303 (temporary secret key generation unit, temporary key generation unit) generates the random numbers, based on a part of the public key stored by the public key storage unit 302, using the processing device 911. The random numbers generated by the random number generation unit 303 are used by the encrypted random number generation unit 304, the encrypted data extraction unit 305, the encrypted random similarity degree calculation unit 314, the plaintext similarity degree extraction unit 315, and the like.

Using the processing device 911, the encrypted random number generation unit 304 (challenge generation unit, temporary public key calculation unit) generates the first challenge (encrypted random numbers) in order to communicate with the certification apparatus 101.

Using the processing device 911, the encrypted data extraction unit 305 (random number removal unit, target ciphertext acquisition unit) removes random numbers included in the first response transmitted from the certification apparatus 101, employing the random numbers (stored in the random number storage unit 322) used in the first challenge corresponding to the first response. The encrypted data extraction unit 305 removes a part of the random numbers used in the first challenge from the first response, thereby extracting an encrypted feature vector.

Using the processing device 911, the encrypted random similarity degree calculation unit 314 (challenge generation unit, interim similarity degree ciphertext calculation unit) generates the second challenge (encrypted random similarity degree) in order to communicate with the decryption apparatus 103. The encrypted random similarity degree calculation unit 314 generates the second challenge, based on the encrypted feature vector extracted by the encrypted data extraction unit 305 and the encrypted feature vectors stored by the encrypted data storage unit 312. The encrypted random similarity degree calculation unit 314 acquires the encrypted feature vector whose user identifier matches the user identifier of the first response received by the first response receiving unit 331 from among the encrypted feature vectors stored by the encrypted data storage unit 312, thereby generating the second challenge.

The plaintext similarity degree extraction unit 315 (random number removal unit, similarity degree calculation unit) removes random numbers included in the second response from the second response transmitted to the decryption apparatus 103, employing the random numbers (stored in the random number storage unit 322) used in the second challenge corresponding to the second response. The plaintext similarity degree extraction unit 315 removes the random numbers from the second response, thereby calculating a plaintext similarity degree.

Using the processing device 911, the determination unit 306 (similarity degree determination unit) performs individual identification by employing the plaintext similarity degree generated by the plaintext similarity degree extraction unit 315, thereby determining whether or not the user is the correct user. That is, the determination unit 306 analyzes the plaintext similarity degree to determine the generator element of the feature vector for authentication is valid or not.

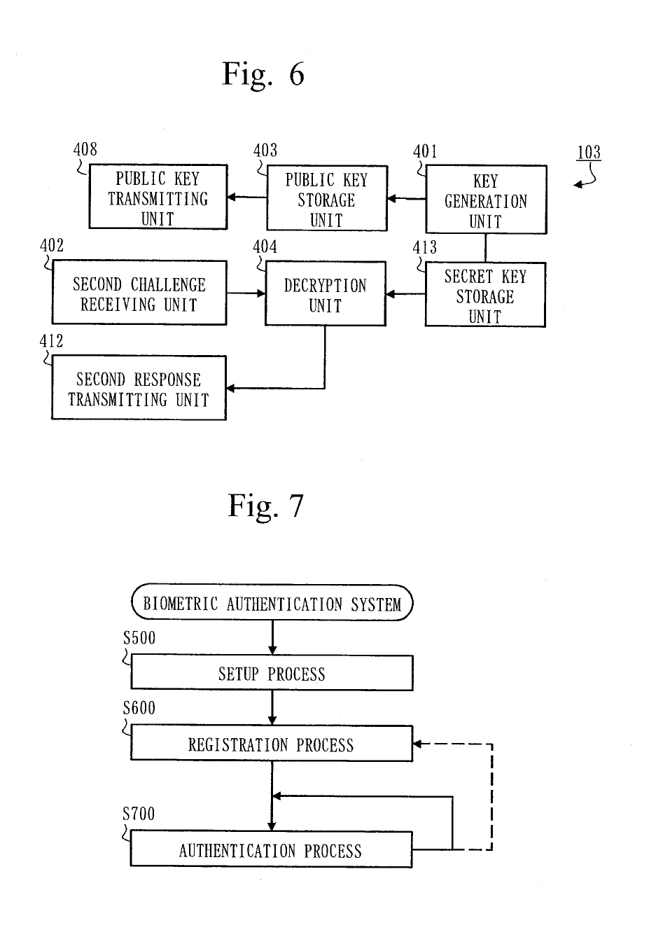

FIG. 6 is a block configuration diagram showing an example of a functional block configuration of the decryption apparatus 103 in this embodiment.

The decryption apparatus 103 includes a key generation unit 401, a secret key storage unit 413, a public key storage unit 403, a public key transmitting unit 408, a second challenge receiving unit 402, a decryption unit 404, and a second response transmitting unit 412, for example.

The key generation unit 401 (a parameter generation unit, a secret key generation unit, a public key calculation unit) generates parameters necessary for encryption and decryption, the public key, a secret key, and the like, using the processing device 911.

The public key transmitting unit 408 (public key notification unit) transmits the public key generated by the key generation unit 401 to the certification apparatus 101 and the authentication apparatus 102 using the output device 913 such as the communication device (communication unit).

The second challenge receiving unit 402 (interim similarity degree ciphertext acquisition unit) receives the second challenge (interim similarity degree ciphertext) from the authentication apparatus 102, using the input device 912 such as the communication device.

The second response transmitting unit 412 (interim similarity degree decrypted text notification unit) transmits the second response (interim similarity degree decrypted text) corresponding to the second challenge to the authentication apparatus 102, using the output device 913 such as the communication device.

The public key storage unit 403 stores various data such as the public key generated by the key generation unit 401, using the storage device 914 (storage unit).

The secret key storage unit 413 stores the secret key generated by the key generation unit 401, using the storage device 914.

The decryption unit 404 (a response generation unit, an interim similarity degree decrypted text calculation unit) generates the second response corresponding to the second challenge transmitted from the authentication apparatus 102, using the processing device 911. The decryption unit 404 decrypts the second challenge (encrypted random similarity degree) to calculate the second response.

FIG. 7 is a flow chart diagram showing an example of an overall operation of the biometric authentication system 100 in this embodiment.

The operation of the biometric authentication system 100 is constituted from three processes, which are a setup process S500, a registration process S600, and an authentication process S700, for example.

In the setup process S500 (setting process), the decryption apparatus 103 generates the parameters, the public key, the secret key necessary, and the like for encryption and decryption.

In the registration process S600, the registration apparatus 104 encrypts the biometric information (comparison data) of each user, and then transmits the encrypted biometric information to the authentication apparatus 102. The authentication apparatus 102 stores the encrypted biometric information (comparison ciphertext).

In the authentication process S700, the authentication apparatus 102 first communicates with the certification apparatus 101 to extract the encrypted biometric information (target ciphertext) from the data (first challenge and first response) used in that communication.

Next, the authentication apparatus 102 communicates with the decryption apparatus 103 to extract a random similarity degree from the data (second challenge and second response) used in that communication based on the extracted encrypted biometric information and the encrypted biometric information registered in advance in the registration process S600.

Finally, the authentication apparatus 102 extracts the plaintext similarity degree from the random similarity, and then compares the similarity degree of the plaintext with a threshold value, thereby determining whether the user is the correct user. The threshold value herein may be a common value set in advance in the system, or a value that is different for each user.

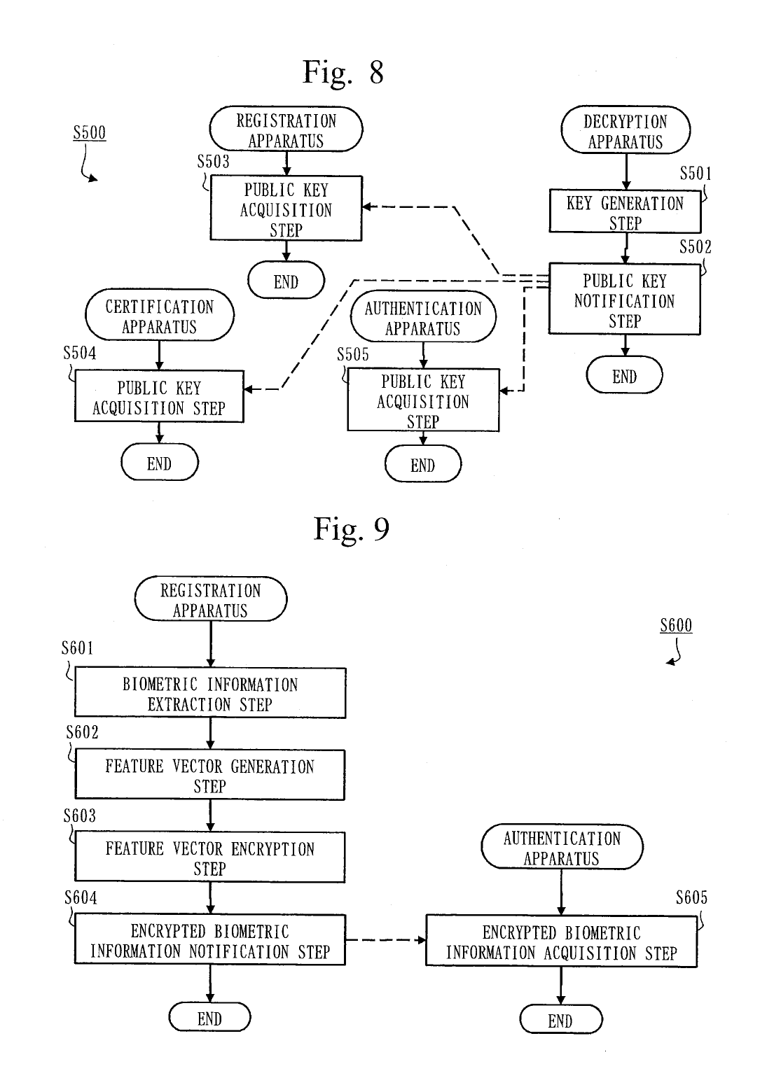

FIG. 8 is a flowchart diagram showing an example of a flow of the setup process S500 in this embodiment.

The setup process S500 includes a key generation step S501, a public key notification step S502, and public key acquisition steps S503 to S505.

First, in the key generation step S501, using the processing device 911, the key generation unit 401 of the decryption apparatus 103 generates a secret key sk and a public key pk, based on the key generation system of the homomorphic encryption system. As the homomorphic encryption system, there is the Okamoto-Takashima encryption system, the BGN encryption system, the Paillier encryption system, or the like, for example.

Next, in the public key notification process S502, the public key storage unit 403 of the decryption apparatus 103 stores the public key pk, using the storage device 914. The secret key storage unit 413 of the decryption apparatus 103 stores the secret key sk, using the storage device 914. The public key transmitting unit 408 of the decryption apparatus 103 transmits the public key pk to each of the registration apparatus 104, the certification apparatus 101, the authentication apparatus 102, and the like, using the output device 913.

In the public key acquisition process S503, the public key receiving unit 208 of the registration apparatus 104 receives the public key pk transmitted by the decryption apparatus 103, using the input device 912. The public key storage unit 202 of the registration apparatus 104 stores the public key pk received by the public key receiving unit 208, using the storage device 914.

In the public key acquisition step S504, the public key receiving unit 218 of the certification apparatus 101 receives the public key pk transmitted by the decryption apparatus 103, using the input device 912. The public key storage unit 212 of the certification apparatus 101 stores the public key pk received by the public key receiving unit 218, using the storage device 914.

In the public key acquisition step S505, the public key receiving unit 308 of the authentication apparatus 102 receives the public key pk transmitted by the decryption apparatus 103, using the input device 912. The public key storage unit 302 of the authentication apparatus 102 stores the public key pk received by the public key receiving unit 308, using the storage device 914.

It may be so configured that the public key pk is transmitted and received through a network or the like, and that the public key pk is distributed to the certification apparatus 101 or the like, using a different method. It may be so configured that, for example, the decryption apparatus 103 stores the public key pk in a recording medium (such as a hard disk drive or an optical disk), the certification apparatus 101 or the like accesses the recording medium through the network or the like, or physically moves the recording medium itself to read the public key pk from the recording medium and then store the read public key pk.

FIG. 9 is a flowchart diagram showing an example of a flow of the registration process S600 in this embodiment.

The registration process S600 includes a biometric information extraction step S601, a feature vector generation step S602, a feature vector encryption step S603, an encrypted biometric information notification step S604, and an encrypted biometric information acquisition step S605, for example.

First, in the biometric information extraction step S601, the biometric information extraction unit 203 of the registration apparatus 104 extracts biometric information of each user, using the input device 912.

In the feature vector generation step S602, the feature vector formation unit 204 of the registration apparatus 104 generates a feature vector b of the biometric information extracted by the biometric information extraction unit 203 in the biometric information extraction step S601, using the processing device 911.

In the feature vector encryption step S603, the random number generation unit 205 of the registration apparatus 104 generates the random numbers, based on the part of the public key pk or the like, using the processing device 911. The encrypted data generation unit 206 of the registration apparatus 104 reads the public key pk stored by the public key storage unit 202, using the processing device 911. The encrypted data generation unit 206 of the registration apparatus 104 generates an encrypted feature vector C, based on the read public key pk and the random numbers generated by the random number generation unit 205, using the processing device 911. The encrypted feature vector C is the one obtained by encrypting the feature vector b.

In the encrypted biometric information notification step S604, the encrypted data transmitting unit 201 of the registration apparatus 104 transmits to the authentication apparatus 102 the encrypted feature vector C generated by the encrypted data generation unit 206 in the feature vector encryption step S603, using the output device 913.

In the encrypted biometric information acquisition step S605, the encrypted data receiving unit 301 of the authentication apparatus 102 receives the encrypted feature vector C transmitted by the registration apparatus 104 in the encrypted biometric information notification step S604, using the input device 912. The encrypted data storage unit 312 of the authentication apparatus 102 stores the encrypted feature vector C received by the encrypted data receiving unit 301, using the storage device 914.

The biometric information of the user and the feature vector b become unnecessary after generation of the encrypted feature vector C. Thus, it is desirable that the biometric information of the user and the feature vector b be erased after generation of the encrypted feature vector C. By doing so, theft of the biometric information of the user and the feature vector by an unauthorized person from the storage device 914 of the registration apparatus 104 may be prevented.

The encrypted feature vector C is encrypted with the public key generated by the decryption apparatus. Thus, even if the unauthorized person has obtained the encrypted feature vector C by intercepting communication between the registration apparatus 104 and the authentication apparatus 102 or stealing the encrypted feature vector C from the storage device 914 of the authentication apparatus 102, the biometric information of the user and the feature vector cannot be known unless the unauthorized person uses the secret key of the decryption apparatus.

Further, as will be described later, the first response including information on the feature vector at a time of authentication can be generated by the feature vector alone, and cannot be generated from the encrypted feature vector. Even if the unauthorized person has obtained the encrypted feature vector C, the unauthorized person cannot generate the first response, so that the unauthorized person cannot spoof the authorized user.

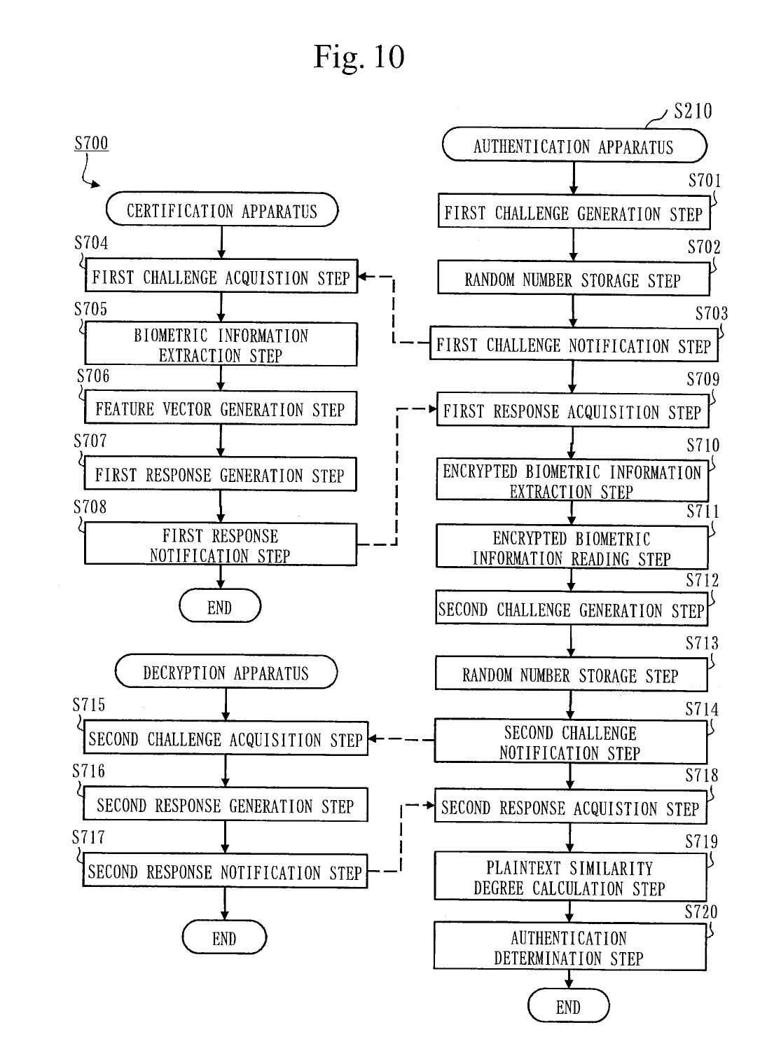

FIG. 10 is a flow chart diagram showing an example of a flow of the authentication process S700 in this embodiment.

The authentication process S700 includes a first challenge generation step S701, a random number storage step S702, a first challenge notification step S703, a first challenge acquisition step S704, a biometric information extraction step S705, a feature vector generation step S706, a first response generation step S707, a first response notification step S708, a first response acquisition step S709, an encrypted biometric information extraction step S710, an encrypted biometric information reading step S711, a second challenge generation step S712, a random storage step S713, a second challenge notification step S714, a second challenge acquisition step S715, a second response generation step S716, a second response notification step S717, a second response acquisition step S718, a plaintext similarity degree calculation step S719, and an authentication determination step S720, for example.

First, in the first challenge generation step S701, using the processing device 911, the random number generation unit 303 of the authentication apparatus 102 reads the public key pk from the public key storage unit 302 to generate the random numbers. The encrypted random number generation unit 304 of the authentication apparatus 102 reads the public key pk from the public key storage unit 302 and encrypts the random numbers generated by the random number generation unit 303, thereby generating the first challenge (encrypted random numbers), using the processing device 911.

In the random storage step S702, the random number storage unit 322 of the authentication apparatus 102 stores the random numbers generated by the random number generation unit 303 in the first challenge generation step S701, using the storage device 914.

In the first challenge notification step S703, the first challenge transmitting unit 311 of the authentication apparatus 102 transmits the first challenge generated by the encrypted random number generation unit 304 in the first challenge generation step S701 to the certification apparatus 101, using the output device 913.

In the first challenge acquisition step S704, the first challenge receiving unit 211 of the certification apparatus 101 receives the first challenge transmitted by the authentication apparatus 102 in the first challenge notification step S703, using the input device 912.

In the biometric information extraction step S705, the biometric information extraction unit 213 of the certification apparatus 101 extracts the biometric information of the user, using the input device 912.

In the feature vector generation step S706, the feature vector formation unit 214 of the certification apparatus 101 forms a feature vector b′ of the biometric information extracted by the biometric information extraction unit 213 in the biometric information extraction step S705, using the processing device 911.

In the first response generation step S707, using the processing device 911, the random number generation unit 215 of the certification apparatus 101 reads the public key pk stored by the public key storage unit 212 to generate the random numbers. The encrypted data embedding unit 217 of the certification apparatus 101 reads the public key pk from the public key storage unit 212, processes the first challenge according to the value of the feature vector b′ formed by the feature vector formation unit 214 in the feature vector generation step S706, based on the random numbers generated by the random number generation unit 215, thereby generating the first response. The first response is the one obtained by embedding an encrypted feature vector C′ in the first challenge.

In the first response notification step S708, the first response transmitting unit 221 of the certification apparatus 101 transmits the first response generated by the encrypted data embedding unit 217 in the first response generation step S707 to the authentication device 102, using the output device 913.

In the first response acquisition step S709, the first response receiving unit 331 of the authentication apparatus 102 receives the first response transmitted by the certification apparatus 101 in the first response notification step S708, using the input device 912.

In the encrypted biometric information extraction step S710, the encrypted data extraction unit 305 of the authentication apparatus 102 extracts from the random number storage unit 322 the random numbers generated by the random number generation unit 303 in the first challenge generation step S701, removes the random numbers from the first response, and then extracts the encrypted feature vector C′, using the processing device 911.

In the encrypted biometric information reading step S711, the encrypted random similarity degree calculation unit 314 of the authentication apparatus 102 extracts the encrypted feature vector C from the encrypted data storage unit 312, using the processing device 911.

In the second challenge generation step S712, the random number generation unit 303 of the authentication apparatus 102 reads the public key pk stored by the public key storage unit 302 to generate the random numbers, using the processing device 911. Using the processing device 911, the encrypted random number generation unit 304 of the authentication apparatus 102 reads the public key pk from the public key storage unit 302 and generates the second challenge (encrypted random similarity degree), based on the encrypted feature vector C′ extracted from the first response by the encrypted data extraction unit 305 in the encrypted biometric information extraction step S710, the encrypted feature vector C extracted in the encrypted biometric information reading step S711, the read public key pk, and the random numbers generated by the random number generation unit 303.

In the random number storage step S713, the random number storage unit 322 of the authentication apparatus 102 stores the random numbers generated by the random number generation unit 303 in the second challenge generation step S712, using the storage device 914.

In the second challenge notification step S714, the second challenge transmitting unit 321 of the authentication apparatus 102 transmits the second challenge generated by the encrypted random similarity degree calculation unit 314 in the second challenge generation step S712 to the decryption apparatus 103, using the output device 913.

In the second challenge acquisition step S715, the second challenge receiving unit 402 of the decryption apparatus 103 receives the second challenge transmitted by the authentication apparatus 102 in the second challenge notification step S714, using the input device 912.

In the second response generation step S716, using the processing device 911, the decryption unit 404 of the decryption apparatus 103 reads the secret key sk from the secret key storage unit 413, performs decryption processing using the secret key sk on the second challenge (encrypted random similarity degree) received by the second receiving unit 402 in the second challenge acquisition step S715, thereby generating the second response (deriving the random similarity degree).

In the second response notification step S717, the second response transmitting unit 412 of the decryption apparatus 103 transmits the second response generated by the decryption unit 404 in the second response generation step S716 to the authentication apparatus 102, using the output device 913.

In the second response acquisition step S718, the second response receiving unit 341 of the authentication apparatus 102 receives the second response transmitted by the decryption apparatus 103 in the second response notification step S717, using the input device 912.

In the plaintext similarity degree calculation step S719, using the processing device 911, the plaintext similarity degree extraction unit 315 of the authentication apparatus 102 extracts from the random number storage unit 322 the random numbers generated by the random number generation unit 303 in the second challenge generation step S712, removes the random numbers from the second response (random similarity degree) received by the second response receiving unit 341 in the second response acquisition step S718, thereby extracting the plaintext similarity degree.

In the authentication determination step S720, using the processing device 911, the determination unit 306 of the authentication apparatus 102 performs identity authentication, based on the plaintext similarity degree extracted in the plaintext similarity degree calculation step S719 and the predetermined threshold value.

The authentication process S700 is started upon receipt of a request for authentication from the certification apparatus 101, for example. It may be so configured, however, that advance preparation of the protocol is performed before the request for the authentication is received so as to reduce the communication cost or the like. To take an example, it may be so configured that the steps from the first challenge generation step S701 to the first challenge acquisition step S704 are executed in advance. That is, before receipt of the request for the authentication from the certification apparatus 101, the authentication apparatus 102 generates the first challenge (encrypted random numbers), and transmits the generated first challenge to the certification apparatus 101. Then, the encrypted data embedding unit 217 of the certification apparatus 101 stores the received first challenge, using the storage device 914. The random numbers used when the first challenge is generated are stored by the random number storage unit 322 of the authentication apparatus 102, using the storage device 914. The random numbers stored by the random number storage unit 322 must not be released to the other apparatus.

As the random numbers generated by the random number generation unit 303 of the authentication apparatus 102 in the first challenge generation step S701 and to be used for generating the first challenge by the encrypted random generation unit 304, there are two types of the random numbers, which are the random numbers as plaintexts and the random numbers to be used for encrypting the plaintexts. Only the random numbers as the plaintexts out of these random numbers should be used as the random numbers stored by the random number storage unit 322 of the authentication apparatus 102 in the random number storage step S702.

In the first response generation step S707, the certification apparatus 101 generates the first response, based on the first challenge and the value of the feature vector, using additive homomorphism of encryption. The first challenge is obtained by encrypting the random numbers as the plaintexts. On the other hand, the value of the feature vector is a plaintext before encryption. The value of the encrypted feature vector is embedded in the first response.

Assume that ciphertexts E(m1) and E(m2) are combined by a group arithmetic operation on a finite group having elements of ciphertexts. Then, a ciphertext E(m1+m2) is derived due to additive homomorphism of encryption. The ciphertext E(m1+m2) is obtained by encrypting a plaintext m1+m2 which is a combination of original plaintexts m1 and m2 by a group arithmetic operation on a finite group having elements of plaintexts. Herein, m1 and m2 indicate the plaintexts. E indicates encryption transformation. “+” indicates the group arithmetic operation on the finite group having the elements of plaintexts or ciphertexts.

Assume that an element obtained by combining n pieces of elements a (n being an integer) of a finite group by a group arithmetic operation on the finite group is described as “n·a”. Then, n·E(m)=E (n·m) holds. Herein, m indicates a plaintext. This operation is called “scalar multiplication”. Herein, the group arithmetic operation on the finite group is described as addition. When a group arithmetic operation on the finite group is described as multiplication, the same operation is called “exponentiation”, and is described as “n^{a}”.

Assume that each plaintext is an integer modulo a predetermined number. Then, the finite group having the elements of plaintexts forms a ring (or a field). Addition and multiplication are performed as the arithmetic operations of the ring. The addition on the finite ring having the elements of plaintexts is associated with the group arithmetic operation on the finite group having the elements of ciphertexts. The multiplication on the finite ring having the element of the integer modulo the predetermined number is equivalent to scalar multiplication. That is, the multiplication on the finite ring having the elements of plaintexts is associated with the scalar multiplication of the element on the finite group having the elements of the ciphertexts.

The inverse element of an element a in multiplication on the finite ring having the elements of plaintexts is described as “a⁻¹”. Assume that an inverse element m⁻¹ of the plaintext m is present. Then, when m⁻¹ pieces of E(n·m) are combined by a group arithmetic operation on the finite group having the elements of ciphertexts, a ciphertext E(n) obtained by encrypting a plaintext n is derived.

The biometric authentication system 100 makes use of this matter.

Assume that the feature vector is a T-dimensional vector (y₁, y₂, . . . y_{T}) (T being an integer not less than 1) having components of integers not less than 0 and less than q. It is assumed, however, that q is an order of a finite ring and is not less than 2. Actual components of the feature vector may be 0 or 1, for example, and may assume only a limited value.

In the first challenge generation step S701, the random number generation unit 303 sets the integers randomly selected from among the integers not less than 0 and less than q as the random numbers as the plaintexts. The random number generation unit 303 generates T pieces of random numbers x₁, x₂, . . . , and x_{T} as the plaintexts. These random numbers are regarded as a vector (x₁, X₂, . . . , x_{T}) of T dimensions that are the same as the feature vector.

The encrypted random number generation unit 304 generates a T-dimensional vector (E(x₁), E(x₂), . . . E(x_{T})) obtained by encryption transforming each component of the T-dimensional vector (x₁, x₂, . . . , x_{T}) This is the first challenge.

In the first response generation step S707, the encrypted data embedding unit 217 scalar multiplies each component of the first challenge (E(x₁), E(x₂), . . . E(x_{T})) by a corresponding component of the feature vector (y₁, y₂, . . . y_{T}), thereby calculating a T-dimensional vector (y₁·(E(x₁), y₂·E(x₂), . . . y_{T}·E(x_{T})). Due to the additive homomorphism of encryption, each component yᵢ·E(xᵢ) (i being each integer not less than 1 and less than T) of the calculated T-dimensional vector forms a ciphertext E(yᵢ·xᵢ) obtained by encryption transforming a product yᵢ·xᵢ of a component yᵢ of the feature vector and a random number xᵢ.

Theoretically, this ciphertext may be set to the first response without alternation. However, by doing so, the value of the feature vector may be able to be calculated, based on the relationship between the first challenge and the first response.

The encrypted data embedding unit 217 performs randomization processing using the random numbers generated by the random number generation unit 215 in order to prevent this calculation of the value of the feature vector. The random numbers to be generated by the random number generation unit 215 are random numbers to be used for encrypting a plaintext. The encrypted data embedding unit 217 generates T ciphertexts E(0) obtained by encrypting a plaintext “0”, using the random numbers generated by the random number generation unit 215. In the encryption system used by the biometric authentication system 100, a plurality of ciphertexts corresponding to one plaintext are present. Then, by randomly selecting one of the ciphertexts from among the plurality of ciphertexts, leakage of information on the plaintext from the ciphertexts is prevented. Accordingly, the plurality of ciphertexts E(0) corresponding to the plaintext “0” are also present. Usually, the T ciphertexts E(0) generated by the encrypted data embedding unit 217 are different to one another. Then, the T ciphertexts E(0) are respectively described as E0₁, E0₂, . . . , and E0_{T}. The encrypted data embedding unit 217 respectively combines the components of the calculated T-dimensional vector (y₁·(E(x₁), y₂·E(x₂), . . . y_{T}·E(x_{T})) and the calculated ciphertexts E0₁, E0₂, . . . , and E0_{T} by the group arithmetic operation on the finite group having the elements of ciphertexts, thereby calculating a T-dimensional vector (y₁·E(x₁)+E0₁, y₂·E(x₂)+E0₂, . . . , y_{T}·E(X_{T})+E0_{T}). Due to the additive homomorphism of encryption, each component yᵢ·E(xᵢ)+E0ᵢ (i being each integer not less than 1 and less than T) of the calculated T-dimensional vector forms a ciphertext E(yᵢ·xᵢ) obtained by encryption transforming the product yᵢ·xᵢ of the component yᵢ of the feature vector and the random number xᵢ. This ciphertext is, however, different from the ciphertext before combining the ciphertext E0ᵢ.

This T-dimensional vector (y₁·E(x₁)+E0₁, y₂·E(x₂)+E0₂, . . . , y_{T}·E(x_{T})+E0_{T})=(E(y₁·x₁), E(y₂·x₂), . . . E(y_{T}·x_{T})) is set to the first response.

In the encrypted biometric information extraction step S710, the encrypted data extraction unit 305 respectively calculates inverse elements (inverse numbers) of x₁⁻¹, x₂⁻¹, . . . , x_{T}⁻¹ in multiplication of integers modulo q for the T pieces of random numbers x₁, x₂, . . . , and x_{T} stored by the random number storage unit 322. When q is a prime number, a finite ring having elements of the integers modulo q forms a field. Thus, the inverse elements are surely present. When q is not the prime number, the inverse elements in the multiplication may not be present. When q is sufficiently large, the possibility that the inverse elements are not present is extremely low, so that the possibility should be ignored.

The encrypted data extraction unit 305 respectively scalar multiplies components of the first response of (E(y₁·x₁), E(y₂·x₂), . . . E(y_{T}·x_{T})) by the calculated inverse elements, thereby calculating a T-dimensional vector (x₁⁻¹·E(y₁·x₁), x₂⁻¹·E(y₂·x₂), . . . x_{T}⁻¹·E(y_{T}·x_{T})). Due to the additive homomorphism of encryption, each component xᵢ⁻¹·E (yᵢ·xᵢ) of the calculated T-dimensional vector (i being each integer not less than 1 and less than T) forms a ciphertext E(yᵢ) obtained by encryption transforming a component yᵢ of the feature vector.

With this arrangement, the authentication apparatus 102 calculates the encrypted feature vector C′.

The inverse elements in the multiplication of the integers modulo q can be readily calculated. Accordingly, when the random number xᵢ is known, the inverse element xᵢ⁻¹ can be readily calculated. Consequently, it is easy to calculate the encrypted feature vector C′ from the first response. However, when the random number xᵢ is not known, it is virtually impossible to calculate the encrypted feature vector C′ from the first response. That is, the random numbers as the plaintexts generated by the random number generation unit 303 in the first challenge generation step S701 constitute a secret key (temporary secret key) known by the authentication apparatus 102 alone. The first challenge obtained by encrypting the random numbers as the plaintexts constitute a public key (temporary public key) for generating the first response from the feature vector.

The first response is herein the one obtained by encrypting the feature vector with the public key of the authentication apparatus 102 and is also the one obtained by encrypting the feature vector with the public key pk of the decryption apparatus 103. It may be said that the first response is obtained by dually encrypting the feature vector. The authentication apparatus 102 can decrypt the first response with the secret key. However, the encrypted feature vector obtained by encrypting the feature vector with the public key pk of the decryption apparatus 103 is obtained as the result of the decryption. The secret key sk of the decryption apparatus 103 is needed in order to obtain the feature vector by further decrypting the encrypted feature vector. The authentication apparatus 102 does not know the secret key sk associated with the public key pk. Thus, the authentication device 102 cannot decrypt the encrypted feature vector C and the encrypted feature vector C′.

Even if a device that has spoofed the authentication apparatus 102 has generated a set of a secret key sk′ and a public key pk′ and has generated the first challenge by encryption transformation using the generated public key pk′ rather than generating the first challenge by encryption transformation using the public key pk of the decryption apparatus 103, the device cannot decrypt the encrypted feature vector C′ from the first response. The ciphertext E0ᵢ is combined with each component of the first response by encryption transformation using the public key pk of the decryption apparatus 103. Thus, the first response becomes insignificant data that cannot be decrypted with any secret key when the encryption transformation is performed. That is, it is necessary that the public key stored by the certification apparatus 101 be the same as the public key stored by the authentication apparatus 102 in order for the first response to become significant data.

As the random numbers as well generated by the random number generation unit 303 of the authentication apparatus 102 in the second challenge generation step S712, there are two types of the random numbers, which are the random numbers as plaintexts and the random numbers to be used for encryption. The random numbers to be stored by the random number storage unit 322 of the authentication apparatus 102 in the random number storage step S713 should be only the random numbers as the plaintexts out of the two types of the random numbers.

The random numbers as the plaintexts generated by the random number generation unit 303 in the first challenge generation step S701 constitute the key (temporary secret key) for decrypting the first response. Similarly, the random numbers as the plaintexts generated by the random number generation unit 303 in the second challenge generation step S712 constitute a key (temporary key) for decrypting the second response.

The relationship between the second challenge and the second response is, however, different from the relationship between the first challenge and the first response. The first challenge is the public key to be used only once by the authentication apparatus 102. The certification apparatus 101 dually encrypts the feature vector with the public key of the authentication apparatus 102 and the public key of the decryption apparatus 103, thereby generating the first response. On contrast therewith, the second challenge is encrypted data. The second challenge is data obtained by further encrypting data encrypted with the public key of the decryption apparatus 103 using the key of the authentication apparatus 102. That is, the second challenge is dually encrypted data. The decryption apparatus 103 decrypts the second challenge with the secret key of the decryption apparatus 103, thereby generating the second response. The decryption apparatus 103 decrypts the dually encrypted second challenge, thereby generating data encrypted with the key of the authentication apparatus 102 alone. The authentication apparatus 102 decrypts the second response with the key of the authentication apparatus 102, thereby obtaining the plaintext similarity degree.

Calculation for calculating the plaintext similarity degree is divided into some stages. The stages are respectively executed in the second challenge generation step S712, the second response generation step S716, and the like, for example. In the second challenge generation step S712, the authentication apparatus 102 executes a portion of the calculation for calculating the similarity degree with the feature vectors kept encrypted. Accordingly, the authentication apparatus 102 cannot know the feature vectors in this stage. The second challenge is obtained by dually encrypting data in a state where the portion of the calculation has already been finished. Since the portion of the calculation is already finished, all of information on the original feature vectors is not included in the second challenge. Only information necessary for calculating the similarity degree is included in the second challenge. In the second response generation step S716, the decryption apparatus 103 decrypts the second challenge to derive data obtained by encrypting the information necessary for the calculation of the similarity degree with the key of the authentication apparatus 102. The decryption apparatus 103 executes a portion of the calculation for calculating the similarity degree with the data kept encrypted with the key of the authentication apparatus 102. Accordingly, the decryption apparatus 103 cannot know the feature vectors and the plaintext similarity degree in this stage. The second response is the one obtained by encrypting data in a state where almost all of the calculation has already been finished. Since almost all of the calculation is already finished, the information on the original feature vectors is not included in the second response. In the plaintext similarity degree calculation step S719, the authentication apparatus 102 decrypts the second response to calculate the similarity degree. The plaintext similarity degree itself is not derived before the plaintext similarity degree calculation step S719.

The plaintext similarity degree is information only indicating to what degree the feature vector b for registration is similar to the feature vector b′ for authentication. Thus, it is difficult to calculate the feature vectors and the biometric information from the plaintext similarity degree.

Next, a description will be given about an example where a specific encryption system has been used for details of processing in each stage. In this embodiment, the description will be directed to the example where the Okamoto-Takashima encryption system has been used.

First, the Okamoto-Takashima encryption system will be outlined.

Assume that q is a prime number not less than 2. Assume that G and G_{T} are finite groups each having an order q. A group arithmetic operation on each of the finite groups G and G_{T} will be described as multiplication. Assume that F_{q} is a finite field having elements of integers not less than 0 and less than q. Assume that e is a pairing G×G→G_{T} that maps a set of two elements of the finite group G to an element of the finite group G_{T}. The pairing e satisfies bilinearity and non-degenerateness. The bilinearity is a property with which e(u^{a}, v^{b})=e(u, v)^{ab} is established for two arbitrary elements u, v in the finite group G and two arbitrary elements a,b in the finite group F_{q}. The non-degenerateness is a property with which at least one element g that satisfies e(g, g)≠1 exists in elements of the finite group G. The pairing e may be an asymmetric pairing.

Assume that V is a direct product set G×G× . . . G constituted from n pieces of the finite groups G.

With respect to addition “+” on the direct product set V, an element (g^{x1+y1}, g^{x2+y2}, . . . , g^{xn+yn}) of the direct product set V is defined as a coupling x+y by addition “+” of two arbitrary elements x=(g^{x1}, g^{x2}, . . . , g^{xn}) and y=(g^{y1}, g^{y2}, . . . , g^{yn}) on the direct product set V.

With respect to scalar multiplication on the direct product set V, an element (g^{αx1}, g^{αx2}, g^{αxn}) on the direct product set V is defined as an element αx obtained by scalar multiplying an arbitrary element x=(g^{x1}, g^{x2}, . . . , g^{xn}) on the direct product set V by an arbitrary element α on the definite field F_{q}.

In this case, the direct product set V constitutes a vector space. Each element in the vector space V is called a “vector”.

With respect to a pairing e: V×V→G_{T} of the vector spaces V, an element Πᵢ [e(uᵢ, vᵢ) (in which iε({1, 2, . . . , n}) on the finite group G_{T} is defined as a pairing e (u, v) of two arbitrary vectors of u=(u₁, u₂, . . . , uₙ) and v=(v₁, v₂, . . . , vₙ) in the vector spaces V.

Further, “A” is defined as a sequence of n vectors (a₁, a₂, . . . , aₙ) in the vector space V. Then, a vector aᵢ=(aᵢ₁, aᵢ₂, . . . , aᵢₙ) is so defined that, when i=j, aᵢⱼ=g, and when i≠j, aᵢⱼ=1 (1 is a unit element of the finite group G).

In this case, the “A” constitutes the base of the vector space V. The base A is called a canonical base.

With respect to a distortion map φᵢⱼ: V→V in the vector space V, a vector xⱼaᵢ is defined as a distortion map φᵢⱼ(x) of an arbitrary vector x in the vector space V, assuming that the vector x=x₁a₁+x₂a₂+ . . . +xₙaₙ and i and j are two arbitrary integers not less than 1 and less than n. It is also assumed that the distortion map φᵢⱼ can be efficiently calculated using a computer.

In the vector spaces V, there are the canonical bases, a pairing of the vector spaces is defined, and the distortion map that can be calculated is defined. The vector spaces as mentioned above are called bilinear pairing vector spaces.

Assume that “X” is an n-dimensional i-row, j-column square matrix having elements of n² values of χᵢⱼ (each of i, j being each integer not less than 1 and less than n) uniform randomly selected from the finite field F_{q}. When the value of q is sufficiently large, the square matrix X will be a regular matrix at a very high probability.

“B” is defined to be a sequence of n vectors (b₁, b₂, . . . , bₙ) in the vector space V, and it is defined that bᵢ=Σⱼ[χᵢ, ⱼaᵢ] (in which i and j are each the integer not less than 1 and less than n). When the square matrix X is the regular matrix, “B” constitutes the base of the vector space V, like “A”. The base B is called a random base.

In this case, the following property is established.

When elements (x₁, x₂, . . . , xₙ) of a direct product F_{q}ⁿ of n pieces of the definite fields F_{q} are given, a vector x=x₁b₁+x₂b₂+ . . . +xₙbₙ in the vector space V can be easily calculated. When a vector x=x₁b₁+x₂b₂+ . . . +X_{L}b_{L} (L being an integer not less than 2 and less than n) in the vector V is given, a vector y=x₁b₁+x₂b₂+x₁b₁ (1 being an integer not less than 1 and less than L) in the vector space V can be calculated, using the regular matrix X. However, when the regular matrix X is not used, it is difficult to calculate the vector y, which is as difficult as to perform a generalized Diffie-Hellman calculation.

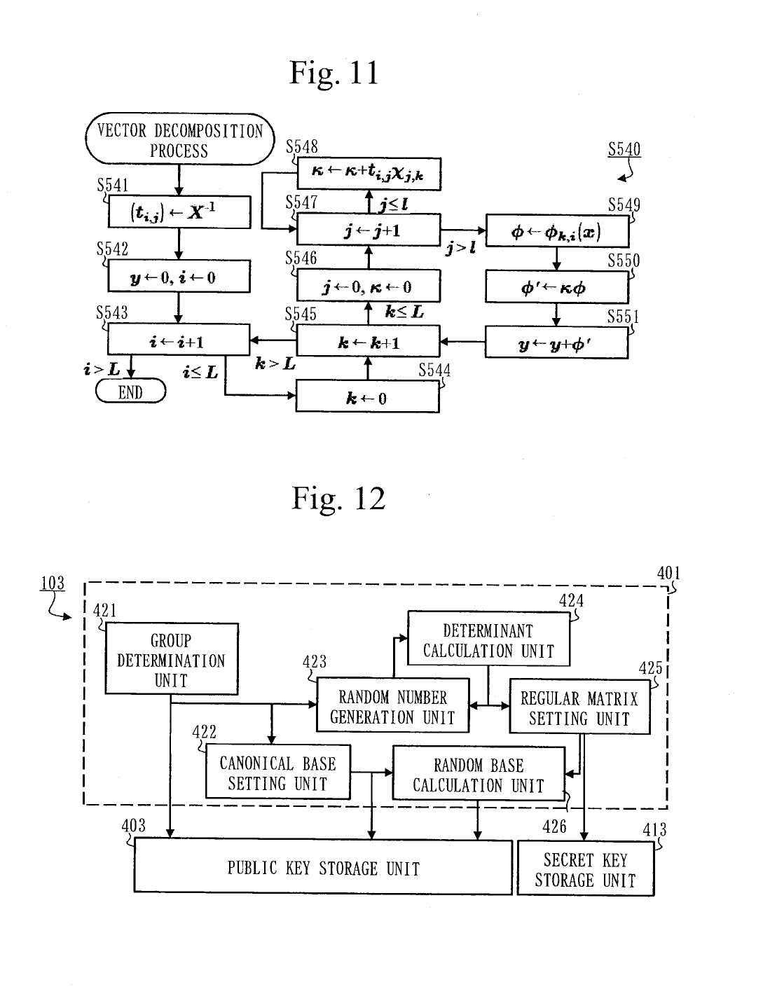

FIG. 11 is a flowchart diagram showing an example of a flow of a vector decomposition process S540 to solve the problem of vector decomposition, using the regular matrix X.

In the vector decomposition process S540, the vector x in the vector space V, vector components <b₁, b₂, . . . , b₁> to be extracted from the vector x, the regular matrix X of n dimensions, and the random base B are input, and a vector y=ΣᵢΣⱼΣₖ[tᵢ, ⱼχⱼ, ₖφₖ, ᵢ(x)] in the vector space V (in which i is an integer not less than 1 and not more than L, j is an integer not less than 1 and not more than 1, k is an integer not less than 1 and not more than L, and t_{i,j} is a component in the ith column and the jth row of an inverse matrix T=X⁻¹ of the regular matrix X) is output. The vector decomposition process S540 includes an inverse matrix calculation step S541, a first initialization step S542, a first repetition step S543, a second initialization step S544, a second repetition step S545, a third initialization step S546, a third repetition step S547, a factor summation step S548, a map calculation step S549, a scalar multiplication step S550, and a vector summation step S551.

First, the inverse matrix X⁻¹ of the regular matrix X is calculated in the inverse matrix calculation step S541.

In the first initialization step S542, the element y of the vector space V is initialized to 0. The integer i is initialized to 0.

In the first repetition step S543, the integer i is incremented by 1. When the integer i is larger than the integer L, the element y is output, and the vector decomposition process S540 is finished. When the integer i is not more than L, the process proceeds to the second initialization step S544.

In the second initialization step S544, the integer k is initialized to 0.

In the second repetition step S545, the integer k is incremented by 1. When the integer k is larger than the integer L, the process returns to the first repetition step S543. When the integer k is not more than the integer L, the process proceeds to the third initialization step S546.

In the third initialization step S546, the integer j is initialized to 0, and a factor κ is initialized to 0.

In the third repetition step S547, the integer j is incremented by 1. When the integer j is larger than the integer 1, the process proceeds to the map calculation step S549. When the integer j is not more than the integer 1, the process proceeds to the factor summation step S548.

In the factor summation step S548, the product of the component t_{i,j} in the ith row and the jth column of the inverse matrix X⁻¹ calculated in the inverse matrix calculation step S541 and a component χ_{j, k} in the j-th row and the k-th column of the regular matrix X is calculated. The calculated product is added to the factor κ, and then the process returns to the third repetition step S547.

In the map calculation step S549, a distortion map φ_{k,i}(x) of the vector x in the vector space V is calculated, and is then set to a vector φ.

In the scalar multiplication step S550, a vector φ′=κφ obtained by multiplying the vector φ=φ_{k,i}(x) in the map calculation step S549 by κ is calculated.

In the vector summation step S551, the vector φ′=κ_{k,i}(x) calculated in the scalar multiplication step S550 is added to the vector y, and then the process returns to the second repetition step S545.

In the Okamoto-Takashima encryption system, the regular matrix X is used as a secret key, thereby realizing a trap door function.

Assume, for example, that an element m of the finite field F_{q} is set to a plaintext and a vector mb₁+r₂b₂+ . . . +rₙbₙ in the vector space V is set to a ciphertext E(m) obtained by encrypting the plaintext m. Assume that rᵢ (i being an integer not less than 2 and not more than n) is set to an element uniform randomly selected from the finite field F_{q}. When performing decryption, the vector decomposition process S540 is performed to calculate a vector mb₁ in the vector space V from the ciphertext E(m), using the regular matrix X that is the secret key, thereby erasing rᵢ, which is a randomization element.

FIG. 12 is a detailed block diagram showing an example of a configuration of the key generation unit 401 in this embodiment.

The key generation unit 401 of the decryption apparatus 103 includes a group determination unit 421, a canonical base setting unit 422, a random number generation unit 423, a determinant calculation unit 424, a regular matrix setting unit 425, and a random base calculation unit 426, for example.

Using the processing device 911, the group determination unit 421 generates the prime number q, based on the size (number of bits) defined according to the security level. The larger the prime number q is, the higher safety is obtained. However, the ciphertext size increases, so that it takes time to perform encryption processing and decryption processing. The size of the prime number q is 200 bits, 1024 bits, or the like, for example. The group determination unit 421 determines the finite group G and the finite group G_{T} based on the generated prime number q. Each of the finite group G and the finite group G_{T} determined by the group determination unit 421 has the order of q, and the finite group G and the finite group G_{T} have the pairing e: G×G→G_{T}. The group determination unit 421 calculates a generator element g of the finite group G. The order of setting may be different. It may be so configured, for example, that the finite group G is first determined, the order of the finite group G is calculated, and then it is determined whether the order of the finite group G is the prime number having a size that satisfies the security level.

Using the processing device 911, the canonical base setting unit 422 sets the vector space V of n dimensions, based on a dimension n defined according to the security level, thereby setting the canonical base A of the vector space V. The larger the dimension n is, the higher security is provided. However, the ciphertext size increases, so that it takes time to perform encryption processing and decryption processing. The dimension n is, for example, 3 or the like.

Using the processing device 911, the random number generation unit 423 generates n² pieces of random numbers χ_{i,j} (each of i and j being each integer not less than 1 and not more than n) based on the order q of the finite group G determined by the group determination unit 421. The random numbers χ_{i,j} generated by the random number generation unit 423 are integers uniform randomly selected from among integers not less than 0 and less than q.

Using the processing device 911, the determinant calculation unit 424 generates the square matrix X of n dimensions based on the n² pieces of random numbers χ_{i,j} generated by the random number generation unit 423. The square matrix X generated by the determinant calculation unit 424 is a matrix of i rows and j columns each having elements of the random numbers χ_{i,j}. The determinant calculation unit 424 calculates a determinant |X| of the generated square matrix X, using the processing device 911.

When the determinant |X| calculated by the determinant calculation unit 424 is not 0, the regular matrix setting unit 425 sets the square matrix X generated by the determinant calculation unit 424 to a regular matrix X, using the processing device 911.

Using the processing device 911, the random base calculation unit 426 calculates the random base B based on the canonical base A set by the canonical base setting unit 422 and the regular matrix X set by the regular matrix setting unit 425. Each vector bᵢ (i being each integer not less than 1 and not more than n) of the random base B calculated by the random base calculation unit 426 is given by bᵢ=Σⱼ[χ_{i,j}aⱼ] (j being each integer not less than 1 and not more than n). The random base calculation unit 426 calculates the ith vector bᵢ of the random base B in the following manner, for example. The random base calculation unit 426 calculates a vector 102 ᵢ, ⱼaⱼ obtained by scalar multiplying the vector aⱼ by χ_{j, i} in the vector space V for each integer j not less than 1 and not more than n, based on the element χ_{i,j} in the ith row and the jth column of the regular matrix X and the jth vector aⱼ of the canonical base A. The random base calculation unit 426 calculates a vector Σⱼ[χᵢ, ⱼaⱼ] obtained by combining calculated n vectors χᵢ, ⱼaⱼ, by addition in the vector space V.

The public key storage unit 403 of the decryption apparatus 103 stores as the public key pk, a set (q, V, e, G_{T}, A, and B) of the order q, the pairing e, and the finite group G_{T} set by the group setting unit 421, the vector space V and the canonical base A set by the canonical base setting unit 422, and the random base B set by the random base calculation unit 426.

Using the storage device 914, the secret key storage unit 413 of the decryption apparatus 103 stores the regular matrix X set by the regular matrix setting unit 425, as the secret key sk.

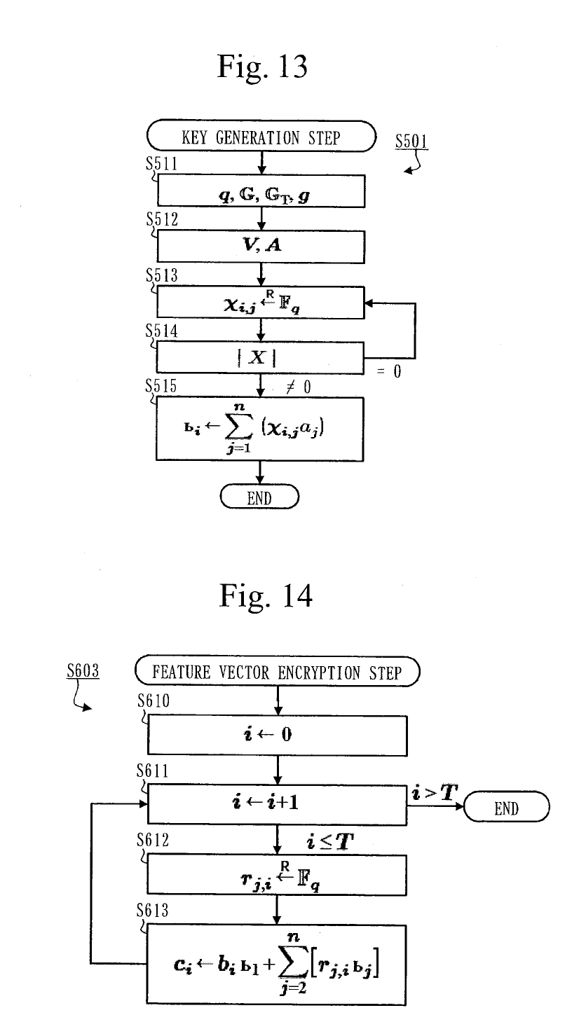

FIG. 13 is a flow chart diagram showing an example of a flow of processes of the key generation step S501 in this embodiment.

In the key generation step S501, the decryption apparatus 103 generates a set of the public key pk and the secret key sk. It may be so configured that a different set of the public key pk and the secret key sk is generated for each user. Alternatively, one set of the public key pk and the secret key sk may be generated for the overall system.

The key generation step S501 includes a group determination step S511, a canonical base setting step S512, a matrix generation step S513, a regular matrix determination step S514, and a random base calculation step S515, for example.

First, in the group determination step S511, the group determination unit 421 determines the order q, the finite group G and the finite group G_{T} each having the order q, and the generator element g of the finite group G, using the processing device 911. The public key storage unit 403 stores the order q and the finite group G_{T} determined by the group determination unit 421, as a part of the public key pk, using the storage device 914.

In the canonical base setting step S512, the canonical base setting unit 422 sets the vector space V and the canonical base A of the vector space V, based on the finite group G determined by the group determination unit 421 in the group determination step S511, using the processing device 911. The public key storage unit 403 stores the vector space V and the canonical base A set by the canonical base setting unit 422, as a part of the public key pk, using the storage device 914.

In the matrix generation step S513, the random number generation unit 423 generates the n² random numbers χ_{i, j}, using the processing device 911. The determinant calculation unit 424 generates the n-dimensional square matrix X, based on the n² random numbers χ_{i, j}, generated by the random number generation unit 423.

In the regular matrix determination step S514, the determinant calculation unit 424 calculates the determinant |X| of the square matrix X generated in the matrix generation step S513, using the processing device 911.

When the determinant |X| calculated by the matrix calculation unit 424 is 0, the determinant calculation unit 424 causes the process to return to the matrix generation step S513, and the random number generation unit 423 generates random numbers again.

When the determinant |X| calculated by the matrix calculation unit 424 is not 0, the regular matrix setting unit 425 sets the square matrix X as the regular matrix X, using the processing device 911. The secret key storage unit 413 stores the regular matrix X set by the regular matrix setting unit 425 as the secret key sk, using the storage device 914.

In the random base calculation step S515, using the processing device 911, the random base calculation unit 426 calculates the random base B, based on the canonical base A set by the canonical base setting unit 422 in the canonical base setting step S512 and the regular matrix X set by the regular matrix setting unit 425 in the regular matrix determination step S514. Using the storage device 914, the public key storage unit 403 stores the random base B calculated by the random base calculation unit 426, as a part of the public key pk.

The public key pk=(q, V, e, G_{T}, A, B) stored by the public key storage unit 403 in this manner is transmitted to each of the authentication apparatus 102 and the like by the public key transmitting unit 408. Each of the authentication apparatus 102 and the like receives and then stores the transmitted public key.

FIG. 14 is a flow chart diagram showing an example of a flow of processes of the feature vector encryption step S603 in this embodiment.

In the feature vector encryption step S603, the registration apparatus 104 encrypts the feature vector b to generate the encrypted feature vector C. The feature vector encryption step S603 includes an initialization step S610, a repetition step S611, a random number generation step S612, and a vector calculation step S613, for example.

The feature vector b formed by the feature vector formation unit 204 of the registration apparatus 104 and then encrypted by the encryption data generation unit 206 is a T-dimensional vector (b₁, b₂, . . . , b_{T}) (T being an integer not less than 1) having components of integers, for example. Each component bᵢ (i being each integer not less than 1 and not more than T) is one of two values of 0 and 1, for example, and indicates whether or not the biometric information has a feature corresponding to the component. The feature vector formation unit 204 divides an image (indicating biometric information) obtained by applying light to the fingerprint to shoot the pattern by the biometric information extraction unit 203 into T regions, and then determines whether or not a feature point (such as an end point or a branch point of the pattern) is present in each of the divided regions, for example. The feature vector formation unit 204 sets 0 or 1 to the feature vector component corresponding to the region. 0 indicates that the feature point exists. 1 indicates that the feature point does not exist

The encrypted feature vector C is a T-dimensional vector (c₁, c₂, . . . , c_{T}) having components of vectors in the vector space V.

First, in the initialization step S610, the encrypted data generation unit 206 initializes the integer i to 0, using the processing device 911.

In the repetition step 611, the encrypted data generation unit 206 adds 1 to the integer i, using the processing device 911. When the integer i is larger than T, the encrypted data generation unit 206 finishes the feature vector encryption step S603. When the integer i is not more than T, the encrypted data generation unit 206 causes the process to proceed to the random number generation step S612 to generate an ith component cᵢ of the encrypted feature vector C.

In the random number generation step S612, the random number generation unit 205 generates (n−1) pieces of random numbers r_{j, i} (j being each integer not less than 2 and not more than n), based on the order q which is a part of the public key pk stored by the public key storage unit 202. The random numbers r_{j, i} generated by the random number generation unit 205 are integers uniform randomly selected from among integers not less than 0 and less than q.

In the vector calculation step S613, using the processing device 911, the encrypted data generation unit 206 calculates the ith component cᵢ of the encrypted feature vector C, based on the random base B which is the part of the public key pk stored by the public key storage unit 202, an ith component bᵢ of the feature vector b generated by the feature vector formation unit 204, and the (n−1) pieces of random numbers r_{j, i} generated by the random number generation unit 205 in the random number generation step S612. The ith component cᵢ of the encrypted feature vector C calculated by the encrypted data generation unit 206 is a vector bᵢb₁+Σⱼ[r_{j,i}bⱼ] (j being each integer not less than 2 and not more than n) obtained by combining a vector bᵢb₁ and (n−1) vectors r_{j,i}bⱼ by addition in the vector space V. The vector bᵢb₁ is obtained by scalar multiplying a first vector b₁ of the random base B by an integer bᵢ using scalar multiplication in the vector space V. The (n−1) vectors r_{j,i}bⱼ are each obtained by scalar multiplying a vector bⱼ (j being each integer not less than 2 and not more than n) of the second and subsequent vectors of the random base B by the random number r_{j,i} by scalar multiplication in the vector space V. To take an example, the encrypted data generation unit 206 calculates the vector bᵢb₁ by scalar multiplying the first vector b₁ of the random base B by the integer bᵢ using scalar multiplication in the vector space V, based on the first vector b₁ of the random base B and ith component bᵢ of the feature vector b. Based on a jth vector bⱼ of the random base B and a (j−1)th random number r_{j, i} of the (n−1) pieces of random numbers generated by the random number generation unit 205, the encrypted data generation unit 206 calculates the vector r_{j,i}bⱼ by scalar multiplying the vector bⱼ by the random number r_{j,i} by scalar multiplication in the vector space V, for each integer j not less than 2 and not more than n. The encrypted data generation unit 206 calculates the vector bᵢb₁+Σⱼ[r_{j,i}bⱼ] (j being each integer not less than 2 and not more than n) by combining the calculated vector bᵢb₁ and all of the calculated (n−1) vectors r_{j,i}bⱼ, by addition in the vector space V.

The encrypted data generation unit 206 causes the process to return to the repetition process S611 to generate the subsequent component of the encrypted feature vector C.

The encrypted feature vector C generated by the encrypted data generation unit 206 in this manner is transmitted to the authentication apparatus 102 by the encrypted data transmitting unit 201. The authentication apparatus 102 receives and then stores the encrypted feature vector C.

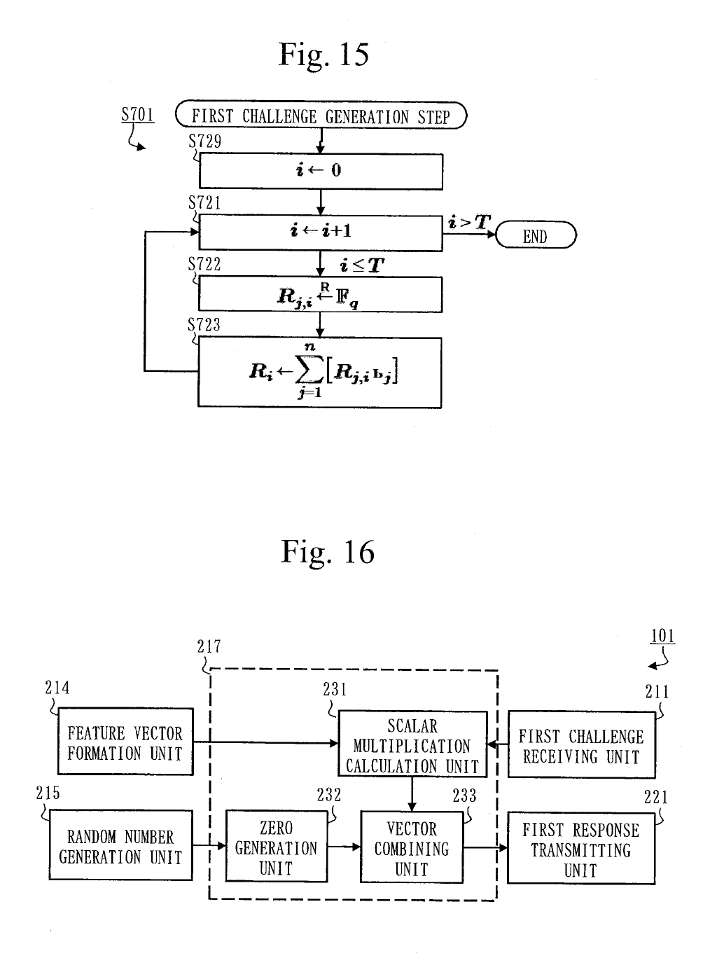

FIG. 15 is a flow chart diagram showing an example of a flow of processes of the first challenge generation step S701 in this embodiment.

In the first challenge generation step S701, the authentication apparatus 102 generates a first challenge R. The first challenge generation step S701 includes an initialization step S729, a repetition step S721, a random number generation step S722, and a vector calculation step S723, for example.

The first challenge R generated by the encrypted random number generation unit 304 of the authentication apparatus 102 is a T-dimensional vector (R₁, R₂, . . . , R_{T}) having components of vectors in the vector space V.

First, in the initialization step S729, the encrypted random number generation unit 304 initializes the integer i to 0, using the processing device 911.

In the repetition step S721, the encrypted random number generation unit 304 adds 1 to the integer i, using the processing device 911. When the integer i is larger than T, the encrypted random number generation unit 304 finishes the first challenge generation step S701. When the integer i is not more than T, the encrypted random number generation unit 304 causes the process to proceed to the random generation step S722 to generate an ith component Rᵢ of the first challenge R.

In the random number generation step S722, the random number generation unit 303 generates n pieces of random numbers R_{j,i} (j being each integer not less than 1 and not more than n), based on the order q which is the part of the public key pk stored by the public key storage unit 302. The random numbers R_{j, i} generated by the random number generation unit 303 are integers uniform randomly selected from among integers not less than 0 and less than q. The random number storage unit 322 stores a first random number R_{1, j} of the n pieces of random numbers R_{j, i} generated by the random number generation unit 303, using the storage device 914.

In the vector calculation step S723, using the processing device 911, the encrypted random number generation unit 304 calculates the ith component Rᵢ of the first challenge R, based on the random base B which is the part of the public key pk stored by the public key storage unit 302 and the n pieces of random numbers R_{j, i} generated by the random number generation unit 303 in the random number generation step S722. The ith component Rᵢ of the first challenge R calculated by the encrypted random number generation unit 304 is a vector Σⱼ[R_{j,i}bⱼ] (j being each integer not less than 1 and not more than n) obtained by combining n vectors R_{j,i}bⱼ by addition in the vector space V. The n vectors R_{,j i}bⱼ are each obtained by scalar multiplying each vector bⱼ (j being each integer not less than 1 and not more than n) by the random number R_{j, i} by scalar multiplication in the vector space C. To take an example, based on the jth vector bⱼ of the random base B and a jth random number R_{j,i} of the n pieces of random numbers generated by the random number generation unit 205, the encrypted random number generation unit 304 calculates the vector R_{j,i}bⱼ by scalar multiplying the vector bⱼ by the random number R_{j,i} by scalar multiplication in the vector space V, for each integer j not less than 1 and not more than n. The encrypted random number generation unit 304 calculates the vector Σⱼ[R_{j,i}bⱼ] (j being each integer not less than 1 and not more than n) by combining the calculated n vectors R_{j,i}bⱼ by addition in the vector space V.

The encrypted random number generation unit 304 causes the process to return to the repetition process S721 to generate the subsequent component of the first challenge R.

The first challenge R generated by the encrypted random number generation unit 304 in this manner is transmitted to the certification apparatus 101 by the first challenge transmitting unit 311. The certification apparatus 101 receives and then stores the first challenge R.

The number of the random numbers R_{j, i} (i being each integer not less than 1 and not more than T. j being each integer not less than 1 and not more than n) generated by the random number generation unit 303 in the first challenge generation step S701 is nT in total. Out of these nT pieces of random numbers, T pieces of random numbers R_{1, i} (i being each integer not less than 1 and not more than T) are stored by the random number storage unit 322. The T pieces of random numbers R_{1, i} stored by the random number storage unit 322 are random numbers as plaintexts, and the remaining (n−1) T pieces of random numbers R_{j, i} (i being each integer not less than 1 and not more than T. j being each integer not less than 2 and not more than n) are random numbers for encryption. Each component Rᵢ of the first challenge R is obtained by encrypting the random number R_{1,i} as a plaintext.

FIG. 16 is a detailed block diagram showing an example of a configuration of the encrypted data embedding unit 217 in this embodiment.

The encrypted data embedding unit 217 of the certification apparatus 101 includes a scalar multiplication calculation unit 231, zero generation unit 232, and a vector combining unit 233, for example.

The feature vector b′ generated by the feature vector formation unit 314 and encrypted by the encrypted data embedding unit 217 is a T-dimensional vector (b′₁, b′₂, . . . , b′_{T}) having components of integers, like the feature vector b generated by the feature vector formation unit 204 of the registration apparatus 104.

Using the processing device 911, the random number generation unit 215 generates (n−1) T pieces of random numbers R′_{j,i} (i being each integer not less than 1 and not more than T, j being each integer not less than 2 and not more than n) based on the order q which is the part of the public key pk stored by the public key storage unit 212. The random numbers R′_{j, i} generated by the random number generation unit 215 are integers random uniformly selected from among integers not less than 0 and less than q.

Using the processing device 911, the scalar multiplication calculation unit 231 calculates a scalar multiplication vector [symbol] [symbol] based on the first challenge R received by the first challenge receiving unit 211 and the feature vector b′ formed by the feature vector formation unit 214. The scalar multiplication vector is a T-dimensional vector having components of vectors ( [symbol] ₁, [symbol] ₂, . . . , [symbol] _{T}) in the vector space V, like the first challenge R. An ith component [symbol] ᵢ (i being the integer not less than 1 and not more than T) of the scalar multiplication vector calculated by the scalar multiplication calculation unit 231 is a vector b′ᵢRᵢ obtained by scalar multiplying the ith component Rᵢ of the first challenge R by an ith component b′ᵢ of the feature vector b′ by scalar multiplication in the vector space V. Each component of the scalar multiplication vector [symbol] [symbol] is obtained by encrypting the product of the component b′ᵢ of the feature vector b′ and the random number R_{1,j} as the plaintexts generated by the authentication apparatus 102.

Using the processing device 911, the zero generation unit 232 generates an encrypted zero vector O, based on the random base B which is the part of the public key pk stored by the public key storage unit 202 and the (n−1) pieces of random numbers R′_{j, i} generated by the random number generation unit 215. The encrypted zero vector O is a T-dimensional vector (o₁, o₂, . . . , o_{T}) having components of vectors in the vector space V. An ith component oᵢ of the encrypted zero vector O (i being the integer not less than 1 and not more than T) is a vector Σⱼ[R′_{j,i}bⱼ] (j being each integer not less than 2 and not more than n) obtained by combining (n−1) vectors R′_{j,i}bⱼ by addition in the vector space V. The (n−1) vectors R′_{j,i}bᵢ are obtained by respectively scalar multiplying second to nth vectors b′ⱼ (j being each integer not less than 2 and not more than n) of the random base B by the random numbers R′_{j,i} by scalar multiplication in the vector space V. Each component of the encrypted zero vector O is obtained by encrypting 0.

Using the processing device 911, the vector combining unit 233 calculates a first response R′, based on the scalar multiplication vector [symbol] [symbol] calculated by the scalar multiplication calculation unit 231 and the encrypted zero vector O generated by the zero generation unit 232. The first response R′ is a T-dimensional vector (R′₁, R′₂, . . . , R′_{T}) having components of vectors in the vector space V. An ith component R′ᵢ (i being the integer not less than 1 and not more than T) of the first response R′ is a vector obtained by combining the ith component [symbol] ᵢ of the scalar multiplication vector [symbol] [symbol] and the ith component oᵢ of the encrypted zero vector O by addition in the vector space V. Each component R′ᵢ of the first response R′ is obtained by encrypting the product of the random number R_{1,j} as the plaintext encrypted in the component Rᵢ of the first challenge R and the component b′ᵢ of the feature vector b′.

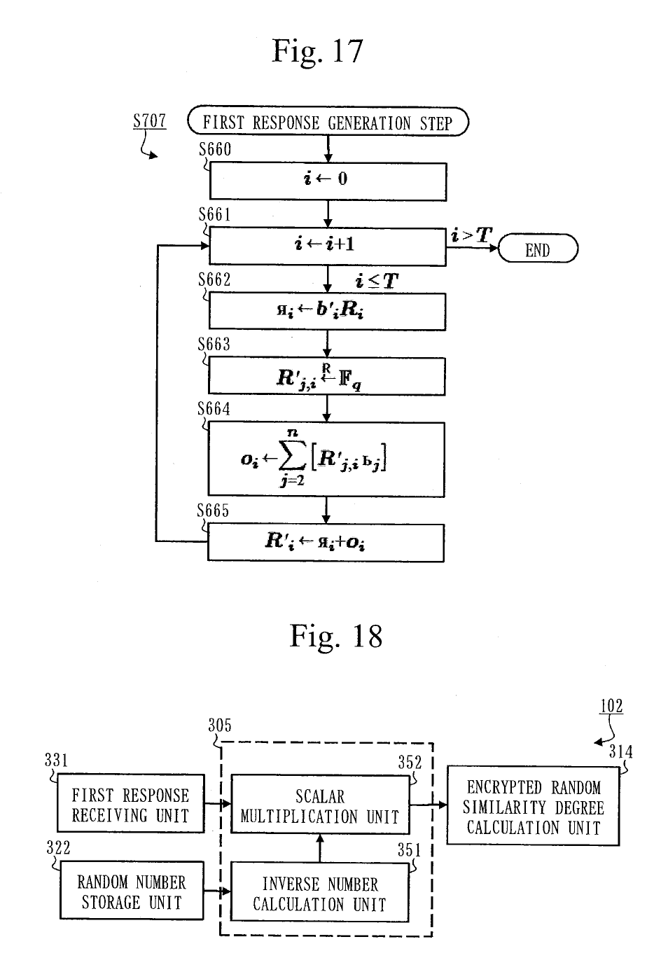

FIG. 17 is a flowchart diagram showing an example of a flow of processes of the first response generation step S707 in this embodiment.

In the first response generation step S707, the certification apparatus 101 generates the first response R′, based on the feature vector b′ and the first challenge R. The first response generation step S707 includes an initialization step S660, a repetition step S661, a scalar multiplication step S662, a random number generation step S663, a zero generation step S664, and a vector combining step S665, for example.

First, in the initialization step S660, the vector combining unit 233 initializes the integer i to 0, using the processing device 911.

In the repetition step 661, the vector combining unit 233 adds 1 to the integer i, using the processing device 911. When the integer i is larger than T, the vector combining unit 233 finishes the first response generation step S707. When the integer i is not more than T, the vector combining unit 233 causes the process to proceed to the scalar multiplication step S662 to generate the ith component R′ᵢ of the first response R′.

In the scalar multiplication step S662, using the processing device 911, the scalar multiplication calculation unit 231 calculates the ith component [symbol] ᵢ of the scalar multiplication vector [symbol] , which is expressed by [symbol] ᵢ=b′ᵢRᵢ, based on the ith component b′ᵢ of the feature vector b′ generated by the feature vector formation unit 214 and the ith vector Rᵢ of the first challenge R received by the first challenge receiving unit 211.

In the zero generation step S663, using the processing device 911, the random number generation unit 215 generates (n−1) pieces of random numbers R′_{j, i} (j being each integer not less than 2 and not more than n).

In the zero generation step S664, using the processing device 911, the zero generation unit 232 calculates the ith component oᵢ of the encrypted zero vector O, which is expressed by oᵢ=Σⱼ[R′_{j,i}bⱼ] (j being each integer not less than 2 and not more than n), based on the (n−1) pieces of random numbers R′_{j,i} generated by the random number generation unit 215 in the random number generation step S663. To take an example, based on the vector bⱼ of the random base B and the (j−1)th random number R′_{j,i} of the (n−1) pieces of random numbers generated by the random number generation unit 215, the zero generation unit 232 calculates the vector R′_{j,i}bⱼ by scalar multiplying the vector bⱼ by the random number R′_{j,i} by scalar multiplication in the vector space V, for each integer j not less than 2 and not more than n. The zero generation unit 232 calculates the vector Σⱼ[R′_{j,i}bⱼ] by combining the calculated (n−1) vectors R′_{j,i}bⱼ by addition in the vector space V.

In the vector combining step S665, the vector combining unit 233 calculates the ith component R′ᵢ of the first response, which is expressed by R′ᵢ= [symbol] ᵢ+oᵢ=b′ᵢRᵢ+Σⱼ[R′_{j,i}bⱼ], based on the ith component of the scalar multiplication vector [symbol] ᵢ given by [symbol] ᵢ=b′ᵢRᵢ calculated by the scalar multiplication calculation unit 231 in the scalar multiplication step S662 and the ith component oᵢ of the encrypted zero vector O given by oᵢ=Σⱼ[R′_{j,i}bⱼ] (j being each integer not less than 2 and not more than n) calculated by the zero generation unit 232 in the zero generation step S664.

The vector combining unit 233 causes the process to return to the repetition process S611 to generate the subsequent component of the first response R′.

The first response R′ generated by the encrypted data embedding unit 217 in this manner is transmitted to the authentication apparatus 102 by the first response transmitting unit 221, and the authentication apparatus 102 receives and then processes the first response R′.

When the component b′ᵢ of the feature vector b′ takes only one of two values of 1 and 0, processing in the first response generation step S707 may be simplified as follows, for example.

First, there is no need for scalar multiplication. Thus, the scalar multiplication calculation unit 231 is not provided, so that the scalar multiplication step S662 is not executed.

In the vector combining step S665, the vector combining unit 233 determines whether or not the value of the ith component b′ᵢ of the feature vector b′ is 0 or 1, using the processing device 911. When the value of the ith component b′ᵢ of the feature vector b′ is 0, the vector combining unit 233 sets the ith component oᵢ of the encrypted zero vector given by oᵢ=Σⱼ[R′_{j,i}bⱼ] calculated by the zero generation unit 232 in the zero generation step S664 to the ith component R′ᵢ of the first response R′, using the processing device 911. When the value of the ith component b′ᵢ of the feature vector b′ is 1, the vector combining unit 233 calculates a vector oᵢ+Rᵢ=Rᵢ+Σⱼ[R′_{j,i}bⱼ] by combining the ith component oᵢ of the encrypted zero vector O given by oᵢ=Σⱼ[R′_{j,i}bⱼ] calculated by the zero generation unit 232 in the zero generation step S664 and the ith component Rᵢ of the first challenge R received by the first challenge receiving unit 211 and sets the calculated vector to the ith component R′ᵢ of the first response R′.

Since the ith component Rᵢ of the first challenge R is Σⱼ[R_{j,i}bⱼ] (j being each integer not less than 1 and not more than n), the ith component R′ᵢ of the first response R′ is expressed by R′ᵢ=b′ᵢΣₖ[R_{k,i}bⱼ]+Σⱼ[R′_{j,i}bⱼ] (j being each integer not less than 2 and less than n, and k being each integer not less than 1 and less than n)=b′ᵢR_{1,i}b₁+Σⱼ[b′ᵢR_{j,i}+R′_{j,i})bⱼ] (j being each integer not less than 2 and not more than n). That is, the ith component R′ᵢ of the first response R′ is obtained by encrypting the product of the ith component b′ᵢ of the feature vector b′ and the random number R_{1,i}.

FIG. 18 is a detailed block diagram showing an example of a configuration of the encrypted data extraction unit 305 in this embodiment.

The encrypted data extraction unit 305 of the authentication apparatus 102 includes an inverse number calculation unit 351 and a scalar multiplication calculation unit 352, for example.

The encrypted feature vector C′ generated by the encrypted data extraction unit 305 of the authentication apparatus 102 is a T-dimensional vector (c′₁, c′₂, . . . , c′_{T}) having components of vectors in the vector space V, like the encrypted feature vector C generated by the encrypted data generation unit 206 of the registration apparatus 104.

Based on the T pieces of random numbers R_{1, i} (i being each integer not less than 1 and not more than T) stored by the random number storage unit 322, the inverse number calculation unit 351 calculates an inverse element κᵢ=R_{1, i}⁻¹ of each of the T pieces of random numbers R_{1,i}, by multiplication on the finite field F_{q}, using the processing device 911. The inverse element κᵢ is an integer where, when the product of the random number R_{1,i} and the inverse element κᵢ is divided by q, the remainder is 1. The encrypted data extraction unit 305 calculates the inverse element κᵢ by computing the reminder by dividing the (q−2)th power of the random number R_{1, i} by q, for example.

Using the processing device 911, the scalar multiplication calculation unit 352 calculates the encrypted feature vector C′, based on the first response R′ received by the first response receiving unit 331 and T pieces of the inverse elements κᵢ calculated by the inverse number calculation unit 351. An ith component c′ᵢ (i being the integer not less than 1 and not more than T) of the encrypted feature vector C′ calculated by the scalar multiplication calculation unit 352 is a vector κᵢR′ᵢ obtained by scalar multiplying the ith component R′ᵢ of the first response R′ by the ith inverse element κᵢ by scalar multiplication in the vector space V. Each component c′ᵢ of the encrypted feature vector C′ is obtained by encrypting the component b′ᵢ of the feature vector b′.

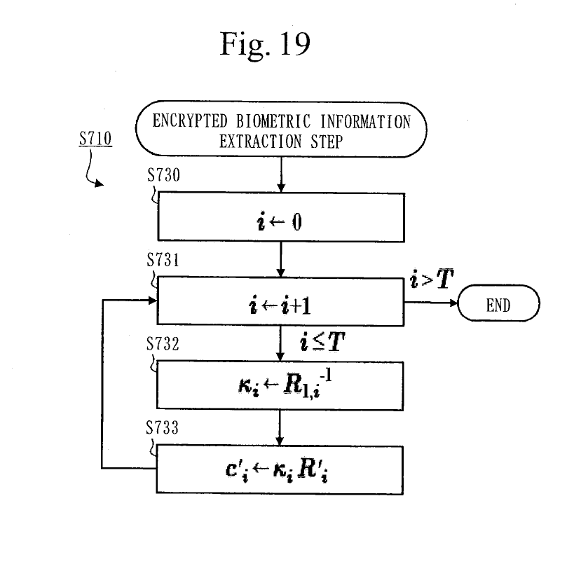

FIG. 19 is a flow chart diagram showing an example of a flow of processes of the encrypted biometric information extraction step S710 in this embodiment.

In the encrypted biometric information extraction step S710, the authentication apparatus 102 generates the encrypted feature vector C′, based on the first response R′. The encrypted biometric information extraction step S710 includes an initialization step S730, a repetition step S731, an inverse number calculation step S732, and a scalar multiplication step S773, for example.

First, in the initialization step S730, using the processing device 911, the scalar multiplication calculation unit 352 initializes the integer i to 0.

In the repetition step S731, the scalar multiplication calculation unit 352 adds 1 to the integer i, using the processing device 911. When the integer i is larger than T, the scalar multiplication calculation unit 352 finishes the encrypted biometric information extraction step S710. When the integer i is not more than T, the scalar multiplication calculation unit 352 causes the process to proceed to the inverse number calculation step S732 to generate the ith component c′ᵢ of the encrypted feature vector C′.

In the inverse number calculation step S732, using the processing device 911, the inverse number calculation unit 351 calculates the inverse element κᵢ=R_{1, i}⁻¹ of the ith random number R_{1, i} out of the T pieces of random numbers stored by the random number storage unit 322 in the first challenge generation step S701, based on the random number R_{1, i} and using multiplication on the finite field F_{q}.

In the scalar multiplication step S733, using the processing device 911, the scalar multiplication calculation unit 352 calculates the ith component c′ᵢ=κᵢR′ᵢ of the encrypted feature vector C′, based on the ith component R′ᵢ of the first response R′ received by the first response receiving unit 331 and the inverse element κᵢ calculated in the inverse number calculation step S732.

The scalar multiplication calculation unit 253 causes the process to return to the repetition step S731 to generate the subsequent component of the encrypted feature vector C′.

The encrypted feature vector C′ generated by the encrypted data extraction unit 305 in this manner is used in the second challenge generation step S712.

The ith component R′ᵢ of the first response R′ is expressed by R′ᵢ=b′ᵢR_{1, i}b₁+Σ[(b′ᵢR_{j,i}+R′_{j, i})bⱼ] (j being each integer not less than 2 and not more than n). Thus, the ith component c′ᵢ of the encrypted feature vector C′ is given by c′ᵢ=R_{1, i}⁻¹b′ᵢR_{1, i}b₁+R_{1, i}⁻¹Σ[(b′ᵢR_{j, i}+R′_{j,i})bⱼ] (j being each integer not less than 2 and not more than n). Since R_{1, i}R_{1, i}⁻¹≡1(mod q), c′ᵢ=b′ᵢb₁+R_{1, i}⁻¹Σ[(b′ᵢR_{j, i}+R′_{j,i})bⱼ] (j being each integer not less than 2 and not more than n) holds. That is, the ith component c′ᵢ of the encrypted feature vector C′ is obtained by encrypting the ith component b′ᵢ of the feature vector b′.

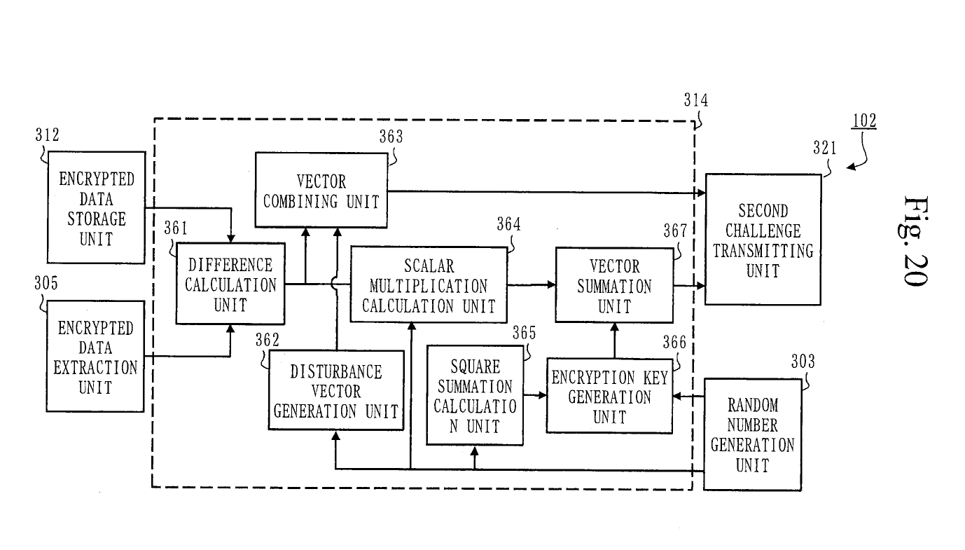

FIG. 20 is a detailed block diagram showing an example of a configuration of the encrypted random similarity degree calculation unit 314 in this embodiment.

The encrypted random similarity degree calculation unit 314 of the authentication apparatus 102 includes a difference calculation unit 361, a disturbance vector generation unit 362, a vector combining unit 363, a scalar multiplication calculation unit 364, a square summation calculation unit 365, an encryption key generation unit 366, and a vector summation unit 367, for example.

Using the processing device 911, the random number generation unit 303 generates n(T+1) pieces of random numbers t_{j,i}, and uⱼ (i being each integer not less than 1 and not more than T, and j being each integer not less than 1 and not more than n), based on the order q which is the part of the public key pk stored by the public key storage unit 302. The random numbers t_{j,i}, and uⱼ generated by the random number generation unit 303 are integers uniform randomly selected from among integers not less than 0 and less than q.

The random number storage unit 322 stores one random number us out of the random numbers generated by the random number generation unit 303, using the storage device 914.

Using the processing device 911, the difference calculation unit 361 calculates an encrypted difference vector ΔC, based on the encrypted feature vector C stored by the encrypted data storage unit 312 and the encrypted feature vector C′ extracted by the encrypted data extraction unit 305. The encrypted difference vector C is a T-dimensional vector (Δc₁, Δc₂, . . . , ΔC_{T}) having components of vectors in the vector space V. An ith component Δcᵢ (i being the integer not less than 1 and not more than T) of the encrypted difference vector C is a vector cᵢ−c′ᵢ obtained by combining an ith component cᵢ of the encrypted feature vector C and an inverse vector −c′ᵢ of an ith component c′ᵢ of the encrypted feature vector C′ by addition in the vector space V. Each component Δcᵢ of the encrypted difference vector ΔC is obtained by encrypting a difference bᵢ−b′ᵢ between the component bᵢ of the feature vector b and the component b′ᵢ of the feature vector b′.

The ith component Δcᵢ of the encrypted difference vector C may be a vector c′ᵢ−cᵢ obtained by combining an inverse vector −cᵢ of the ith component cᵢ of the encrypted feature vector C and the ith component c′ᵢ of the encrypted feature vector C′ by addition in the vector space V. The component Δcᵢ of the encrypted difference vector ΔC may be a randomly selected one of the vector cᵢ−c′ᵢ and the vector c′ᵢ−cᵢ.

Using the processing device 911, the disturbance vector generation unit 362 generates a disturbance vector T, based on the random base B which is the part of the public key pk stored by the public key storage unit 302 and nT pieces of random numbers t_{j,i} of the random numbers generated by the random number generation unit 303. The disturbance vector T is a T-dimensional vector (t₁, t₂, . . . , t_{T}) having components of vectors in the vector space V. Each component tᵢ (i being each integer not less than 1 and not more than T) of the disturbance vector T is a vector Σⱼ[t_{j,i}bⱼ] (j being each integer not less than 1 and not more than n) obtained by combining n vectors t_{j,i}bⱼ by addition in the vector space V. The n vectors t_{j,i}bⱼ are each obtained by scalar multiplying each vector bⱼ (j being each integer not less than 1 and not more than n) of the random base B by the random number t_{j,i}, by scalar multiplication in the vector space V. Each component tᵢ of the disturbance vector T is obtained by encrypting the random number t_{1, i} as a plaintext.

Using the processing device 911, the vector combining unit 363 calculates T vectors ĉᵢ (i being each integer not less than 1 and not more than T) which are a part of a second challenge Ĉ, based on the encrypted difference vector ΔC calculated by the difference calculation unit 361 and the disturbance vector T calculated by the disturbance vector generation unit 362. The vectors ĉᵢ are vectors in the vector space V. The ith vector ĉᵢ is a vector Δcᵢ+tᵢ obtained by combining the ith component Δcᵢ of the encrypted difference vector C and the ith component tᵢ of the disturbance vector T, by addition in the vector space V. The vector ĉᵢ is obtained by encrypting a sum of (bᵢ−b′ᵢ)+t_{1, i} of a difference between the component bᵢ of the feature vector b and the component b′ᵢ of the feature vector b′ and the random number t_{1, i} as the plaintext.

Using the processing device 911, the scalar multiplication calculation unit 364 calculates a scalar multiplication vector , based on the encrypted difference vector ΔC calculated by the difference calculation unit 361 and the T pieces of random numbers t_{1,i} as the plaintexts out of the random numbers generated by the random number generation unit 303. The scalar multiplication vector is a T-dimensional vector (₁, ₂, . . . , _{T}) having components of vectors in the vector space V. The ith component ᵢ (i being the integer not less than 1 and not more than T) of the scalar multiplication vector calculated by the scalar multiplication calculation unit 364 is a vector 2t_{1,i}Δ cᵢ obtained by scalar multiplying the ith component cᵢ of the encrypted difference vector ΔC by twice the ith random number t_{1,i} of the T pieces of random numbers as the plaintexts, by scalar multiplication in the vector space V. Each component ᵢ of the scalar multiplication vector calculated by the scalar multiplication calculation unit 364 is obtained by encrypting a product 2t_{1,i} (b−b′) of 2t_{1,i} and the difference between the component bᵢ of the feature vector b and the component b′ᵢ of the feature vector b′.

Using the processing device 911, the square summation calculation unit 365 calculates a square summation Σ, based on the T pieces of random numbers T_{1,i} as the plaintexts out of the random numbers generated by the random number generation unit 303. The square summation Σ is a value Σᵢ[t_{1, i}²] (i being each integer not less than 1 and not more than T) obtained by summating the squares of the T pieces of random numbers t_{1,i}.

Using the processing device 911, the encryption key generation unit 366 calculates an encryption key [symbol] [symbol] , based on the random base B which is the part of the public key pk stored by the public key storage unit 302 and the n pieces of random numbers uⱼ of the random numbers generated by the random number generation unit 303. The encryption key u is a vector in the vector space V. The encryption key [symbol] [symbol] is a vector (u₁+Σ)b₁+Σⱼ[uⱼbᵢ] (j being each integer not less than 1 and not more than n) obtained by combining a vector (u₁+Σ)b₁ and (n−1) vectors uⱼbⱼ by addition in the vector space V. The vector (u₁+Σ)b₁ is obtained by scalar multiplying the first vector b₁ of the random base B by the sum of the first random number u₁ of the n pieces of random numbers u₁ and the square summation Σ, by scalar multiplication in the vector space V. The (n−1) vectors uⱼbⱼ are obtained by respectively scalar multiplying the second and subsequent vectors bⱼ (j being each integer not less than 2 and not more than n) of the random base B by the second and subsequent random numbers uⱼ of the n pieces of random numbers uⱼ, by scalar multiplication in the vector space V. To take an example, the encryption key generation unit 366 calculates a sum u₁+Σ of the random number u₁ generated by the random number generation unit 303 and the square summation Σ calculated by the square summation calculation unit 365. The encryption key generation unit 366 calculates a vector (u₁+Σ)b₁ by scalar multiplying the first vector b₁ of the random base B by the calculated sum u₁+Σ by scalar multiplication in the vector space V. The encryption key generation unit 366 calculates the vector uⱼbⱼ by scalar multiplying the ith vector bⱼ of the random base B by the random number uⱼ generated by the random number generation unit 303, by scalar multiplication in the vector space V, for each integer j not less than 2 and not more than n. The encryption key generation unit 366 calculates the vector (u₁+Σ)b₁+Σⱼ[uⱼbⱼ] (j being each integer not less than 1 and not more than n) by combining the calculated vector (u₁+Σ)b₁ and the calculated (n−1) vectors uⱼbⱼ, by addition in the vector space V.

Using the processing device 911, the vector summation unit 367 calculates one vector ĉ which is a part of the second challenge Ĉ, based on the scalar multiplication vector calculated by the scalar multiplication calculation unit 364 and the encryption key [symbol] [symbol] calculated by the encryption key generation unit 366. The vector ĉ is a vector Σᵢ[2t_{1, i} Δcᵢ]+(u₁+Σ)b₁+Σⱼ[uⱼbⱼ] (i being each integer not less than 1 and not more than T, and j being each integer not less than 1 and not more than n) by combining the T vectors ᵢ=2t_{1, i}Δ cᵢ (i being each integer not less than 1 and not more than T) which are the components of the scalar multiplication vector calculated by the scalar multiplication calculation unit 364 and the encryption key [symbol] [symbol] =(u₁+Σ)b₁+Σⱼ[uⱼbⱼ] (j being each integer not less than 1 and not more than n). The vector ĉ is obtained by encrypting an inclusive sum u₁+Σᵢ[2t_{1, i}(bᵢ−b′ᵢ)+t_{1, i}²] which is the inclusive sum of the random number u₁ and a summation of the square of t_{1, i} and the product of 2t_{1, i} and the difference between the component bᵢ of the feature vector b and the component b′ⱼ of the feature vector b′. The random number u₁ of these components of the vector ĉ is a random number as a temporary key for encrypting and decrypting a similarity degree. Σᵢ[2t_{1, i} (bᵢ−b′ᵢ)+t_{1, i}²], which is the component other than the random number u₁ is information for removing disturbance by the random numbers t_{1,i} as the plaintexts to enable calculation of an encrypted similarity degree.

The second challenge Ĉ generated by the encrypted random similarity degree calculation unit 314 is constituted from (T+1) vectors obtained by combining T vectors ĉᵢ (i being each integer not less than 1 and not more than T) calculated by the vector combining unit 363 and one vector ĉ calculated by the vector summation unit 367.

The sequence of the first T vectors ĉᵢ of the second challenge Ĉ may be different from the sequence of the components of the feature vectors b and b′.

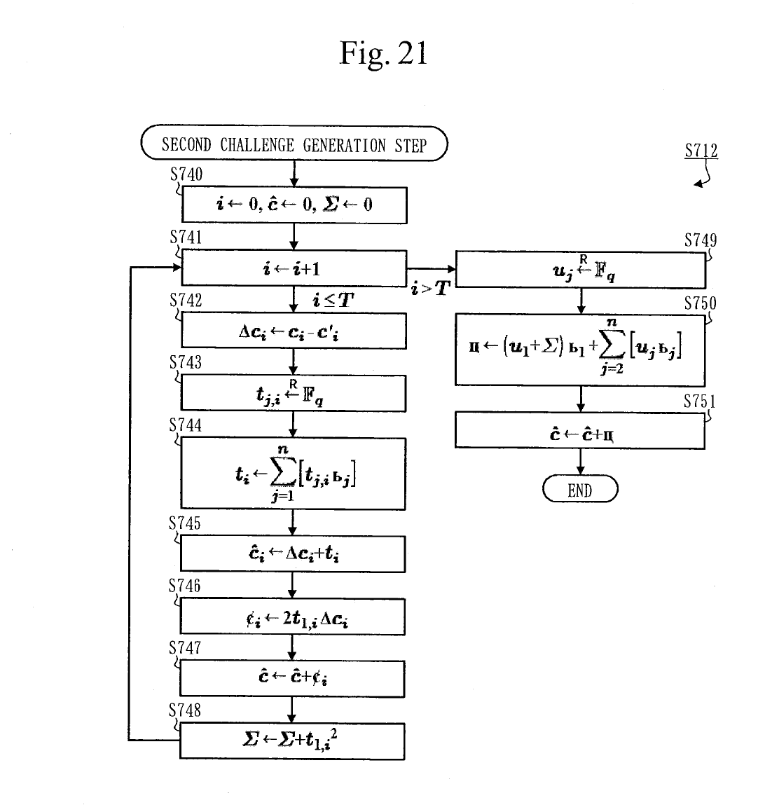

FIG. 21 is a flow chart diagram showing an example of a flow of processes of the second challenge generation step S712 in this embodiment.

In the second challenge generation step S712, the authentication apparatus 102 generates the second challenge Ĉ, based on two encrypted feature vectors C and C′. The second challenge generation step S712 includes an initialization step S740, a repetition step S741, a difference calculation step S742, a random number generation step S743, a disturbance vector generation step S744, a vector combining step S745, a scalar multiplication step S746, a vector summation step S747, a square summation step S748, a random number generation step S749, an encryption key generation step S750, and a vector summation step S751, for example.

First, in the initialization step S740, using the processing device 911, the vector combining unit 363 initializes the integer i to 0 and initializes the vector ĉ to 0 (zero vector in the vector space V). The square summation calculation unit 365 initializes the square summation Σ to 0, using the processing device 911.

In the repetition step S741, using the processing device 911, the vector combining unit 363 adds 1 to the integer i. When the integer i is larger than T, the vector combining unit 363 causes the process to proceed to the random number generation step S749. When the integer i is not more than T, the vector combining unit 363 causes the process to the difference calculation step S742, thereby generating the ith vector ĉᵢ of the second challenge Ĉ.

In the difference calculation step S742, using the processing device 911, the difference calculation unit 361 calculates the ith component Δcᵢ of the encrypted difference vector ΔC based on the ith component cᵢ of the encrypted feature vector C stored by the encrypted data storage unit 312 and the ith component c′ᵢ of the encrypted feature vector C′ extracted by the encrypted data extraction unit 305.

In the random number generation step S743, the random number generation unit 303 generates n pieces of random numbers t_{j,i} (j is the integer not less than 1 and not more than n), using the processing device 911.

In the disturbance vector generation step S744, using the processing device 911, the disturbance vector generation unit 362 calculates the ith component tᵢ=Σⱼ[t_{j,i}bⱼ] (j being each integer not less than 1 and not more than n) of the disturbance T, based on the n pieces of random numbers t_{j, i} generated by the random number generation unit 303 in the random generation step S743.

In the vector combining step S745, using the processing device 911, the vector combining unit 363 calculates an ith vector ĉᵢ=Δ cⱼ+tᵢ, based on the ith component of Δ cᵢ of the encrypted difference vector Δ C calculated by the difference calculation unit 361 in the difference calculation step S742 and the ith component tᵢ of the disturbance vector T calculated by the disturbance vector generation unit 362 in the disturbance vector generation step S744.

When the order of the first T vectors ĉᵢ of the second challenge Ĉ and the order of the components of the feature vectors b and b′ are configured to be different, the vector combining unit 363 performs the following operations, for example. The vector combining unit 363 generates a sequence where the integers not less than 1 and not more than T are randomly rearranged, in the initialization step S740. In the vector combining step S745, the vector combining unit 363 obtains an ith integer in that sequence and sets the ith integer to the integer j, and sets the calculated vector cᵢ+tᵢ to the j th vector ĉᵢ of the second challenge Ĉ.

In the scalar multiplication step S746, using the processing device 911, the scalar multiplication calculation unit 364 calculates the ith component ᵢ=t_{1,i}Δ cᵢ of the scalar multiplication vector , based on the ith component Δcᵢ of the encrypted difference vector C calculated by the difference calculation unit 361 in the difference calculation step S742 and the first random number t_{1, i} of the n pieces of random numbers t_{j,i} generated by the random number generation unit 303 in the random number generation step S743.

In the vector summation step S747, using the processing device 911, the vector summation unit 367 combines the vector ᵢ with the vector ĉ, based on the ith component ᵢ=t_{1,i}Δcᵢ of the scalar multiplication vector calculated by the scalar multiplication calculation unit 364 in the scalar multiplication step S746, by addition in the vector space V.

In the square summation step S748, using the processing device 911, based on the first t_{1, i} of the n pieces of random numbers t_{j, i} generated by the random number generation unit 303 in the random number generation step S743, the square summation calculation unit 365 calculates the square t_{1, i}² of the random number t_{1, i} by multiplication on the finite field F_{q}. Then, the square summation calculation unit 365 combines the calculated square t_{1, i}² with the square summation Σ, by addition on the finite filed F_{q}.

The vector combining unit 363 causes the process to return to the repetition step S741 to generate the subsequent vector of the second challenge C′.

In the random number generation step S749, using the processing device 911, the random number generation unit 303 generates the n pieces of random numbers uⱼ (j being each integer not less than 1 and not more than n). The random number storage unit 322 stores the random number u₁ which is the random number out of the n pieces of random numbers generated by the random number generation unit 303, as the temporary key.

In the encryption key generation step S750, using the processing device 911, the encryption key generation unit 366 generates the encryption key [symbol] [symbol] , based on the square summation Σ summated by the square summation calculation unit 365 in the square summation step S748 and the n pieces of random numbers uⱼ generated by the random number generation unit 303 in the random number generation step S749.

In the vector summation step S751, using the processing device 911, the vector summation unit 367 combines the encryption key [symbol] [symbol] with the vector ĉ by addition in the vector space V, based on the encryption key [symbol] [symbol] generated by the encryption key generation unit 366 in the encryption key generation step S750. With this arrangement, the (T+1)th vector ĉ of the second challenge Ĉ is completed, and the second challenge Ĉ is also completed.

The second challenge Ĉ calculated by the encrypted random similarity degree calculation unit 314 in this manner is transmitted to the decryption apparatus 103 by the second challenge transmitting unit 321, and the decryption apparatus 103 receives and then processes the transmitted second challenge Ĉ.

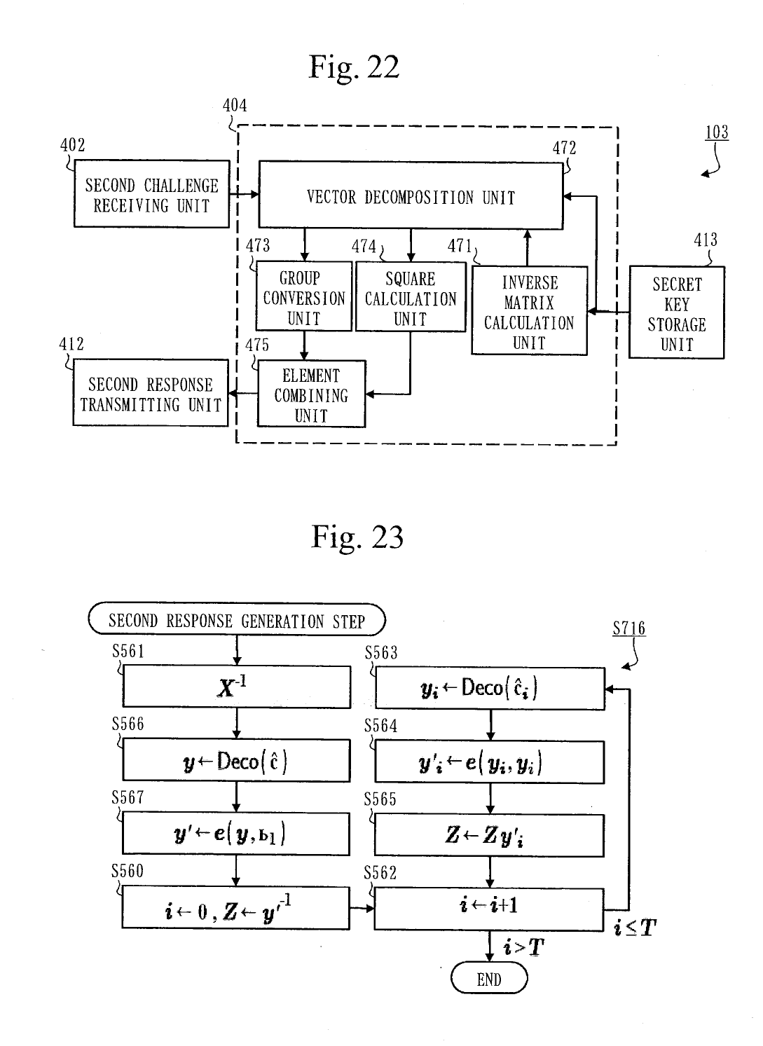

FIG. 22 is a detailed block diagram of a configuration of the decryption apparatus 404 in this embodiment.

The decryption unit 404 of the decryption apparatus 103 includes an inverse matrix calculation unit 471, a vector decomposition unit 472, a square calculation unit 473, a group conversion unit 474, and an element combining unit 475, for example.

Using the processing device 911, the inverse matrix calculation unit 471 calculates the inverse matrix X⁻¹ of the regular matrix X in the finite field F_{q}, based on the order q which is the part of the public key pk stored by the public key storage unit 403 and the regular matrix X which is the secret key sk stored by the secret key storage unit 413.

Using the processing device 911, the vector decomposition unit 472 calculates (T+1) decryption vectors yᵢ and y (i being each integer not less than 1 and not more than T), based on the regular matrix X which is the secret key sk stored by the secret key storage unit 413, the second challenge Ĉ received by the second challenge receiving unit 402, and the inverse matrix X⁻¹ calculated by the inverse matrix calculation unit 471. The decryption vectors yᵢ and y are vectors in the vector space. An ith decryption vector yᵢ (i being the integer not less than 1 and not more than T) is a vector obtained by decomposing the ith vector ĉᵢ of the second challenge Ĉ into a linear combination of the random base B, and then removing a component applied to each of the second and subsequent vectors bⱼ (j being each integer not less than 2 and not more than n) to be the vector scalar multiplied by the first vector b₁ of the random base B. The decryption vector y is a vector obtained by decomposing the (T+1)th vector ĉ of the second challenge Ĉ into a linear combination of the random base B, and then removing a component applied to each of the second and subsequent vectors bⱼ (j being each integer not less than 2 and not more than n) to be the vector scalar multiplied by the first vector b₁ of the random base B. The vector decomposition unit 472 calculates the decryption vectors yᵢ and y by the vector decomposition process S540 shown in FIG. 11, for example. Since the ith vector ĉᵢ (i being the integer not less than 1 and not more than T) of the second challenge Ĉ is Δcᵢ+tᵢ, the ith decryption vector yᵢ becomes (bᵢ−b′ᵢ+t_{1, i})b₁. Since the (T+1)th vector ĉ of the second challenge Ĉ is Σᵢ[2t_{1,i}Δcᵢ]+(Σᵢ[t_{1, i}²])b₁+Σⱼ[uⱼbⱼ] (i being each integer not less than 1 and not more than T, and j being each integer not less than 1 and not more than n), the decryption vector y becomes (u₁+Σᵢ[2t_{1,i}(bᵢ−b′ᵢ)+t_{1, i}²])b₁.

Using the processing device 911, the square calculation unit 473 calculates T pieces of square elements y′ᵢ (i being each integer not less than 1 and not more than T), based on the pairing e which is a part of the public key pk stored by the public key storage unit 403 and the T decryption vectors yᵢ calculated by the vector decomposition unit 472. The square elements y′ᵢ are elements of the finite group G_{T}. The ith square element y′ᵢ (i being the integer not less than 1 and not more than T) is an element e(yᵢ, yᵢ) obtained by translation of a set of the ith decryption vectors yᵢ by the pairing e. Since the ith decryption vector yᵢ is (bᵢ−b′ᵢ+t_{1, i})b₁, the ith square element y′ᵢ is an element obtained by exponentiating the element e(b₁, b₁) of the finite group G_{T} by the square of (bᵢ−b′ᵢ+t_{1, i}), by exponentiation on the finite group G_{T}, due to bilinearity of the pairing e. The element e(b₁, b₁) of the finite group G_{T} is obtained by translation of a set of the first vectors b₁ of the random base B by the pairing e.

Using the processing device 911, the group conversion unit 474 calculates a translation element y′, based on the pairing e and the random base B which are the parts of the public key pk stored by the public key storage unit 403 and decryption vector y calculated by the vector decomposition unit 472. The translation element y′ is an element of the finite group G_{T}. The translation element y′ is an element e(y, b₁) obtained by translation of a set of the decryption vector y and the first vector b₁ of the random base B by the pairing e. The decryption vector y is expressed by (u₁+Σᵢ[2t_{1, i}(bᵢ−b′ᵢ)+t_{1, i}²])b₁. Thus, the translation element y′ is an element obtained by exponentiating the element e(b₁, b₁) of the finite group G_{T} by (u₁+Σᵢi[2t_{1, i}(bᵢ−b′ᵢ)+t_{1, i}²]) (i being each integer not less than 1 and not more than T) by exponentiation in the unite group G_{T}, due to binearlity of the pairing e.

Using the processing device 911, the element combining unit 475 calculates a second response Z based on the finite group G_{T} which is a part of the public key pk stored by the public key storage unit 403, the T pieces of square elements y′ᵢ calculated by the square calculation unit 473, and the translation element y′ calculated by the group conversion unit 474. The second response Z is an element of the finite group G_{T}. The second response Z calculated by the element combining unit 475 is an element obtained by combining the T pieces of square elements y′ᵢ and an inverse element y′⁻¹ of the translation element y′ by multiplication on the finite group G_{T}. The second response Z is an element obtained by exponentiating the element (b₁, b₁) of the finite group G_{T} by (Σᵢ[(bᵢ−b′ᵢ)²]−u₁) (i being each integer not less than 1 and not more than T) by exponentiation on the finite group G_{T}. That is, the second response Z is the one obtained by encrypting the square of the Euclidean distance between the feature vector b and the feature vector b′, which is given by Σᵢ[(bᵢ−b′ᵢ)²], by the random number u₁ as the temporary key.

FIG. 23 is a flowchart diagram showing a flow of processes of the second response generation step S716 in this embodiment.

In the second response generation step S716, the decryption apparatus 103 generates the second response Z from the second challenge Ĉ. The second response generation step S716 includes an inverse matrix calculation step S561, a vector decomposition step S566, a group conversion step S567, an initialization step S560, a repetition step S562, a vector decomposition step S563, a square calculation step S564, and an element combining step S565, for example.

First, in the inverse matrix calculation step S561, using the processing device 911, the inverse matrix calculation unit 471 calculates the inverse matrix X⁻¹ of the regular matrix X which is the secret key sk stored by the secret key storage unit 413. It may be so configured that, using the processing device 911, the inverse matrix calculation unit 471 calculates the inverse matrix X⁻¹ in advance (e.g., in the setup process S500), and stores the calculated inverse matrix X⁻¹, using the storage device 914.

In the vector decomposition step S566, using the processing device 911, the vector decomposition unit 472 vector-decomposes the last vector ĉ of the second challenge Ĉ received by the second challenge receiving unit 402, based on the inverse matrix X⁻¹ calculated by the inverse matrix calculation unit 471 in the inverse matrix calculation step S561 and the like, thereby calculating the decryption vector y.

In the group conversion step S567, using the processing device 911, the group conversion unit 474 calculates the translation element y′, based on the decryption vector y calculated by the vector decomposition unit 472 in the vector decomposition step S566.

In the initialization step S560, using the processing device 911, the element combining unit 475 initializes the integer i to 0, and initializes the second response Z to the inverse element y′⁻¹ of the translation element y′ by multiplication on the finite group G_{T}.

In the repetition step S562, using the processing device 911, the element combining unit 475 adds 1 to the integer i. When the integer i is larger than T, the second response Z has been completed. Thus, the element combining unit 475 finishes the second response generation step S716. When the integer i is not more than T, the element combining unit 475 causes the process to proceed to the vector decomposition step S563.

In the vector decomposition step S563, using the processing device 911, the vector decomposition unit 472 vector-decomposes the ith vector ĉᵢ of the second challenge Ĉ received by the second challenge receiving unit 402 based on the inverse matrix X⁻¹ calculated by the inverse matrix calculation unit 471 in the inverse matrix calculation step S561, thereby calculating the ith decryption vector yᵢ.

In the square calculation step S564, using the processing device 911, the square calculation unit 473 calculates the ith square element y′ᵢ=e(yᵢ, yᵢ), based on the ith decryption vector yᵢ calculated by the vector decomposition unit 472 in the vector decomposition step S563.

In the element combining step S565, using the processing device 911, the element combining unit 475 combines the ith square element y′ᵢ with the second response Z, by multiplication on the finite group G_{T}, based on the ith square element y′ᵢ calculated by the square calculation unit 473 in the square calculation step S564.

The element combining unit 475 causes the process to return to the repetition step S562 to process the subsequent vector of the second challenge C′.

The second response Z generated by the decryption unit 404 in this manner is transmitted to the authentication apparatus 102 by the second response transmitting unit 412. Then, the authentication apparatus 102 receives and then processes the second response Z.

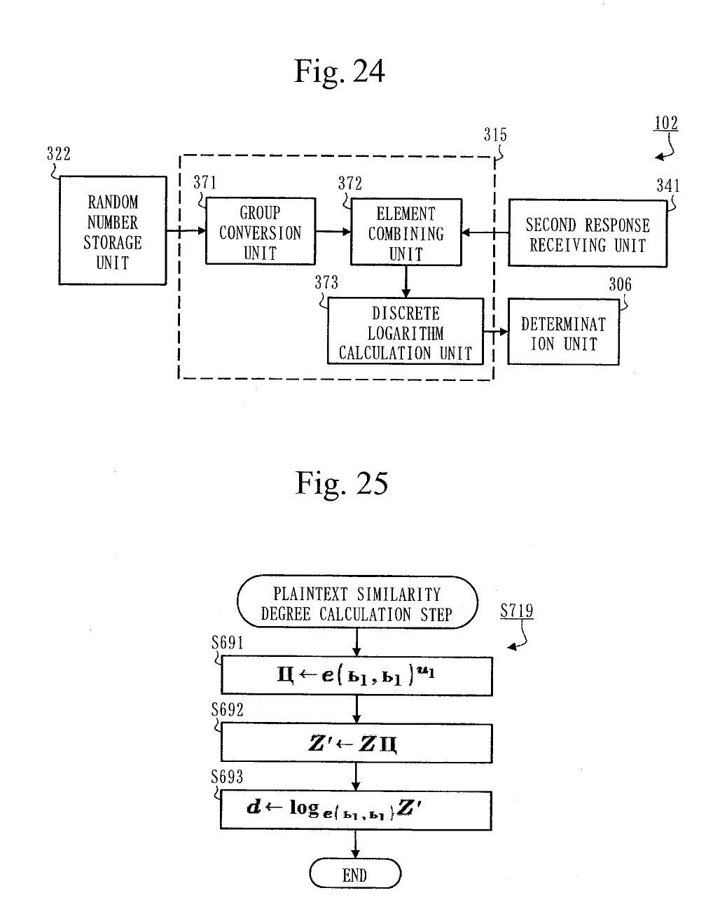

FIG. 24 is a detailed block diagram showing an example of a configuration of the plaintext similarity degree extraction unit 315 in this embodiment.

The plaintext similarity degree extraction unit 315 of the authentication apparatus 102 includes a group conversion unit 371, an element combining unit 372, and a discrete logarithm calculation unit 373, for example.

Using the processing device 911, the group conversion unit 371 calculates a decryption key [symbol] based on the pairing e and the random base B which are the parts of the public key pk stored by the public key storage unit 302 and the random number u₁ as the temporary key stored by the random storage unit 322. The decryption key [symbol] is an element of the finite group G_{T}. The decryption key [symbol] calculated by the group conversion unit 371 is an element e(b₁, b₁)^{u1} obtained by expotentiating the element e(b₁, b₁) by the random number u₁ by expotentiation on the finite group G_{T}. The element e(b₁, b₁)^{u1} is obtained by translation of the set of the first vectors b₁ of the random base B by the pairing e.

Using the processing device 911, the element combining unit 372 calculates a decrypted similarity degree element Z′, based on the finite group G_{T} which is the part of the public key pk stored by the public key storage unit 302, the second response Z received by the second response receiving unit 341, and the decryption key [symbol] calculated by the group conversion unit 371. The decrypted similarity degree element Z′ is an element of the finite group G_{T}. The decrypted similarity degree element Z′ is an element obtained by combining the second response Z and the decryption key [symbol] by multiplication on the finite group G_{T}. The second response Z is an element obtained by exponentiating the element e (b₁, b₁) of the finite group G_{T} by [Σᵢ(bᵢ−b′ᵢ)²]−u₁) (i being each integer not less than 1 and not more than T). Thus, the decrypted similarity degree element Z′ is an element obtained by expotentiating the element e (b₁, b₁) of the finite group G_{T} by [Σᵢ(bᵢ−b′ᵢ)²]−u₁) (i being each integer not less than 1 and not more than T), using exponentiation on the finite group G_{T}.

Using the processing device 911, the discrete logarithm calculation unit 373 calculates a similarity degree d, based on the pairing e and the random base B which are the parts of the public key pk stored by the public key storage unit 302 and the decrypted similarity degree element Z′ calculated by the element combining unit 372. The similarity degree d is an element of the finite field F_{q}. The similarity degree d calculated by the discrete logarithm calculation unit 373 determines to what power the element e (b₁, b₁) of the finite group G_{T} is raised to be equal to the decrypted similarity degree element Z′ by exponentiation on the finite group G_{T}.

Calculation of the similarity degree d from the decrypted similarity degree element Z′ by the discrete logarithm calculation unit 373 is to solve a so-called discrete logarithm problem. Thus, it is generally difficult to calculate the similarity degree d. However, when the range of the similarity degree d is limited in advance, it becomes possible to calculate the similarity degree d. To take an example, it should be so arranged that, for each integer d in this range, an element e(b₁, b₁)^{d} obtained by exponentiating the e(b₁, b₁) by the integer d is calculated in advance, and then, it is determined which integer d causes the element e(b₁, b₁)^{d} to be equal to the decrypted similarity degree element Z′.

The similarity degree d is the square of the Euclidean distance between the two feature vectors b and b′. Thus, it indicates that the smaller the similarity degree d is, the more the two feature vectors b and b′ are similar. To take an example, the determination unit 306 compares the similarity degree d with a predetermined threshold value d₀, and then determines that the two feature vectors b and b′ are similar when the similarity degree d is smaller than the threshold value d₀. For this reason, it is not necessary to know the specific value of the similarity degree d. It should be known whether the similarity degree d is larger or smaller than the threshold value d₀.

The threshold value d₀ is an integer far smaller than the order q, and is on the order of several hundreds to several ten thousands, for example.

When each component of each of the feature vectors b and b′ is 0 or 1, the square of the Euclidean distance between the two feature vectors b and b′ becomes an integer not less than 0 and not more than T. In this case, unless the threshold value d₀ is an integer smaller than the order T of each feature vector, it is determined that the two feature vectors b and b′ are similar in all cases. Thus, the determination using this comparison does not make sense.

It is easy to calculate the element e(b₁, b₁)^{d} in advance, for each integer d not less than 0 and not more than d₀. By doing so, the discrete logarithm unit 373 can calculate the similarity degree d when the similarity degree d is not more than d₀. When the similarity degree d is larger than d₀, the discrete logarithm unit 373 cannot calculate the similarity degree d, but can determine that the similarity degree d is larger than d₀.

FIG. 25 is a flow chart diagram showing an example of a flow of processes of the plaintext similarity degree calculation step S719 in this embodiment.

In the plaintext similarity degree calculation step S719, the authentication apparatus 102 calculates the similarity degree d from the second response Z. The plaintext similarity degree calculation step S719 includes a group conversion step S691, an element combining step S692, and a discrete logarithm calculation step S693, for example.

First, in the group conversion step S691, using the processing device 911, the group conversion unit 371 calculates the decryption key [symbol] =e(b₁, b₁)^{u1}, based on the random number u₁ as the temporary key, stored by the random number storage unit 322.

In the element combining step S692, using the processing device 911, the element combining unit 372 calculates the decrypted similarity degree element Z′=Z [symbol] , based on the second response Z received by the second response receiving unit 341 and the decryption key [symbol] calculated by the group conversion unit 371 in the group conversion step S691.

In the discrete logarithm calculation step S693, using the processing device 911, the discrete logarithm calculation unit 373 calculates the similarity d, based on the decrypted similarity degree element Z′ calculated by the element combining unit 372 in the element combining unit 372.

The determination unit 306 determines whether or not the two feature vectors b and b′ are similar, based on the similarity degree d calculated by the plaintext similarity degree extraction unit 315, thereby determining whether or not a person having the biometric information represented by the feature vector b and a person having the biometric information represented by the feature vector b′ are the same person. As described above, the determination unit 306 determines that the two feature vectors b and b′ are similar when the similarity degree d is smaller than the threshold value d₀.

As described above, the biometric authentication system 100 calculates the square of the Euclidean distance between the two feature vectors b and b′, as the similarity degree between the two feature vectors b and b′. The procedure for calculating the similarity degree is divided into some stages. Then, the authentication apparatus 102 and the decryption apparatus 103 perform calculations in the respective stages, thereby preventing the authentication apparatus 102 from obtaining information on the feature vectors b and b′ and preventing the decryption apparatus 103 from obtaining the information on the feature vectors b and b′ and information on the similarity degree d.

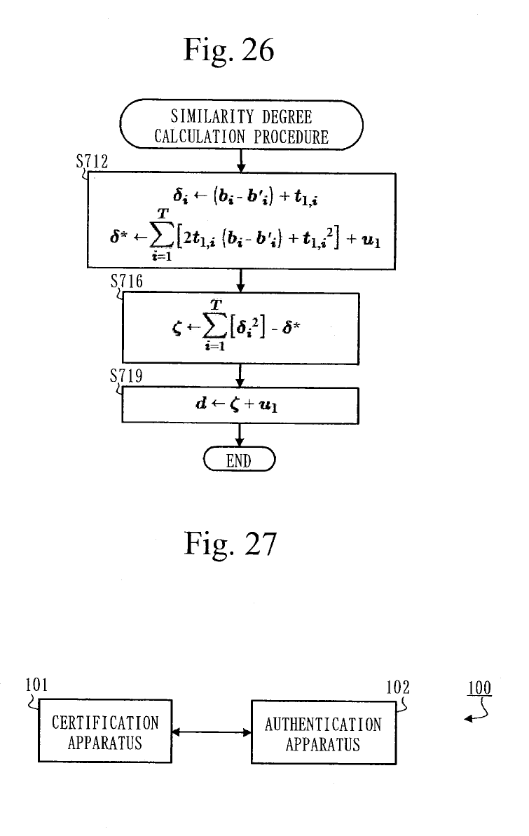

FIG. 26 is a flow chart diagram showing a procedure for calculating a similarity degree in the biometric authentication system 100 in this embodiment.

In this diagram, a portion related to the procedure for calculating the similarity degree is extracted from the authentication process S700. δᵢ and δ* indicate information encrypted in the second challenge Ĉ, and ξ indicates information represented by the second response Z.

As a first stage, the authentication apparatus 102 calculates the second challenge Ĉ from the two encrypted feature vectors C and C′, thereby calculating T pieces of δᵢ=(bᵢ−b′ᵢ)+t_{1, i} (i being each integer not less than 1 and not more than T) and one δ*=Σᵢ[2t_{1, i}(bᵢ−b′ᵢ)+t_{1, i}²]+u₁ (i being each integer not less than 1 and less than T). This calculation is performed with the encrypted feature vectors C and C′ kept encrypted with the key of the decryption apparatus 103. Thus, the authentication apparatus 102 cannot obtain the information on the feature vectors b and b′.

As a second stage, in the second response generation step S716, the decryption apparatus 103 calculates the second response Z from the second challenge Ĉ, thereby calculating ξ=Σᵢ[δᵢ²]−δ* (i being each integer not less than 1 and not more than T). This calculation is performed with the second challenge Ĉ decrypted with the secret key sk of the decryption apparatus 103. The decryption apparatus 103 does not know the temporary key u₁. Thus, the decryption apparatus 103 cannot obtain the information on the feature vectors b and b′ and information on the similarity degree d. That is, this calculation is performed with a result of the decryption encrypted with the temporary key u¹.

As a third stage, in the plaintext similarity degree calculation step S719, the authentication apparatus 102 calculates the similarity degree d=ξ+u₁ from the second response Z. With this arrangement, the authentication apparatus 102 can obtain the similarity degree d, but cannot obtain the information on the feature vectors b and b′.

In the biometric system 100 (data collation apparatus) in this embodiment, the key generation unit (401) generates the public key and the secret key, based on the key generation system of an additive homomorphic scheme.

A data extraction apparatus (authentication apparatus 102) includes the public key storage unit (302) that holds the public key distributed from the key generation unit; the encrypted data storage unit (312) that stores as encrypted first data (encrypted feature vector C) first data (feature vector b) encrypted with the public key and held by a data processing apparatus (registration apparatus 104) that holds the public key distributed from the key generation unit; the random number generation unit (303) that generates a first random number and a second random number using at least a part of the public key; the random number storage unit (322) that stores the first random number and the second random number; the encrypted random number generation unit (304) that encrypts the first random number, thereby generating the first challenge; the encrypted data extraction unit (305) that calculates, from the first response generated by a data processing apparatus (certification apparatus 101) by an arithmetic operation on second data (feature vector b′) using the first challenge, encrypted second data (encrypted feature vector C′) that is encryption of second data by processing with the first random number stored in the random number storage unit; the encrypted random similarity degree calculation unit (314) that generates the second challenge using the encrypted second data and the second random number; and the plaintext similarity degree extraction unit (315) that processes the second response using the second random number stored in the random number storage unit to calculate the plaintext similarity degree. The second response is obtained by processing the second challenge by the decryption apparatus or the data processing apparatus, using the secret key stored in the secret key storage unit (413).

The data processing apparatus (certification apparatus 101) includes the encrypted data embedding unit (217) that generates the first response by an arithmetic operation on the second data using the first challenge.

The decryption apparatus (103) or a data processing apparatus includes the key generation unit (401) that generates the public key and the secret key, based on the key generation system of the additive homomorphic scheme; the secret key storage unit (413) that stores the secret key; and the decryption unit (404) that processes the second challenge using the secret key stored in the secret key storage unit, thereby generating the second response.

With this arrangement, even if an attacker holds information (such as a set of the first challenge R and the first response R′ and a set of the second challenge Ĉ and the second response Z) being exchanged on the network among the certification apparatus 101, the authentication apparatus 102, the decryption apparatus 103, and the registration apparatus 104, it is difficult for the attacker to spoof an authorized user. That is, information that is critical for spoofing is never leaked from the information being exchanged among the apparatuses.

As a first reason for this prevention of leakage of the critical information for spoofing is that values of the random numbers R_{1, i}, and uᵢ as the plaintexts to be used for the first challenge R and the second challenge Ĉ generated by the authentication apparatus 102, the first response R′, and the second response Z change each time authentication is performed. Thus, a replay attack reusing these data without alteration cannot be performed.

As a second reason for this prevention of leakage of the critical information for spoofing is that the Okamoto-Takashima encryption system described in this embodiment, the BGN encryption, and the Paillier encryption have security where a cypertext cannot be identified. For this reason, even if the attacker uses homomorphism, the feature vectors b and b′ as plaintexts, the random numbers R_{1,i} and u₁ as the plaintexts, and the secret key sk will not leak from the first challenge R and the second challenge Ĉ, and the first response R′ and the second response Z respectively corresponding to the first challenge R and the second challenge Ĉ.

A third reason for this prevention of leakage of the critical information for spoofing is that the authentication apparatus 102 generates the first challenge R using the information not known by the certification apparatus 101, and the certification apparatus 101 generates the first response R′ using the information not known by the authentication apparatus 102. That is, the authentication apparatus 101 holds the random numbers R_{1, i} used for the first challenge R, and the certification apparatus 101 holds the user feature vector b′ as the plaintext. The attacker cannot obtain the feature vector b′ and information on the random numbers R_{1, i} as the plaintexts from the first challenge R and the first response R′ without knowing these secret information. Further, the authentication apparatus 102 cannot obtain the feature vector b as the plaintext even if the authentication apparatus 102 knows the random numbers R_{1, i}. The certification apparatus 101 cannot obtain the information on the random numbers R_{1, i} even if the certification apparatus 101 knows the feature vector b.

A similar relationship holds between the second challenge Ĉ and the second response Z. The authentication apparatus 102 generates the second challenge Ĉ using the information not known by the decryption apparatus 103, and the decryption apparatus 103 generates the second response Z using the information not known by the authentication apparatus 102. That is, the authentication apparatus 102 holds the random number u₁ used for the second challenge Ĉ, and the decryption apparatus 103 holds the secret key sk. The attacker cannot obtain information on the random number u₁ and information on the secret key sk from the second challenge Ĉ and the second response Z, without knowing these secret information. Further, the authentication apparatus 102 cannot obtain the secret key sk even if the authentication apparatus 102 knows the random number u₁. The decryption apparatus 103 cannot obtain the information on the random number u₁ even if the decryption apparatus 103 knows the secret key sk.

In the biometric information registration process S600 in this embodiment, each user (registration apparatus 104) transmits the encrypted feature vector C itself to the authentication apparatus 102, and then the authentication apparatus 102 just stores the transmitted encrypted feature vector C. Communication using the feature vector b does not need to be performed. Thus, a trusted registration processing apparatus is not needed.

The random numbers in this embodiment are uniformly generated from a random number space. For this reason, there is no correlation among the random numbers, so that there is no possibility that some information leaks from the correlation among the random numbers.

The feature vector b is held in the authentication apparatus 102 in an encrypted state, rather than being held without alteration. For this reason, the risk of the feature b, which is privacy information of the user, being peeped by the manager of the authentication apparatus 102 may be reduced.

Even if the encrypted feature vector C has leaked, the original feature vector b itself does not leak from the authentication apparatus 102. Thus, compared with holding of the feature vector b itself, the time and effort of data management for the authentication apparatus 102 may be reduced.

Further, according to the procedure in this embodiment, the decryption apparatus 103 can decrypt only the index value of a random similarity degree. The decryption apparatus 103 cannot decrypt the feature vectors b and b′. Thus, the feature vectors b and b′ do not come out during the process of authentication. Thus, biometric authentication with the biometric information kept secret is possible.

According to this embodiment, the biometric information is extracted so as to transmit the first response R′ from the certification apparatus 101 to the authentication apparatus 102 when authentication is performed. When generation of the first response R′ is finished, there is no process using the biometric information as the plaintext. For this reason, the biometric information can be immediately deleted on the certification apparatus 101. Accordingly, an opportunity where the biometric information is stolen from the certification apparatus 101 may be reduced.

The encryption system is not limited to the Okamoto-Takashima encryption system. It may be also so configured that a different additive homomorphic encryption system, such as the BGN encryption system, the Gentry encryption system, or the Paillier encryption system is employed.

The first response R′ to be transmitted from the certification apparatus 101 to the authentication apparatus 102 is obtained by encrypting the encrypted feature vector C′. The encrypted feature vector C′ is obtained by decrypting the first response R′ by the certification apparatus 101. The biometric authentication system 100 may be configured to use a different encryption system for this encryption system used for encryption and decryption. The encryption system in that case may be configured to use a standard public key encryption system rather than the additive homomorphic encryption system.

To take an example, the authentication apparatus 102 generates a set of the public key and the secret key, using the second encryption system, and then transmits the public key to the certification apparatus 101, as the first challenge R. The certification apparatus 101 encrypts the feature vector b′ using the public key of the decryption apparatus and according to the first addictive homomorphic encryption system, thereby generating the encrypted feature vector C′. Then, the certification apparatus 101 encrypts the generated encrypted feature vector C′ as the first response R′, using the public key received from the authentication apparatus 102 as the first challenge R and according to the second encryption system, and transmits the encrypted feature vector C′ to the authentication apparatus 102, as the first response R′. The authentication apparatus 102 decrypts the received first response R′ using the secret key generated by the authentication apparatus 102 and according to the second encryption system, thereby obtaining the encrypted feature vector C′.

However, when the first challenge R is the public key in the second encryption system and when the encrypted feature vector C′ encrypted with that public key is set to the first response R′, the first response R′ can be generated from the first challenge R and the encrypted feature vector C′. On contrast therewith, in the method described in this embodiment, the first response R′ is generated from the first challenge R and the original feature vector b′ without alteration. Thus, the first response R′ cannot be generated from the first challenge R and the encrypted feature vector C′. For this reason, even if a third party has obtained the encrypted feature vector C transmitted from the registration apparatus 104 to the authentication apparatus 102 in the registration process S600 by evesdropping of the third party, the third party cannot be authenticated by spoofing the certification apparatus 101.

### Second Embodiment

A second embodiment will be described, using FIG. 27.

Same reference signs are given to components that are common to those in the first embodiment, thereby omitting description of the components that are common to those in the first embodiment.

FIG. 27 is a system configuration diagram showing an example of an overall configuration of the biometric authentication system 100 in this embodiment.

The biometric authentication system 100 includes the certification apparatus 101 and the authentication apparatus 102. The certification apparatus 101 combines the function of the certification apparatus 101, the function of the decryption apparatus 103, and the function of the registration apparatus 104, all of which have been described in the first embodiment.

The certification apparatus 101 generates a set of the public key pk and the secret key sk, discloses the public key pk, and holds the secret key sk in secret. The authentication apparatus 102 performs an encryption process, using the public key pk disclosed by the certification apparatus 101.

The biometric authentication system 100 may include a plurality of the certification apparatuses 101. To take an example, assume that each user to be authenticated by the biometric authentication system 100 has his own certification apparatus 101. The user connects his certification apparatus 101 to a network or the like. The certification apparatus 101 communicates with the authentication apparatus 102 through the network or the like.

The authentication apparatus 102 stores the public key pk of each certification apparatus 101. The authentication apparatus 102 selects the public key pk of the certification apparatus 101 from among the stored public keys pk, based on the ID of the certification apparatus 101 or the ID of the user for which authentication has been demanded, and then performs encryption processing using the selected public key pk.

The public key pk of each certification apparatus 101 is transmitted to the authentication apparatus 102 by the certification apparatus 101 together with the encrypted feature vector C, in the registration process S600, for example. The authentication apparatus 102 then associates and stores the received public key pk and the encrypted feature vector C.

In the authentication process S700, the authentication apparatus 102 generates the first challenge R, based on the public key pk of the certification apparatus 101, and then transmits the first challenge R to the certification apparatus 101. The certification apparatus 101 generates the first response R′, based on the public key pk of the certification apparatus 101, the received first challenge R, and the feature vector b′, and transmits the first response R′ to the authentication apparatus 102. The authentication apparatus 102 generates the encrypted feature vector C′, based on the public key pk of the certification apparatus 101 and the received first response R′. The authentication apparatus 102 generates the second challenge Ĉ, based on the public key pk of the certification apparatus 101, the generated encrypted feature vector C′, and the encrypted feature vector C stored in the registration process S600, and then transmits the generated second challenge Ĉ to the certification apparatus 101. The certification apparatus 101 generates the second response Z, based on the secret key sk of the certification apparatus 101 and the received second challenge Ĉ, and transmits the generated second response Z to the authentication apparatus 102. The authentication apparatus 102 calculates the similarity degree d, based on the received second response.

When a third party spoofs the certification apparatus 101, the third party tries to generate the second response Z indicating that the feature vector b and the feature vector b′ are similar. The third party, however, does not know the temporary key u₁ generated by the certification apparatus 101. Thus, the third party does not know what kind of the second response Z indicates that the feature vector b and the feature vector b′ are similar. If the third party has decrypted the second challenge Ĉ by stealing the secret key of the certification apparatus 101, the third party cannot know the temporary key u₁. Thus, the third party cannot generate the second response Z indicating that the feature vector b and the feature vector b′ are similar.

### Third Embodiment

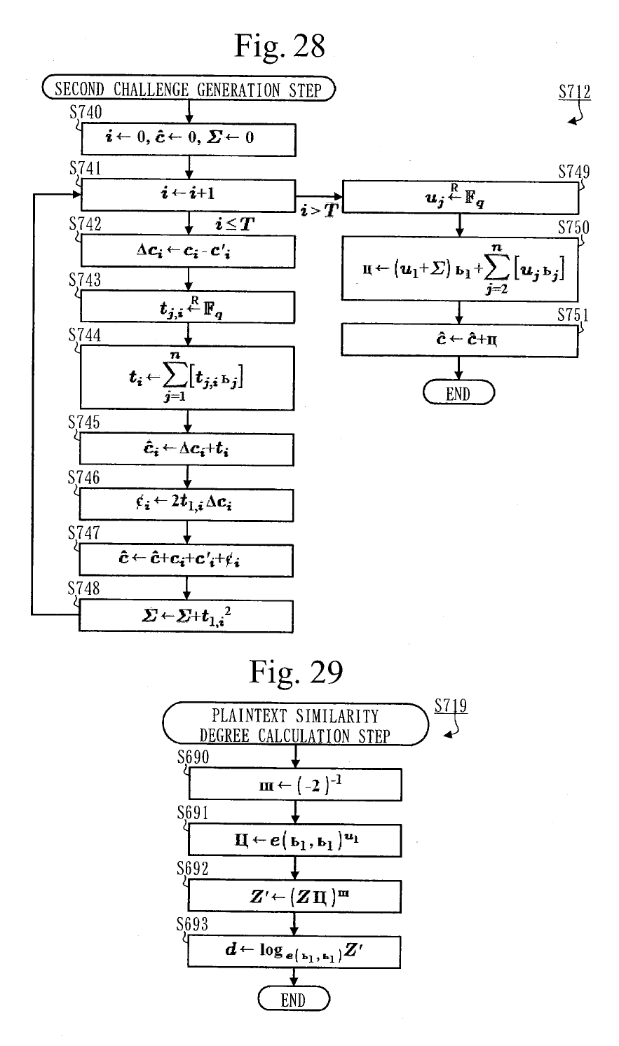

A third embodiment will be described using FIGS. 28 to 30.

Same reference signs are given to components that are common to those in the first and second embodiments, thereby omitting description of the components that are common to those in the first and second embodiments.

In this embodiment, the description will be directed to a case where, as the similarity degree d between the two feature vectors b and b′, an inner product Σᵢ[bᵢb′ᵢ] rather than the square of the Euclidean distance Σᵢ[(bᵢ−b′ᵢ)²] is calculated.

It is assumed that each component of each feature vector has one of two values of 1 and 0.

An overall configuration of the biometric authentication system 100 and inner configurations of the certification apparatus 101, the authentication apparatus 102, the decryption apparatus 103, and the registration apparatus 104 are similar to those described in the first embodiment. Thus, only a difference will be explained.

Using the processing device 911, the vector summation unit 367 of the encrypted random similarity degree calculation unit 314 in the authentication apparatus 102 calculates the vector ĉ, based on the encrypted feature vector C stored by the encrypted data storage unit 312, the encrypted feature vector C′ extracted by the encrypted data extraction unit 305, the scalar multiplication vector calculated by the scalar multiplication calculation unit 364, and the encryption key [symbol] [symbol] calculated by the encryption key generation unit 366. The vector ĉ is a vector Σᵢ[cᵢ]+Σᵢ[c′ᵢ]+Σᵢ[2t_{1, i}Δcᵢ]+(Σᵢ[t_{1, i}²])b₁+Σᵢ[uⱼbⱼ] (i being each integer not less than 1 and not more than T, and j being each integer not less than 1 and not more than n) obtained by combining T pieces of components cᵢ of the encrypted feature vector C, T pieces of components c′ᵢ of the encrypted feature vector C′, T pieces of components 2t_{1, u}Δcᵢ of the scalar multiplication vector calculated by the scalar multiplication calculation unit 364, and the encryption key [symbol] [symbol] =(Σᵢ[t_{1, i}²])b₁+Σⱼ[uⱼbⱼ] (i being each integer not less than 1 and not more than T, and j being each integer not less than 1 and not more than n), by addition in the vector space V. The vector ĉ is obtained by encrypting Σᵢ[bᵢ+b′ᵢ+2t_{1,i}(bᵢ−b′ᵢ)+2t_{1, i}²]+u₁, due to additive homomorphism of encryption.

FIG. 28 is a flow chart diagram showing an example of a flow of processes of the second challenge generation step S712 in this embodiment.

Though the flow of processes of the second challenge generation step S712 is almost the same as that in the first embodiment, only the vector summation step S747 is different.

In the vector summation step S747, using the processing device 911 and based on the ith component cᵢ of the encrypted feature vector C stored by the encrypted data storage unit 312, the ith component c′ᵢ of the encrypted feature vector C′ extracted by the encrypted data extraction unit 305, the ith component ᵢ=2t_{1, i}Δcᵢ of the scalar multiplication vector calculated by the scalar multiplication calculation unit 364 in the scalar multiplication step S746, the vector summation unit 367 combines the vector cᵢ, the vector c′ᵢ, and the vector with the vector ĉ by addition in the vector space V.

Though the decryption unit 404 of the decryption apparatus 103 has the same configuration as that in the first embodiment, the vector ĉ has a different meaning. Thus, the second response Z to be generated by the decryption unit 404 also has a meaning different from that in the first embodiment.

That is, the second response Z is an element obtained by exponentiating the element e (b₁, b₁) of the finite group G_{T} by (Σᵢ[(bᵢ−b′ᵢ)²−(bᵢ+b′ᵢ)]−u₁) (i being each integer not less than 1 and not more than T) by exponentiation on the finite group G_{T}. Since each of bᵢ and b′ᵢ takes one of values of 0 and 1, bᵢ=bᵢ² and b′ᵢ=b′ᵢ² constantly hold. Accordingly, the second response Z is the element obtained by exponentiating the element e (b₁, b₁) of the finite group G_{T} by (−2Σᵢ[bᵢ b′ᵢ]−u₁) (i being each integer not less than 1 and not more than T). That is, the second response Z is the one obtained by encrypting the inner product Σᵢ[bᵢb′ᵢ] between the feature vector b and the feature vector b′ by the random number u₁ as the temporary key.

Using the processing device 911, the element combining unit 372 of the plaintext similarity degree extraction unit 315 in the authentication apparatus 102 calculates an inverse element [symbol] =(−2)⁻¹ of (−2) using multiplication on the finite field F_{q}, based on the order q which is the part of the public key pk stored by the public key storage unit 302. Using the processing device 911, the authentication apparatus 102 calculates the decrypted similarity degree element Z′, based on the finite group G_{T}, which is the part of the public key pk stored by the public key storage unit 302, the second response Z received by the second response receiving unit 341, the decryption key [symbol] =e(b₁, b₁)^{u1} calculated by the group conversion unit 371, and the calculated inverse element [symbol] . The decrypted similarity degree element Z′ is an element (Z [symbol] ) [symbol] obtained by exponentiating an element Z [symbol] by the inverse element [symbol] by exponentiation on the finite group G_{T}. The element Z [symbol] is obtained by combining the second response Z and the decryption key [symbol] by multiplication on the finite group G_{T}. The second response Z is the element obtained by exponentiating the element e (b₁, b₁) of the finite group G_{T} by (−2Σᵢ[bᵢ b′ᵢ]−u₁) (i being each integer not less than 1 and not more than T) using exponentiation on the finite group G_{T}. Thus, the decrypted similarity degree element Z′ is the element obtained by exponentiating the element e (b₁, b₁) of the finite group G_{T} by (Σᵢ[bᵢ b′ᵢ]) (i being each integer not less than 1 and more than T) using exponentiation on the finite group G_{T}.

FIG. 29 is a flow chart diagram showing an example of a flow of processes of the plaintext similarity degree calculation step S719 in this embodiment.

In addition to the steps described in the first embodiment, the plaintext similarity degree calculation step S719 includes an inverse number calculation step S690.

In the inverse number calculation step S690, using the processing device 911, the element combining unit 372 calculates the inverse element [symbol] of (−2) using multiplication on the finite field F_{q}. The inverse element [symbol] is constant irrespective of the second response Z. Thus, it may be so configured that the inverse element [symbol] is calculated in advance.

In the element combining step S692, using the processing device 911, the element combining unit 372 calculates the decrypted similarity degree element Z′=(Z [symbol] ) [symbol] ^{, based on the second response Z received by the second response receiving unit 341, the inverse element} [symbol] ^{calculated in the inverse number calculation step S690, and the decryption key} [symbol] ^{calculated by the group calculation unit 371 in the group conversion step S691.}

It may also be so configured that, as the decrypted similarity degree element Z′, the element combining unit 372 calculates the element Z [symbol] by combining the second response Z and the decryption key [symbol] using multiplication on the finite group G_{T}, and that the discrete logarithm calculation unit 373 determines, as the similarity degree d, to what power e (b₁, b₁)⁻² of the finite group G_{T} is raised to be equal to the decrypted similarity degree element Z′.

The inner product Σᵢ[bᵢb′ᵢ] between the two feature vectors b and b′ indicates that the larger the inner product Σᵢ[bᵢb′ᵢ] is, the more similar the two feature vectors b and b′ are, to the contrary of the square of the Euclidean distance Σᵢ[(bᵢ−b′ᵢ)²]. For this reason, the determination unit 306 determines that the two feature vectors b and b′ are similar when the similarity degree d calculated by the discrete logarithm calculation unit 373 is larger than the predetermined threshold value do.

Each component of each feature vector takes one of the two values of 0 and 1. Thus, the inner product Σᵢ[bᵢb′ᵢ] between the two feature vectors b and b′ becomes an integer not less than 0 and not more than T. The discrete logarithm calculation unit 373 calculates the element e(b₁, b₁)^{d} by exponentiating e(b₁, b₁) by the integer d in advance for each integer d not less than d₀ and not more than T, for example. The discrete logarithm calculation unit 373 thereby calculates the similarity degree d when the similarity degree d is not less than d₀ and not more than T, and determines that the similarity degree d is smaller than d₀ when the similarity degree is less than d₀. The discrete logarithm calculation unit 373 may also be configured to calculate the similarity degree d when the similarity degree d is not more than d₀ and to determine that the similarity degree d is larger than d₀ when the similarity degree is larger than d₀, as in the first embodiment.

With this arrangement, it can be determined whether the two feature vectors b and b′ are similar, using the number of matches between feature points as a reference.

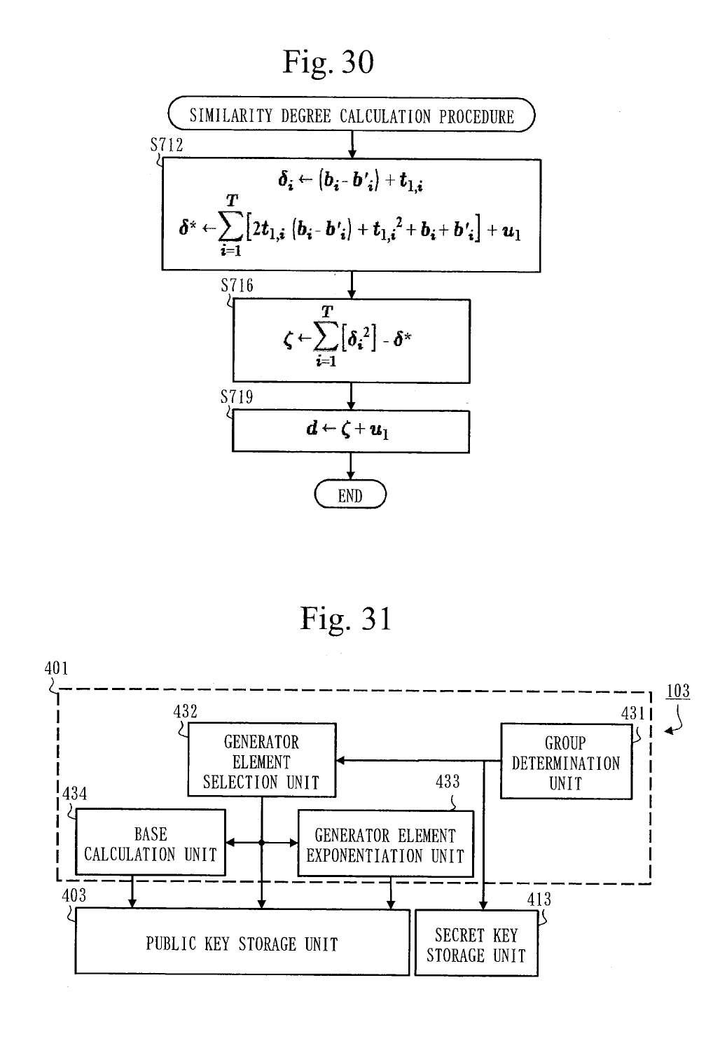

FIG. 30 is a flow chart diagram showing a procedure for calculating a similarity degree in the biometric authentication system 100 in this embodiment.

As a first stage, the authentication apparatus 102 calculates the second challenge Ĉ from the two encrypted feature vectors C and C′, thereby calculating T pieces of δᵢ=(bᵢ−b′ᵢ)+t_{1, i} (i being each integer not less than 1 and not more than T) and one δ=Σᵢ[2t_{1, i}(bᵢ−b′ᵢ)+t_{1, i}²+bᵢ+b′ᵢ]+u₁ (i being each integer not less than 1 and not more than T), in the second challenge generation step S712. This calculation is performed with the encrypted feature vectors C and C′ kept encrypted with the key of the decryption apparatus 103. Thus, the authentication apparatus 102 cannot obtain information on the feature vectors b and b′.

As a second stage, the decryption apparatus 103 calculates the second response Z from the second challenge Ĉ, thereby calculating ξ=Σᵢ[δᵢ²]−δ* (i being each integer not less than 1 and not more than T), in the second response generation step S716. This calculation is performed with the second challenge Ĉ decrypted with the secret key of the decryption apparatus 103. Since the decryption apparatus 103 does not know the temporary key u₁, the decryption apparatus 103 does not obtain the information on the feature vectors b and b′ and information on the similarity degree. That is, this calculation is performed with a result of the decryption kept encrypted with the temporary key u₁.

As a third stage, the authentication apparatus 102 calculates the similarity degree d=ξ+u₁ from the second response Z, in the plaintext similarity degree calculation step S719. With this arrangement, the authentication apparatus 102 can obtain the similarity degree d, but cannot obtain the information on the feature vectors b and b′.

The encryption system is not limited to the Okamoto-Takashima encryption system. It may be so configured that a different additive homomorphic encryption system, such as the BGN encryption system, the Gentry encryption system, or the Paillier encryption system is employed. It may also be so configured that a second encryption system such as the standard public key encryption system is employed for communication between the certification apparatus 101 and the authentication apparatus 102.

As in the second embodiment, the biometric authentication system 100 may be so configured that the certification apparatus 101 combines functions as the decryption apparatus 103 and the registration apparatus 104.

As compared with the first embodiment, configurations of the certification apparatus 101, the decryption apparatus 103, and the registration apparatus 104 remain unchanged, but only the configuration of the authentication apparatus 102 is different in this embodiment. Accordingly, by setting the authentication apparatus 102 to a configuration capable of switching between the configuration described in the first embodiment and the configuration described in this embodiment, two types of similarity degrees using the Euclidean distance and the inner product may be calculated without altering the other apparatuses in the biometric authentication system 100.

### Fourth Embodiment

A fourth embodiment will be described, using FIGS. 31 to 45.

Same reference signs are given to components that are common to those in the first to third embodiments, thereby omitting description of the components that are common to those in the first to third embodiments.

In this embodiment, a description will be directed to a case where the BGN encryption system is employed as the encryption system. The square of the Euclidean distance is used for the similarity degree d, as in the first embodiment.

First, the BGN encryption system will be outlined.

Assume that N is the product of two mutually different prime numbers p and q. Assume that G and G_{T} are finite groups of the order N. A group arithmetic operation on each of the finite group G and the finite group G_{T} is described as multiplication. Assume that e is a pairing G×G→G_{T} that maps a set of two elements of the finite group G to an element of the finite group G_{T}. The pairing e satisfies bilinearity and non-degenerateness.

Assume that g and u are elements uniform randomly selected from the generator element of the finite group G. Assume that h is an element of the finite group G, and is an element u^{q} obtained by exponentiating the element u by the prime number q, using exponentiation on the finite group G.

Each of the finite group G and the finite group G_{T} is the direct product of the cyclic group of the order p and the cyclic group of the order q. Accordingly, the order of the element h is p.

Assume that x and r are each an integer not less than 0 and less than N. Assume that a product g^{x}h^{r} of an element g^{x} and an element h^{r} is given. The element g^{x} is obtained by exponentiating the element g by an integer x using exponentiation on the finite group G, and the element h^{r} is obtained by exponentiating the element h by an integer r using exponentiation on the finite group G. Then, an element [g^{x}h^{r}]^{p} obtained by exponentiating the product g^{x}h^{r} by the prime number p using exponentiation on the finite group G is equal to [g^{x}]^{p}, because the order of the element h is p.

Assume that a set of the finite group G, the finite group G_{T}, the order N, the pairing e, the element g, and the element h is set to the public key pk, and the prime number p is set to the secret key sk, for example. Then, assume that the integer x not less than 0 and not more than L which is sufficiently smaller than the prime number q is set to a plaintext, and the element g^{x}h^{r} of the finite group G is set to a ciphertext E(x) obtained by encrypting the plaintext x. Assume, however, that r is the integer uniform randomly selected from among integers not less than 0 and less than N.

The prime number p, which is the secret key sk, is used for decryption. An element E(x)^{p}=[g^{x}]^{p}=[g^{p}]^{x} obtained by exponentiating the ciphertext E(x) by the prime number p is calculated, using exponentiation on the finite group G. When it is known to what power g^{p} is raised to be equal to [g^{p}]^{x}, x can be decrypted.

When the integer L is small, this problem of discrete logarithm can be solved, by using Pollard's lambda method, for example. The amount of calculation necessary in that case is proportional to \sqrt{L}. Accordingly, when the value of the integer L is set so that the calculation may be performed with a practical amount of calculation, x can be decrypted.

When a ciphertext E(x₁)=g^{x1}h^{r1} of an integer x₁ and a ciphertext E(x₂)=g^{x2}h^{r2} of an integer x₂ are combined using multiplication on the finite group G, E(x₁)E(x₂)=g^{x1+x2}h^{r1+r2} is obtained. Thus, a ciphertext E (x₁+x₂) for x1+x2, which is the sum of the integer x1 and the integer x2, is obtained.

The ciphertext E(x) can also be decrypted in a state of being kept encrypted, after having been translated to the finite group G_{T} using the pairing e. A pairing e (g^{x1}h^{r1}, g^{x2} h^{r2}) between the ciphertext E(x₁) of the integer x₁=g^{x1}h^{r1} and the ciphertext E(x₂) of the integer x₂=g^{x2}h^{r2} is e(g, g)^{x1x2}e(g, h)^{x1r2}e(h,g)^{x2r1}e(h, h)^{r1r2} due to bilinearity of the paring. Since the order of the element h of the finite group G is p, the order of each of pairings e(g, h), e(h, g), e(h, h), which are elements of the finite group G_{T}, is p. Accordingly, when the pairing e (E(x₁), E(x₂)) between the ciphertext E(x₁) and the ciphertext E(x₂) is exponentiated by the prime number p using exponentiation on the finite group G_{T}, [e(g, g)^{p}]^{x1x2} is obtained. That is, the pairing e (E(x₁), E(x₂)) between the ciphertext E(x₁) and the ciphertext E(x₂) is the ciphertext of the product x₁x₂ of the integer x₁ and the integer x₂.

FIG. 31 is a detailed block diagram showing an example of a configuration of the key generation unit 401 in this embodiment.

The key generation unit 401 of the decryption apparatus 103 includes a group determination unit 431, a generator element selection unit 432, and a generator element exponentiation unit 433, for example.

Using the processing device 911, the group determination unit 431 generates the two mutually different prime numbers p and q, based on the size (such as 512 bits or 1024 bits) determined according to the security level. The group determination unit 431 calculates the product N=pq between the two generated prime numbers p and q, using the processing device 911. The group determination unit 431 determines the finite group G and the finite group G_{T}, based on the calculated product N, using the processing device 911. The order of each of the finite group G and the finite group G_{T} is N, and the finite group G and the finite group G_{T} have the pairing e: G×G→G_{T}.

Using the processing device 911, the generator element selection unit 432 selects the two generator elements g and u of the finite group G, based on the finite group G determined by the group determination unit 431.

Using the processing device 911, the generator element exponentiation unit 433 calculates the element h, based on the prime number q generated by the group determination unit 431 and the generator element u selected by the generator element selection unit 432. The element h is the element u^{q} obtained by exponentiating the generator element u by the prime number q using exponentiation on the finite group G.

Using the processing device 911, a base calculation unit 434 calculates an element π, based on the prime number p generated by the group determination unit 431, the paring e, and the generator element g selected by the generator element selection unit 432. The element π is an element of the finite group G_{T}. The element π is an element e(g, g)^{p} obtained by exponentiating the element (g, g) by the prime number p using exponentiation on the finite group G_{T}. The element (g, g) is obtained by translation of a set of the generator elements g by the pairing e.

The public key storage unit 403 stores, as the public key pk, a set (G, G_{T}, N, e, g, h, π) of the finite group G, the finite group G_{T}, the product N, the pairing e, the generator element g, the element h, and the element π, using the storage device 914.

The secret key storage unit 413 stores, as the secret key sk, the prime number p generated by the group determination unit 431, using the storage device 914.

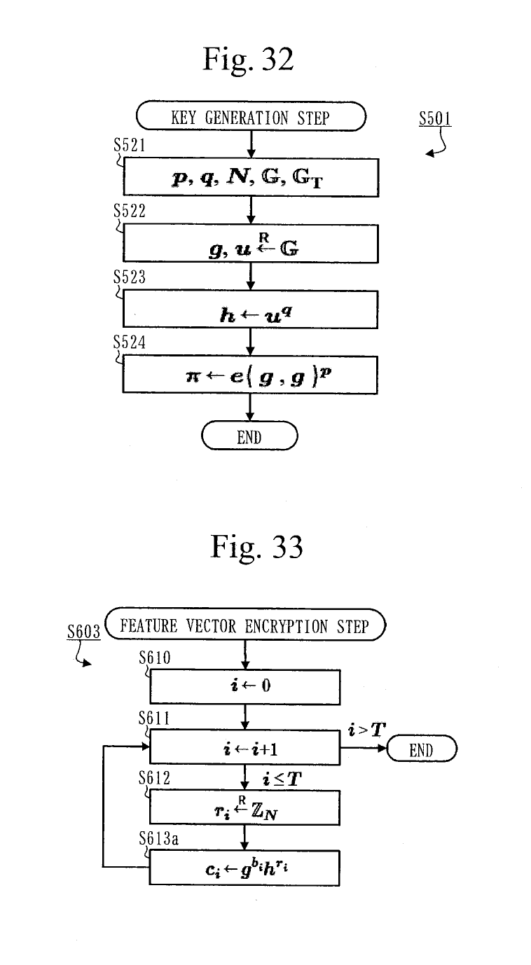

FIG. 32 is a flow chart diagram showing an example of a flow of processes of the key generation step S501 in this embodiment.

In the key generation step S501, the decryption apparatus 103 generates a set of the public key pk and the secret key sk. It may also be so configured that a set of the public key pk and the secret key sk which is different for each user is generated. Alternatively, it may be so configured that one set of the public key pk and the secret key sk is generated for the overall system.

The key generation step S501 includes a group determination step S521, a generator element selection step S522, a generator element exponentiation step S523, and a base calculation step S524, for example.

First, in the group determination step S521, using the processing device 911, the group determination unit 431 determines the two prime numbers p and q, the product N, and each of the finite groups G and G_{T} of the order N. Using the storage device 914, the public key storage unit 403 stores the product N, the finite group G, and the finite group G_{T}, as a part of the public key pk. Using the storage device 914, the secret key storage unit 413 stores the prime number p as the secret key sk.

In the generator element selection step S522, using the processing device 911, the generator element selection unit 432 selects the two generator elements g and u, based on the finite group G determined by the group determination unit 431 in the group determination step S521. The public key storage unit 403 stores the generator element g, as a part of the public key pk, using the storage device 914.

In the generator element exponentiation step S523, using the processing device 911, the generator element exponentiation unit 433 calculates the element h=u^{q} of the finite group G, based on the prime number q determined by the group determination unit 431 in the group determination step S521 and the generator element u selected by the generator element selection unit 432 in the generator element selection step S522. Using the processing device 911, the public key storage unit 403 stores the element h, as a part of the public key pk.

In the base calculation step S524, using the processing device 911, the base calculation unit 434 calculates the element π=e(g, g)^{p} of the finite group G_{T}, based on the prime number p determined by the group determination unit 431 in the group determination step S521, the pairing e, and the generator element g selected by the generator element selection unit 432 in the generator element selection step S522. Using the processing device 911, the public key storage unit 403 stores the element π as a part of the public key pk.

The public key pk=(G, G_{T}, N, e, g, h, π) stored by the public key storage unit 403 in this manner is transmitted to each of the authentication apparatus 102 and the like by the public key transmitting unit 408, and each of the authentication apparatus 102 and the like receives and then stores the public key pk.

FIG. 33 is a flow chart diagram showing an example of a flow of processes of the feature vector encryption step S603 in this embodiment.

In the feature vector encryption step S603, the registration apparatus 104 encrypts the feature vector b, thereby generating the encrypted feature vector C. The feature vector encryption step S603 includes the initialization step S610, the repetition step S611, the random number generation step S612, and an element calculation step S613a, for example.

The feature vector b generated by the feature vector formation unit 204 of the registration apparatus 104 is a T-dimensional vector (b₁, b₂, . . . , b_{T}) (T being an integer not less than 1) having components of integers. The encrypted feature vector C generated by the encrypted data generation unit 206 is a T-dimensional vector (c₁, c₂, . . . , c_{T}) having components of elements of the finite group G.

First, in the initialization step S610, using the processing device 911, the encrypted data generation unit 206 initializes the integer i to 0.

In the repetition step S611, using the processing device 911, the encrypted data generation unit 206 adds 1 to the integer i. When the integer i is larger than T, the encrypted data generation unit 206 finishes the feature vector encryption step S603. When the integer i is not more than T, the encrypted data generation unit 206 causes the process to proceed to the random number generation step S612, thereby generating the ith component cᵢ of the encrypted feature vector C.

In the random number generation step S612, using the processing device 911, the random number generation unit 205 generates a random number rᵢ, based on the order N which is a part of the public key pk stored by the public key storage unit 202. The random number rᵢ generated by the random number generation unit 205 is an integer uniform randomly selected from among integers not less than 0 and less than N.

In the element calculation step S613a, using the processing device 911, the encrypted data generation unit 206 calculates the ith component cᵢ of the encrypted feature vector C, based on the generator element g and the element h which are the parts of the public key pk stored by the public key storage unit 202, the ith component bᵢ of the feature vector b generated by the feature vector formation unit 204, and the random number rᵢ generated by the feature vector formation unit 204 in the random number generation step S612. The ith component cᵢ of the encrypted feature vector C calculated by the encrypted data generation unit 206 is an element g^{bi}h^{ri} obtained by combining an element g^{bi} and an element h^{ri} using multiplication on the finite group G. The element g^{bi} is obtained by exponentiating the generator element g by an integer bᵢ using exponentiation on the finite group G. The element h^{ri} is obtained by exponentiating the element h by the random number rᵢ using exponentiation on the finite group G.

The encrypted data generation unit 206 causes the process to return to the repetition step S611, thereby generating the subsequent component of the encrypted feature vector C.

The encrypted feature vector C generated by the encrypted data generation unit 206 in this manner is transmitted to the authentication apparatus 102 by the encrypted data transmitting unit 201, and the authentication apparatus 102 receives and then stores the encrypted feature vector C.

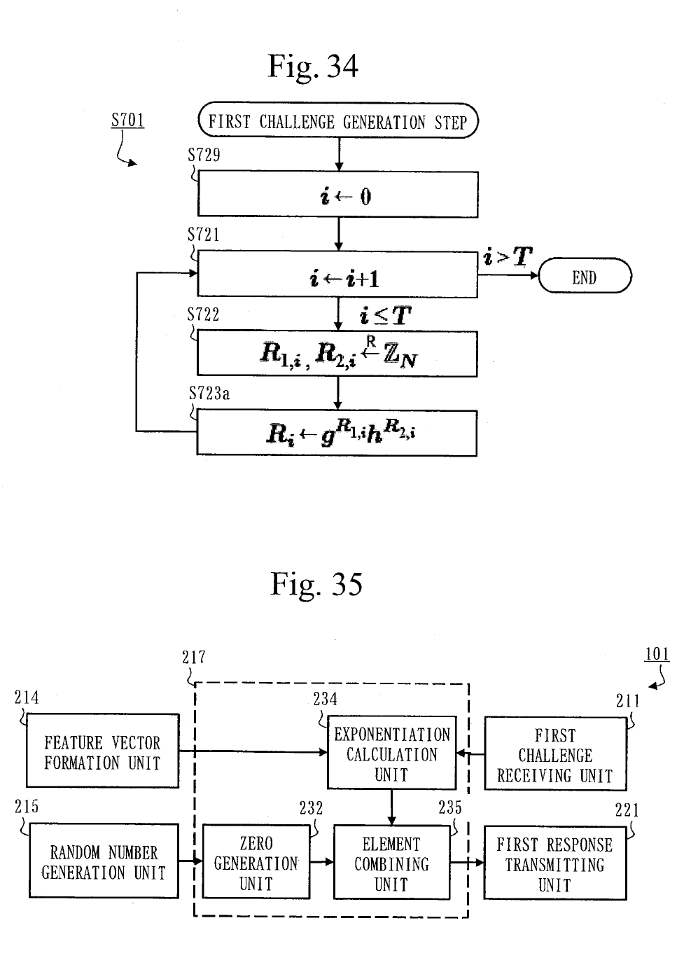

FIG. 34 is a flow chart diagram showing an example of a flow of processes of the first challenge generation step S701 in this embodiment.

In the first challenge generation step S701, the authentication apparatus 102 generates the first challenge R. The first challenge generation step S701 includes the initialization step S729, the repetition step S721, the random number generation step S722, and an element calculation step S723a, for example.

The first challenge R generated by the encrypted random number generation unit 304 of the authentication apparatus 102 is a T-dimensional vector (R₁, R₂, . . . , R_{T}) having components of elements of the finite group G.

First, in the initialization step S729, using the processing device 911, the encrypted random number generation unit 304 initializes the integer i to 0.

In the repetition step S721, using the processing device 911, the encrypted random number generation unit 304 adds 1 to the integer i. When the integer i is larger than T, the encrypted random number generation unit 304 finishes the first challenge generation step S701. When the integer i is not more than T, the encrypted random number generation unit 304 causes the process to proceed to the random number generation step S722, thereby generating the ith component Rᵢ of the first challenge R.

In the random number generation step S722, using the processing device 911, the random number generation unit 303 generates two random numbers R_{1, i} and R_{2, i}, based on the order N, which is the part of the public key pk stored by the public key storage unit 302. The random numbers R_{1, i} and R_{2, i} generated by the random number generation unit 303 are integers uniform randomly selected from among the integers not less than 0 and less than N. The random number storage unit 322 stores the random number R_{1, i} generated by the random number generation unit 303, using the storage device 914.

In the element calculation step S723a, using the processing device 911, the encrypted random number generation unit 304 calculates the ith component Rᵢ of the first challenge R, based on the generator element g and the element h which are the parts of the public key pk stored by the public key storage unit 302 and the two random numbers R_{1, i} and R_{2, i} generated by the random number generation unit 303 in the random number generation step S722. The ith component Rᵢ of the first challenge R calculated by the encrypted random number generation unit 304 is an element resulting from combination of an element obtained by exponentiating the generator element g by the random number R_{1, i} using exponentiation on the finite group G and an element obtained by exponentiating the element h by the random number R_{2, i} using exponentiation on the finite group G, by multiplication on the finite group G.

The encrypted random number generation unit 304 causes the process to return to the repetition step S721, thereby generating the subsequent component of the first challenge R.

The first challenge R generated by the encrypted random number generation unit 304 in this manner is transmitted to the certification apparatus 101 by the first challenge transmitting unit 311. The certification apparatus 101 receives and then processes the first challenge R.

The number of the random numbers R_{1, i} and R_{2, i} (i being each integer not less than 1 and not more than T) generated by the random number generation unit 303 in the first challenge generation step S701 is 2T in total. T pieces of random numbers R_{1, i} (i being each integer not less than 1 and not more than T) are stored by the random number storage unit 322. The T pieces of random numbers R_{1, i} stored by the random number storage unit 322 are random numbers as plaintexts, and the remaining T pieces of random numbers R_{2, i} (i being each integer not less than 1 and not more than T) are random numbers for encryption. Each component Rᵢ of the first challenge R is obtained by encrypting the random number R_{1, i} as a plaintext.

FIG. 35 is a detailed block diagram showing an example of a configuration of the encrypted data embedding unit 217 in this embodiment.

The encrypted data embedding unit 217 of the certification apparatus 101 includes an exponentiation calculation unit 234, the zero generation unit 232, and an element combining unit 235.

A feature vector b′ generated by the feature vector formation unit 214 of the certification apparatus 101 is a T-dimensional vector (b′₁, b′₂, . . . , b′_{T}) having components of integers, like the feature vector b generated by the feature vector formation unit 204 of the registration apparatus 104.

Using the processing device 911, the random number generation unit 215 generates T pieces of random numbers r′ᵢ (i being each integer not less than 1 and not more than T), based on the order N which is the part of the public key pk stored by the public key storage unit 212. The random numbers r′ᵢ generated by the random number generation unit 215 are integers uniform randomly selected from among the integers not less than 1 and less than N.

Using the processing device 911, the exponentiation calculation unit 234 calculates an exponentiation vector [symbol] [symbol] , based on the first challenge R received by the first challenge receiving unit 211 and the feature vector b′ generated by the feature vector formation unit 214. The exponentiation vector [symbol] [symbol] calculated by the exponentiation calculation unit 234 is a T-dimensional vector ( [symbol] ₁, [symbol] ₂, . . . , [symbol] _{T}) having components of elements of the finite group G, like the first challenge R. The ith component [symbol] ᵢ (i being the integer not less than 1 and not more than T) of the exponentiation vector [symbol] [symbol] calculated by the exponentiation calculation unit 234 is an element Rᵢ^{b′i} obtained by exponentiating the ith component Rᵢ of the first challenge R by the ith component b′ᵢ of the feature vector b′ using exponentiation on the finite group G. Each component [symbol] of the exponentiation vector [symbol] [symbol] calculated by the exponentiation calculation unit 234 is obtained by encrypting the product of the component b′ᵢ of the feature vector b′ and the random number R_{1, i} as the plaintext generated by the authentication apparatus 102.

Using the processing device 911, the zero generation unit 232 generates the encrypted zero vector O based on the element h which is the part of the public key pk stored by the public key storage unit 202 and the T pieces of random numbers r′ᵢ generated by the random number generation unit 21. The encrypted zero vector O is a T-dimensional vector (o₁, o₂, . . . , o_{T}) having components of elements of the finite group G. The ith component oᵢ (i being the integer not less than 1 and not more than T) of the encrypted zero vector O is an element h^{r′i} obtained by exponentiating the element h by the ith random number r′ᵢ using exponentiation on the finite group G.

Using the processing device 911, the element combining unit 235 calculates the first response R′, based on the exponentiation vector [symbol] [symbol] calculated by the exponentiation calculation unit 234 and the encrypted zero vector O generated by the zero generation unit 232. The first response R′ is a T-dimensional vector (R′₁, R′₂, . . . , R′_{T}) having components of elements of the finite group G. The ith component R′i (i being the integer not less than 1 and not more than T) of the first response R′ is an element Rᵢ^{b′i}h^{r′i} obtained by combining the ith component [symbol] =Rᵢ^{b′i} of the exponentiation vector and the ith component oᵢ=h^{r′i} of the encrypted zero vector O using multiplication on the finite group G. Each component R′ᵢ of the first response R′ is obtained by encrypting the product of the random number R_{1, i} as the plaintext and the component b′ᵢ of the feature vector b′. The random number R_{1, i} is encrypted in the component Rᵢ of the first challenge R.

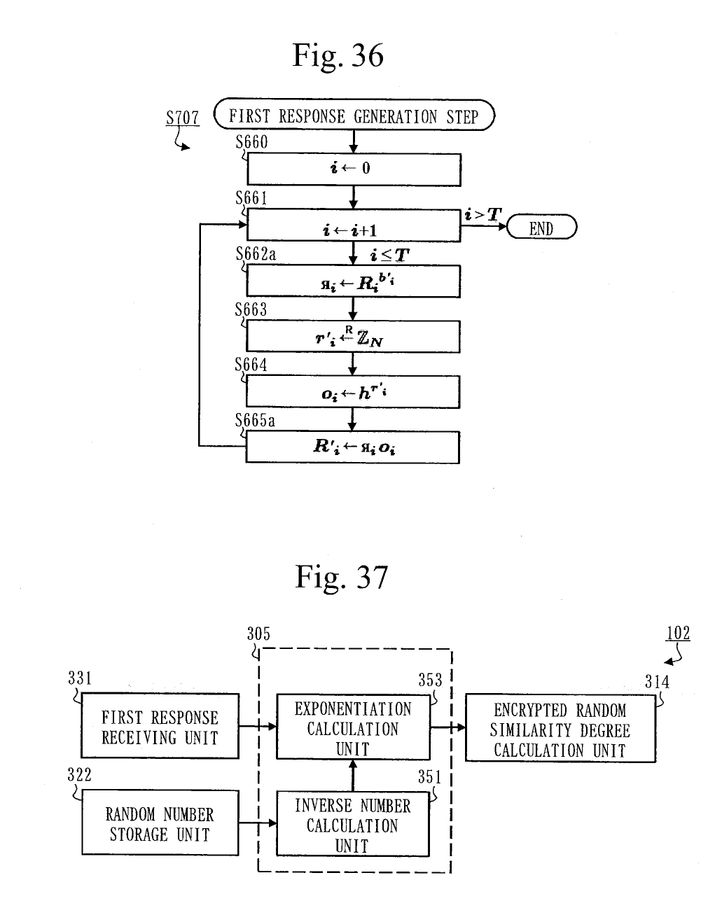

FIG. 36 is a flow chart diagram showing an example of a flow of processes of the first response generation step S707 in this embodiment.

In the first response generation step S707, the certification apparatus 101 generates the first response R′, based on the feature vector b′ and the first challenge R. The first response generation step S707 includes the initialization step S660, the repetition step S661, an exponentiation calculation step S662a, the random number generation step S663, the zero generation step S664, and an element combining step S665a.

First, in the initialization step S660, the element combining unit 235 initializes the integer i to 0, using the processing device 911.

In the repetition step S661, the element combining unit 235 adds I to the integer i, using the processing device 911. When the integer i is larger than T, the element combining unit 235 finishes the first response generation step S707. When the integer i is not more than T, the element combining unit 235 causes the process to proceed to the exponentiation calculation step S662a to generate the ith component R′ᵢ of the first response R′.

In the exponentiation calculation step S662a, using the processing device 911, the exponentiation calculation unit 234 calculates the ith component [symbol] ᵢ=Rᵢ^{b′i} of the exponentiation vector [symbol] [symbol] , based on the ith component b′ᵢ of the feature vector b′ generated by the feature vector formation unit 214 and the ith vector Rᵢ of the first challenge R received by the first challenge receiving unit 211.

In the random number generation step S663, the random number generation unit 215 generates the random number r′ᵢ, using the processing device 911.

In the zero generation step S664, using the processing device 911, the zero generation unit 232 calculates the ith component oᵢ=h^{r′i} of the encrypted zero vector O, based on the random number r′ᵢ generated by the random number generation unit 215 in the random number generation step S663.

In the element combining step S665a, using the processing device 911, the element combining unit 235 calculates the ith component R′ᵢ= [symbol] ᵢoᵢ, based on the ith component [symbol] of the exponentiation vector [symbol] [symbol] calculated by the exponentiation calculation unit 234 in the exponentiation calculation step S662a and the ith component oᵢ of the encrypted zero vector O calculated by the zero generation unit 232 in the zero generation step S664.

The element combining unit 235 causes the process to return to the repetition step S661 to generate the subsequent component of the first response R′.

The first response R′ generated by the encrypted data embedding unit 217 in this manner is transmitted to the authentication apparatus 102 by the first response transmitting unit 221. The authentication apparatus 102 receives and then processes the first response R′.

When the component b′ᵢ of the feature vector b′ takes only one of two values of 0 and 1, the processes of the first response generation step S707 can be simplified, as follows, for example.

First, there is no need for exponentiation, so that the exponentiation calculation unit 234 is not provided, and the exponentiation calculation step S662a is not executed.

Using the processing device 911, the element combining unit 235 determines whether or not the ith component b′ᵢ of the feature vector b′ is 0 or 1, in the element combining step S665a. When the ith component b′ᵢ of the feature vector b′ is 0, the element combining unit 235 sets the ith component oᵢ=h^{r′i} of the encrypted zero vector O calculated by the zero generation unit 232 in the zero generation step S664 to the ith component R′ᵢ of the first response R′, using the processing device 911. When the ith component b′ᵢ of the feature vector b′ is 1, the element combining unit 235 calculates an element Rᵢh^{r′i} by combining the ith component oᵢ=h^{r′i} of the encrypted zero vector O calculated by the zero generation unit 232 in the zero generation step S664 and the ith component Rᵢ of the first challenge R received by the first challenge receiving unit 211 to set the element Rᵢh^{r′i} to the ith component R′ᵢ of the first response R′ by multiplication on the finite group G, using the processing device 911.

The ith component Rᵢ of the first challenge R is the product of the R_{1, i} th power of the generator element g and the R_{2, i} th power of the element h. Thus, the ith component R′ᵢ of the first response R′ is the product of the b′ᵢR_{1, i} th power of the generator element g and the (b′ᵢR_{2, i}+r′ᵢ) th power of the element h. That is, the ith component R′ᵢ of the first response R′ is obtained by encrypting the product of the ith component b′ᵢ of the feature vector b′ and the random number R_{1, i}.

FIG. 37 is a detailed block diagram showing an example of a configuration of the encrypted data extraction unit 305 in this embodiment.

The encrypted data extraction unit 305 of the authentication apparatus 102 includes the inverse number calculation unit 351 and the scalar multiplication calculation unit 352, for example.

The encrypted feature vector C′ generated by the encrypted data extraction unit 305 of the authentication apparatus 102 is a T-dimensional vector (c′₁, c′₂, . . . , c′_{T}) having components of elements of the finite group G, like the encrypted feature vector C generated by the encrypted data generation unit 206 of the registration apparatus 104.

Using the processing device 911, the inverse number calculation unit 351 calculates an inverse number κᵢ=R_{1, i}⁻¹ it of each random number R_{1, i} by multiplication of integers modulo N, based on the T pieces of random numbers R_{1,i} (i being each integer not less than 1 and not more than T) stored by the random number storage unit 322. The inverse number κᵢ is an integer where, when the product of the random number R_{1, i} and the inverse number κᵢ is divided by N, the remainder is 1. Since N is not a prime number, the random number R_{1, i} does not necessarily have the inverse number κᵢ. However, the two prime numbers p and q, which are prime factors of N, are sufficiently large, the probability that the random number R_{1, i} is a zero divisor is extremely small and is negligible.

Using the processing device 911, the exponentiation calculation unit 353 calculates the encrypted feature vector C′, based on the first response R′ received by the first response receiving unit 331 and the T inverse numbers κᵢ calculated by the inverse number calculation unit 351. The ith component c′ᵢ (i being the integer not less than 1 and not more than T) of the encrypted feature vector C′ calculated by the exponentiation calculation unit 353 is an element obtained by exponentiating the ith component R′ᵢ of the first response R′ by the ith inverse number κᵢ using multiplication on the finite group G. Each component c′ᵢ of the encrypted feature vector C′ is obtained by encrypting the component b′ᵢ of the feature vector b′.

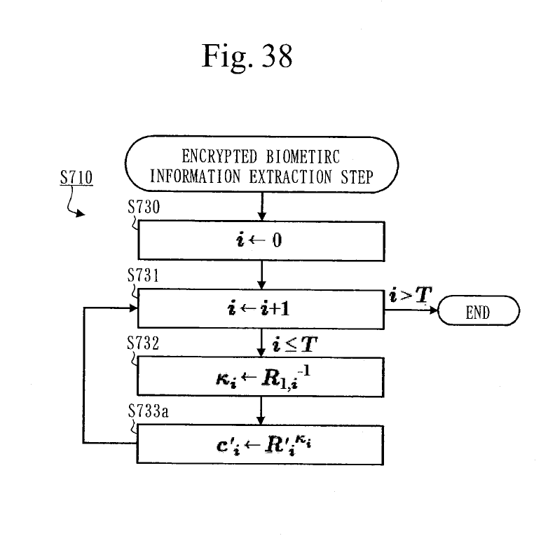

FIG. 38 is a flow chart diagram showing an example of a flow of processes of the encrypted biometric information extraction step S710 in this embodiment.

In the encrypted biometric information extraction step S710, the authentication apparatus 102 generates the encrypted feature vector C′, based on the first response R′. The encrypted biometric information extraction unit S710 includes the initialization step S730, the repetition step S731, the inverse number calculation step S732, and an exponentiation calculation step S733a, for example.

First, in the initialization step S730, the exponentiation calculation unit 353 initializes the integer i to 0, using the processing device 911.

In the repetition step S731, the exponentiation calculation unit 353 adds 1 to the integer i, using the processing device 911. When the integer i is larger than T, the exponentiation calculation unit 353 finishes the encrypted biometric information extraction step S710. When the integer i is not more than T, the exponentiation calculation unit 353 causes the process to proceed to the inverse number calculation step S732 to generate the ith component c′ᵢ of the encrypted feature vector C′.

In the inverse number calculation step S732, using the processing device 911, the inverse number calculation unit 351 calculates the inverse number κᵢ=R_{1, i}⁻¹, based on the ith random number R_{1, i} out of the T pieces of random numbers stored by the random number storage unit 322 in the first challenge generation step S701.

In the exponentiation calculation step S733a, using the processing device 911, the exponentiation calculation unit 353 calculates the ith component c′ᵢ=R′ᵢ^{κi}, based on the ith component R′ᵢ of the first response R′ received by the first response receiving unit 331 and the inverse number κᵢ calculated in the inverse number calculation step S732.

The exponentiation calculation unit 353 causes the process to return to the repetition step S731 to generate the subsequent component of the encrypted feature vector C′.

The encrypted feature vector C′ generated by the encrypted data extraction unit 305 in this manner is used in the second challenge generation step S712.

The ith component R′i of the first response R′ is the product of the b′ᵢR_{1, i}th power of the generator element g and the (b′ᵢR_{2, i}+r′ᵢ)th power of the element h. Thus, the ith component c′ᵢ of the encrypted feature vector C′ is the product of the (R_{1, i}⁻¹b′R_{1, i}) th power of the generator element g and the R_{1, i}⁻¹(b′ᵢR_{2, i}+r′ᵢ) th power of the element h. Since R_{1, i}R_{1, i}⁻¹≡1(mod N), c′ᵢ is the product of the b′ᵢth power of the generator element g and the R_{1, i}⁻¹(b′ᵢR_{2, i}+r′ᵢ) th power of the element h. That is, the ith component c′ᵢ of the encrypted feature vector C′ is obtained by encrypting the ith component b′ᵢ of the feature vector b′.

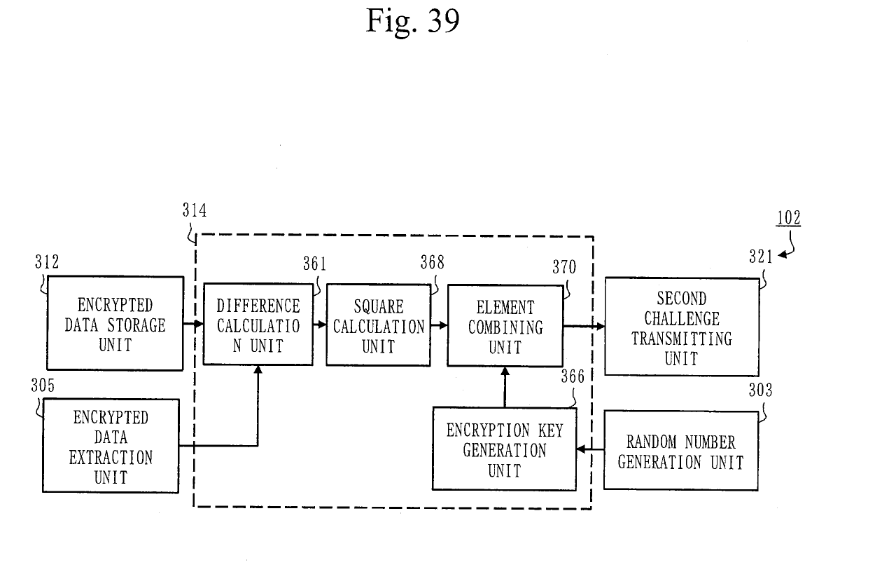

FIG. 39 is a detailed block diagram showing an example of a configuration of the encrypted random similarity degree calculation unit 314 in this embodiment.

The encrypted random similarity degree calculation unit 314 of the authentication apparatus 102 includes the difference calculation unit 361, a square calculation unit 368, the encryption key generation unit 366, and an element combining unit 370.

Using the processing device 911, the random number generation unit 303 generates two random numbers s₁ and s₂, based on the order N, which is a part of the public key pk stored by the public key storage unit 302. The random numbers s₁ and s₂ generated by the random number generation unit 303 are the integers uniform randomly selected from among integers not less than 0 and less than N.

The random number storage unit 322 stores one random number s₁ out of the random numbers generated by the random number generation unit 303, using the storage device 914.

Using the processing device 911, the difference calculation unit 361 calculates the encrypted difference vector ΔC, based on the encrypted feature vector C stored by the encrypted data storage unit 312 and the encrypted feature vector C′ extracted by the encrypted data extraction unit 305. The encrypted difference vector ΔC is a T-dimensional vector (Δc₁, Δc₂, . . . , ΔC_{T}) having components of elements of the finite group G. The ith component Δcᵢ (i being the integer not less than 1 and not more than T) of the encrypted difference vector ΔC is an element cᵢc′ᵢ⁻¹ obtained by combining the ith component cᵢ of the encrypted feature vector C and an inverse element c′ᵢ⁻¹ of the ith component of the encrypted feature vector C′ using multiplication on the finite group G. Each component Δcᵢ of the encrypted difference vector ΔC is obtained by encrypting a difference (bᵢ−b′ᵢ) between the component bᵢ of the feature vector b and the component b′ᵢ of the feature vector b′.

The ith component Δcᵢ of the encrypted difference vector ΔC may be an element cᵢ⁻¹ c′ᵢ obtained by an inverse element cᵢ⁻¹ of the ith component cᵢ of the encrypted feature vector C and the ith component c′ᵢ of the encrypted feature vector C′ using multiplication on the finite group G. Further, the component Δcᵢ of the encrypted difference vector ΔC may be a randomly selected one of the elements cᵢc′ᵢ⁻¹ and cᵢ⁻¹c′ᵢ.

Using the processing device 911, the square calculation unit 368 calculates an encrypted square vector ΔC′, based on the pairing e which is a part of the public key pk stored by the public key storage unit 302 and the encrypted difference vector ΔC calculated by the difference calculation unit 361. The encrypted square vector ΔC′ is a T-dimensional vector ((Δc′₁, Δc′₂, . . . , Δc′_{T}) having components of elements of the finite group G_{T}. The ith component Δc′ᵢ (i being the integer not less than 1 and not more than T) of the encrypted square vector ΔC′ is a paring e (Δcᵢ, Δcᵢ) obtained by translation of a set of the ith components Δcᵢ of the encrypted difference vector ΔC by the pairing e. Each component Δc′ᵢ of the encrypted square vector ΔC′ is obtained by encrypting the square (bᵢ−b′ᵢ)² of a difference between the component bᵢ of the feature vector b and the component b′ᵢ of the feature vector b′.

Using the processing device 911, the encryption key generation unit 366 calculates the encryption key [symbol] [symbol] , based on the paring e, the generator element g, and the element h, which are the parts of the public key pk stored by the public key storage unit 302, and the two random numbers s₁ and s₂ generated by the random number generation unit 303. The encryption key [symbol] is an element of the finite group G_{T}. The encryption key [symbol] is an element e (g^{s1}h^{s2}, g) obtained by translation of a set of an element g^{s1}h^{s2} and the generator element g by the pairing e. The element g^{s1}h^{s2} is obtained by combining an element g^{s1} and an element h^{s2} using multiplication on the finite group G. The element g^{s1} is obtained by exponentiating the generator element g by the random number s₁, using exponentiation on the finite group G. The element h^{s2} is obtained by exponentiating the element h by the random number s₂, using exponentiation on the finite group G. Based on the generator element g and the random number s₁, the encryption key generation unit 366 calculates the element g^{s1} by exponentiating the generator element g by the random number s₁, using the exponentiation on the finite group G, for example. Based on the element h and the random number s₂, the encryption key generation unit 366 calculates the element h^{s2} by exponentiating the element h by the random number s₂, using the exponentiation on the finite group G. The encryption key generation unit 366 calculates the element g^{s1}h^{s2} by combining the two calculated elements g^{s1} and h^{s2} using the multiplication on the finite group G. The encryption key generation unit 366 calculates the element e(g^{s}h^{s2}, g) by translation of the set of the calculated element g^{s1}h^{s2} and the generator element g by the pairing e. The encryption key [symbol] [symbol] is obtained by encrypting the random number s₁ calculated by the random number generation unit 303.

Using the processing device 911, the element combining unit 370 calculates the second challenge Ĉ, based on the encrypted square vector ΔC′ calculated by the square calculation unit 368 and the encryption key [symbol] calculated by the encryption key generation unit 366. The second challenge Ĉ is an element of the finite group G_{T}. The second challenge Ĉ calculated by the element combining unit 370 is an element Πᵢ[Δc′ᵢ] [symbol] obtained by combining T components Δc′ᵢ of the encrypted square vector ΔC′ and the encryption key [symbol] [symbol] [symbol] , using multiplication on the finite group G_{T}. The second challenge C′ is obtained by encrypting a summation Σᵢ[(bᵢ−b′ᵢ)²]+s₁, which is the sum of the random number s₁ and the summation of the square (bᵢ−b′ᵢ)² of the difference between the component bᵢ of the feature vector b and the component b′ᵢ of the feature vector b′.

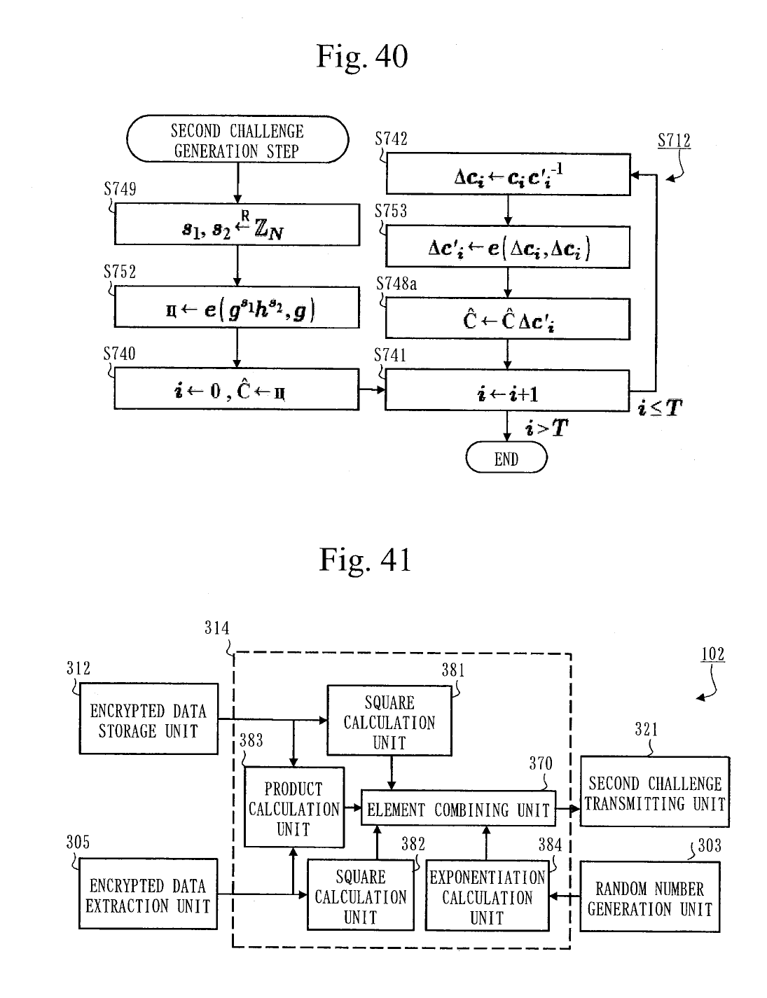

FIG. 40 is a flow chart diagram showing an example of a flow of processes of the second challenge generation step S712 in this embodiment.

In the second challenge generation step S712, the authentication apparatus 102 generates the second challenge Ĉ, based on the two encrypted feature vectors C and C′. The second challenge generation step S712 includes the random number generation step S749, an encryption key generation step S752, the initialization step S740, the repetition step S741, the difference calculation step S742, a square calculation step S753, and an element summation step S748a, for example.

First, in the random generation step S749, the random number generation unit 303 generates the two random numbers s₁ and s₂, using the processing device 911.

In the encryption key generation step S752, using the processing device 911, the encryption key generation unit 366 calculates the encryption key [symbol] [symbol] [symbol] =g^{s1}h^{s2}, based on the two random numbers s₁ and s₂ generated by the random number generation unit 303 in the random number generation step S749. Using the processing device 911, the element combining unit 370 initializes the second challenge Ĉ to the encryption key [symbol] [symbol] [symbol] calculated by the encryption key generation unit 366.

In the initialization step S740, the element combining unit 370 initializes the integer i to 0, using the processing device 911.

In the repetition step S741, using the processing device 911, the element combining unit 370 adds 1 to the integer i. When the integer i is larger T, the element combining unit 370 finishes the second challenge generation step S712, because the second challenge Ĉ has been completed. When the integer is not more than T, the element combining unit 370 causes the process to proceed to the difference calculation step S742.

In the difference calculation step S742, using the processing device 911, the difference calculation unit 361 calculates the ith component Δcᵢ of the encrypted difference vector ΔC, based on the component cᵢ of the encrypted feature vector C stored by the encrypted data storage unit 305 and the ith component c′ᵢ of the encrypted feature vector C′ extracted by the encrypted data extraction unit 305.

In the square calculation step S753, the square calculation unit 368 calculates the ith component Δc′ᵢ=e(Δcᵢ, Δcᵢ) of the encrypted square vector ΔC′, based on the element Δcᵢ calculated by the difference calculation unit 361 in the difference calculation step S742.

In the element summation step S748a, using the processing device 911, the element combining unit 370 combines the ith component Δc′ᵢ of the encrypted square vector ΔC′ calculated by the square calculation unit 368 in the square calculation step S753 with the second challenge Ĉ.

The element combining unit 370 causes the process to the repetition step S741.

The second challenge Ĉ calculated by the encrypted random similarity degree calculation unit 314 in this manner is transmitted to the decryption device 103 by the second challenge transmitting unit 321, and the decryption device 103 receives and then processes the second challenge Ĉ.

The procedure for calculating the second challenge Ĉ may be different from the above-mentioned procedure. Assume that calculation such as multiplication can be performed more quickly on the finite group G_{T} than on the finite group G, for example. Then, the number of arithmetic operations on the finite group G_{T} should be increased and the number of arithmetic operations on the finite group G should be reduced. Then, the time to be taken for calculation in the second challenge generation step S712 can be thereby reduced.

FIG. 41 is a detailed block diagram showing another example of a configuration of the encrypted random similarity degree calculation unit 314 in this embodiment.

The encrypted random similarity degree calculation unit 314 of the authentication apparatus 102 includes two square calculation units 381 and 382, a product calculation unit 383, an exponentiation calculation unit 384, and the element combining unit 370, for example.

Using the processing device 911, the square calculation unit 381 calculates a first encrypted square vector [symbol] , based on the pairing e which is the part of the public pk stored by the public key storage unit 302 and the encrypted feature vector C stored by the encrypted data storage unit 312. The first encrypted square vector is a T-dimensional vector ( [symbol] ₁, [symbol] ₂, . . . [symbol] _{T}) having components of elements of the finite group G_{T}. The ith component [symbol] ₁, (i being the integer not less than 1 and not more than T) of the first encrypted square vector [symbol] is an element e(cᵢ, cᵢ) obtained by translation of a set of the ith components cᵢ of the encrypted feature vector C by the pairing e.

Using the processing unit 911, the square calculation unit 382 calculates a second encrypted square vector [symbol] ′, based on the pairing e which is the part of the public pk stored by the public key storage unit 302 and the encrypted feature vector C′ extracted by the encrypted data extraction unit 305. The second encrypted square vector [symbol] ′ is a T-dimensional vector ( [symbol] ′₁, [symbol] ₂ . . . [symbol] _{T}) having components of elements of the finite group G_{T}. The ith component [symbol] ′ᵢ (i being the integer not less than 1 and not more than T) of the second encrypted square vector [symbol] ′ is an element e(c′ᵢ, c′ᵢ) obtained by converting a set of the ith components c′ᵢ of the encrypted feature vector C′.

Using the processing device 911, the product calculation unit 383 calculates an encrypted product vector , based on the pairing e which is the part of the public pk stored by the public key storage unit 302, the encrypted feature vector C stored by the encrypted data storage unit 312, and the encrypted feature vector C′ extracted by the encrypted data extraction unit 305. The encrypted product vector is a T-dimensional vector (₁, ₂ . . . _{T}) having components of elements of the finite group G_{T}. The ith component ᵢ (i being the integer not less than 1 and not more than T) of the encrypted product vector is an element e(cᵢ, c′ᵢ) obtained by translation of a set of the ith component cᵢ of the encrypted feature vector C and the ith component c′ᵢ of the encrypted feature vector C′ by the pairing e.

Using the processing device 911, the exponentiation calculation unit 384 calculates two exponentiation elements [symbol] [symbol] [symbol] ₁ and [symbol] [symbol] [symbol] ₂, based on the pairing e, the generator element g, and the element h which are the parts of the public key pk stored by the public key storage unit 302 and the two random numbers s₁ and s₂ generated by the random number generation unit 303. The first exponentiation element [symbol] [symbol] [symbol] ₁ is an element e(g, g)^{s1} obtained by exponentiating an element e(g, g) by the random number s₁, using exponentiation on the finite group G_{T}. The element e(g, g) is obtained by translation of a set of the generator elements g by the pairing e. The second exponentiation element u₂ is an element e(g, h)^{s2} obtained by exponentiating an element e(g, h) by the random number s₂, using exponentiation on the finite group G_{T}. The element e(g, h) is obtained by translation of a set of the generator element g and the generator element h by the pairing e.

Using the processing device 911, the element combining unit 370 calculates the second challenge Ĉ, based on the first encrypted square vector [symbol] calculated by the square calculation unit 381, the second encrypted squarevector [symbol] calculated by the square calculation unit 382, the encrypted productvector calculated by the product calculation unit 383, and the two exponentiation elements [symbol] [symbol] [symbol] ₁ and [symbol] [symbol] [symbol] ₂ calculated by the exponentiation calculation unit 384. The second challenge Ĉ is an element of the finite group G_{T}. The second challenge Ĉ calculated by the element combining unit 370 is an element Πᵢ[ [symbol] ᵢ [symbol] ′ᵢᵢ⁻²] [symbol] ₁ [symbol] ₂ obtained by combining all of the T components [symbol] ᵢ of the first encrypted square vector [symbol] , the T components [symbol] ′ᵢ of the second encrypted square vector [symbol] ′, the minus square of the T components [symbol] ′ᵢ of the encrypted product vector , and the two exponentiation elements [symbol] ₁ and [symbol] ₂. In this case, the second challenge Ĉ is obtained by encrypting Σᵢ[bᵢ²+b′ᵢ²−2bᵢb′ᵢ]+s₁=Σᵢ[(bᵢ−b′ᵢ)²]+s₁.

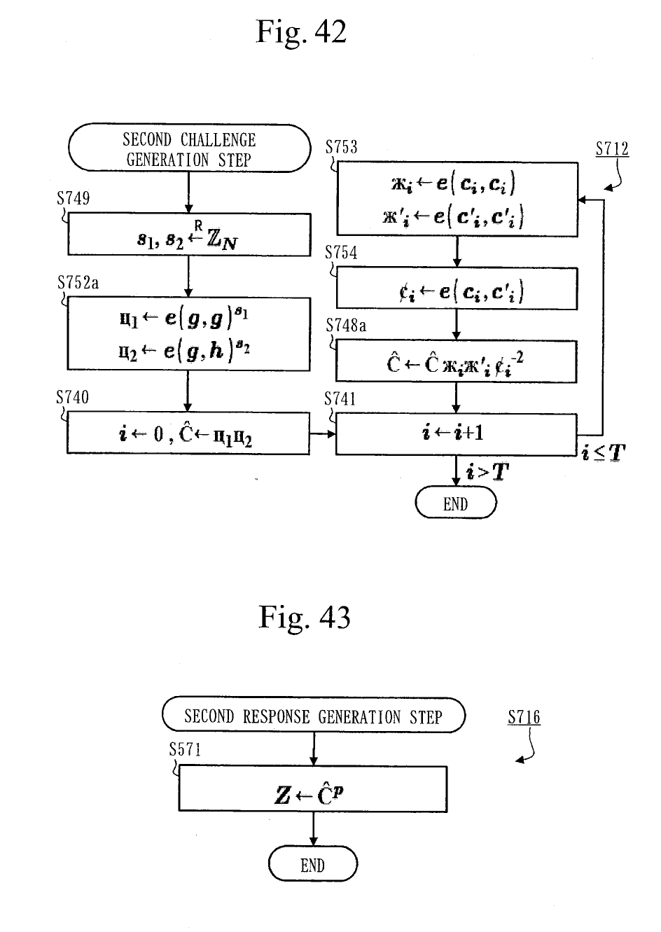

FIG. 42 is a flow chart diagram showing another example of a flow of processes of the second challenge generation step S712 in this embodiment.

The second challenge generation step S712 includes the random number generation step S749, an exponentiation calculation step S752a, the initialization step S740, the repetition step S741, the square calculation step S753, a product calculation step S754, and the element summation step S748a, for example.

In the random number generation step S749, the random number generation unit 303 generates the two random numbers s₁ and s₂, using the processing device 911.

In the exponentiation calculation step S752a, using the processing device 911, the exponentiation calculation unit 384 calculates the two exponentiation element [symbol] [symbol] [symbol] ₁=e(g, g)^{s1} and [symbol] [symbol] [symbol] ₂=e(g, h)^{s2}, based on the two random numbers s₁ and s₂ generated by the random number generation unit 303 in the random number generation step S749.

In the initialization step S740, using the processing device 911, the element combining unit 370 initializes the integer i to 0. Using the processing device 911, the element combining unit 370 calculates an element [symbol] [symbol] [symbol] ₁, [symbol] [symbol] [symbol] ₂ by combining the two exponentiation elements us and u₂ calculated by the exponentiation calculation unit 384 in the exponentiation calculation step S752a, using multiplication on the finite group G_{T}. The element combining unit 370 initializes the second challenge Ĉ to the calculated element [symbol] [symbol] [symbol] ₁, [symbol] [symbol] [symbol] ₂, using the processing device 911.

In the repetition step S741, using the processing device 911, the element combining unit 370 adds 1 to the integer i. When the integer i is larger than T, the second challenge Ĉ has been completed. Thus, the element combining unit 370 finishes the second challenge generation step S712. When the integer i is not more than T, the element combining unit 370 causes the process to proceed to the square calculation step S753.

In the square calculation step S753, using the processing device 911, the square calculation unit 381 calculates the ith component [symbol] ᵢ=e(cᵢ, cᵢ) of the first encrypted square vector [symbol] , based on the ith component cᵢ of the encrypted feature vector C stored by the encrypted data storage unit 312. Using the processing device 911, the square calculation unit 382 calculates the ith component [symbol] ′ᵢ=e(c′ᵢ, c′ᵢ) of the second encrypted square vector [symbol] ′, based on the ith component c′ᵢ of the encrypted feature vector C′ extracted by the encrypted data extraction unit 305.

In the product calculation step S754, using the processing device 911, the product calculation unit 383 calculates the ith component ᵢ=e(cᵢ, c′ᵢ), based on the ith component cᵢ of the encrypted feature vector C stored by the encrypted data storage unit 312 and the ith component c′ᵢ of the encrypted feature vector C′ extracted by the encrypted data extraction unit 305.

In the element summation step S748a, using the processing device 911, the element combining unit 370 combines the ith component [symbol] ′ᵢ of the first encrypted square vector [symbol] calculated by the square calculation unit 381 in the square calculation step S753, the ith component [symbol] ′ᵢ of the second encrypted square vector [symbol] ′ calculated by the square calculation unit 382 in the square calculation step S753, and the minus square of the ith component ᵢ of the encrypted product vector calculated by the product calculation unit 383 in the product calculation step S754 with the second challenge Ĉ.

The element combining unit 370 causes the process to return to the repetition step S741.

By using the processing procedure as described above, the need for an arithmetic operation on the finite group G is eliminated. The second challenge Ĉ can be generated just by calculation using the pairing e and multiplication on the finite group G_{T}.

Since the pairings e(g, g) and e(g, h) and the component e(cᵢ, cᵢ) of the first encrypted square vector [symbol] are not related to the encrypted feature vector C′, the pairings e(g, g) and e(g, h) and the component e(cᵢ, cᵢ) of the first encrypted square vector [symbol] can be calculated in advance. By calculating these pairings and component in advance, the time to be taken for generating the second challenge Ĉ can be reduced.

FIG. 43 is a flow chart diagram showing an example of a flow of processes of the second response generation step S716 in this embodiment.

In the second response generation step S716, the decryption device 103 generates the second response Z from the second challenge Ĉ. The second response generation step S716 includes an exponentiation calculation step S571, for example.

In the exponentiation calculation step S571, using the processing device 911, the decryption unit 404 of the decryption device 103 calculates the second response Z, based on the prime number p that is the secret key sk stored by the secret key storage unit 413 and the second challenge Ĉ received by the second challenge receiving unit 402. The second response Z is an element of the finite group G_{T}. The second response Z calculated by the decryption unit 404 is an element obtained by exponentiating the second challenge Ĉ by the prime number p, using exponentiation on the finite group G_{T}.

The second challenge Ĉ is obtained by encrypting Σᵢ[bᵢ−b′ᵢ]²]+s₁. Thus, the second response Z is an element obtained by exponentiating an element e(g, g)^{p} by Σᵢ[(bᵢ−b′ᵢ)²]+s₁ using exponentiation on the finite group G_{T}. The element e(g, g)^{p} is obtained by exponentiating the element e(g, g) by the prime number p using exponentiation on the finite group G_{T}. The element e(g, g) is obtained by translation of a set of the generator elements g by the pairing e. Since the element e(g, g)^{p} is the element π released as the part of the public key pk, the second response Z is an element obtained by exponentiating the element π by Σᵢ[(bᵢ−b′ᵢ)²]+s₁, using exponentiation on the finite group G_{T}.

Since the configuration of the plaintext similarity degree extraction unit 315 is the same as that described in the first embodiment, a description will be given with reference to FIG. 24

Using the processing device 911, the group conversion unit 371 calculates a decryption key [symbol] , based on the element π which is the part of the public key pk stored by the public key storage unit 302 and the random number s₁ stored by the random number storage unit 322. The decryption key [symbol] is an element of the definite group G_{T}. The decryption key [symbol] is an element π⁻¹ obtained by exponentiating the element π by the additive inverse −s₁ of the random number s₁, using exponentiation on the finite group G_{T}.

Using the processing device 911, the element combining unit 372 calculates the decrypted similarity degree element Z′, based on the second response Z received by the second response receiving unit 341 and the decryption key [symbol] calculated by the group conversion unit 371. The decrypted similarity degree element Z′ is an element of the finite group G_{T}. The decrypted similarity degree element Z′ is an element Z [symbol] obtained by combining the second response Z and the decryption key [symbol] , using multiplifaction on the finite group G_{T}. The second response Z is an element obtained by exponentiating the element π by Σᵢ[(bᵢ−b′ᵢ)²]+s₁, using multiplication on the finite group G_{T}. Thus, the decrypted similarity degree element Z′ is an element obtained by exponentiating the element π by Σᵢ[(bᵢ−b′ᵢ)²], using exponentiation on the finite group G_{T}.

Using the processing device 911, the discrete logarithm calculation unit 373 calculates to what power the element π is raised to be equal to the decrypted similarity degree element Z′, based on the element π which is the part of the public key pk stored by the public key storage unit 302 and the decrypted similarity degree element Z′ calculated by the element combining unit 372, thereby setting the power to the similarity degree d. As in the first embodiment, the discrete logarithm calculation unit 373 may be so configured to calculate the similarity degree d when the similarity degree d is not more than the threshold value d₀, and to determine that the similarity degree d is larger than the threshold value d₀ when the similarity degree d is larger than the threshold value d₀.

With this arrangement, the authentication apparatus 102 calculates the square Σᵢ[(bᵢ−b′ᵢ)²] of the Euclidean distance between the two feature vectors b and b′.

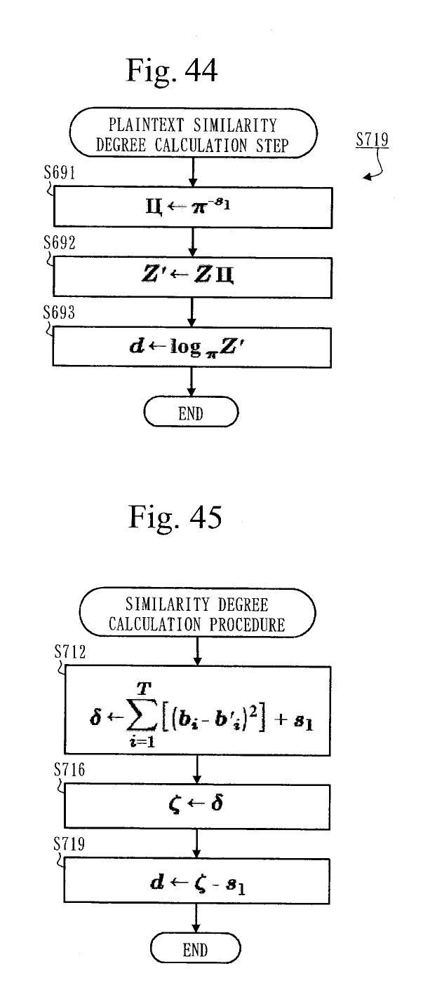

FIG. 44 is a flow chart diagram showing an example of a flow of processes of the plaintext similarity degree calculation step S719 in this embodiment.

In the plaintext similarity degree calculation step S719, the authentication apparatus 102 calculates the similarity degree d from the second response Z. The plaintext similarity degree calculation step S719 includes, the group conversion step S691, the element combining step S692, and the discrete logarithm calculation step S693, for example.

First, in the group conversion step S691, the group conversion unit 371 calculates the decryption key [symbol] =π^{-s1}, based on the random number s₁ stored by the random number storage unit 322 as a temporary key, using the processing device 911.

In the element combining step S692, using the processing device 911, the element combining unit 372 calculates the decrypted similarity degree element Z′=Z [symbol] , based on the second response received by the second response receiving unit 341 and the decryption key [symbol] calculated by the group conversion unit 371 in the group conversion step S691.

In the discrete logarithm calculation step S693, using the processing device 911, the discrete logarithm calculation unit 373 calculates the similarity degree d, based on the decrypted similarity degree element Z′ calculated by the element combining unit 372 in the element combining unit 372.

The determination unit 306 determines whether or not the two feature vectors b and b′ are similar, based on the similarity degree d calculated by the plaintext similarity degree extraction unit 315, thereby determining a person having biometric information represented by the feature vector b and a person having biometric information represented by the feature vector b′ are identical. When the similarity degree d is smaller than the threshold value d₀, the determination unit 306 determines that the two feature vectors b and b′ are similar.

FIG. 45 is a flow chart diagram showing a similarity degree calculation procedure in the biometric authentication system 100 in this embodiment.

As a first stage, in the second challenge generation step S712, the authentication apparatus 102 calculates the second challenge Ĉ from the two encrypted feature vectors C and C′, thereby calculating δ=Σᵢ[(bᵢ−b′ᵢ)²]+s₁ (i being each integer not less than 1 and not more than T). This calculation is performed with the encrypted feature vector C and C′ kept encrypted with the key of the decryption apparatus 103. Thus, the authentication apparatus 102 cannot obtain information on the feature vectors b and b′.

As a second stage, in the second response generation step S716, the decryption apparatus 103 calculates the second response Z from the second challenge Ĉ, thereby calculating ξ. The decryption apparatus 103 just performs decryption processing, so that ξ is equal to δ. The decryption apparatus 103 does not know the temporary key s₁. Thus, the decryption apparatus 103 cannot obtain the information on the feature vectors b and b′ and information on the similarity degree. That is, this calculation is performed with a result of the decryption kept encrypted with the temporary key s₁.

As a third stage, in the plaintext similarity degree calculation step S719, the authentication apparatus 102 calculates from the second response Z the similarity degree d=ξ−s₁. With this arrangement, the authentication apparatus 102 can obtain the similarity degree d, but cannot obtain the information on the feature vectors b and b′.

By employing the encryption system by which an arithmetic operation corresponding to plaintext multiplication as well as an arithmetic operation corresponding to plaintext addition with the data associated with feature vectors b and b′ kept encrypted can be performed at least once, most of the similarity degree calculation procedure may be finished in the first stage. With this arrangement, the decryption apparatus 103 should simply perform the decryption processing.

According to this embodiment, the number of the public key pk, the secret key sk, the random numbers to be generated, and the number of the random numbers to be stored can be reduced.

Further, the amount of data of the second challenge to be transmitted from the authentication apparatus 102 to the decryption apparatus 103 is reduced. Thus, the amount of communication necessary for authentication can be reduced.

The encryption system is not limited to the BGN encryption system. It may be so configured that a different ring-homomorphic encryption system such as the Genrty encryption system is employed. It may be so configured that a second encryption system such as the standard public key encryption system is employed for communication between the certification apparatus 101 and the authentication apparatus 102.

As in the second embodiment, the certification apparatus 101 in the biometric authentication system 100 may be configured to combine functions as the decryption apparatus 103 and the registration apparatus 104.

### Fifth Embodiment

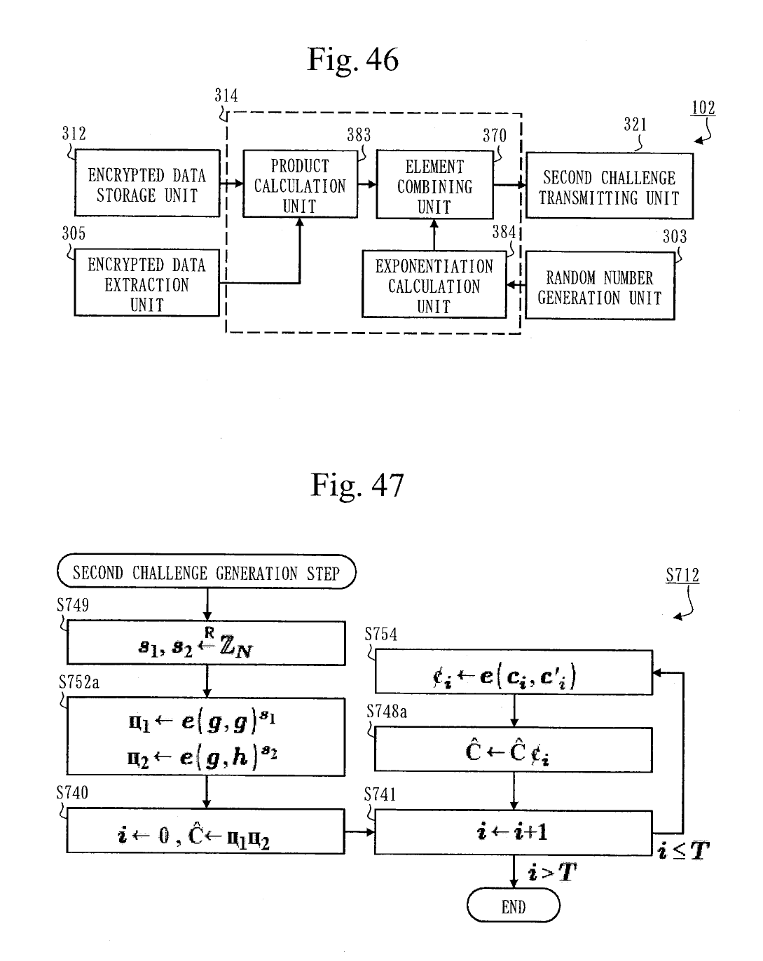

A fifth embodiment will be described, using FIGS. 46 to 48.

Same reference signs are given to components that are common to those in the first to fourth embodiments, thereby omitting description of the components that are common to those in the first to fourth embodiments.

In this embodiment, the description will be given about a case where the BGN encryption system described in the fourth embodiment is employed as the encryption system, and the inner product Σᵢ[bᵢb′ᵢ] is calculated as the similarity degree d, as in the third embodiment.

An overall configuration of the biometric authentication system 100 and inner configurations of the certification apparatus 101, the authentication apparatus 102, the decryption apparatus 103, and the registration apparatus 104 are similar to those described in the fourth embodiment. Thus, only a difference will be described.

FIG. 46 is a detailed block diagram showing an example of a configuration of the encrypted random similarity degree calculation unit 314 in this embodiment.

The encrypted random similarity degree calculation unit 314 of the authentication apparatus 102 includes the product calculation unit 383, the exponentiation calculation unit 384, and the element combining unit 370, for example.

Using the processing device 911, the product calculation unit 383 calculates the encrypted product vector , based on the pairing e which is the part of the public pk stored by the public key storage unit 302, the encrypted feature vector C stored by the encrypted data storage unit 312, and the encrypted feature vector C′ extracted by the encrypted data extraction unit 305. The encrypted product vector is a T-dimensional vector (₁, ₂, . . . , _{T}) having components of elements of the finite group G_{T}. The ith component ₁ of the encrypted product vector is an element e(cᵢ, c′ᵢ) obtained by translation of a set of the ith component cᵢ of the encrypted feature vector C and the ith component c′ᵢ of the encrypted feature vector C′ by the pairing e.

Using the processing device 911, the exponentiation calculation unit 384 calculates the two exponentiation elements [symbol] and [symbol] ₂, based on the pairing e, the generator element g, and the element h which are the parts of the public key pk stored by the public key storage unit 302 and the two random numbers s₁ and s₂ generated by the random number generation unit 303. The first exponentiation element us is the element e(g, g)^{s1} obtained by exponentiating the element e(g, g) by the random number s₁, using exponentiation on the finite group G_{T}. The element e(g, g) is obtained by translation of the set of the generator elements g by the pairing e. The second exponentiation element [symbol] [symbol] [symbol] ₂ is the element e(g, h)^{s2} obtained by exponentiating the element e(g, h) by the random number s2, using exponentiation on the finite group G_{T}. The element e(g, h) is obtained by translation of the set of the generator element g and the element h by the pairing e.

Using the processing device 911, the element combining unit 370 calculates the second challenge Ĉ, based on the encrypted product vector calculated by the product calculation unit 383 and the two exponentiation elements [symbol] [symbol] [symbol] ₁ and [symbol] [symbol] [symbol] ₂ calculated by the exponentiation calculation unit 384. The second challenge Ĉ is an element of the finite group G_{T}. The second challenge Ĉ calculated by the element combining unit 370 is an element Πᵢ[ᵢ] [symbol] [symbol] [symbol] ₁ [symbol] [symbol] [symbol] ₂ obtained by combining all of T components ᵢ of the encrypted product vector and the two exponentiation elements [symbol] [symbol] [symbol] ₁ and [symbol] [symbol] [symbol] ₂, using multiplication on the finite group G_{T}. The second challenge Ĉ is obtained by encrypting Σᵢ[bᵢ b′ᵢ]+s₁.

FIG. 47 is a flow chart diagram showing an example of a flow of processes of the second challenge generation step S712 in this embodiment.

The second challenge generation step S712 includes the random number generation step S749, the exponentiation calculation step S752a, the initialization step S740, the repetition step S741, the product calculation step S754, and the element summation step S748a, for example.

In the random number generation step S749, the random number generation unit 303 generates the two random numbers s₁ and s₂, using the processing device 911.

In the exponentiation calculation step S752a, using the processing device 911, the exponentiation calculation unit 384 calculates the two exponentiation elements [symbol] [symbol] [symbol] ₁=e(g, g)^{s1} and [symbol] [symbol] [symbol] ₂=e(g, h)^{s2}, based on the two random numbers s₁ and s₂ generated by the random number generation unit 303 in the random number generation step S749.

In the initialization step S740, using the processing device 911, the element combining unit 370 initializes the integer i to 0. Using the processing device 911, the element combining unit 370 calculates the element [symbol] [symbol] [symbol] ₁ [symbol] [symbol] [symbol] ₂ by combining the two exponentiation elements [symbol] [symbol] [symbol] ₁ and [symbol] [symbol] [symbol] ₂ calculated by the exponentiation calculation unit 384, using multiplication on the finite group G_{T}. The element combining unit 370 initializes the second challenge Ĉ to the calculated element [symbol] [symbol] [symbol] ₁ [symbol] [symbol] [symbol] ₂, using the processing device 911.

In the repetition step S741, using the processing device 911, the element combining unit 370 adds 1 to the integer i. When the integer i is larger than T, the second challenge Ĉ has been completed. Thus, the element combining unit 370 finishes the second challenge generation step S712. When the integer i is not more than T, the element combining unit 370 causes the process to proceed to the product calculation step S754.

In the product calculation step S754, using the processing device 911, the product calculation unit 383 calculates the ith component ᵢ=e(cᵢ, c′ᵢ) of the encrypted product vector , based on the ith component cᵢ of the encrypted feature vector C stored by the encrypted data storage unit 312 and the ith component c′ᵢ of the encrypted feature vector C′ extracted by the encrypted data extraction unit 305.

In the element summation step S748a, using the processing device 911, the element combining unit 370 combines the ith component ᵢ of the encrypted product vector calculated by the product calculation unit 383 in the product calculation step S754 with the second challenge Ĉ, using multiplication on the finite group G_{T}.

The element combining unit 370 causes the process to proceed to the repetition step S741.

The second challenge Ĉ calculated by the encrypted random similarity degree calculation unit 314 in this manner is transmitted to the decryption apparatus 103 by the second challenge transmitting unit 321. The decryption apparatus 103 receives and then processes the second challenge Ĉ.

The decryption unit 404 of the decryption apparatus 103 has the same configuration as that in the fourth embodiment. However, the second challenge Ĉ has a different meaning. Thus, the second response Z to be generated by the decryption unit 404 also has a meaning different from that in the first embodiment.

That is, the second response Z is an element obtained by exponentiating the element π of the finite group G_{T} by (Σᵢ[(bᵢ b′ᵢ)+s₁) (i being each integer not less than 1 and not more than T) by exponentiation on the finite group G_{T}. That is, the second response Z is the one obtained by the inner product Σᵢ[bᵢb′ᵢ] between the feature vector b and the feature vector b′ by the random number s₁ as the temporary key.

The plaintext similarity degree extraction unit 315 of the authentication apparatus 102 also has the same configuration as that in the fourth embodiment.

The decrypted similarity degree element Z′ calculated by the element combining unit 370 is an element obtained by exponentiating the element π by the inner product Σᵢ[bᵢb′ᵢ] between the feature vector b and the feature vector b′ by exponentiation on the finite group G_{T}. Accordingly, the plaintext similarity degree extraction unit 315 calculates the inner product Σᵢ[bᵢb′ᵢ] between the feature vector b and the feature vector b′, as the similarity degree d.

The determination unit 306 determines that the two feature vectors b and b′ are similar when the similarity degree d calculated by the discrete logarithm calculation unit 373 is larger than the predetermined threshold value d₀.

With this arrangement, it can be determined whether or not the two feature vectors b and b′ are similar, using the number of matches between feature points as a reference.

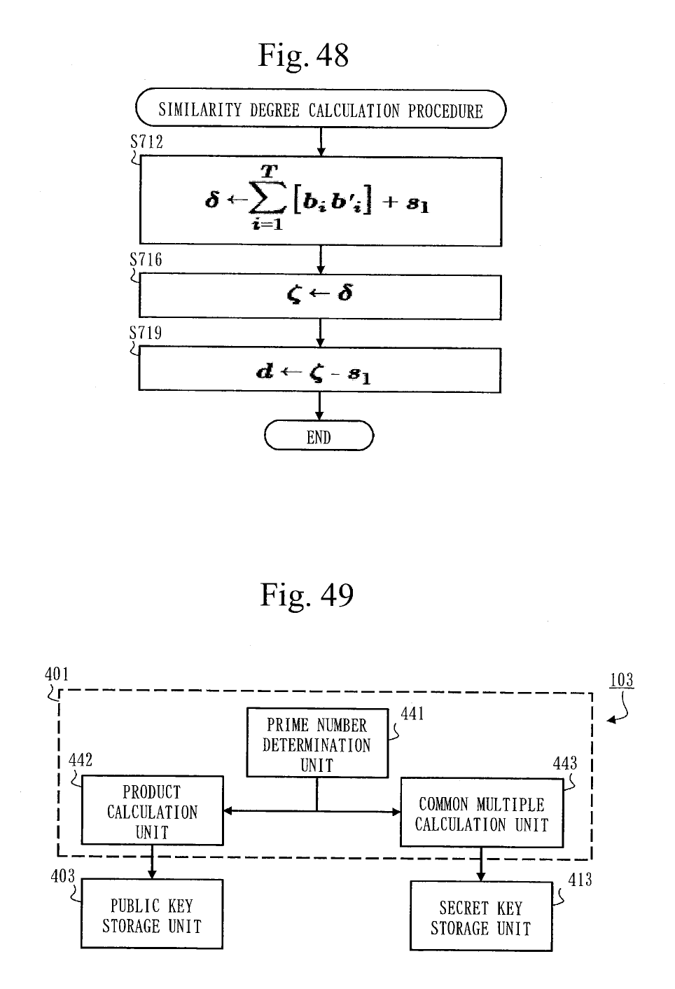

FIG. 48 is a similarity degree calculation procedure in the biometric authentication system 100 in this embodiment.

As a first stage, in the second challenge generation step S712, the authentication apparatus 102 calculates the second challenge Ĉ from the two encrypted feature vectors C and C′, thereby calculating δ=Σᵢ[(bᵢ−b′ᵢ)²]+s₁ (i being each integer not less than 1 and not more than T). This calculation is performed with the encrypted feature vectors C and C′ kept encrypted with the key of the decryption apparatus 103. Thus, the authentication apparatus 102 cannot obtain information on the feature vectors b and b′.

As a second stage, in the second response generation step S716, the decryption apparatus 103 calculates the second response Z from the second challenge Ĉ, thereby calculating ξ. The decryption apparatus 103 just performs decryption processing, so that ξ is equal to δ. The decryption apparatus 103 does not know the temporary key s₁. Thus, the decryption apparatus 103 cannot obtain the information on the feature vectors b and b′ and information on the similarity degree. That is, this calculation is performed with a result of the decryption encrypted with the temporary key s₁.

As a third stage, in the plaintext similarity degree calculation step S719, the authentication apparatus 102 calculates from the second response Z the similarity degree d=ξ−s₁. With this arrangement, the authentication apparatus 102 can obtain the similarity degree d, but cannot obtain the information on the feature vectors b and b′.

The encryption system is not limited to the BGN encryption system. It may be so configured that a different ring-homomorphic encryption system such as the Genrty encryption system is employed. It may be so configured that a second encryption system such as the standard public key encryption system is employed for communication between the certification apparatus 101 and the authentication apparatus 102.

As in the second embodiment, the certification apparatus 101 in the biometric authentication system 100 may be configured to combine functions as the decryption apparatus 103 and the registration apparatus 104.

As compared with the fourth embodiment, configurations of the certification apparatus 101, the decryption apparatus 103, and the registration apparatus 104 remain unchanged, and only the authentication apparatus 102 has a different configuration from that in the fourth embodiment. Accordingly, by setting the authentication apparatus 102 to a configuration capable of switching between the configuration described in the fourth embodiment and the configuration described in this embodiment, two types of similarity degrees using the Euclidean distance and the inner product can be calculated, without altering the other apparatuses in the biometric authentication system 100.

### Sixth Embodiment

A sixth embodiment will be described, using FIGS. 49 to 61.

Same reference signs are given to components that are common to those in the first to fifth embodiments, thereby omitting description of the components that are common to those in the first to fifth embodiments.

In this embodiment, the description will be given about a case where the Paillier encryption system is employed as the encryption system. The square of the Euclidean distance is used for the similarity degree d, as in the first embodiment.

The Pailler encryption system will be outlined.

Assume that N is the product of two mutually different prime numbers p and q. Assume that λ is a common multiple between p−1 and q−1. When r and N are set to integers that are relatively prime, r^{λN}≡1(mod N²) holds. When x and y are set to integers, (1+xN)^{y}≡1+xyN (mod N²) holds. Accordingly, [r^{N}(1+xN)]^{λ}≡1+xλN (mod N²) holds.

Assume that N is set to the public key pk, and the least common multiple λ between p−1 and q−1 is set to the secret key sk, for example. Assume that an integer x not less than 0 and less than N is set to a plaintext, while r^{N} (1+xN) is set to a ciphertext E(x) obtained by encrypting the plaintext x. Assume, however, that r is an integer uniform randomly selected from among integers not less than 0 and less than N. When the prime numbers p and q are sufficiently large, the probability that r and N are not relatively prime is extremely small to be neglible.

For decryption, X that is the secret key sk is used. When E(x)^{λ}≡1+xλN (mod N²) is used, the random number r can be deleted. Since E(x)^{λ}−1 is a multiple of N, [E(x)^{λ}−1]/N is an integer. Assume that the inverse element of λ in multiplication of integers modulo N is indicated by λ⁻¹. Then, when the product of (E(x)^{λ}−1]/N and λ⁻¹ is divided by N to obtain the remainder, the plaintext x can be decrypted.

The remainder obtained by dividing the product of a ciphertext E(x₁) of an integer x₁ and a ciphertext E(x₂) of an integer x₂ by N² is r₁^{N} (1+x₁N)r₂^{N} (1+x₂N)≡(r₁r₂)^{N} [1+(x₁+x₂)N](mod N²). Thus, the remainder is a ciphertext E (x₁+x₂) of x₁+x₂ which is the sum of the integer x₁ and the integer x₂.

FIG. 49 is a detailed block diagram showing an example of a configuration of the key generation unit 401 in this embodiment.

The key generation unit 401 of the decryption apparatus 103 includes a prime number determination unit 441, a product calculation unit 442, and a common multiple calculation unit 443, for example.

Using the processing device 911, the prime number determination unit 441 generates the mutually different two prime numbers p and q, based on the size (such as 512 bits or 1024 bits) determined according to the security level.

Using the processing device 911, the product calculation unit 442 calculates the integer N, based on the two prime numbers p and q generated by the prime number determination unit 441. The integer N is the product of the two prime numbers p and q.

Using the processing device 911, the common multiple calculation unit 443 calculates the least common multiple λ=LCM (p−1, q−1) between p−1 and q−1, based on the two prime numbers p and q generated by the prime number determination unit 441.

The public key storage unit 403 stores the product N, as the public key pk, using the storage device 914.

The secret key storage unit 413 stores the least common multiple λ, as the secret key sk, using the storage device 914.

Since the inverse number λ⁻¹ of λ in multiplication of integers modulo N is necessary for decryption, it may be so configured that the common multiple calculation unit 443 calculates the inverse number λ⁻¹, and then, the secret key storage unit 413 stores the inverse number λ⁻¹ as a part of the secret key sk.

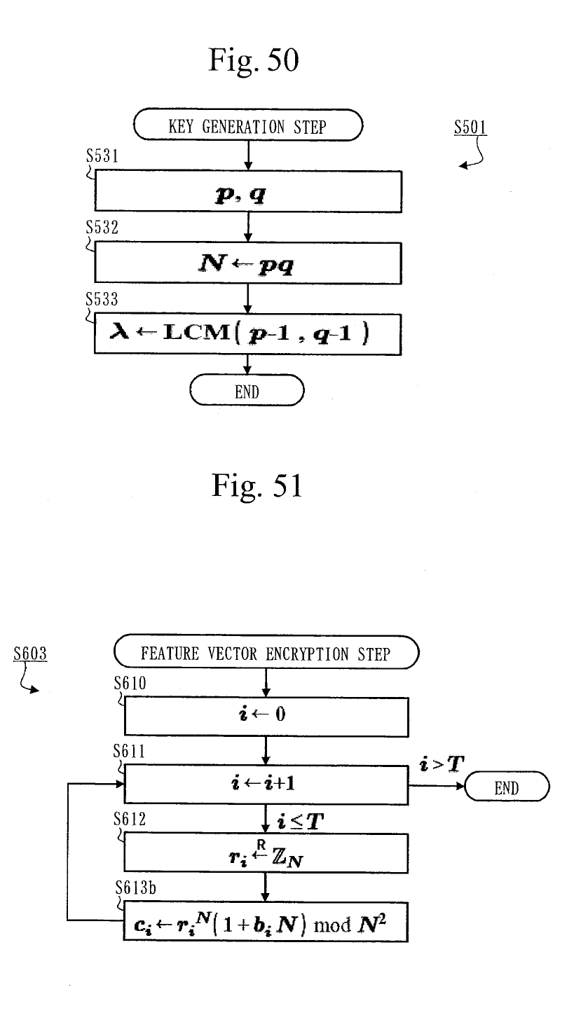

FIG. 50 is a flow chart diagram showing an example of a flow of processes of the key generation step S501 in this embodiment.

In the key generation step S501, the decryption apparatus 103 generates a set of the public key pk and the secret key sk.

It may be so configured that a set of the public key pk and the secret key sk that is different for each user is generated, or that a set of one public key pk and one secret key sk is generated for the overall system.

The key generation step S501 includes a prime number determination step S531, a product calculation step S532, and a common multiple calculation step S533.

First, in the prime number determination step S531, the prime number determination unit 441 determines the two prime numbers p and q, using the processing device 911.

In the product calculation step S532, the product calculation unit 442 calculates the integer N=pq, based on the two prime numbers p and q determined by the prime number determination unit 441 in the prime number determination step S531, using the processing device 911. Using the storage device 914, the public key storage unit 403 stores the integer N calculated by the product calculation unit 442, as the public key pk.

In the common multiple calculation step S533, using the processing device 911, the common multiple calculation unit 443 calculates the least common multiple λ=LCM (p−1, q−1), based on the two prime numbers p and q determined by the prime number determination unit 441 in the prime number determination step S531. Using the storage device 914, the secret key storage unit 413 stores the least common multiple λ calculated by the common multiple calculation unit 443, as the secret key sk.

The public key pk=(N) stored by the public key storage unit 403 in this manner is transmitted to each of the authentication apparatus 102 and the like by the public key transmitting unit 408. Each of the authentication apparatus 102 and the like receives and then stores the public key pk.

FIG. 51 is a flow chart diagram showing an example of a flow of processes of the feature vector encryption step S603 in this embodiment.

In the feature vector encryption step S603, the registration apparatus 104 encrypts the feature vector b to generate the encrypted feature vector C. The feature vector encryption step S603 includes the initialization step S610, the repetition step S611, the random number generation step S612, and an integer calculation step S613b, for example.

The feature vector b generated by the feature vector formation unit 204 of the registration apparatus 104 is a T-dimensional vector (b₁, b₂, . . . , b_{T}) (T being an integer not less than 1) having components of integers not less than 0 and less than N. The encrypted feature vector C generated by the encrypted data generation unit 206 is a T-dimensional vector (c₁, c₂, . . . , c_{T}) having components of integers not less than 0 and less than N².

First, in the initialization step S610, the encrypted data generation unit 206 initializes the integer i to 0, using the processing device 911.

In the repetition step 611, the encrypted data generation unit 206 adds 1 to the integer i, using the processing device 911. When the integer i is larger than T, the encrypted data generation unit 206 finishes the feature vector encryption step S603. When the integer i is not more than T, the encrypted data generation unit 206 causes the process to proceed to the random number generation step S612 to generate the ith component cᵢ of the encrypted feature vector C.

In the random number generation step S612, using the processing device 911, the random number generation unit 205 generates the random number rᵢ, based on the integer N which is the public key pk stored by the public key storage unit 202. The random number rᵢ generated by the random number generation unit 205 is the integer uniform randomly selected from among integers not less than 1 and less than N.

In the integer calculation step S613b, using the processing device 911, the encrypted data generation unit 206 calculates the ith component cᵢ of the encrypted feature vector C, based on the integer N which is the public key pk stored by the public key storage unit 202, the ith component bᵢ of the feature vector b generated by the feature vector formation unit 204, and the random number rᵢ generated by the random number generation unit 205 in the random number generation step S612. The ith component cᵢ of the encrypted feature vector C calculated by the encrypted data generation unit 206 is a remainder when a product rᵢ^{N} (1+bᵢN) of a sum (1+bᵢN) and an integer rᵢ^{N} is divided by the square of the integer N. The sum (1+bᵢN) is obtained by adding 1 to a product bᵢN of the ith component bi of the feature vector b and the integer N. The integer rᵢ^{N} is obtained by exponentiating the random number rᵢ by the integer N.

The encrypted data generation unit 206 causes the process to return to the repetition step S611 to generate the subsequent component of the encrypted feature vector C.

The encrypted feature vector C generated by the encrypted data generation unit 206 in this manner is transmitted to the authentication apparatus 102 by the encrypted data transmitting unit 201. The authentication apparatus 102 receives and then stores the encrypted feature vector C.

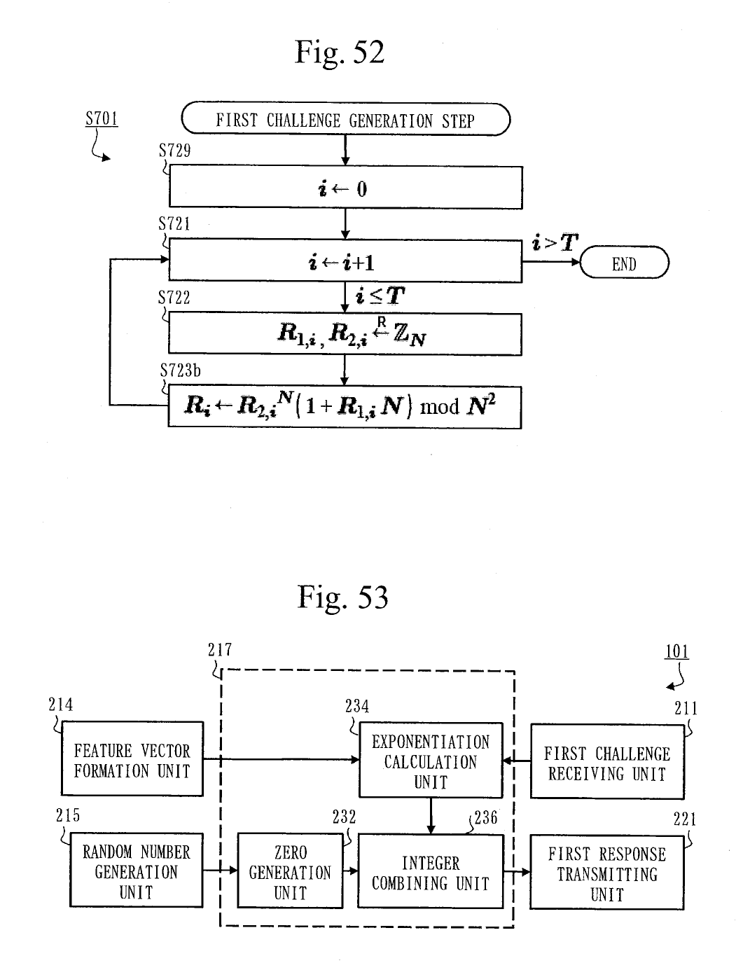

FIG. 52 is a flow chart diagram showing an example of a flow of processes of the first challenge generation step S701 in this embodiment.

In the first challenge generation step S701, the authentication apparatus 102 generates the first challenge R. The first challenge generation step S701 includes the initialization step S729, the repetition step S721, the random number generation step S722, and an integer calculation step S723b, for example.

The first challenge R generated by the encrypted random number generation unit 304 of the authentication apparatus 102 is a T-dimensional vector (R₁, R₂, . . . , R_{T}) having components of integers not less than 0 and less than N².

First, in the initialization step S729, using the processing device 911, the encrypted random number generation unit 304 initializes the integer i to 0.

In the repetition step S721, using the processing device 911, the encrypted random number generation unit 304 adds 1 to the integer i. When the integer i is larger than T, the encrypted random number generation unit 304 finishes the first challenge generation step S701. When the integer i is not more than T, the encrypted random number generation unit 304 causes the process to proceed to the random number generation step S722, thereby generating the ith component Rᵢ of the first challenge R.

In the random number generation step S722, using the processing device 911, the random number generation unit 303 generates the two random numbers R_{1, i} and R_{2, i}, based on the integer N which is the public key pk stored by the public key storage unit 302. The random numbers R_{1, i} and R_{2, i} generated by the random number generation unit 303 are the integers uniform randomly selected from among the integers not less than 1 and less than N. The random number storage unit 322 stores the random number R_{1, i} generated by the random number generation unit 303, using the storage device 914.

In the element calculation step S723a, using the processing device 911, the encrypted random number generation unit 304 calculates the ith component Rᵢ of the first challenge R, based on the integer N which is the public key pk stored by the public key storage unit 302 and the two random numbers R_{1, i} and R_{2, i} generated by the random number generation unit 303 in the random number generation step S722. The ith component Rᵢ of the first challenge R calculated by the encrypted random number generation unit 304 is a remainder when the product of a sum (1+R_{1,i}N) and an integer R_{2, i}^{N} is divided by the square of the integer N. The sum (1+R_{1,i}N) is obtained by adding 1 to a product R_{1, i}N of the random number R_{1, i} and the integer N. The integer R_{2, i}^{N} is obtained by exponentiating the random number R_{2, i} by the integer N.

The encrypted random number generation unit 304 causes the process to return to the repetition step S721, thereby generating the subsequent component of the first challenge R.

The first challenge R generated by the encrypted random number generation unit 304 in this manner is transmitted to the certification apparatus 101 by the first challenge transmitting unit 311. The certification apparatus 101 receives and then processes the first challenge R.

The number of the random numbers R_{1, i} and R_{2, i} (i being each integer not less than 1 and not more than T) generated by the random number generation unit 303 in the first challenge generation step S701 is 2T in total. T pieces of random numbers R_{1, i} (i being each integer not less than 1 and not more than T) are stored by the random number storage unit 322. The T pieces of random numbers R_{1, i} stored by the random number storage unit 322 are random numbers as plaintexts, and the remaining T pieces of random numbers R_{2, i} (i being each integer not less than 1 and not more than T) are random numbers for encryption. Each component Rᵢ of the first challenge R is obtained by encrypting the random number R_{1,i} as a plaintext.

FIG. 53 is a detailed block diagram showing an example of a configuration of the encrypted data embedding unit 217 in this embodiment.

The encrypted data embedding unit 217 of the certification apparatus 101 includes the exponentiation calculation unit 234, the zero generation unit 232, and an integer combining unit 236, for example.

The feature vector b′ generated by the feature vector formation unit 214 of the certification apparatus 101 is a T-dimensional vector (b′₁, b′₂, . . . , b′_{T}) having components of the integers not less than 0 and less than N, like the feature vector b generated by the feature vector formation unit 204 of the registration apparatus 104.

Using the processing device 911, the random number generation unit 215 generates T pieces of random numbers r′ᵢ (i being each integer not less than 1 and not more than T), based on the integer N which is the public key pk stored by the public key storage unit 212. The random numbers r′ᵢ generated by the random number generation unit 215 are integers uniform randomly selected from among the integers not less than 1 and less than N.

Using the processing device 911, the exponentiation calculation unit 234 calculations the exponentiation vector [symbol] [symbol] , based on the first challenge R received by the first challenge receiving unit 211 and the feature vector b′ generated by the feature vector formation unit 214. The exponentiation vector [symbol] [symbol] calculated by the exponentiation calculation unit 234 is a T-dimensional vector ( [symbol] ₁, [symbol] ₂, . . . , [symbol] _{T}) having components of integers not less than 1 and less than N², like the first challenge R. The ith component [symbol] ᵢ (i being the integer not less than 1 and not more than T) of the exponentiation vector [symbol] [symbol] calculated by the exponentiation calculation unit 234 is a remainder when an integer Rᵢ^{b′i} obtained by exponentiating the ith component Rᵢ of the first challenge R by the ith component b′ᵢ of the feature vector b′ is divided by the square of the integer N. Each component [symbol] ᵢ of the exponentiation vector [symbol] [symbol] calculated by the exponentiation calculation unit 234 is obtained by encrypting the product of the component b′ᵢ of the feature vector b′ and the random number R_{1, i} as the plaintext that has been generated by the authentication apparatus 102.

Using the processing device 911, the zero generation unit 232 generates the encrypted zero vector O based on the integer N which is the public key pk stored by the public key storage unit 202 and the T pieces of random numbers r′ᵢ generated by the random number generation unit 215. The encrypted zero vector O is a T-dimensional vector (o₁, o₂, . . . , o_{T}) having components of integers not less than 0 and less than N². The ith component oᵢ (i being the integer not less than 1 and not more than T) of the encrypted zero vector O is a remainder when an integer r′ᵢ^{N} obtained by exponentiating the ith random number r′ᵢ by the integer N is divided by the square of the integer N. Each component oᵢ of the encrypted zero vector O is obtained by encrypting 0.

Using the processing device 911, the integer combining unit 236 calculates the first response R′, based on the exponentiation vector [symbol] [symbol] calculated by the exponentiation calculation unit 234 and the encrypted zero vector O generated by the zero generation unit 232. The first response R′ is a T-dimensional vector (R′₁, R′₂, . . . , R′_{T}) having components of integers not less than 0 and less than N². The ith component R′ᵢ (i being the integer not less than 1 and not more than T) of the first response R′ is a remainder when the product of the ith component [symbol] ᵢ of the exponentiation vector [symbol] [symbol] and the ith component oᵢ of the encrypted zero vector O is divided by the square of the integer N. Each component R′ᵢ of the first response R′ is obtained by encrypting the product of the random number R_{1, i} as the plaintext and the component b′ᵢ of the feature vector b′. The random number R_{1, i} is encrypted in the component Rᵢ of the first challenge R.

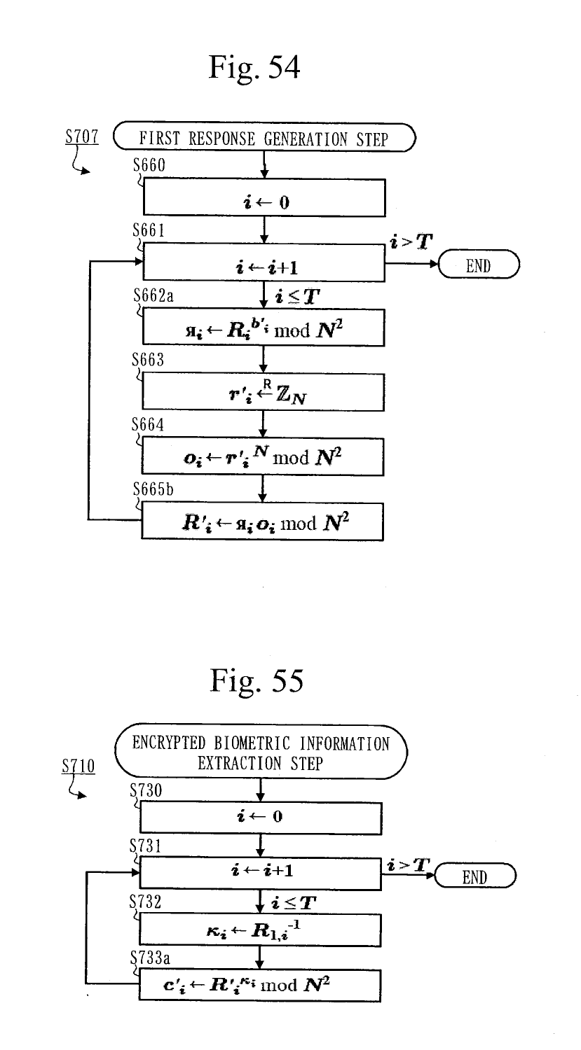

FIG. 54 is a flow chart diagram showing an example of a flow of processes of the first response generation step S707 in this embodiment.

In the first response generation step S707, the certification apparatus 101 generates the first response R′, based on the feature vector b′ and the first challenge R. The first response generation step S707 includes the initialization step S660, the repetition step S661, the exponentiation calculation step S662a, the random number generation step S663, the zero generation step S664, and an integer combining step S665b.

First, in the initialization step S660, the integer combining unit 236 initializes the integer i to 0, using the processing device 911.

In the repetition step S661, the integer combining unit 236 adds 1 to the integer i, using the processing device 911. When the integer i is larger than T, the element combining unit 236 finishes the first response generation step S707. When the integer i is not more than T, the integer combining unit 236 causes the process to proceed to the exponentiation calculation step S662a to generate the ith component R′ᵢ of the first response R′.

In the exponentiation calculation step S662a, using the processing device 911, the exponentiation calculation unit 234 calculates the ith component [symbol] ᵢ=Rᵢ^{b′i} mod N² of the exponentiation vector [symbol] [symbol] , based on the ith component b′ᵢ of the feature vector b′ generated by the feature vector formation unit 214 and the ith vector Rᵢ of the first challenge R received by the first challenge receiving unit 211.

In the random number generation step S663, the random number generation unit 215 generates the random number r′ᵢ, using the processing device 911.

In the zero generation step S664, using the processing device 911, the zero generation unit 232 calculates the ith component oᵢ=r′i^{N} mod N² of the encrypted zero vector O, based on the random number r′ᵢ generated by the random number generation unit 215 in the random number generation step S663.

In the integer combining step S665b, using the processing device 911, the integer combining unit 236 calculates the ith component R′ᵢ of the first response R′, based on the ith component [symbol] ᵢ of the exponentiation vector [symbol] [symbol] calculated by the exponentiation calculation unit 234 in the exponentiation calculation step S662a and the ith component oᵢ of the encrypted zero vector O calculated by the zero generation unit 232 in the zero generation step S664.

The integer combining unit 236 causes the process to return to the repetition step S661 to generate the subsequent component of the first response R′.

The first response R′ generated by the encrypted data embedding unit 217 in this manner is transmitted to the authentication apparatus 102 by the first response transmitting unit 221. The authentication apparatus 102 receives and then processes the first response R′.

When the component b′ᵢ of the feature vector b′ takes only one of two values of 0 and 1, the processes of the first response generation step S707 can be simplified, as follows, for example.

First, there is no need for exponentiation, so that the exponentiation calculation unit 234 is not provided, and the exponentiation calculation step S662a is not executed.

Using the processing device 911, the integer combining unit 236 determines whether or not the ith component b′ᵢ of the feature vector b′ is 0 or 1, in the integer combining step S665a. When the ith component b′ᵢ of the feature vector b′ is 0, the integer combining unit 236 sets the ith component oᵢ=r′ᵢ^{N} mod N² of the encrypted zero vector O calculated by the zero generation unit 232 in the zero generation step S664 to the ith component R′ᵢ of the first response R′, using the processing device 911. When the ith component b′ᵢ of the feature vector b′ is 1, the element combining unit 235 calculates a remainder when the product of the ith component oᵢ of the encrypted zero vector O calculated by the zero generation unit 232 in the zero generation step S664 and the ith component Rᵢ of the first challenge R received by the first challenge receiving unit 211 is divided by the square of the integer N, and sets the remainder to the ith component R′ᵢ of the first response R′, using the processing device 911.

The ith component Rᵢ of the first challenge R is the remainder when the product of the integer (1+R_{1,i}N) and the integer obtained by exponentiating the random number R_{2, i}^{N} by N is divided by N². The integer (1+R_{1,i}N) is obtained by adding 1 to the product of the random number R_{1, i} and the integer N. Thus, the ith component R′ᵢ of the first response R′ is a remainder when the product of an integer (1+b′ᵢR_{1, i}N) and the Nth power of the product of the b′ᵢ power of the random number R_{2, i} and the random number r′ᵢ is divided by N². The integer (1+b′ᵢR_{1, i}N) is obtained by adding 1 to the product of the ith component b′ᵢ of the feature vector b′, the random number R_{1, i}, and the integer N. That is, the ith component R′ᵢ of the first response R′ is obtained by encrypting the product of the random number R_{1, i} and the ith component b′ᵢ of the feature vector b′.

The encrypted data extraction unit 305 has the same configuration as that explained in the fourth embodiment. Thus, a description will be given, with reference to FIG. 37.

The encrypted data extraction unit 305 of the authentication apparatus 102 includes the inverse number calculation unit 351 and the exponentiation calculation unit 353, for example.

The encrypted feature vector C′ generated by the encrypted data extraction unit 305 of the authentication apparatus 102 is a T-dimensional vector (c′₁, c′₂, . . . , c′_{T}) having components of elements of integers not less than 0 and less than N², like the encrypted feature vector C generated by the encrypted data generation unit 206 of the registration apparatus 104.

Using the processing device 911, the inverse number calculation unit 351 calculates the inverse number κᵢ=R_{1, i}⁻¹ of each random number R_{1, i} by multiplication of integers modulo N, based on the T pieces of random numbers R_{1,i} (i being each integer not less than 1 and not more than T) stored by the random number storage unit 322. The inverse number κᵢ is the integer where, when the product of the random number R_{1, i} and the inverse number κᵢ is divided by N, the remainder is one. Since N is not the prime number, the random number R_{1, i} does not necessarily have the inverse number κᵢ. However, when the two prime numbers p and q that are the prime factors of N are sufficiently large, the probability that the random number R_{1, i} is the zero divisor is extremely small and is negligible.

Using the processing device 911, the exponentiation calculation unit 353 calculates the encrypted feature vector C′, based on the first response R′ received by the first response receiving unit 331 and the T inverse numbers κᵢ calculated by the inverse number calculation unit 351. The ith component c′ᵢ (i being the integer not less than 1 and not more than T) of the encrypted feature vector C′ calculated by the exponentiation calculation unit 353 is a remainder when an integer obtained by exponentiating the ith component R′ᵢ of the first response R′ by the ith inverse number κᵢ is divided by the square of the integer N. Each component c′ᵢ of the encrypted feature vector C′ is obtained by encrypting the component b′ᵢ of the feature vector b′.

FIG. 55 is a flow chart diagram showing an example of a flow of processes of the encrypted biometric information extraction step S710 in this embodiment.

In the encrypted biometric information extraction step S710, the authentication apparatus 102 generates the encrypted feature vector C′, based on the first response R′. The encrypted biometric information extraction unit S710 includes the initialization step S730, the repetition step S731, the inverse number calculation step S732, and the exponentiation calculation step S733a, for example.

First, in the initialization step S730, the exponentiation calculation unit 353 initializes the integer i to 0, using the processing device 911.

In the repetition step S731, the exponentiation calculation unit 353 adds 1 to the integer i, using the processing device 911. When the integer i is larger than T, the exponentiation calculation unit 353 finishes the encrypted biometric information extraction step S710. When the integer i is not more than T, the exponentiation calculation unit 353 causes the process to proceed to the inverse number calculation step S732 to generate the ith component c′ᵢ of the encrypted feature vector C′.

In the inverse number calculation step S732, using the processing device 911, the inverse number calculation unit 351 calculates the inverse number κᵢ=R_{1, i}⁻¹, based on the ith random number R_{1, i} out of the T pieces of random numbers stored by the random number storage unit 322 in the first challenge generation step S701.

In the exponentiation calculation step S733a, using the processing device 911, the exponentiation calculation unit 353 calculates the ith component c′ᵢ=R′ᵢ^{κi}, based on the ith component R′ᵢ of the first response R′ received by the first response receiving unit 331 and the inverse number κᵢ calculated by the inverse number calculation step S732.

The exponentiation calculation unit 353 causes the process to return to the repetition step S731 to generate the subsequent component of the encrypted feature vector C′.

The encrypted feature vector C′ generated by the encrypted data extraction unit 305 in this manner is used in the second challenge generation step S712.

The ith component R′ᵢ of the first response R′ is the remainder when the product of the integer (1+b′ᵢR_{1,i}N) and the Nth power of R_{2, i}^{b′i}r′ᵢ is divided by N². The integer (1+b′R_{1,i}N) is obtained by adding 1 to the product of an integer b′ᵢR_{1, i} and the integer N. Thus, the ith component c′ᵢ of the encrypted feature vector C′ is the product of an integer (1+κᵢb′ᵢR_{1, i}N) and the Nth power of (R_{2, i}^{b′i}r′ᵢ)^{κi}. The integer (1+κᵢb′ᵢR_{1, i}N) is obtained by adding 1 to the product of an integer κᵢb′ᵢRᵢ, and the integer N. Since R_{1, i}κᵢ≡1(mod N), c′ᵢ is the product of the Nth power of (R_{2, i}^{b′, i}r′ᵢ)^{κi} and an integer (1+b′ᵢN). The integer (1+b′ᵢN) is obtained by adding 1 to the product of an integer b′ᵢ and the integer N. That is, the ith component c′ᵢ of the encrypted feature vector C′ is obtained by encrypting the ith component b′ᵢ of the feature vector b′.

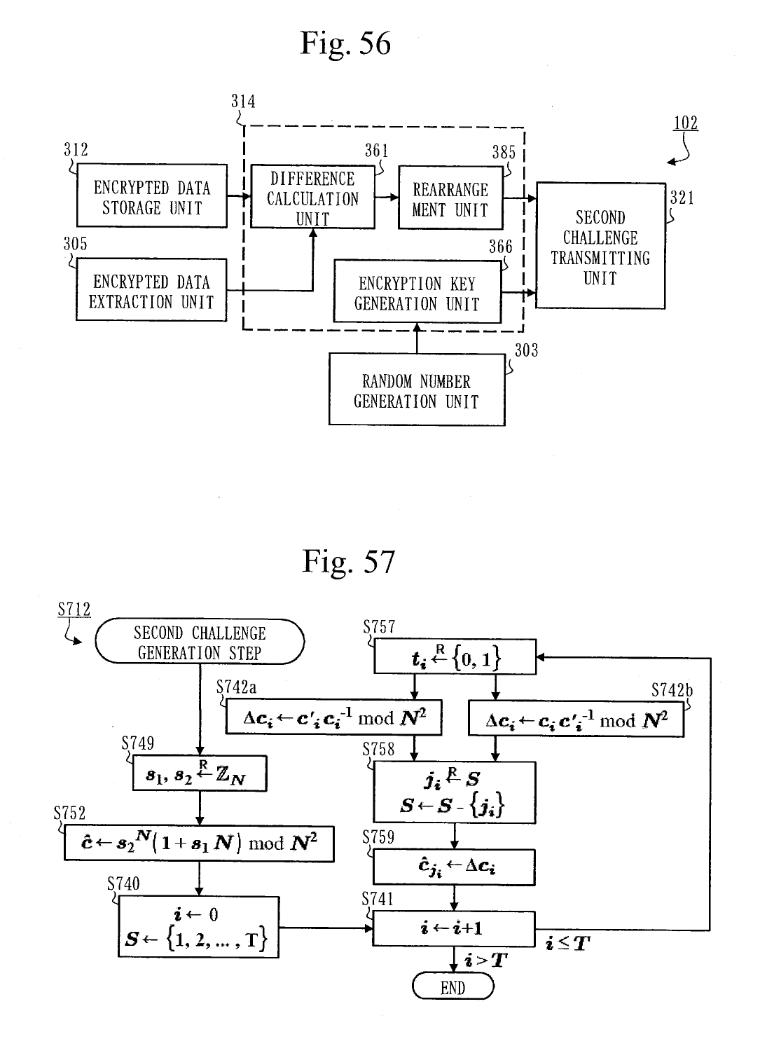

FIG. 56 is a detailed block diagram showing an example of a configuration of the encrypted random similarity degree calculation unit 314 in this embodiment.

The second challenge Ĉ to be generated by the encrypted random similarity degree calculation unit 314 of the authentication apparatus 102 is constituted from (T+1) integers ĉ₁, ĉ₂, . . . , ĉ_{T}, and ĉ which are not less than 0 and less than N². The encrypted random similarity degree calculation unit 314 includes the difference calculation unit 361, a rearrangement unit 385, and the encryption key generation unit 366, for example.

Using the processing device 911, the random number generation unit 303 generates two random numbers s₁ and s₂, based on the integer N, which is the public key pk stored by the public key storage unit 302. The random numbers s₁ and s₂ generated by the random number generation unit 303 are integers uniform randomly selected from among the integers not less than 0 and less than N.

The random number storage unit 322 stores one random number s₁ out of the random numbers generated by the random number generation unit 303, using the storage device 914.

Using the processing device 911, the difference calculation unit 361 calculates the encrypted difference vector ΔC, based on the encrypted feature vector C stored by the encrypted data storage unit 312 and the encrypted feature vector C′ extracted by the encrypted data extraction unit 305. The encrypted difference vector ΔC is a T-dimensional vector (Δc₁, Δc₂, . . . , Δc_{T}) having components of elements of the integers not less than 0 and less than N². The ith component Δcᵢ (i being the integer not less than 1 and not more than T) of the encrypted difference vector ΔC is one of the following two integers randomly selected. The integer which is the first candidate for Δcᵢ is a remainder when the product of the ith component c′ᵢ of the encrypted feature vector C′ and an inverse number cᵢ⁻¹ of the ith component cᵢ of the encrypted feature vector C is divided by N² in multiplication of integers modulo N². The integer which is the second candidate for Δcᵢ is a remainder when the product of the ith component cᵢ of the encrypted feature vector C and an inverse number c′ᵢ⁻¹ of the ith component c′ᵢ of the encrypted feature vector C′ is divided by N² in the multiplication of integers modulo N². That is, the first candidate and the second candidate are in a relationship of inverse numbers in the multiplication of integers modulo N². Each component Δcᵢ of the encrypted difference vector ΔC is obtained by encrypting a difference (bᵢ−b′ᵢ) whose polarity has been randomly changed. The difference (bᵢ−b′ᵢ) is the one between the component bᵢ of the feature vector b and the component b′ᵢ of the feature vector b′.

Using the processing device 911, the rearrangement unit 385 generates T integers ĉᵢ (i being each integer not less than 1 and not more than T), which is a part of the second challenge Ĉ, based on the encrypted difference vector ΔC calculated by the difference calculation unit 361. The integers ĉᵢ are integers not less than 0 and less than N². The T integers ĉᵢ are obtained by rearranging the order of T components Δcᵢ of the encrypted difference vector ΔC.

Using the processing device 911, the encryption key generation unit 366 calculates one integer ĉ which is a part of the second challenge Ĉ, based on the integer N which is the public key pk stored by the public key storage unit 302 and the two random numbers s₁ and s₂ generated by the random number generation unit 303. The integer ĉ is an integer not less than 0 and less than N². The integer ĉ is a remainder when the product of an integer (1+s₁N) and an integer s₂N is divided by the square of the integer N. The integer (1+s₁N) is obtained by adding 1 to the product of the random number s₁ and the integer N. The integer s₂N is obtained by exponentiating the random number s₂ by the integer N. The integer ĉ is obtained by encrypting the random number s₁ calculated by the random number generation unit 303.

FIG. 57 is a flow chart diagram showing an example of a flow of processes of the second challenge generation step S712 in this embodiment.

In the second challenge generation step S712, the authentication apparatus 102 generates the second challenge Ĉ, based on the two encrypted feature vectors C and C′. The second challenge generation step S712 includes the initialization step S740, the repetition step S741, a random number generation step S757, two difference calculation steps S742a and S742b, a random number generation step S758, a second challenge setting step S759, the random number generation step S749, and the encryption key generation step S752, for example.

First, in the initialization step S740, using the processing device 911, the rearrangement unit 385 initializes the integer i to 0. Using the processing device 911, the rearrangement unit 385 initializes a group S to a group having components of elements of T integers not less than 1 and not more than T.

In the repetition step S741, using the processing device 911, the rearrangement unit 385 adds 1 to the integer i. When the integer i is larger T, the rearrangement unit 385 finishes the second challenge generation step S712. When the integer is not more than T, the rearrangement unit 385 causes the process to proceed to the random number generation step S757.

In the random number generation step S757, the random number generation unit 303 generates a random number tᵢ, using the processing device 911. The random number tᵢ is an integer uniform randomly selected from 0 or 1.

When the random number tᵢ is 0, the difference calculation unit 361 causes the process to proceed to the difference calculation step S742a.

When the random number tᵢ is 1, the difference calculation unit 361 causes the process to proceed to the difference calculation step S742b.

In the difference calculation step S742a, using the processing device 911, the difference calculation unit 361 calculates the inverse number cᵢ⁻¹ of the integer cᵢ in multiplication of integers modulo N², based on the ith component cᵢ of the encrypted feature vector C. Using the processing device 911, the difference calculation unit 361 calculates the remainder when the product of the integer c′ᵢ and the inverse number cᵢ⁻¹ is divided by the square of the integer N, based on the calculated inverse number cᵢ⁻¹ and the ith component c′ᵢ of the encrypted feature vector C′ to set the remainder to the component Δcᵢ of the encrypted difference vector ΔC. The difference calculation unit 361 causes the process to proceed to the random number generation step S758.

In the difference calculation step S742b, using the processing device 911, the difference calculation unit 361 calculates the inverse number c′ᵢ⁻¹ of the integer c′ᵢ in multiplication of integers modulo N², based on the ith component c′ᵢ of the encrypted feature vector C′. Using the processing device 911, the difference calculation unit 361 calculates the remainder when the product of the integer cᵢ and the inverse number c′ᵢ is divided by the square of the integer N, based on the calculated inverse number c′ᵢ⁻¹ and the ith component cᵢ of the encrypted feature vector C to set the remainder to the component Δcᵢ of the encrypted difference vector ΔC. The difference calculation unit 361 causes the process to proceed to the random number generation step S758.

In the random number generation step S758, using the processing device 911, the random number generation unit 303 generates a random number jᵢ. The random number jᵢ is an integer uniform randomly selected from among elements of the group S. The rearrangement unit 385 removes the random number jᵢ from the elements of the group S.

In the second challenge setting step S759, using the processing device 911, the rearrangement unit 385 sets the ith component Δcᵢ of the encrypted difference vector ΔC to a jth integer ĉⱼᵢ of the second challenge Ĉ.

The rearrangement unit 385 causes the process to return to the repetition step S741.

In the random number generation step S749, using the processing device 911, the random number generation unit 303 generates the two random numbers s₁ and s₂.

In the encryption key generation step S752, the encryption key generation unit 366 calculates the (T+1)th integer ĉ=s₂^{N} (1+s₁N) mod N² of the second challenge Ĉ, based on the two random numbers s₁ and s₂ generated by the random number generation unit 303 in the random number generation step S749.

The second challenge Ĉ calculated by the encrypted random similarity degree calculation unit 314 in this manner is transmitted to the decryption apparatus 103. The decryption apparatus 103 receives and then processes the second challenge Ĉ.

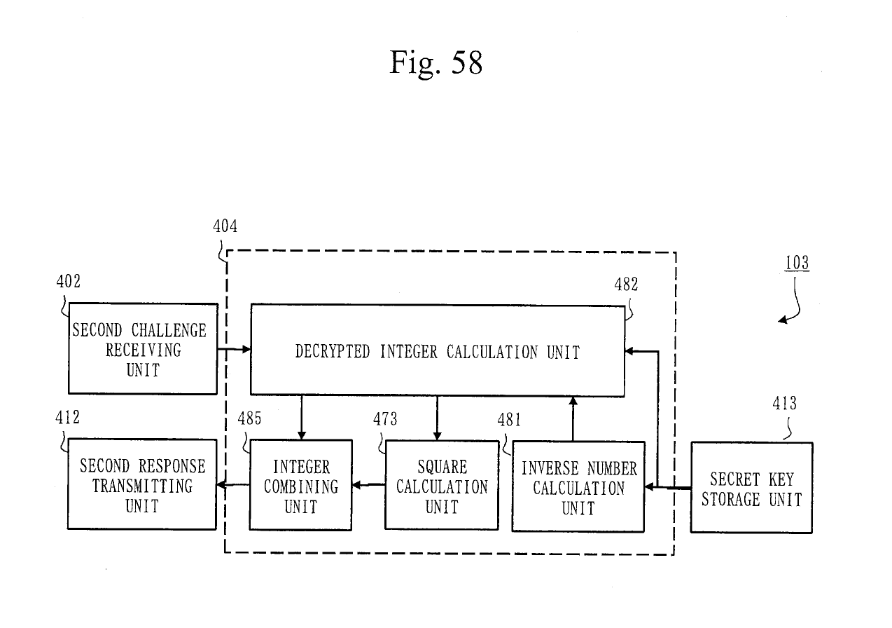

FIG. 58 is a detailed block diagram showing an example of a configuration of the decryption apparatus 404 in this embodiment.

The decryption unit 404 of the decryption apparatus 103 includes an inverse number calculation unit 481, a decrypted integer calculation unit 482, the square calculation unit 473, and an integer combining unit 485, for example.

Using the processing device 911, based on the integer N which is the public key pk stored by the public key storage unit 403 and the integer λ which is the secret key sk stored by the secret key storage unit 413, the inverse number calculation unit 481 calculates the inverse number λ⁻¹ of the integer λ in multiplication of integers modulo N.

Using the processing device 911, the decrypted integer calculation unit 482 calculates (T+1) integers zᵢ and z′ (i being each integer not less than 1 and not more than T), based on the integer λ which is the secret key sk stored by the secret key storage unit 413, the second challenge Ĉ received by the second challenge receiving unit 402, and the inverse number λ⁻¹ calculated by the inverse calculation unit 481. The integers zᵢ and z′ are integers not less than 0 and less than N. The ith integer zᵢ (i being the integer not less than 1 and not more than T+1) is an integer obtained by decrypting the ith integer ĉᵢ of the second challenge Ĉ. The integer z′ is an integer obtained by decrypting the (T+1)th integer ĉ of the second challenge Ĉ. Accordingly, the integer zᵢ indicates a difference between the component of the feature vector b and the corresponding component of the feature vector b′. The integer z′ is equal to the random number s₁ generated by the random number generation unit 303 of the authentication apparatus 102.

The first to Tth integers ĉᵢ of the second challenge Ĉ are obtained by randomly rearranging the sequence of the components of the encrypted difference vector ΔC. Thus, the decryption apparatus 103 cannot know from which components of the feature vectors b and b′ the difference between the components of the feature vectors b and b′ indicated by the integer zᵢ comes from. Further, the polarity of the component Δcᵢ of the encrypted difference vector ΔC is randomly changed. Thus, the decryption apparatus 103 cannot know which one of the two feature vectors b and b′ has the larger components than the other of the two feature vectors b and b′.

Using the processing device 911, the square calculation unit 473 calculates square values z′ᵢ (i being each integer not less than 1 and not more than T), based on the integer N which is the public key pk stored by the public key storage unit 403 and the T integers zᵢ calculated by the decrypted integer calculation unit 911. Each square value z′ᵢ is an integer not less than 0 and less than N. The ith square value z′ᵢ (i being the integer not less than 1 and not more than T) is a remainder when the square of the ith integer zᵢ is divided by the integer N.

Using the processing device 911, the integer combining unit 485 calculates the second response Z, based on the integer N which is the public key pk stored by the public key storage unit 403, the integer z′ calculated by the decrypted integer calculation unit 482, and the T integers z′ᵢ calculated by the square calculation unit 473. The second response Z is an integer not less than 0 and less than N. The second response Z calculated by the integer combining unit 485 is a remainder obtained by dividing the sum of the T integers z′ᵢ and the integer z′ by the integer N. The second response Z is equal to the sum of the random number s₁ and Σᵢ[(bᵢ−b′ᵢ)²] of the square of the Euclidean distance between the feature vector b and the feature vector b′. That is, the second response Z is obtained by encrypting the square of the Euclidean distance between the feature vector b and the feature vector b′ by a random number u₁ as a temporary key.

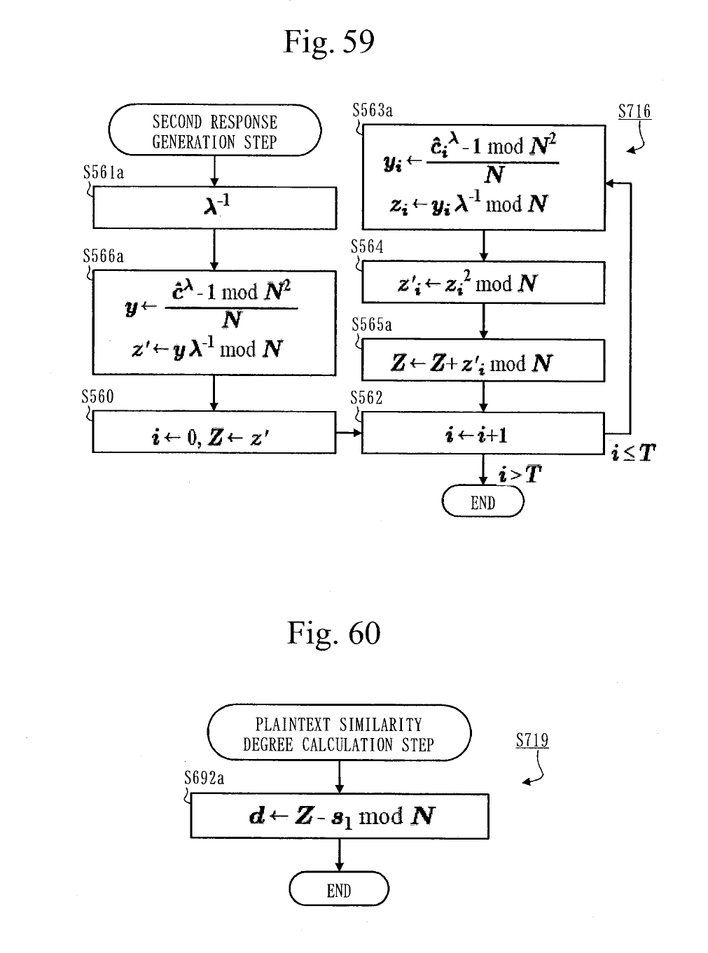

FIG. 59 is a flow chart diagram showing an example of a flow of processes of the second response generation step S716 in this embodiment.

In the second response generation step S716, the decryption apparatus 103 generates the second response Z from the second challenge Ĉ. The second response generation step S716 includes an inverse number calculation step S561a, a decrypted integer calculation step S566a, the initialization step S560, the repetition step S562, a decrypted integer calculation step S563a, the square calculation step S564, and an integer combining step S565a, for example.

First, in the inverse number calculation step S561a, using the processing device 911, the inverse number calculation unit 481 calculates the inverse number λ⁻¹ of the integer λ which is the secret key sk stored by the secret key storage unit 413. The inverse calculation unit 481 may be configured to calculate the inverse number λ⁻¹ in advance (e.g., in the setup process S500) using the processing device 911 and then to store the calculated inverse number λ⁻¹, using the storage device 914.

In the decrypted integer calculation step S566a, using the processing device 911, the decrypted integer calculation unit 482 decrypts the last integer ĉ of the second challenge Ĉ received by the second challenge receiving unit 402 to calculate the integer z′, based on the inverse number λ⁻¹ calculated by the inverse number calculation unit 481 in the inverse number calculation step S561a. To take an example, the decrypted integer calculation unit 482 calculates a quotient y. The quotient y is obtained by dividing, by N, a remainder when an integer (ĉ^{λ}−1) is divided by the square of the integer N. The integer (ĉ^{λ}−1) is obtained by subtracting 1 from an integer obtained by exponentiating the integer ĉ by the integer λ. The decrypted integer calculation unit 482 calculates a remainder when a product yλ⁻¹ of the calculated quotient y and the inverse number λ⁻¹ is divided by N, and then sets the remainder to the integer z′.

In the initialization step S560, using the processing device 911, the integer combining unit 485 initializes the integer i to 0. The integer combining unit 485 initializes the second response Z to the integer z′ calculated by the decrypted integer calculation unit 482 in the decrypted integer calculation step S566a.

In the repetition step S562, using the processing device 911, the integer combining unit 485 adds 1 to the integer i. When the integer i is larger than T, the second response Z has been completed. Thus, the integer combining unit 485 finishes the second response generation step S716. When the integer i is not more than T, the integer combining unit 485 causes the process to proceed to the decrypted integer calculation step S563a.

In the decrypted integer calculation step S563a, using the processing device 911, the decrypted integer calculation unit 482 decrypts the ith component ĉᵢ of the second challenge Ĉ received by the second challenge receiving unit 402 to calculate the ith integer zᵢ, based on the inverse number λ⁻¹ calculated by the inverse number calculation unit 481 in the inverse number calculation step S561a. To take an example, the decrypted integer calculation unit 482 calculates a quotient yᵢ. The quotient yᵢ is obtained by dividing an integer (ĉᵢ^{λ}−1) by the square of the integer N. The integer (ĉi^{λ}−1) is obtained by subtracting 1 from an integer resulting from exponentiation of the integer ĉᵢ by the integer λ. The decrypted integer calculation unit 482 calculates a remainder when a product yᵢλ⁻¹ of the calculated integer yᵢ and the inverse number λ⁻¹ is divided by N, and then sets the remainder to the integer zᵢ.

In the square calculation step S564, using the processing device 911, the square calculation unit 473 calculates the ith square value z′ᵢ, based on the ith integer zᵢ calculated by the decrypted integer calculation unit 482 in the decrypted integer calculation step S563a.

In the integer combining step S565a, using the processing device 911, the integer combining unit 485 combines the ith square value z′ᵢ calculated by the square calculation unit 473 in the square calculation step S564 with the second response Z, by addition of integers modulo the integer N.

The integer combining unit 485 causes the process to return to the repetition step S562 to process the subsequent integer of the second challenge Ĉ.

The second response Z generated by the decryption unit 404 in this manner is transmitted to the authentication apparatus 102 by the second response transmitting unit 412. The authentication apparatus 102 receives and then processes the second response Z.

FIG. 60 is a flow chart diagram showing an example of a flow of processes of the plaintext similarity degree calculation step S719 in this embodiment.

In the plaintext similarity degree calculation step S719, the authentication apparatus 102 calculates the similarity degree d from the second response Z. The plaintext similarity degree calculation step S719 includes an integer combining step S692a, for example.

In the integer combining step S692a, using the processing device 911, the plaintext similarity degree extraction unit 315 of the authentication apparatus 102 calculates the similarity degree d, based on the random number s₁ stored by the random number storage unit 322 and the second response Z received by the second response receiving unit 341. The similarity degree d is an integer not less than 0 and less than N. The similarity degree d calculated by the plaintext similarity degree extraction unit 315 is a remainder when a difference obtained by subtracting the random number s₁ from the second response Z is divided by N.

Based on the similarity degree d calculated by the plaintext similarity degree extraction unit 315, the determination unit 306 determines whether or not the two feature vectors b and b′ are similar, thereby determining whether or not a person having biometric information represented by the feature vector b and a person having biometric information represented by the feature vector b′ are identical. When the similarity degree d is smaller than the threshold value d₀, the determination unit 306 determines that the two feature vectors b and b′ are similar.

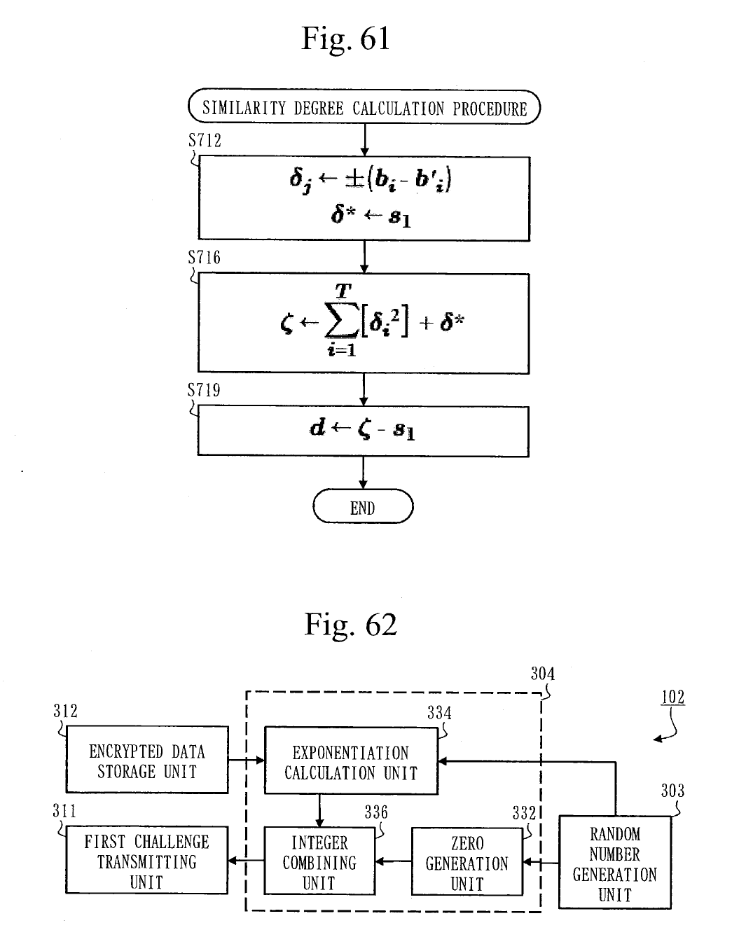

FIG. 61 is a flow chart diagram showing a similarity degree calculation procedure in the biometric authentication system 100 in this embodiment.

As a first stage, in the second challenge generation step S712, the authentication apparatus 102 calculates the second challenge Ĉ from the two encrypted feature vectors C and C′, thereby calculating T pieces of δⱼ=±(bᵢ−b′ᵢ) (each of i and j being each integer not less than 1 and not more than T) and one δ*=s₁. This calculation is performed with the encrypted feature vectors C and C′ kept encrypted with the key of the decryption apparatus 103. Thus, the authentication apparatus 102 cannot obtain information on the feature vectors b and b′. Further, the polarity of each δⱼ is randomly changed, and the sequence of the T pieces of δᵢ is also randomly rearranged in order to prevent leakage of the information on the feature vectors b and b′ to the decryption apparatus 103.

As a second stage, in the second response generation step S716, the decryption apparatus 103 calculates the second response Z from the second challenge Ĉ, thereby calculating ξ=Σᵢ[δᵢ²]+δ* (i being each integer not less than 1 and not more than T). The first term Σᵢ[δᵢ²] represents the similarity degree d and the second term δ* represents encryption. That is, the decryption apparatus 103 calculates the similarity degree d, and then encrypts the similarity degree d using δ*=s₁. This calculation is performed the second challenge Ĉ decrypted with the secret key of the decryption apparatus 103. However, due to randomization in the first stage, the decryption apparatus 103 cannot obtain the information on the feature vectors b and b′.

As a third stage, in the plaintext similarity degree calculation step S719, the authentication apparatus 102 calculates from the second response Z the similarity degree d=ξ−s₁. With this arrangement, the authentication apparatus 102 can obtain the similarity degree d, but cannot obtain the information on the feature vectors b and b′.

The encryption system is not limited to the Paillier encryption system. It may be so configured that a different additive-homomorphic encryption system such as the Okamoto-Takashima encryption system, the BGN encryption system, or the Gentry encryption system is employed. It may be so configured that a second encryption system such as the standard public key encryption system is employed for communication between the certification apparatus 101 and the authentication apparatus 102.

As in the second embodiment, the biometric authentication system 100 may be so configured that the certification apparatus 101 combines functions of the decryption apparatus 103 and the registration apparatus 104.

### Seventh Embodiment

A seventh embodiment will be described, using FIGS. 62 to 68.

Same reference signs are given to components that are common to those in the first to sixth embodiments, thereby omitting description of the components that are common to those in the first to sixth embodiments.

In this embodiment, a description will be directed to a configuration in which information on comparison data b that derives from the encrypted feature vector C is embedded into the first challenge R to cause the certification apparatus 101 to perform calculation in the first stage of similarity degree calculation.

In this embodiment, a description will be directed to a case where the Paillier encryption system described in the sixth embodiment is employed, and the inner product Σᵢ[bᵢb′ᵢ] is calculated as the similarity degree d, as in the third embodiment.

FIG. 62 is a detailed block diagram showing an example of a configuration of the encrypted random number generation unit 304 in this embodiment.

The encrypted random number generation unit 304 of the authentication apparatus 102 includes an exponentiation calculation unit 334, a zero generation unit 332, and an integer combining unit 336, for example.

Using the processing device 911, the random number generation unit 303 generates 2T pieces of random numbers R_{1, i} and R_{2, i} (i being each integer not less than 1 and not more than T), based on the integer N which is the public key pk stored by the public key storage unit 302. The random numbers R_{1, i} and R_{2, i} generated by the random number generation unit 303 are integers uniform randomly selected from among integers not less than 0 and less than N. Using the storage device 914, the random number storage unit 322 stores T pieces of random numbers R_{1, i} (i being each integer not less than 1 and not more than T) out of the random numbers generated by the random number generation unit 303.

Using the processing device 911, the exponentiation calculation unit 334 calculations an exponentiation vector [symbol] [symbol] ′, based on the encrypted feature vector C stored by the encrypted data storage unit 312 and the T pieces of random numbers R_{1, i} generated by the random number generation unit 303. The exponentiation vector [symbol] [symbol] ′ calculated by the exponentiation calculation unit 334 is a T-dimensional vector ( [symbol] ′₁, [symbol] ′₂, . . . , [symbol] ′_{T}) having components of integers not less than 0 and less than N². The ith component [symbol] ′ᵢ (i being the integer not less than 1 and not more than T) of the exponentiation vector [symbol] [symbol] ′ calculated by the exponentiation calculation unit 334 is a remainder when an integer obtained by exponentiating the ith component cᵢ of the encrypted feature vector C by the ith random number R_{1,i}′ is divided by the square of the integer N. Each component [symbol] ′ᵢ of the exponentiation vector [symbol] [symbol] ′ calculated by the exponentiation calculation unit 334 is obtained by encrypting the product of the component bᵢ of the feature vector b and the random number R_{1, i} as a plaintext.

Using the processing device 911, the zero generation unit 332 generates an encrypted zero vector O′ using the integer N which is the public key pk stored by the public key storage unit 302 and T pieces of random numbers R_{2,i} generated by the random number generation unit 303. The encrypted zero vector O′ is a T-dimensional vector (o′₁, o′₂, . . . , o′_{T}) having components of integers not less than 0 and less than N². The ith component o′ᵢ (i being the integer not less than 1 and not more than T) of the encrypted zero vector O′ is a remainder when an integer R_{2, i}^{N} obtained by exponentiating the ith random number R_{2,i} by the integer N is divided by the square of the integer N. Each component o′ᵢ of the encrypted zero vector O′ is obtained by encrypting 0.

Using the processing device 911, the integer combining unit 336 calculates the first challenge R, based on the exponentiation vector [symbol] [symbol] ′ calculated by the exponentiation calculation unit 334 and the encrypted zero vector O′ generated by the zero generation unit 232. The first challenge R is a T-dimensional vector (R₁, R₂, . . . , R_{T}) having components of the integers not less than 0 and less than N². The ith component Rᵢ (i being the integer not less than 1 and not more than T) of the first challenge R is a remainder when the product of the ith component [symbol] ′ᵢ of the exponentiation vector [symbol] [symbol] ′ and the ith component o′ᵢ of the encrypted zero vector O′ is divided by the square of the integer N. Each component Rᵢ of the first challenge R is obtained by encrypting the product of the random number R_{1, i} as the plaintext and the component bᵢ of the feature vector b.

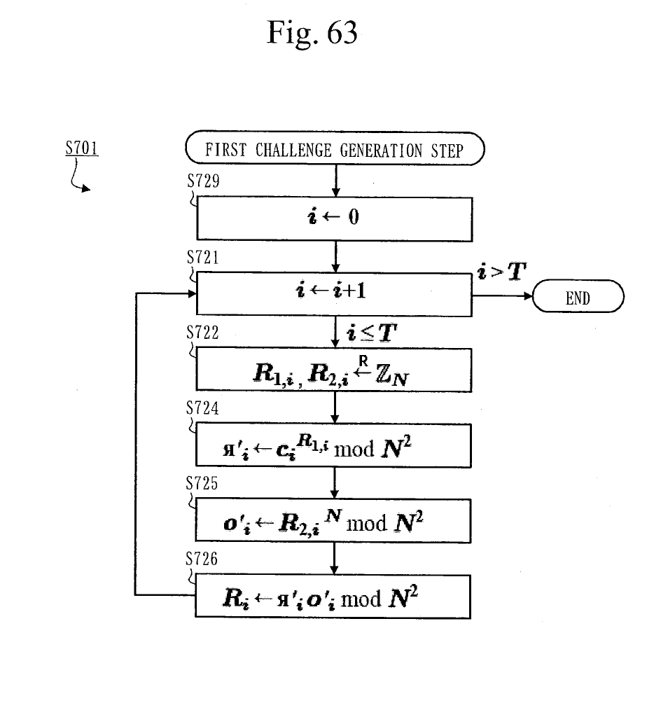

FIG. 63 is a flow chart diagram showing an example of a flow of processes of the first challenge generation step S701 in this embodiment.

In the first challenge generation step S701, the authentication apparatus 102 generates the first challenge R, based on the encrypted feature vector C. The first challenge generation step S701 includes the initialization step S729, the repetition step S721, the random number generation step S722, an exponentiation calculation step S724, a zero generation step S725, and an integer combining step S726, for example.

First, in the initialization step S729, using the processing device 911, the integer combining unit 336 initializes the integer i to 0.

In the repetition step S721, using the processing device 911, the integer combining unit 336 adds 1 to the integer i. When the integer i is larger than T, the integer combining unit 336 finishes the first challenge generation step S701. When the integer i is not more than T, the integer combining unit 336 causes the process to proceed to the random number generation step S722, thereby generating the ith component R, of the first challenge R.

In the random number generation step S722, using the processing device 911, the random number generation unit 303 generates two random numbers R_{1, i} and R_{2, i}. The random number storage unit 322 stores the random number R_{1, i} generated by the random number generation unit 303, using the storage device 914.

In the exponentiation calculation step S724, using the processing device 911, the exponentiation calculation unit 334 calculates the ith component [symbol] ′ᵢ of the exponentiation vector [symbol] [symbol] ′, based on the ith component cᵢ of the encrypted feature vector C stored by the encrypted data storage unit 312 and the random number R_{1, i} generated by the random number generation unit 303 in the random number generation step S722.

In the zero generation step S725, using the processing device 911, the zero generation unit 332 calculates the ith component o′ᵢ of the encrypted zero vector O′, based on the random number R_{2, i} generated by the random number generation unit 303 in the random number generation step S722.

In the integer combining step S726, the integer combining unit 336 calculates the ith component Rᵢ of the first challenge R, based on the ith component [symbol] ′ᵢ of the exponentiation vector [symbol] [symbol] ′calculated by the exponentiation calculation unit 334 in the exponentiation calculation step S724a and the ith component o′ᵢ of the encrypted zero vector O′ calculated by the zero generation unit 332 in the zero generation step S725.

The integer combining unit 336 causes the process to return to the repetition step S721 to generate the subsequent component of the first challenge R.

The first challenge R generated by the encrypted random number generation unit 304 in this manner is transmitted to the certification apparatus 101 by the first challenge transmitting unit 311. The certification apparatus receives and then processes the first challenge R.

Though the encrypted data embedding unit 217 of the certification apparatus 101 has the same configuration as that in the sixth embodiment, the first challenge R has a different meaning. Thus, the first response R′ to be generated by the encrypted data embedding unit 217 also has a meaning different from that in the sixth embodiment.

That is, the ith component R′ᵢ (i being the integer not less than 1 and not more than T) of the first response R′ is obtained by encrypting the product of the ith component bᵢ of the feature vector b, an ith component b′ᵢ of a feature vector b′, and the random number R_{1, i}.

The encrypted data extraction unit 305 of the authentication apparatus 102 also has the same configuration as that in the sixth embodiment.

The ith component c′ᵢ (i being the integer not less than 1 and not more than T) of the encrypted feature vector C′ generated by the encrypted data extraction unit 305 is obtained by encrypting a product bᵢb′ᵢ of the ith components bᵢ and b′ᵢ of the two feature vectors b and b′ rather than the ith component b′ᵢ of the feature vector b′.

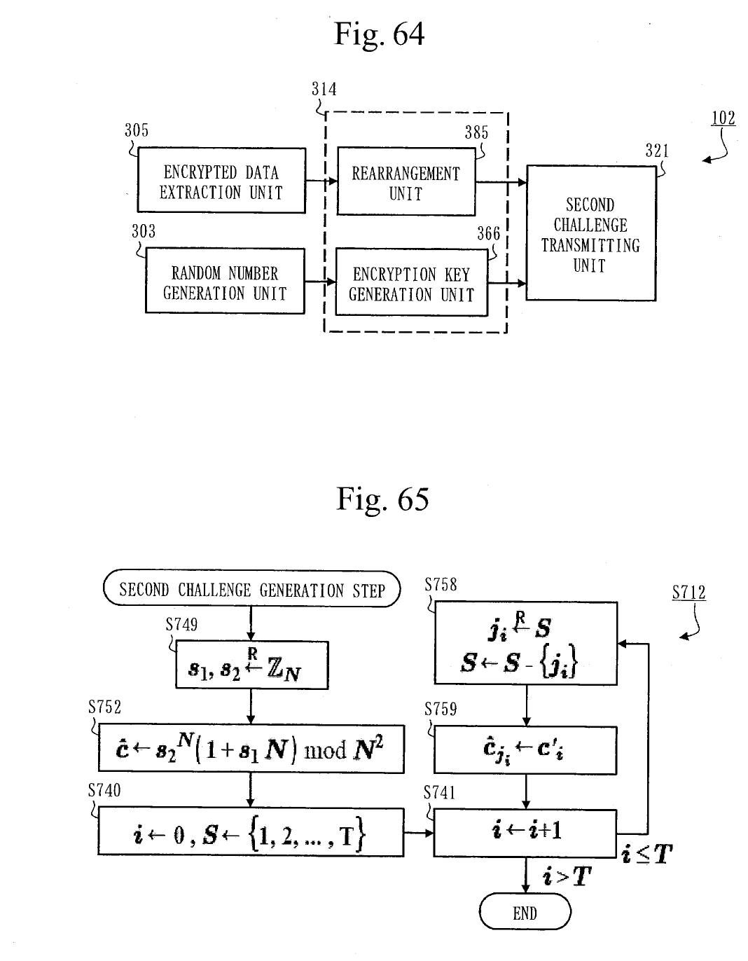

FIG. 64 is a detailed block diagram showing an example of a configuration of the encrypted random similarity calculation unit 314 in this embodiment.

The second challenge Ĉ to be generated by the encrypted random similarity degree calculation unit 314 of the authentication apparatus 102 is constituted from (T+1) integers ĉ₁, ĉ₂, . . . , ĉ_{T}, and ĉ which are not less than 0 and less than N². The encrypted random similarity degree calculation unit 314 includes the rearrangement unit 385, and the encryption key generation unit 366, for example.

Using the processing device 911, the random number generation unit 303 generates two random numbers s₁ and s₂, based on the integer N which is the public key pk stored by the public key storage unit 302. The random numbers s₁ and s₂ generated by the random number generation unit 303 are integers uniform randomly selected from among the integers not less than 0 and less than N.

The random number storage unit 322 stores one random number s₁ out of the random numbers generated by the random number generation unit 303, using the storage device 914.

Using the processing device 911, the rearrangement unit 385 generates T integers ĉᵢ (i being each integer not less than 1 and not more than T), which is a part of the second challenge Ĉ, based on the encrypted feature vector C′ generated by the encrypted data extraction unit 305. The integers ĉᵢ are integers not less than 0 and less than N². The T integers ĉᵢ are obtained by rearranging the sequence of T components Δcᵢ of the encrypted feature vector C′.

Using the processing device 911, the encryption key generation unit 366 calculates one integer ĉ which is a part of the second challenge Ĉ, based on the integer N which is the public key pk stored by the public key storage unit 302 and the two random numbers s₁ and s₂ generated by the random number generation unit 303. The integer ĉ is an integer not less than 0 and less than N². The integer ĉ is a remainder when the product of the integer (1+s₁N) and the integer s₂^{N} is divided by the square of the integer N. The integer (1+s₁N) is obtained by adding 1 to the product of the random number s₁ and the integer N. The integer s₂^{N} is obtained by exponentiating the random number s₂ by the integer N. The integer ĉ is obtained by encrypting the random number s₁ calculated by the random number generation unit 303.

FIG. 65 is a flow chart diagram showing an example of a flow of processes of the second challenge generation step S712 in this embodiment.

Though the flow of processes of the second challenge generation step S712 is almost the same as that in the sixth embodiment, there are just two differences between the process flows of the second challenge generation step S712 in this embodiment and the sixth embodiment.

The first difference is that, there are no random number generation step S757 and no two difference calculation steps S742a and S742b, and the procedure is made to proceed to the random number generation step S758 when the integer i is not more than T in the repetition step S741.

The second difference is the process in the second challenge setting step S759. In the second challenge setting step S759, using the processing device 911, the rearrangement unit 385 sets the ith component Δcᵢ of the encrypted feature vector C′ to the jᵢth integer ĉⱼᵢ of the second challenge Ĉ.

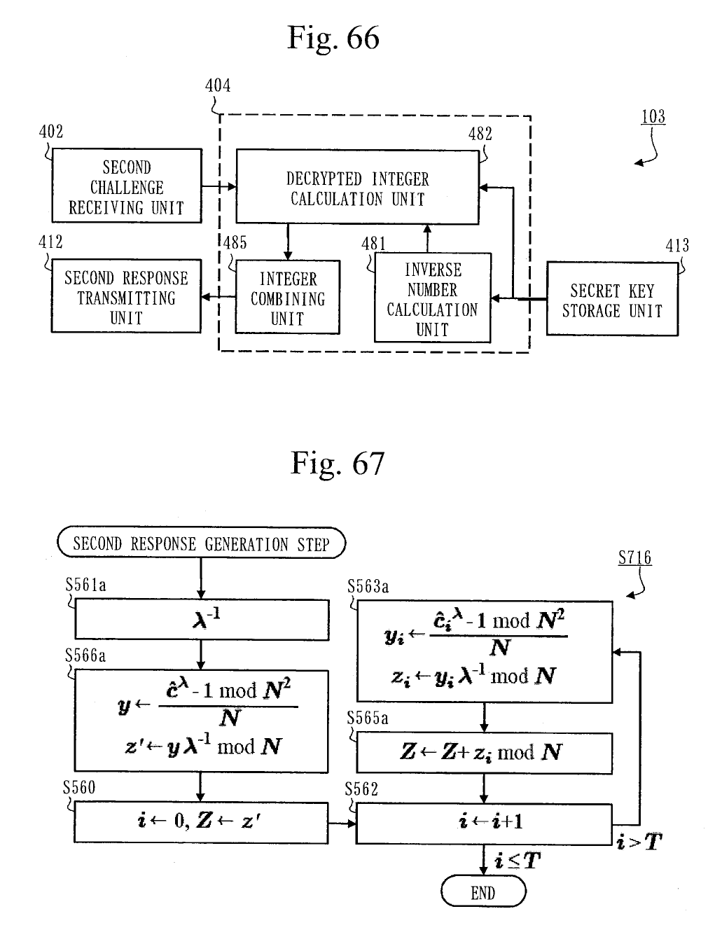

FIG. 66 is a detailed block diagram showing an example of a configuration of the decryption unit 404 in this embodiment.

The decryption unit 404 of the decryption apparatus 103 includes the inverse number calculation unit 481, the decrypted integer calculation unit 482, and the integer combining unit 485, for example.

Using the processing device 911, the inverse number calculation unit 481 calculates the inverse number λ⁻¹ of the integer λ in multiplication of integers modulo N, based on the integer N which is the public key pk stored by the public key storage unit 403 and the integer λ which is the secret key sk stored by the secret key storage unit 413.

Using the processing device 911, the decrypted integer calculation unit 482 calculates (T+1) integers zᵢ and z′ (i being each integer not less than 1 and not more than T), based on the integer λ which is the secret key sk stored by the secret key storage unit 413, the second challenge Ĉ received by the second challenge receiving unit 402, and the inverse number λ⁻¹ calculated by the inverse calculation unit 481. The integers zᵢ and z′ are integers not less than 0 and less than N. The ith integer zᵢ (i being the integer not less than 1 and not more than T+1) is an integer obtained by decrypting the ith integer ĉᵢ of the second challenge Ĉ. The integer z′ is an integer obtained by decrypting the (T+1)th integer ĉ of the second challenge Ĉ. Accordingly, the integer zᵢ indicates the product of the component of the feature vector b and the corresponding component of the feature vector b′. The integer z′ is equal to the random number s₁ generated by the random number generation unit 303 of the authentication apparatus 102.

Using the processing device 911, the integer combining unit 485 calculates the second response Z, based on the integer N which is the public key pk stored by the public key storage unit 403, the (T+1) integers zᵢ and z′ calculated by the decrypted integer calculation unit 482. The second response Z is an integer not less than 0 and less than N. The second response Z calculated by the integer combining unit 485 is a remainder when the sum of the T integers z′ᵢ and the integer z′ is divided by the integer N. The second response Z is equal to the sum of the random number s₁ and the inner product Σᵢ[bᵢb′ᵢ] between the feature vector b and the feature vector b′. That is, the second response Z is obtained by encrypting the inner product of the feature vector b and the feature vector b′ by the random number s₁ as a temporary key.

FIG. 67 is a flow chart diagram showing an example of a flow of processes of the second response generation step S716 in this embodiment.

Though the flow of processes of the second response generation step S716 is almost the same as that in the sixth embodiment, there are just two differences between the process flows of the second response generation step S716 in the seventh embodiment and the sixth embodiment.

The first difference is that there is no square calculation step S564, and the procedure is made to proceed to the integer combining step S565a subsequently to the decrypted integer calculation step S563a.

The second difference is the processing in the integer combining step S565a. In the integer combining step S565a, using the processing device 911, the integer combining unit 485 combines the ith integer zᵢ calculated by the decrypted integer calculation unit 482 in the decrypted integer calculation step S563a with the second response Z, by addition modulo the integer N.

The second response Z generated by the decryption unit 404 in this manner is transmitted to the authentication apparatus 102 by the second response transmitting unit 412. The authentication apparatus 102 receives and then processes the second response Z.

The plaintext similarity degree extraction unit 315 of the authentication apparatus 102 has the same configuration as that in the sixth embodiment.

The plaintext similarity degree extraction unit 315 calculates the inner product Σᵢ[bᵢb′ᵢ] between the two feature vectors b and b′, as the similarity degree d.

The determination unit 306 determines that the two feature vectors b and b′ are similar when the similarity degree d calculated by the discrete logarithm calculation unit 373 is larger than the predetermined threshold value d₀.

With this arrangement, it can be determined whether the two feature vectors b and b′ are similar, using the number of matches between feature points as a reference.

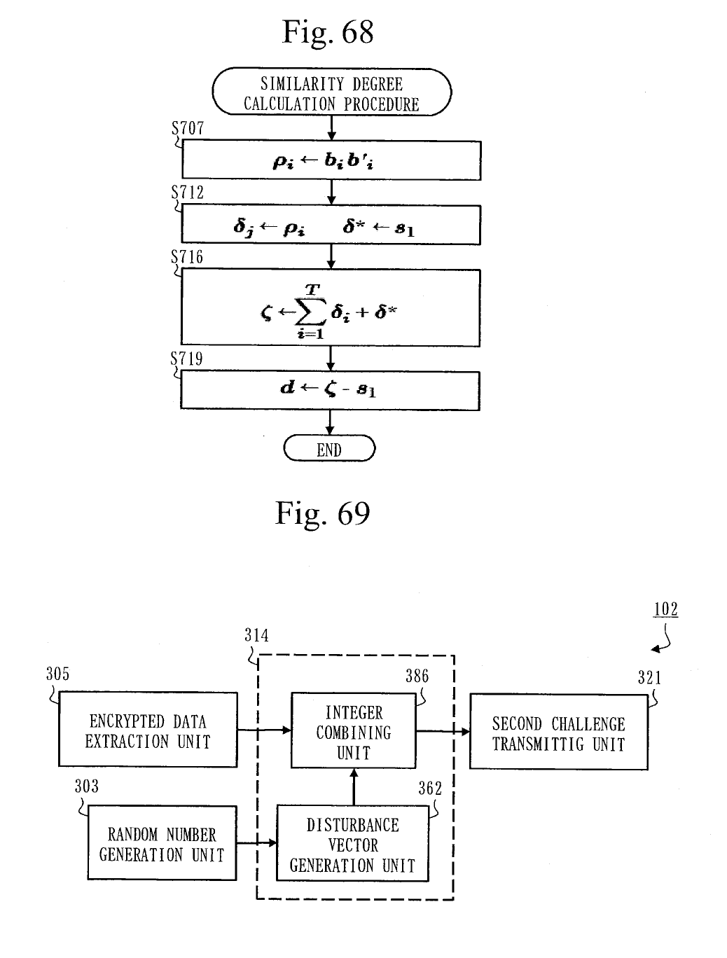

FIG. 68 is a flow chart diagram showing a similarity degree calculation procedure in the biometric authentication system 100 in this embodiment.

Assume that ρᵢ indicates information encrypted in the first response R′.

A first stage is the first response generation step S707 rather than the second challenge generation step S712. In the first response generation step S707, the certification apparatus 101 calculates the first response R′ from the first challenge R, thereby calculating Tρᵢ=bᵢb′ᵢ. This calculation is performed with the feature vectors b and b′ kept encrypted with the key of the decryption apparatus 103. Thus, the certification apparatus 101 cannot obtain information on the feature vector b.

As a second stage, in the second challenge generation step S712, the authentication apparatus 102 calculates the second challenge Ĉ from the encrypted feature vector C′, thereby calculating T pieces of δⱼ (j being each integer not less than 1 and not more than T), and one δ*=s₁. Since δⱼ are obtained by rearranging the order of the ρᵢ so as to prevent leakage of the information on the feature vector b and information on the feature vector b′ to the decryption apparatus 103. Thus, the decryption apparatus 103 cannot obtain the information on the feature vector b and the information on the feature vector b′.

As a third stage, in the second response generation step S716, the decryption apparatus 103 calculates the second response Z from the challenge Ĉ, thereby calculating ξ=Σᵢ[δᵢ]+δ* (i being each integer not less than 1 and not more than T). The first term Σᵢ[δᵢ] indicates the similarity degree d, while the second term δ* indicates encryption. That is, the decryption apparatus 103 calculates the similarity degree d, and then encrypts the similarity degree, using δ*=s₁. This calculation is performed with the second challenge Ĉ decrypted with the secret key of the decryption apparatus 103. However, due to randomization in the second stage, the certification apparatus 101 cannot obtain the information on the feature vector b and the information on the feature vector b′.

As a fourth stage, the authentication apparatus 102 calculates the similarity degree d=ξ−s₁ in the plaintext similarity degree calculation step S719. With this arrangement, the authentication apparatus 102 can obtain the similarity degree d, but cannot obtain the information on the feature vector b and the information on the feature vector b′.

The encryption system is not limited to the Paillier encryption system. It may be so configured that a different additive-homomorphic encryption system such as the Okamoto-Takashima encryption system, the BGN encryption system, or the Gentry encryption system is employed. It may be so configured that a second encryption system such as the standard public key encryption system is employed for communication between the certification apparatus 101 and the authentication apparatus 102.

The biometric authentication system 100 may be so configured that the certification apparatus 101 combines functions of the decryption apparatus 103 and the registration apparatus 104, as in the second embodiment.

When each component value of the feature vectors b and b′ is one of 0 and 1, the product bᵢb′ᵢ of the components of the two feature vectors b and b′ takes one of the values 0 and 1. Thus, the decryption apparatus 103 may have the same configuration as that described in the sixth embodiment. With that arrangement, the certification apparatus 101, the decryption apparatus 103, and the registration apparatus 104 have the same configurations as those in the sixth embodiment, and only the authentication apparatus 102 has a different configuration from that in the sixth embodiment. Accordingly, by setting the authentication apparatus 102 to a configuration capable of switching between the configuration described in the sixth embodiment and the configuration described in this embodiment, two types of similarity degrees using the Euclidean distance and the inner product may be calculated without altering the other apparatuses in the biometric authentication system 100.

### Eighth Embodiment

An eighth embodiment will be described, using FIGS. 69 to 72.

Same reference signs are given to components that are common to those in the first to seventh embodiments, thereby omitting description of the components that are common to those in the first to seventh embodiments.

In this embodiment, the description will be directed to a variation example of the configuration described in the seventh embodiment.

The encrypted feature vector C′ is a T-dimensional vector (c′₁, c′₂, . . . , c′_{T}) having components of integers not less than 0 and less than N². The ith component cᵢ (i being an integer not less than 1 and not more than T) of the encrypted feature vector C′ is obtained by encrypting the product bᵢb′ᵢ of the ith component bᵢ of the feature vector b and the ith component b′ᵢ of the feature vector b′.

FIG. 69 is a detailed block diagram showing an example of a configuration of the encrypted random similarity calculation unit 314 in this embodiment.

The encrypted random similarity degree calculation unit 314 of the authentication apparatus 102 includes the disturbance vector generation unit 362 and an integer combining unit 386, for example.

Using the processing device 911, the random number generation unit 303 generates 2T pieces of random numbers t_{1, i} and t_{2, i} (i being each integer not less than 1 and not more than T). The random numbers t_{1, i} and t_{2, i} are integers uniform randomly selected from among the integers not less than 0 and less than N. The random number storage unit 322 stores a summation value s₁=Σᵢ[t_{1, i}] of the T pieces of random numbers t_{1, i} generated by the random number generation unit 303, using the storage device 914. The random number storage unit 322 may be configured to store the T pieces of random numbers t_{1, i} generated by the random number generation unit 303 without alteration. However, only the summation value is needed in a later stage. Thus, the configuration of storing the summation value needs a smaller storage amount than the configuration of storing the T pieces of random numbers t_{1, i} without alteration.

Using the processing device 911, the disturbance vector generation unit 362 generates the disturbance vector T, based on the integer N which is the public key pk stored by the public key storage unit 302 and the 2T pieces of random numbers t_{1,i} and t_{2, i} generated by the random number generation unit 303. The disturbance vector T is a T-dimensional vector (t₁, t₂, . . . , t_{T}) having components of integers not less than 0 and less than N². The ith component tᵢ (i being the integer not less than 1 and not more than T) of the disturbance vector T is a remainder when the product of a sum (1+t_{1, i}N) and an integer t_{2, i}^{N} is divided by the square of the integer N. The sum (1+t_{1, i}N) is obtained by adding 1 to the product of the random number t_{1,i} and the integer N. The integer t_{2, i}^{N} is obtained by exponentiating the random number t_{2, i} by the integer N. Each component tᵢ of the disturbance vector T is obtained by encrypting the random number t_{1, i}.

Using the processing device 911, the integer combining unit 386 generates the second challenge Ĉ, based on the integer N which is the public key pk stored by the public key storage unit 403, the encrypted feature vector C′ generated by the encrypted data extraction unit 305, and the disturbance vector T calculated by the disturbance vector generation unit 362. The second challenge Ĉ is constituted from T integers of ĉ₁, ĉ₂, . . . , ĉ_{T}. The T integers ĉᵢ are integers not less than 0 and less than N². The ith integer ĉᵢ (i being the integer not less than 1 and not more than T) of the second challenge Ĉ is a remainder when the product of the ith component c′ᵢ of the encrypted feature vector C′ and ith component tᵢ of the disturbance vector T is divided by the square of the integer N. Each integer ĉᵢ of the second challenge Ĉ is obtained by encrypting a sum bᵢb′ᵢ+t_{1, i} of bᵢb′ᵢ encrypted by the component of the encrypted feature vector C′ and the random number t_{1, i}.

The sequence of the T integers ĉᵢ of the second challenge Ĉ may be different from the sequence of the components of the feature vectors b and b′.

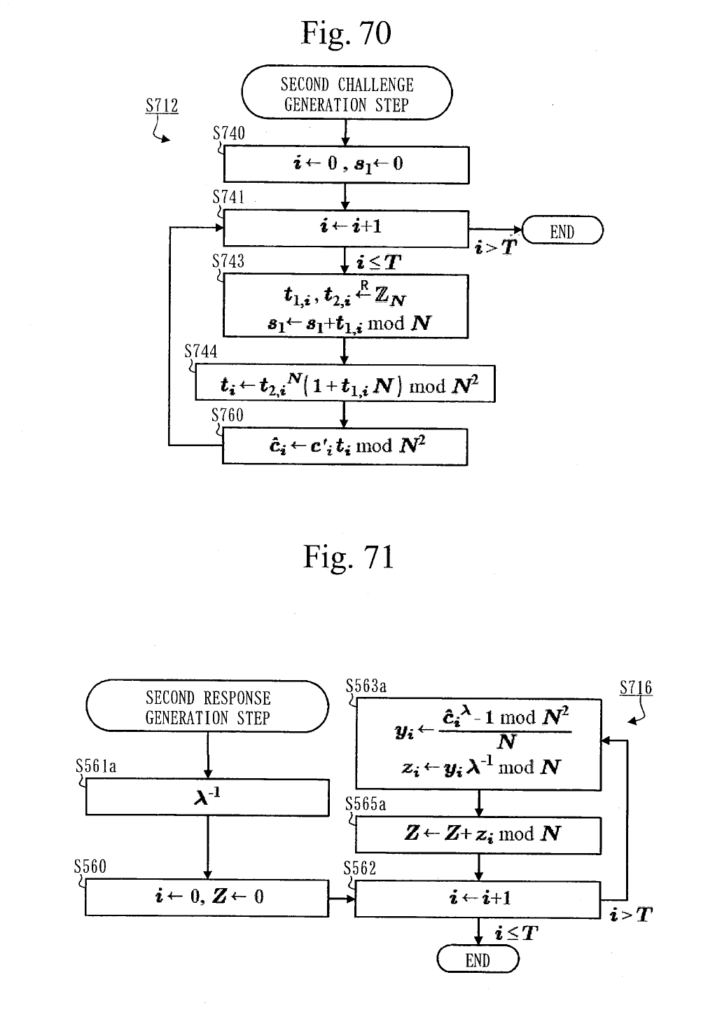

FIG. 70 is a flow chart diagram showing an example of a flow of processes of the second challenge generation step S712 in this embodiment.

In the second challenge generation step S712, the authentication apparatus 102 generates the second challenge Ĉ, based on the encrypted feature vector C′. The second challenge generation step S712 includes the initialization step S740, the repetition step S741, the random number generation step S743, the disturbance vector generation step S744, and an integer combining step S760, for example.

First, in the initialization step S740, using the processing device 911, the integer combining unit 386 initializes the integer i to 0. Using the processing device 911, the random number storage unit 322 initializes the integer s₁ to 0. Then, the random number storage unit 322 stores the initialized integer s₁, using the storage device 914.

In the repetition step S741, using the processing device 911, the integer combining unit 386 adds 1 to the integer i. When the integer i is larger than T, the integer combining unit 386 finishes the second challenge generation step S712. When the integer is not more than T, the integer combining unit 386 causes the procedure to proceed to the random number generation step S743 to generate the ith integer ĉᵢ of the second challenge Ĉ.

In the random number generation step S743, using the processing device 911, the random number generation unit 303 generates two random numbers t_{1,i}, and t_{2, i}. The random number storage unit 322 adds the random number t_{1,i} generated by the random number generation unit 303 to the integer s₁, using the processing device 911, and then stores the integer s₁ resulting from the calculation, using the storage device 914.

In the disturbance vector generation step S744, using the processing device 911, the disturbance vector generation unit 362 calculates the ith component tᵢ of the disturbance vector T, based on the two random numbers t_{1, i} and t_{2, i} generated by the random number generation unit 303 in the random number generation step S743.

In the integer combining step S760, using the processing device 911, the integer combining unit 386 calculates the ith integer ĉᵢ of the second challenge Ĉ, based on the ith component c′ᵢ of the encrypted feature vector C′ generated by the encrypted data extraction unit 305 and the ith component tᵢ of the disturbance vector T calculated by the disturbance vector generation unit 362 in the disturbance vector generation step S744.

The integer combining unit 386 causes the procedure to return to the repetition step S741 to generate the subsequent integer of the second challenge Ĉ.

The second challenge Ĉ calculated by the encrypted random similarity degree calculation unit 314 in this manner is transmitted to the decryption apparatus 103 by the second challenge transmitting unit 321. The decryption apparatus 103 receives and then processes the second challenge Ĉ.

Since the decryption unit 404 of the decryption apparatus 103 has the same configuration as that described in the seventh embodiment, a description will be given with reference to FIG. 66.

The decryption unit 404 of the decryption apparatus 103 includes the inverse number calculation unit 481, the decrypted integer calculation unit 482, and the integer combining unit 485, for example.

Using the processing device 911, the inverse number calculation unit 481 calculates the inverse number λ⁻¹ of the integer λ in multiplication of integers modulo N, based on the integer N which is the public key pk stored by the public key storage unit 403 and the integer λ which is the secret key sk stored by the secret key storage unit 413.

Using the processing device 911, the decrypted integer calculation unit 482 calculates T integers zᵢ (i being each integer not less than 1 and not more than T), based on the integer λ which is the secret key sk stored by the secret key storage unit 413, the second challenge Ĉ received by the second challenge receiving unit 402, and the inverse number λ⁻¹ calculated by the inverse calculation unit 481. The integers zᵢ are integers not less than 0 and less than N. The ith integer zᵢ (i being the integer not less than 1 and not more than T+1) is an integer obtained by decrypting the ith integer ĉᵢ of the second challenge Ĉ. The integer zᵢ is equal to the sum bᵢb′ᵢ+t_{1,i} of the random number t_{1, i} and the product of the corresponding components bᵢ and b′ᵢ of the two feature vectors b.

Using the processing device 911, the integer combining unit 485 calculates the second response Z, based on the integer N which is the public key pk stored by the public key storage unit 403 and the T integers zᵢ calculated by the decrypted integer calculation unit 482. The second response Z is an integer not less than 0 and not more than N. The second response Z calculated by the integer combining unit 485 is a remainder when the summation of the T integers z′ᵢ is divided by the integer N. The second response Z is equal to the sum of the inner product Σᵢ[bᵢb′ᵢ] between the feature vector b and the feature vector b′ and the summation value s₁=Σᵢ[t_{1,i}] of the random numbers t_{1,i}. That is, the second response Z is obtained by encrypting the inner product between the feature vector b and the feature vector b′ by the random number s₁ as a temporary key.

FIG. 71 is a flow chart diagram showing an example of a flow of processes of the second response generation step S716 in this embodiment.

Though the flow of processes of the second response generation step S716 is almost the same as that in the seventh embodiment, there are two differences between the flows of processes of the second response generation steps S716 in the seventh embodiment and the eighth embodiment.

The first difference is that there are no decrypted integer calculation step S566a and no integer combining step S568a, and the initialization step S560 is executed subsequently to the inverse number calculation step S561a.

The second difference is that, in the initialization step S560, the integer combining unit 485 initializes the second response Z to 0, using the processing device 911.

The second response Z generated by the decryption unit 404 in this manner is transmitted to the authentication apparatus 102 by the second response transmitting unit 412. The authentication apparatus 102 receives and then processes the second response Z.

The plaintext similarity degree extraction unit 315 of the authentication apparatus 102 has the same configuration as that in the sixth embodiment.

The plaintext similarity degree extraction unit 315 calculates the inner product Σᵢ[bᵢb′ᵢ] between the two feature vectors b and b′, as the similarity degree d.

The determination unit 306 determines that the two feature vectors b and b′ are similar when the similarity degree d calculated by the discrete logarithm calculation unit 373 is larger than the predetermined threshold value d₀.

With this arrangement, it can be determined whether the two feature vectors b and b′ are similar, using the number of matches between feature points as a reference.

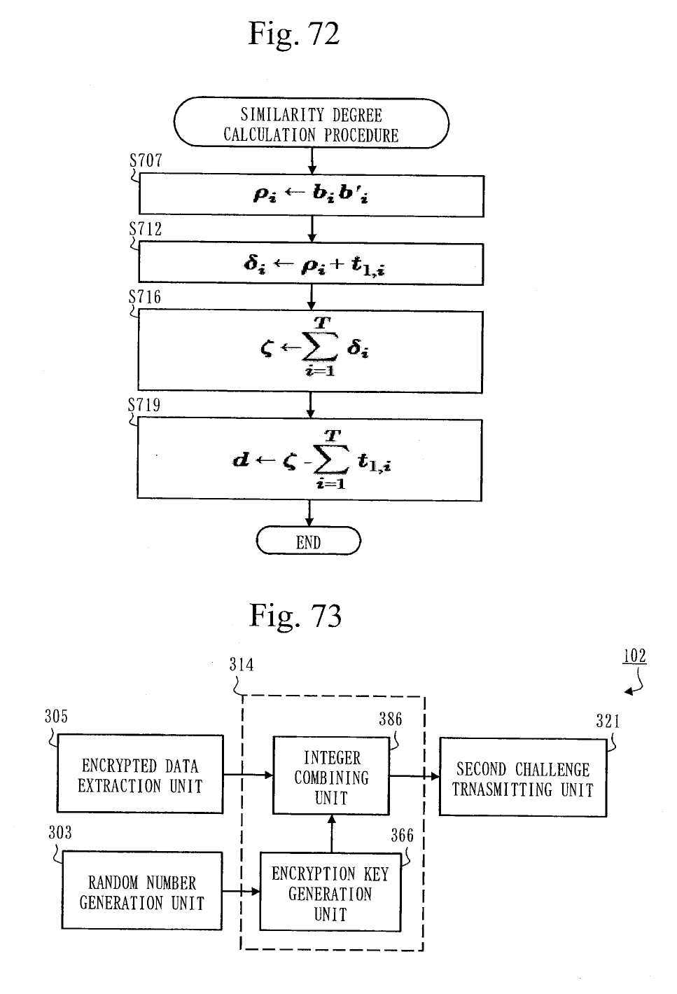

FIG. 72 is a flow chart diagram showing a similarity degree calculation procedure in the biometric authentication system 100 in this embodiment.

As a first stage, in the first response generation step S707, the certification apparatus 101 calculates the first response R′ from the first challenge R, thereby calculating T pieces of ρᵢ=bᵢb′ᵢ. This calculation is performed with the feature vectors b and b′ kept encrypted with the key of the decryption apparatus 103. Thus, the certification apparatus 101 cannot obtain information on the feature vector b.

As a second stage, in the second challenge generation step S712, the authentication apparatus 102 calculates the second challenge Ĉ from the encrypted feature vector C′, thereby calculating T pieces of δᵢ=ρᵢ+t_{1, i} (i being each integer not less than 1 and not more than T). This calculation is performed with the encrypted feature vectors C and C′ kept encrypted with the key of the decryption apparatus 103. Thus, the authentication apparatus 102 cannot obtain the information on the feature vector b, information on the feature vector b′ and information on the similarity degree.

As a third stage, in the second response generation step S716, the decryption apparatus 103 calculates the second response Z from the second challenge Ĉ, thereby calculating ξ=Σᵢ[δᵢ] (i being each integer not less than 1 and not more than T). This calculation is performed with the second challenge Ĉ decrypted with the secret key of the decryption apparatus 103. The decryption apparatus 103, however, does not know the temporary key sᵢ=Σᵢ[t_{1,i}]. Thus, the decryption apparatus 103 cannot obtain the information on the feature vector b, the information on the feature vector b′, and the information on the similarity degree. That is, this calculation is performed with a result of the decryption encrypted with the temporary key s₁.

As a fourth stage, the authentication apparatus 102 in the plaintext similarity degree calculation step S719 calculates the similarity degree d=ξ−s₁ from the second response Z. With this arrangement, the authentication apparatus 102 can obtain the similarity degree d, but cannot obtain the information on the feature vector b and the information on the feature vector b′.

The encryption system is not limited to the Paillier encryption system. It may be so configured that a different additive-homomorphic encryption system such as the Okamoto-Takashima encryption system, the BGN encryption system, or the Gentry encryption system is employed. It may be so configured that a second encryption system such as the standard public key encryption system is employed for communication between the certification apparatus 101 and the authentication apparatus 102.

The biometric authentication system 100 may be so configured that the certification apparatus 101 combines functions of the decryption apparatus 103 and the registration apparatus 104, as in the second embodiment.

### Ninth Embodiment

A ninth embodiment will be described, using FIGS. 73 to 77.

Same reference signs are given to components that are common to those in the first to eighth embodiments, thereby omitting description of the components that are common to those in the first to eighth embodiments.

In this embodiment, the description will be directed to another variation example of the configuration described in the seventh embodiment.

The encrypted feature vector C′ is a T-dimensional vector (c′₁, c′₂, . . . , C′_{T}) having components of integers not less than 0 and less than N². The ith component cᵢ (i being an integer not less than 1 and not more than T) of the encrypted feature vector C′ is obtained by encrypting the product bᵢb′ᵢ between the ith components bᵢ and b′ᵢ of feature vectors b and b′.

FIG. 73 is a detailed block diagram showing an example of a configuration of the encrypted random number generation unit 314 in this embodiment.

The encrypted random similarity degree calculation unit 314 of the authentication apparatus 102 includes the encryption key generation unit 366 and the integer combining unit 386, for example.

Using the processing device 911, the random number generation unit 303 generates two random numbers s₁ and s₂. The random numbers s₁ and s₂ are integers uniform randomly selected from among integers not less than 0 and less than N. Using the storage device 914, the random number storage unit 322 stores the random number s₁ generated by the random number generation unit 303.

Using the processing device 911, the encryption key generation unit 366 calculates the encryption key [symbol] [symbol] [symbol] , based on the integer N which is the public key pk stored by the public key storage unit 302 and the random numbers s₁ and s₂ generated by the random number generation unit 303. The encryption key [symbol] [symbol] [symbol] is an integer not less than 0 and less than N². The encryption key [symbol] [symbol] [symbol] is a remainder when the product of the sum (1+s₁N) and the integer s₂^{N} is divided by the square of the integer N. The sum (1+s₁N) is obtained by adding 1 to the product of the random number s₁ and the integer N. The integer s₂^{N} is obtained by exponentiating the random number s₂ by the integer N. The encryption key [symbol] [symbol] [symbol] is obtained by encrypting the random number s₁ as a plaintext.

Using the processing device 911, the integer combining unit 386 generates the second challenge Ĉ, based on the integer N which is the public key pk stored by the public key storage unit 302, the encrypted feature vector C′ generated by the encrypted data extraction unit 305, and the encryption key [symbol] [symbol] [symbol] calculated by the encryption key generation unit 366. The second challenge Ĉ is an integer not less than 0 and less than N². The second challenge Ĉ is a remainder when a total product Πᵢ[c′ᵢ] [symbol] [symbol] [symbol] of T components c′ᵢ of the encrypted feature vector C′ and the encryption key [symbol] [symbol] [symbol] is divided by the square of the integer N. The second challenge Ĉ is obtained by encrypting a sum Σᵢ[bᵢb′ᵢ]+s₁ of the random number sᵢ as the plaintext and the summation of encrypted bᵢb′ᵢ which are the components of the encrypted feature vector C′ (or the inner product of two feature vectors b and b′).

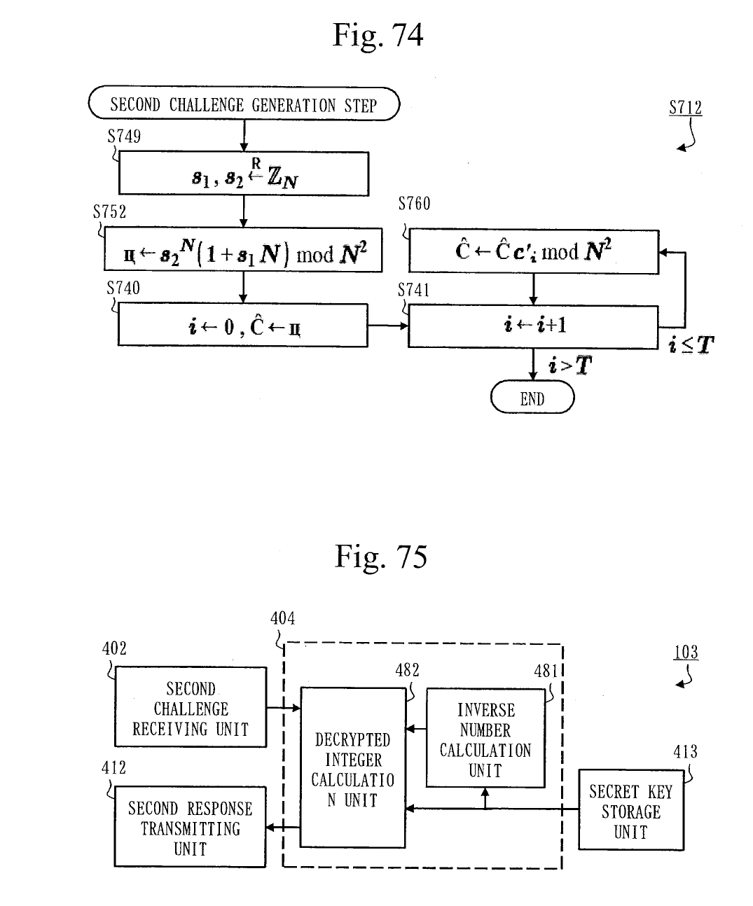

FIG. 74 is a flow chart diagram showing an example of a flow of processes of the second challenge generation step S712 in this embodiment.

In the second challenge generation step S712, the authentication apparatus 102 generates the second challenge Ĉ, based on the encrypted feature vector C′. The second challenge generation step S712 includes the random number generation step S749, the encryption key generation step S752, the initialization step S740, the repetition step S741, and the integer combining step S760, for example.

First, in the random number generation step S749, using the processing device 911, the random number generation unit 303 generates two random numbers s₁ and s₂. The random number storage unit 322 stores the integer s₁, using the storage device 914.

In the encryption key generation step S752, using the processing device 911, the encryption key generation unit 366 calculates the encryption key u, based on the two random numbers s₁ and s₂ generated by the random number generation unit 303 in the random number generation step S749.

In the initialization step S740, using the processing device 911, the integer combining unit 386 initializes the integer i to 0, and initializes the second challenge Ĉ to the encryption key u calculated by the encryption key generation unit 366 in the encryption key generation step S752.

In the repetition step S741, using the processing device 911, the integer combining unit 386 adds 1 to the integer i. When the integer i is larger than T, the second challenge C′ has been completed. Thus, the integer combining unit 386 finishes the second challenge generation step S712. When the integer i is not more than T, the integer combining unit 386 causes the procedure to proceed to the integer combining step S760.

In the integer combining step S760, using the processing device 911, the integer combining unit 386 combines the ith component c′ᵢ of the encrypted feature vector C′ generated by the encrypted data extraction unit 305 with the second challenge Ĉ, by multiplication of integers modulo the square of the integer N.

The integer combining unit 386 causes the procedure to return to the repetition step S741.

The second challenge Ĉ generated by the encrypted random similarity degree calculation unit 314 in this manner is transmitted to the decryption apparatus 103 by the second challenge transmitting unit 321. The decryption apparatus 103 receives and then processes the second challenge Ĉ.

FIG. 75 is a detailed block diagram showing an example of a configuration of the decryption unit 404 in this embodiment.

The decryption unit 404 of the decryption apparatus 103 includes the inverse number calculation unit 481 and the decrypted integer calculation unit 482, for example.

Using the processing device 911, the inverse number calculation unit 481 calculates the inverse number λ⁻¹ of the integer λ in multiplication of integers modulo N, based on the integer N which is the public key pk stored by the public key storage unit 403 and the integer λ which is the secret key sk stored by the secret key storage unit 413.

Using the processing device 911, the decrypted integer calculation unit 482 calculates the second response Z, based on the integer λ which is the secret key sk stored by the secret key storage unit 413, the second challenge Ĉ received by the second challenge receiving unit 402, and the inverse number λ⁻¹ calculated by the inverse calculation unit 481. The second response Z is an integer not less than 0 and less than N. The second response Z is the integer obtained by decrypting the second challenge Ĉ. The second response Z is equal to the sum of the random number s₁ and the inner product Σᵢ[bᵢb′ᵢ] between the feature vector b and the feature vector b′. That is, the second response Z is obtained by encrypting the inner product of the feature vector b and the feature vector b′ by the random number s₁ as the temporary key.

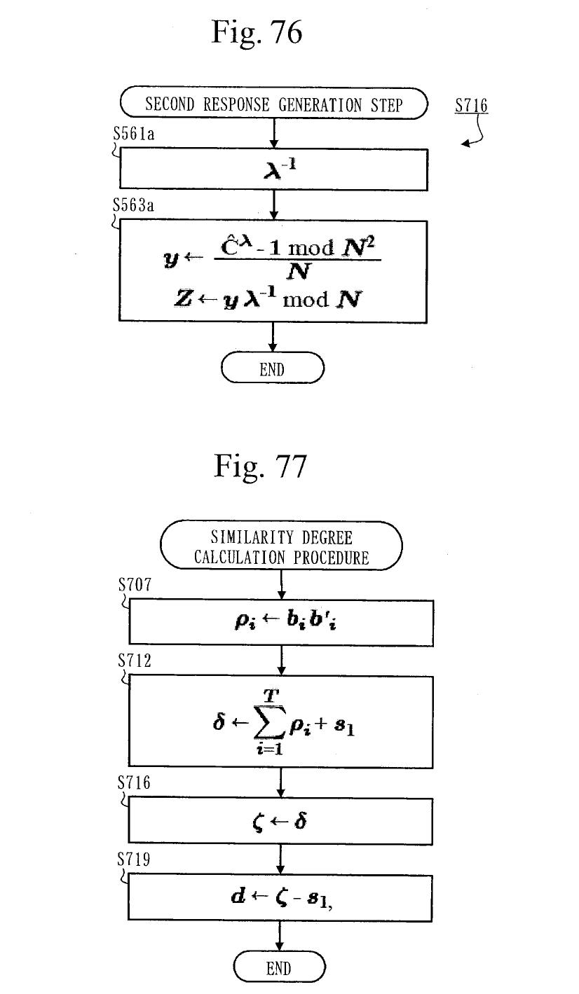

FIG. 76 is a flow chart diagram showing an example of a flow of processes of the second response generation step S716 in this embodiment.

In the second response generation step S716, the decryption apparatus 103 generates the second response Z from the second challenge Ĉ. The second response generation step S716 includes the inverse number calculation step S561a and the decrypted integer calculation step S563a, for example.

First, in the inverse number calculation step S561a, using the processing device 911, the inverse number calculation unit 481 calculates the inverse number λ⁻¹ of the integer λ which is the secret key sk stored by the secret key storage unit 413.

In the decrypted integer calculation step S563a, using the processing device 911, the decrypted integer calculation unit 482 decrypts the second challenge Ĉ received by the second challenge receiving unit 402 to calculate the second response Z, based on the inverse matrix λ⁻¹ calculated by the inverse number calculation unit 481 in the inverse number calculation step S561a and the like. To take an example, the decrypted integer calculation unit 482 calculates the quotient y. The quotient y is obtained by dividing an integer (Ĉ^{λ}−1) by the square of the integer N. The integer (Ĉ−1) is obtained by subtracting 1 from an integer resulting from exponentiation of the second challenge Ĉ by the integer λ. The decrypted integer calculation unit 482 calculates a remainder when the product yλ⁻¹ of the calculated quotient y and the inverse number λ⁻¹ is divided by the integer N, and then sets the remainder to the second response Z.

The second response Z generated by the decryption unit 404 in this manner is transmitted to the authentication apparatus 102 by the second response transmitting unit 412. The authentication apparatus 102 receives and then processes the second response Z.

The plaintext similarity degree extraction unit 315 of the authentication apparatus 102 has the same configuration as that in the sixth embodiment.

The plaintext similarity degree extraction unit 315 calculates the inner product Σᵢ[bᵢb′ᵢ] between the two feature vectors b and b′, as the similarity degree d.

The determination unit 306 determines that the two feature vectors b and b′ are similar when the similarity degree d calculated by the discrete logarithm calculation unit 373 is larger than the predetermined threshold value d₀.

With this arrangement, it can be determined whether or not the two feature vectors b and b′ are similar, using the number of matches between feature points as a reference.

FIG. 77 is a flow chart diagram showing a similarity degree calculation procedure in the biometric authentication system 100 in this embodiment.

As a first stage, in the first response generation step S707, the certification apparatus 101 calculates the first response R′ from the first challenge R, thereby calculating T pieces of ρᵢ=bᵢb′ᵢ. This calculation is performed with the two feature vectors b and b′ kept encrypted with the key of the decryption apparatus 103. Thus, the certification apparatus 101 cannot obtain information on the feature vector b.

As a second stage, in the second challenge generation step S712, the authentication apparatus 102 calculates the second challenge Ĉ from the encrypted feature vector C′, thereby calculating δ=Σᵢ[bᵢb′ᵢ]+s₁ (i being each integer not less than 1 and not more than T). This calculation is performed with the encrypted feature vectors C and C′ kept encrypted with the key of the decryption apparatus 103. Thus, the authentication apparatus 102 cannot obtain the information on the feature vector b and information on the feature vector b′.

As a third stage, in the second response generation step S716, the decryption apparatus 103 calculates the second response Z from the second challenge Ĉ, thereby calculating ξ. Since the decryption apparatus 103 just performs decryption processing, ξ is equal to δ. The decryption apparatus 103 does not know the temporary key s₁. Thus, the decryption apparatus 103 cannot obtain the information on the feature vector b, the information on the feature vector b′, and information on the similarity degree. That is, this calculation is performed with a result of the decryption encrypted with the temporary key s₁.

As a fourth stage, in the plaintext similarity degree calculation step S719, the authentication apparatus 102 calculates the similarity degree d=ξ−s₁ from the second response Z. With this arrangement, the authentication apparatus 102 can obtain the similarity degree d, but cannot obtain the information on the feature vector b and the information on the feature vector b′.

The encryption system is not limited to the Paillier encryption system. It may be so configured that a different additive-homomorphic encryption system such as the Okamoto-Takashima encryption system, the BGN encryption system, or the Gentry encryption system is employed. It may be so configured that a second encryption system such as the standard public key encryption system is employed for communication between the certification apparatus 101 and the authentication apparatus 102.

The biometric authentication system 100 may be so configured that the certification apparatus 101 combines functions of the decryption apparatus 103 and the registration apparatus 104, as in the second embodiment.

### Tenth Embodiment

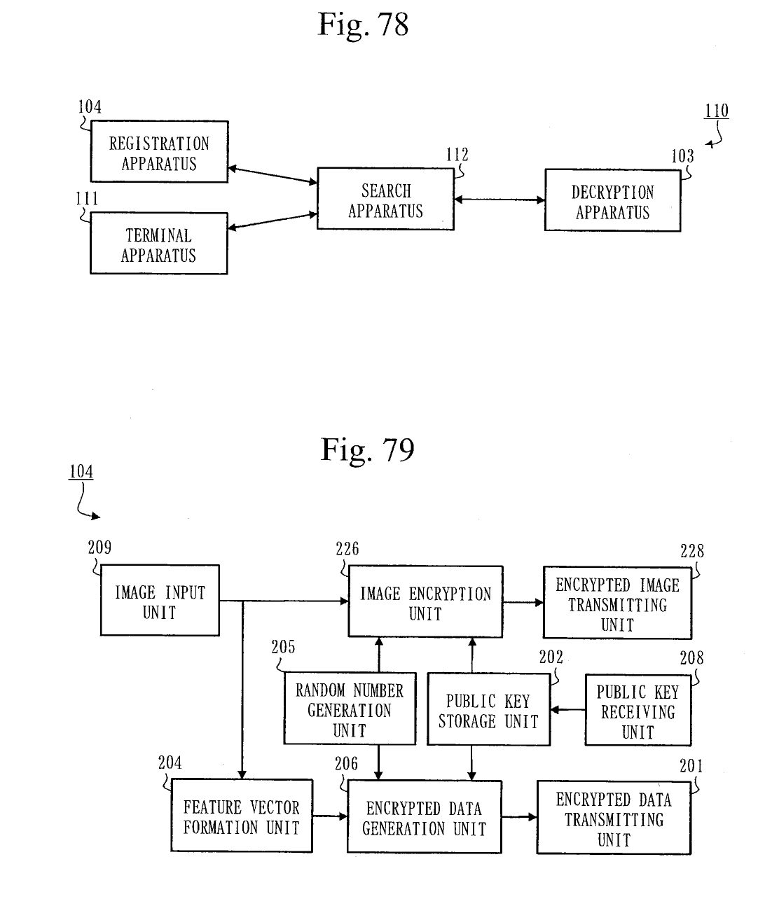

A tenth embodiment will be described, using FIGS. 78 to 81.

Same reference signs are given to components that are common to those in the first to ninth embodiments, thereby omitting description of the components that are common to those in the first to ninth embodiments.

FIG. 78 is a system configuration diagram showing an example of an overall configuration of an image search system 110.

The image search system 110 is a system for searching an image similar to a specified image from among registered images with image data of the registered images kept encrypted.

The image search system 110 (similarity degree calculation system) includes a terminal apparatus 111, a search apparatus 112, the decryption apparatus 103, and the registration apparatus 104, for example.

The registration apparatus 104 inputs image data, and then extracts from the input image data a feature of each image represented by the image data, thereby generating the feature vector b. The registration apparatus 104 encrypts the generated feature vector b to generate the encrypted feature vector C. The registration apparatus 104 encrypts the input image data to generate encrypted image data. The registration apparatus 104 registers the encrypted feature vector C and the encrypted image data in the search apparatus 112. It may be so configured that the encrypted image data is stored in a location different from the search apparatus 112, and that the encrypted feature vector C and data indicating the location of the encrypted image data are registered in the search apparatus 112.

The terminal apparatus 111 receives image data and extracts from the input image data a feature of an image represented by the image data, thereby generating the feature vector b′. The terminal apparatus 111 encrypts the generated feature vector b′ to generate the encrypted feature vector C′. The terminal apparatus 112 requests the search apparatus 112 to make a search.

The search apparatus 112 stores a plurality of the encrypted feature vectors C registered in the registration apparatus 104. The search apparatus 112 calculates the similarity d, based on each of the stored encrypted feature vectors C and the encrypted feature vector C′ transmitted from the terminal apparatus 111, based on the request for the search from the terminal apparatus 111. The search apparatus 112 determines the image similar to the specified image from among the registered images, based on the calculated similarity degree d, and returns the encrypted image data of the determined image or the data indicating the location of the encrypted image data to the terminal apparatus 111.

Hardware configurations of the terminal apparatus 111, the search apparatus 112, the decryption apparatus 103, and the registration apparatus 104 are the same as those described in the first embodiment.

FIG. 79 is a block configuration diagram showing an example of a functional block configuration of the registration apparatus 104 in this embodiment.

The registration apparatus 104 includes the public key receiving unit 208, the public key storage unit 202, an image input unit 209, the feature vector formation unit 204, the random number generation unit 205, the encrypted data generation unit 206, the encrypted data transmitting unit 201, an image encryption unit 226, and an encrypted image transmitting unit 228, for example.

The public key receiving unit 208 (public key acquisition unit) receives the public key pk of the decryption apparatus 103, using the input device 912 such as a communication device. The public key pk of the decryption apparatus 103 is a public key corresponding to the secret key sk stored by the decryption apparatus 103 in secret. Data encrypted with the public key pk of the decryption apparatus 103 can be decrypted only with the secret key sk stored by the decryption apparatus 103.

The public key storage unit 202 stores the public key pk received by the public key receiving unit 208, using the storage device 914.

The image input unit 209 inputs the image data to be registered, using the input device 912.

Using the processing device 911, the feature vector formation unit 204 (comparison data acquisition unit) generates the feature vector b (comparison data) from the image data input by the image input unit 209. The feature vector b is a T-dimensional vector having components of integers, for example.

Using the processing device 911, the random number generation unit 205 generates random numbers to be used when encrypting the feature vector b and the image data.

Using the processing device 911, the encrypted data generation unit 206 (comparison ciphertext generation unit) generates the encrypted feature vector C (comparison ciphertext), based on the public key stored by the public key storage unit 202, the feature vector b generated by the feature vector formation unit 204, and the random numbers generated by the random number generation unit 205. The encrypted feature vector C is a T-dimensional vector having components of ciphertexts. Each component of the encrypted feature vector C is obtained by encrypting each component of the feature vector b.

The encrypted data transmitting unit 201 (comparison ciphertext notification unit) transmits the encrypted feature vector C to the search apparatus 112, using the output device 913 such as a communication device, in order to register the encrypted feature vector C generated by the encrypted data generation unit 206 in the search apparatus 112.

Using the processing device 911, the image encryption unit 226 generates the encrypted image data, based on the public key stored by the public key storage unit 202, the image data input by the image input unit 209, and the random numbers generated by the random number generation unit 205. The encrypted image data is obtained by encrypting the image data. An encryption system to be used when the image encryption unit 226 encrypts the image data may be the same encryption system as that to be used when the encrypted data generation unit 206 encrypts the feature vector b, or may be a different encryption system.

The encrypted image transmitting unit 228 transmits the encrypted image data to the search apparatus 112 together with the encrypted feature vector C to be transmitted by the encrypted data transmitting unit 201, using the output device 913 such as the communication device, in order to register the encrypted image data generated by the image encryption unit 226. It may be so configured that the encrypted image data is not registered in the search apparatus 112, but is registered in a different apparatus. It may also be so configured that the registration apparatus 104 itself stores the encrypted image data. In that case, the encrypted image transmitting unit 228 transmits to the search apparatus 112 the data indicating the location of the encrypted image data such as the URI (unified resource identifier) of the encrypted image data.

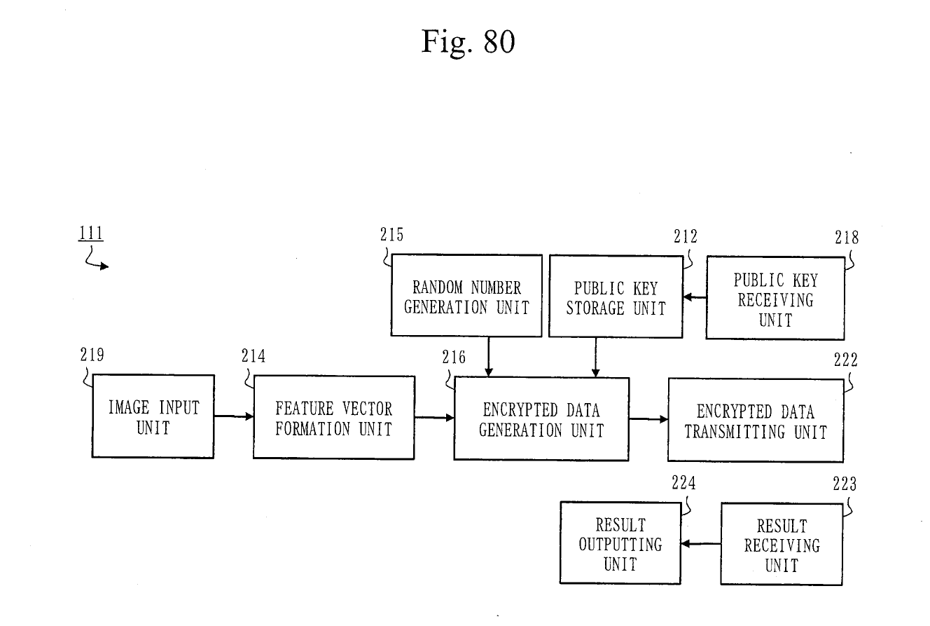

FIG. 80 is a block configuration diagram showing an example of a functional block configuration of the terminal apparatus 111 in this embodiment.

The terminal apparatus 111 includes the public key receiving unit 218, the public key storage unit 212, an image input unit 219, the feature vector formation unit 214, the random number generation unit 215, an encrypted data generation unit 216, an encrypted data transmitting unit 222, a result receiving unit 223, and a result outputting unit 224, for example.

The public key receiving unit 218 (public key acquisition unit) receives the public key pk of the decryption apparatus 103, using the input device 912 such as a communication device.

Using the storage device 914, the public key storage unit 202 stores the public key pk received by the public key receiving unit 218.

The image input unit 219 inputs the image data from which the similar image should be searched, using the input device 912.

The feature vector formation unit 214 (target data acquisition unit) generates the feature vector b′ (target data) from the image data input by the image input unit 219, using the processing device 911. The feature vector b′ is a T-dimensional vector having components of integers, for example.

Using the processing device 911, the random number generation unit 215 generates random numbers to be used when encrypting the feature vector b′.

Using the processing device 911, the encrypted data generation unit 216 (target ciphertext generation unit) generates the encrypted feature vector C′ (target ciphertext), based on the public key stored by the public key storage unit 212, the feature vector b′ generated by the feature vector formation unit 214, and the random numbers generated by the random number generation unit 215. The encrypted feature vector C′ is a T-dimensional vector having components of ciphertexts. Each component of the encrypted feature vector C′ is obtained by encrypting each component of the feature vector b′.

Using the output device 913 such as a communication device, the encrypted data transmitting unit 222 (target ciphertext notification unit) transmits to the search apparatus 112 the encrypted feature vector C′ generated by the ciphertext data generation unit 216 in order to search the image similar to that represented by the image data input by the image input unit 219.

Using the input device 912 such as the communication device, the result receiving unit 223 receives a result of the search transmitted by the search apparatus 112. The result of the search is the encrypted image data itself representing the image similar to that represented by the image data input by the image input unit 219 or the data indicating the location of the encrypted image data, for example.

Using the output device 913 such as a display device, the result outputting unit 224 outputs the result of the search received by the result receiving unit 223. The result outputting unit 224 displays the number of the images similar to the image represented by the image data input by the image input unit 219, for example. Alternatively, it may be so configured that the result outputting unit 224 displays the image by decryption of the encrypted image data.

Different from the certification apparatus 101 described in the first to ninth embodiments, the terminal apparatus 111 transmits the encrypted feature vector C′ without alteration. In an authentication system, it is necessary to prevent spoofing using a replay attack. On contrast therewith, the terminal apparatus 111 in the image search system 110 in this embodiment can just obtain the encrypted image data that has been encrypted, as the result of the search. If the terminal apparatus 111 has no authorization of decrypting the encrypted image data, the terminal apparatus 111 cannot display the searched image. Thus, the need for preventing the replay attack is eliminated.

However, the terminal apparatus 111 may be configured to receive the first challenge R from the search apparatus 112, to generate the first response R′ based on the received first challenge R and the feature vector b′, and then to transmit the generated first response R′ to the search apparatus 112, like the certification apparatus 101 described in each of the first to ninth embodiments.

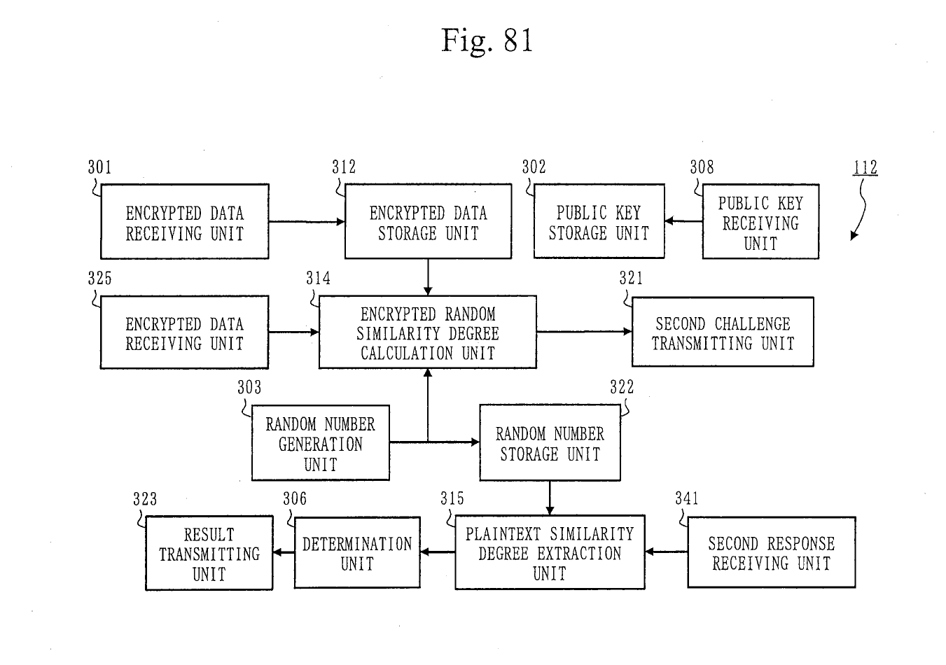

FIG. 81 is a block configuration diagram showing an example of a functional block configuration of the search apparatus 112 in this embodiment.

The search apparatus 112 includes the public key receiving unit 308, the public key storage unit 302, the encrypted data receiving unit 301 and an encrypted data receiving unit 325 which are two encrypted data receiving units, the encrypted data storage unit 312, the random number generation unit 303, the random number storage unit 322, the encrypted random similarity degree calculation unit 314, the second challenge transmitting unit 321, the second response receiving unit 341, the plaintext similarity degree extraction unit 315, the determination unit 306, and a result transmitting unit 323.

Using the input device 912 such as a communication device, the public key receiving unit 308 (public key acquisition unit) receives the public key pk of the decryption apparatus 103.

Using the storage device 914, the public key storage unit 302 stores the public key pk received by the public key receiving unit 308.

The encrypted data receiving unit 301 (comparison ciphertext acquisition unit) receives the encrypted feature vector C transmitted by the registration apparatus 104, using the input device 912 such as the communication device.

The encrypted data storage unit 312 (comparison ciphertext storage unit) stores the encrypted feature vector C received by the encrypted data receiving unit 301, using the storage device 914. The encrypted data storage unit 312 associates the plurality of the encrypted feature vectors C with the data indicating the locations of the encrypted image data.

The encrypted data receiving unit 325 (target ciphertext acquisition unit) receives the encrypted feature vector C′ transmitted by the terminal apparatus 111, using the input device 912 such as the communication device.

Using the processing device 911, the random number generation unit 303 generates random numbers to be used for generation of the second challenge Ĉ.

Using the storage device 914, the random number storage unit 322 stores the random numbers as plaintexts out of the random numbers generated by the random number generation unit 303.

Using the processing device 911, the encrypted random similarity degree calculation unit 314 generates the second challenge Ĉ, based on the encrypted feature vector C′ received by the encrypted data receiving unit 325 and the random numbers generated by the random number generation unit 303 for each of the encrypted feature vectors C stored by the encrypted data storage unit 312.

The second challenge transmitting unit 321 transmits the second challenge Ĉ generated by the encrypted random similarity degree calculation unit 314 to the decryption apparatus 103, using the output device 913 such as a communication device.

The second response receiving unit 341 receives the second response Z transmitted by the decryption apparatus 103, as a response for the second challenge Ĉ transmitted by the second challenge transmitting unit 321, using the input device 912 such as the communication device.

Using the processing device 911, the plaintext similarity degree extraction unit 315 calculates the similarity degree d, based on the random numbers stored by the random number storage unit 322 and the second response Z received by the second response receiving unit 341.

Using the processing device 911, the determination unit 306 determines the image similar to the image represented by the image data input by the terminal apparatus 111, based on the similarity degree d calculated by the plaintext similarity degree extraction unit 315. Assume that the similarity degree d is the square of the Euclidean distance or the like which indicates that the feature vectors b and b′ are more similar as the similarity degree d becomes smaller. Then, when the similarity degree d is smaller than the predetermined threshold value d₀, the determination unit 306 determines that the image having the similarity degree d is similar to the image represented by the image data input by the terminal apparatus 111. When the number of images having the similarity degrees d smaller than the threshold value d₀ is larger than a predetermined number, the determination unit 306 may be configured to determine that only the predetermined number of images having the similarity degrees d in the descending order of the similarity degrees d are similar to the image represented by the image data input by the terminal apparatus 111.

Using the output device 913 such as the communication device, the result transmitting unit 323 transmits a result determined by the plaintext similarity degree extraction unit 315 to the terminal apparatus 111.

Detailed configurations of the encrypted random similarity degree calculation unit 314, the plaintext similarity degree extraction unit 315, and the like are the same as those of the encrypted random similarity degree calculation unit 314, the plaintext similarity degree extraction unit 315, and the like of the authentication apparatus 102 described in each of the first to ninth embodiments.

The decryption apparatus 103 also has the same configuration as that of the decryption apparatus 103 described in each of the first to ninth embodiment.

By searching the image similar to the image represented by the image data input by the terminal apparatus 111 based on the similarity degree d calculated by the method described in each of the first to ninth embodiments, the image can be searched without decrypting the encrypted image data and the feature vectors.

Data to be searched is not limited to the image data. The data to be searched may be different data such as document data. Assume that the target to be searched is the document data. Then, a configuration may be considered where the number of occurrences of a predetermined word is set to the value of each feature vector component.

The configuration described in each embodiment is an example, and may be a different configuration. To take an example, a configuration that combines the configurations described in the different embodiments may be used. Alternatively, a configuration may be used where the configuration of an insignificant portion is replaced by a different configuration.

The description was directed to the configuration where the square of the Euclidean distance between the two feature vectors b and b′ is calculated as the similarity degree d and the configuration where the inner product of the two feature vectors b and b′ is calculated as the similarity degree d, for example. A configuration may be employed where the similarity degree d is calculated by a different formula for computation, such as a Hamming distance between the two feature vectors b and b′ or the number of matches between feature points.

In the biometric system 100 described in each of the first to ninth embodiments, the description was directed to the configuration where the encrypted feature vector C corresponding to the first response R′ received by the first response receiving unit 331 is identified from among the encrypted feature vectors C stored by the encrypted data storage unit 312 of the authentication apparatus 102, using the user identifier, thereby generating the second challenge C′. A configuration may be employed where the similarity degree d is calculated for each encrypted feature vector C stored by the encrypted data storage unit 312, as in the image search system 110 described in the tenth embodiment. In that case, the determination unit 306 may be configured to determine a user who input biometric information to the certification apparatus 101 is the user having the encrypted feature vector C determined to be most similar, for example.

In each of the first to ninth embodiments, the description was given about the biometric authentication system 100 that performs authentication based on biometric information. An authentication system that performs authentication based on different information may be used.

Further, the similarity degree calculation system described above is not limited to the authentication system or the search system, but may be applied to other various systems.

The similarity degree calculation apparatus (authentication apparatus 102; or search apparatus 112) described above calculates a similarity degree (d) between comparison data (feature vector b) and target data (feature vector b′).

The similarity degree calculation apparatus includes a storage device (914) that stores data, a processing device (911) that processes the data, a comparison ciphertext storage unit (encrypted data storage unit 312), a target ciphertext acquisition unit (encrypted data extraction unit 305; or encrypted data receiving unit 325), a temporary key generation unit (random number generation unit 303), an interim similarity degree ciphertext calculation unit (encrypted random similarity degree calculation unit 314), an interim similarity degree ciphertext notification unit (second challenge transmitting unit 321), an interim similarity degree decrypted text acquisition unit (second response receiving unit 341), and a similarity degree calculation unit (plaintext similarity degree extraction unit 315).

Using the storage device, the comparison ciphertext storage unit stores a comparison ciphertext (encrypted feature vector C) obtained by transforming the comparison data by encryption transformation using a public key (pk) corresponding to a secret key (sk) stored by a decryption apparatus (103).

Using the processing device, the target ciphertext acquisition unit acquires a target ciphertext (encrypted feature vector C′) obtained by transforming the target data by the encryption transformation using the public key.

Using the processing device, the temporary key generation unit generates a temporary key (random number u₁; or random number s₁).

Using the processing device, based on the comparison ciphertext stored by the comparison ciphertext storage unit, the target ciphertext acquired by the target ciphertext acquisition unit, and the temporary key generated by the temporary key generation unit, the interim similarity degree ciphertext calculation unit performs calculation for calculating the similarity degree in a first stage with the comparison cirphertext and the target ciphertext kept encrypted. The interim similarity degree ciphertext calculation unit calculates an interim similarity degree ciphertext (second challenge Ĉ) by encrypting a result of the calculation with the temporary key.

Using the processing device, the interim similarity degree ciphertext notification unit notifies to the decryption apparatus the interim similarity degree ciphertext calculated by the interim similarity degree ciphertext calculation unit.

Using the processing device, the interim similarity degree decrypted text acquisition unit acquires an interim similarity degree decrypted text (second response Z) calculated and notified by the decryption apparatus, based on the interim similarity degree ciphertext notified by the interim similarity degree ciphertext notification unit.

Using the processing device, the similarity degree calculation unit decrypts the interim similarity degree decrypted text with the temporary key, based on the temporary key generated by the temporary key generation unit and the interim similarity degree decrypted text acquired by the similarity degree calculating decrypted text acquisition unit, thereby calculating the similarity degree between the comparison data and the target data.

The similarity degree calculation system (biometric authentication system 100; or image search system 110) described above includes the similarity degree calculation apparatus (authentication apparatus 102; or search apparatus 112) and a decryption apparatus (103).

The decryption apparatus includes a storage device (914) that stores data, a processing device (911) that processes the data, a secret key storage unit (413), an interim similarity degree ciphertext acquisition unit (second challenge receiving unit 402), an interim similarity degree decrypted text calculation unit (decryption unit 404), and an interim similarity degree decrypted text notification unit (second response transmitting unit 412).

Using the storage device of the decryption apparatus, the secret key storage unit of the decryption apparatus stores the secret key (sk).

Using the processing device of the decryption apparatus, the interim similarity degree ciphertext acquisition unit of the decryption apparatus acquires the interim similarity degree ciphertext notified from the similarity degree calculation unit.

Using the processing device of the decryption apparatus, the interim similarity degree decrypted text calculation unit of the decryption apparatus decrypts the interim similarity degree ciphertext with the secret key, based on the secret key stored by the secret key storage unit of the decryption apparatus and the interim similarity degree ciphertext acquired by the interim similarity degree ciphertext acquisition unit of the decryption apparatus. The interim similarity degree decrypted text calculation unit performs calculation for calculating the similarity degree in a second stage with a result of the decryption kept encrypted with the temporary key, thereby calculating the interim similarity degree decrypted text.

Using the processing device of the decryption apparatus, the interim similarity degree decrypted text notification unit of the decryption apparatus notifies the interim similarity degree decrypted text calculated by the interim similarity degree decrypted text calculation unit of the decryption apparatus to the similarity degree calculation apparatus.

In the similarity degree calculation system (biometric authentication system 100; or image search system 110) described above,

each of the comparison data (feature vector b) and the target data (feature vector b′) is a T-dimensional vector (T being an integer not less than 1) having components of integers.

Using the processing device (911) of the similarity degree calculation apparatus (authentication apparatus 102; or search apparatus 112), the interim similarity degree ciphertext calculation unit (encrypted random similarity degree calculation unit 314) of the similarity degree calculation apparatus calculates the difference or the product of the corresponding components of the comparison data and the target data, with the comparison ciphertext (encrypted feature vector C) and the target ciphertext (encrypted feature vector C′) kept encrypted.

Using the processing device (911) of the decryption apparatus (103), the interim similarity degree ciphertext calculation unit (decryption unit 404) of the decryption apparatus decrypts the interim similarity degree ciphertext with the secret key (sk), and calculates the similarity degree (d), with the result of the decryption kept encrypted with the temporary key.

Using the processing device of the similarity degree calculation apparatus, the similarity degree calculation unit (plaintext similarity degree extraction unit 315) of the similarity degree calculation apparatus decrypts the interim similarity degree decrypted text, thereby obtaining the similarity degree.

In the similarity degree calculation system (biometric authentication system 100; or image search system 110) described above,

the encryption transformation is transformation for transforming an integer (integer not less than 0 and less than q; or integer not less than 0 and less than N) into a ciphertext (vector in a vector space V; element in a finite group G; or integer not less than 0 and less than N²). An arithmetic operation (addition in the vector space V; multiplication on the finite group G; multiplication of integers modulo N²) for combining and transforming a plurality of ciphertexts into a different ciphertext may be calculated for the ciphertext. A ciphertext obtained by combining a ciphertext (E(x1)) resulting from transformation of an arbitrary first integer (x1) and a ciphertext (E(x2)) resulting from transformation of an arbitrary second integer (x2) by the arithmetic operation for the ciphertext is a ciphertext (E(x1+x2)) resulting from transformation of the sum (x1+x2) of the first integer and the second integer.

In the similarity degree calculation system (biometric authentication system 100; or image search system 110),

each of the comparison data (feature vector b) and the target data (feature vector b′) is a T-dimensional vector (T being an integer not less than 1) having each component of an integer (bᵢ or b′ᵢ).

The comparison ciphertext (encrypted feature vector C) is a T-dimensional vector having a component of a ciphertext (cᵢ) obtained by transforming each component of the comparison data by the encryption transformation using the public key (pk).

The target ciphertext (encrypted feature vector C′) is a T-dimensional vector having a component of a ciphertext (c′ᵢ) obtained by transforming each component of the target data by the encryption transformation using the public key.

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores a public key (pk) corresponding to the secret key (sk) stored by the decryption apparatus (103).

Using the processing device (911) of the similarity degree calculation apparatus, the temporary key generation unit (random number generation unit 303) of the similarity degree calculation apparatus randomly generates an integer (u₁), and sets the generated integer to the temporary key.

The interim similarity degree ciphertext calculation unit (encrypted random similarity degree calculation unit 314) of the similarity degree calculation apparatus includes a random number plaintext generation unit (disturbance vector generation unit 362), a first ciphertext calculation unit (vector combining unit 363), and a second ciphertext calculation unit (vector summation unit 367).

Using the processing device of the similarity degree calculation apparatus, the random number plaintext generation unit of the similarity degree calculation apparatus generates a T-dimensional vector having a component of an integer (t_{1, i}), and sets the generated T-dimensional vector to a random number plaintext (disturbance vector T).

Using the processing device of the similarity degree calculation apparatus, the first ciphertext calculation unit of the similarity degree calculation apparatus calculates a first interim similarity degree ciphertext using the arithmetic operation for the ciphertext, based on the comparison ciphertext stored by the comparison ciphertext storage unit (encrypted data storage unit 312) of the similarity degree calculation apparatus, the target ciphertext acquired by the target ciphertext acquisition unit (encrypted data extraction unit 305; or encrypted data receiving unit 325) of the similarity degree calculation apparatus, and the random number plaintext generated by the random number plaintext generation unit of the similarity degree calculation apparatus. The first interim similarity degree ciphertext is a T-dimensional vector having a component of a ciphertext (ĉᵢ) obtained by transforming a sum (bᵢ−b′ᵢ+t_{1, i}) of a difference between each component of the comparison data and the corresponding component of the target data and the corresponding component of the random number plaintext by the encryption transformation using the public key.

Using the processing device of the similarity degree calculation apparatus, the second ciphertext calculation unit of the similarity degree calculation apparatus calculates a second interim similarity degree ciphertext (ĉ) using the arithmetic operation for the ciphertext, based on the comparison ciphertext stored by the comparison ciphertext storage unit of the similarity degree calculation apparatus, the target ciphertext acquired by the target ciphertext acquisition unit of the similarity degree calculation apparatus, the temporary key generated by the temporary key generation unit of the similarity degree calculation apparatus, and the random number plaintext generated by the random number plaintext generation unit of the similarity degree calculation apparatus. The second interim similarity degree ciphertext is a ciphertext obtained by transforming the sum of a correction value and the temporary key (u₁) by the encryption transformation using the public key. The correction value is an integer (Σᵢ[2t_{1, i}(bᵢ−b′ᵢ)+t_{1, i}²]) obtained by summating, for all of the components, sums of squares of the respective components of the random number plaintext and twice the products of differences between the respective components of the comparison data and the corresponding components of the target data and the corresponding components of the random number plaintext.

Using the processing device of the similarity degree calculation apparatus, the similarity degree calculating ciphertext notification unit (second challenge transmitting unit 321) of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus.

In the similarity degree calculation system (biometric authentication system 100: or image search system 110) described above,

each of the comparison data (feature vector b) and the target data (feature vector b′) is a T-dimensional vector (T being an integer not less than 1) having each component (bᵢ, or b′ᵢ) of an integer of 0 or one.

The comparison ciphertext (encrypted feature vector C) is a T-dimensional vector having a component of a ciphertext obtained by transforming each component of the comparison data by the encryption transformation using the public key (pk).

The target ciphertext is a T-dimensional vector having a component of a ciphertext obtained by transforming each component (b′ᵢ) of the target data by the encryption transformation using the public key.

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores the public key (pk) corresponding to the secret key (sk) stored by the decryption apparatus (103).

Using the processing device (911) of the similarity degree calculation apparatus, the temporary key generation unit (random number generation unit 303) of the similarity degree calculation apparatus randomly generates an integer (u₁) and sets the integer to the temporary key.

The interim similarity degree ciphertext calculation unit (encrypted random similarity degree calculation unit 314) of the similarity degree calculation apparatus includes a random number plaintext generation unit (disturbance vector generation unit 362), a first ciphertext calculation unit (vector combining unit 363), and a second ciphertext calculation unit (vector summation unit 367).

Using the processing device of the similarity degree calculation apparatus, the random number plaintext generation unit of the similarity degree calculation apparatus generates a T-dimensional vector having a component of an integer (t_{1, i}), and sets the generated T-dimensional vector to a random number plaintext (disturbance vector T).

Using the processing device of the similarity degree calculation apparatus, the first ciphertext calculation unit of the similarity degree calculation apparatus calculates a first interim similarity degree ciphertext using the arithmetic operation for the ciphertext, based on the comparison ciphertext stored by the comparison ciphertext storage unit (encrypted data storage unit 312) of the similarity degree calculation apparatus, the target ciphertext acquired by the target ciphertext acquisition unit (encrypted data extraction unit 305; and encrypted data receiving unit 325) of the similarity degree calculation apparatus, and the random number plaintext generated by the random number plaintext generation unit of the similarity degree calculation apparatus. The first interim similarity degree ciphertext is a T-dimensional vector having a component of a ciphertext (ĉᵢ) obtained by transforming a sum (bᵢ−b′ᵢ+t_{1, i}) of a difference between each component of the comparison data and the corresponding component of the target data and the corresponding component of the random number plaintext by the encryption transformation using the public key.

Using the processing device of the similarity degree calculation apparatus, the second ciphertext calculation unit of the similarity degree calculation apparatus calculates a second interim similarity degree ciphertext (ĉ) using the arithmetic operation for the ciphertext, based on the comparison ciphertext stored by the comparison ciphertext storage unit of the similarity degree calculation apparatus, the target ciphertext acquired by the target ciphertext acquisition unit of the similarity degree calculation apparatus, the temporary key generated by the temporary key generation unit of the similarity degree calculation apparatus, and the random number plaintext generated by the random number plaintext generation unit of the similarity degree calculation apparatus. The second interim similarity degree ciphertext is a ciphertext obtained by transforming the sum of a correction value and the temporary key by the encryption transformation using the public key. The correction value is an integer (Σᵢ[2t_{1, i}(bᵢ−b′ᵢ)+t_{1, i}²+bᵢ+b′ᵢ]) obtained by summating, for all the components, sums of squares of the respective components of the random number plaintext, the respective components of the comparison data, the respective components of the target data, and twice the products of differences between the respective components of the comparison data and the corresponding components of the target data and the corresponding components of the random number plaintext.

Using the processing device of the similarity degree calculation apparatus, the interim similarity degree ciphertext notification unit (second challenge transmitting unit 321) of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus.

In the similarity degree calculation system (biometric authentication system 100; or image search system 110) described above,

each of the comparison data (feature vector b) and the target data (feature vector b′) is a T-dimensional vector (T being an integer not less than 1) having each component (bᵢ or b′ᵢ) of an integer.

The comparison ciphertext (encrypted feature vector C) is a T-dimensional vector having a component of a ciphertext (cᵢ) obtained by transforming each component of the comparison data by the encryption transformation using the public key (pk).

The target ciphertext (encrypted feature vector C′) is a T-dimensional vector having a component of a ciphertext (c′ᵢ) obtained by transforming each component of the target data by the encryption transformation using the public key.

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores the public key (ps) corresponding to the secret key (sk) stored by the decryption apparatus (103).

Using the processing device of the similarity degree calculation apparatus, the temporary key generation unit (random number generation unit 303) of the similarity degree calculation apparatus randomly generates an integer (s₁), and sets the generated integer to the temporary key.

The interim similarity degree ciphertext calculation unit of the similarity degree calculation apparatus includes a first ciphertext calculation unit (difference calculation unit 361, and rearrangement unit 385) and a second ciphertext calculation unit (encryption key generation unit 366).

Using the processing device of the similarity degree calculation apparatus, the first ciphertext calculation unit of the similarity degree calculation apparatus calculates a first interim similarity degree ciphertext using the arithmetic operation for the ciphertext, based on the comparison ciphertext stored by the comparison ciphertext storage unit (encrypted data storage unit 312) of the similarity degree calculation apparatus and the target ciphertext acquired by the target ciphertext acquisition unit (encrypted data extraction unit 305; or encrypted data receiving unit 325) of the similarity degree calculation apparatus. The first interim similarity degree ciphertext is a T-dimensional vector having a component of a ciphertext (ĉᵢ) obtained by transforming a difference (bᵢ−b′ᵢ) between each component of the comparison data and the corresponding component of the target data by the encryption transformation using the public key.

Using the processing device of the similarity degree calculation apparatus, the second ciphertext calculation unit of the similarity degree calculation apparatus sets a ciphertext (ĉ) obtained by transformation of the temporary key by the encryption transformation using the public key to a second interim similarity degree ciphertext, based on the public key stored by the public key storage unit of the similarity degree calculation apparatus and the temporary key generated by the temporary key generation unit of the similarity degree calculation apparatus.

Using the processing device of the similarity degree calculation apparatus, the interim similarity degree ciphertext notification unit (second challenge transmitting unit 321) of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus.

In the similarity degree calculation system (biometric authentication system 100; or image search system 110) described above,

using the processing device (911) of the similarity degree calculation apparatus (authentication apparatus 102; or search apparatus 112), the first ciphertext calculation unit (difference calculation unit 361, and rearrangement unit 385) of the similarity degree calculation apparatus sets, as the first interim similarity degree ciphertext, the T-dimensional vector having components of a ciphertext randomly selected from among ciphertexts obtained by transforming the difference of each component of the comparison data from the corresponding component of the target data by the encryption transformation using the public key (pk) and ciphertexts obtained by transforming the difference of each component of the target data from the corresponding component of the comparison data by the encryption transformation using the public key, the T-dimensional vector having a sequence of the components randomly rearranged.

In the similarity degree calculation system (biometric authentication system 100; or image search system 110) described above,

using the processing device (911) of the decryption apparatus (103), the interim similarity degree decrypted text calculation unit (decryption unit 404) of the decryption apparatus calculates a difference or a sum between the summation of squares of the integers obtained by decrypting the T components of the first interim similarity degree ciphertext and the integer obtained by decrypting the second interim similarity degree ciphertext, or calculates an element obtained by combining z pieces of predetermined elements (in which z is the difference or the sum between the summation of squares of the integers obtained by decrypting the T components of the first interim similarity degree ciphertext and the integer obtained by decrypting the second interim similarity degree ciphertext) in a predetermined finite group by a group arithmetic operation on the predetermined finite group, and sets the calculated difference or the calculated sum or the calculated element to the interim similarity degree decrypted text (second response Z).

In the similarity degree calculation system (biometric authentication system 100; or image search system 110) described above,

each of the comparison data (feature vector b) and the target data (feature vector b′) is a T-dimensional vector (T being an integer not less than 1) having each component (bᵢ or b′ᵢ) of an integer.

The comparison ciphertext (encrypted feature vector C) is a T-dimensional vector having a component of a ciphertext (cᵢ) obtained by transforming each component of the comparison data by the encryption transformation using the public key (pk).

The target ciphertext (encrypted feature vector C′) is a T-dimensional vector having a component of a ciphertext (c′ᵢ) obtained by transforming each component of the target data by the encryption transformation using the public key.

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores the public key (pk) corresponding to the secret key (sk) stored by the decryption apparatus (103).

Using the processing device (911) of the similarity degree calculation apparatus, the temporary key generation unit (random number generation unit 303) of the similarity degree calculation apparatus randomly generates an integer (s₁), and sets the generated integer to the temporary key.

using the processing device of the similarity degree calculation apparatus, the interim similarity degree ciphertext calculation unit (encrypted random similarity degree calculation unit 314) of the similarity degree calculation apparatus calculates the interim similarity degree ciphertext (second challenge Ĉ) using the arithmetic operation for the ciphertext, based on the comparison ciphertext stored by the comparison ciphertext storage unit (encrypted data storage unit 312) of the similarity degree calculation apparatus and the target ciphertext acquired by the target ciphertext acquisition unit (encrypted data extraction unit 305; or encrypted data receiving unit 325) of the similarity degree calculation apparatus, and the temporary key generated by the temporary key generation unit of the similarity degree calculation apparatus. The interim similarity degree ciphertext is a ciphertext obtained by transforming a sum or a difference between a summation value and the temporary key by the encryption transformation using the public key. The summation value is an integer (Σᵢ[(bᵢ−b′ᵢ)²]; or Σᵢ[bᵢb′ᵢ]) obtained by summating a square of a difference between each component of the comparison data and the corresponding component of the target data or the product of each component of the comparison data and the corresponding component of the target data, for all the components.

In the similarity degree calculation system (biometric authentication system 100; or image search system 110),

the encryption transformation is transformation for transforming an integer not less than 0 and less than q (q being a prime number) into a ciphertext that is an n-dimensional vector (n being an integer not less than 2) in a vector space (V).

The vector space is a direct product of n cyclic groups of an order q.

The arithmetic operation for the ciphertext is addition of vectors in the vector space.

The public key (pk) includes a random base (B) that is a base of the vector space.

The encryption transformation is transformation for transforming an integer x not less than 0 and less than q into a vector obtained by adding x times a first vector (b₁) of the random base and random number times a different vector (bⱼ) of the random base.

In the similarity degree calculation system (biometric authentication system 100; or image search system 110),

the encryption transformation is transformation for transforming an integer not less than 0 and less than N (N being the product of mutually different two prime numbers p and q) into a ciphertext that is an element of a finite group (G) of an order N.

The arithmetic operation for the ciphertext is a group arithmetic operation on the finite group.

The public key (pk) includes a generator element (g) of the finite group and a disturbance element (h) that is an element of the finite group and has an order of the prime number p.

The encryption transformation is transformation for transforming an integer x not less than 0 and less than N into an element obtained by combining x pieces of the generator elements and a random number of the disturbance elements using the group arithmetic operation on the finite group.

In the similarity degree calculation system (biometric authentication system 100; or image search system 110),

the encryption transformation is transformation for transforming an integer not less than 0 and less than N (N being the product of mutually different two prime numbers p and q) into a ciphertext that is an integer not less than 0 and less than N².

The arithmetic operation for the ciphertext is multiplication of integers modulo N².

The encryption transformation is transformation for transforming an integer x not less than 0 and less than N into a remainder when the product of an Nth power of a random number and the sum of 1 and the product of the integer x and the integer N is divided by N².

The similarity degree calculation system (biometric authentication system 100; or image search system 110) further includes an encryption apparatus (certification apparatus 101; or terminal apparatus 111).

The encryption apparatus includes a storage device (914) that stores data, a processing device (911) that processes the data, a public key storage unit (212), a target data acquisition unit (feature vector formation unit 214), a temporary public key acquisition unit (first challenge receiving unit 211), a target dual encryption text calculation unit (encrypted data embedding unit 217), and a target dual encryption text notification unit (first response transmitting unit 221).

Using the storage device of the encryption apparatus, the public key storage unit of the encryption apparatus stores the public key (pk) corresponding to the secret key (sk) stored by the decryption apparatus (103).

Using the processing device of the encryption apparatus, the target data acquisition unit of the encryption apparatus acquires the target data (feature vector b′).

Using the processing device of the encryption apparatus, the temporary public key acquisition unit of the encryption apparatus acquires a temporary public key (first challenge R) notified from the similarity degree calculation apparatus (authentication apparatus 102; or search apparatus 112).

Using the processing device of the encryption apparatus, the target dual encryption text calculation unit of the encryption apparatus transforms the target data by second encryption transformation using the public key and the temporary public key, thereby calculating a target dual encryption text (first response R′), based on the public key stored by the public key storage unit of the encrypted apparatus, the target data acquired by the target data acquisition unit of the encryption apparatus, and the temporary public key acquired by the temporary public key acquisition unit of the encryption apparatus.

Using the processing device of the encryption apparatus, the target dual encryption text notification unit of the encryption apparatus notifies the target dual encryption text calculated by the target dual encryption text calculation unit of the encryption apparatus to the similarity degree calculation apparatus.

The similarity degree calculation apparatus further includes a temporary secret key generation unit (random number generation unit 303, and encrypted random number generation unit 304), a temporary public key notification unit (first challenge transmitting unit 311), and a target dual encryption text acquisition unit (first response receiving unit 331).

Using the processing device (911) of the similarity degree calculation apparatus, the temporary secret key generation unit of the similarity degree calculation apparatus generates a temporary secret key (R_{1, i}) and a temporary public key (first challenge R) corresponding to the temporary secret key.

Using the processing device of the similarity degree calculation apparatus, the temporary public key notification unit of the similarity degree calculation apparatus notifies the temporary public key generated by the temporary secret key generation unit of the similarity degree calculation apparatus to the encryption apparatus.

Using the processing device of the similarity degree calculation apparatus, the target dual encryption text acquisition unit of the similarity degree calculation apparatus acquires the target dual encryption text notified from the encryption apparatus.

Using the processing device of the similarity degree calculation apparatus, the target ciphertext acquisition unit of the similarity degree calculation apparatus transforms the target dual encryption text by second decryption transformation using the temporary secret key, based on the temporary secret key generated by the temporary secret key generation unit of the similarity degree calculation apparatus and the target dual encryption text acquired by the target dual encryption text acquisition unit of the similarity degree calculation apparatus, thereby calculating the target ciphertext (encrypted feature vector C′) obtained by transforming the target data by the encryption transformation using the public key.

In the similarity degree calculation system (biometric authentication system 100; or image search system 110) described above,

each of the comparison data (feature vector b) and the target data (feature vector b′) is a T-dimensional vector (T being an integer not less than 1) having each component (bᵢ or b′ᵢ) of an integer.

Using the processing device (911) of the similarity degree calculation apparatus (authentication apparatus 102; or search apparatus 112), the temporary secret key generation unit (random number generation unit 303, and encrypted random number generation unit 304) of the similarity degree calculation apparatus generates the temporary public key (first challenge R) including encrypted information on the comparison data, based on the comparison ciphertext (encrypted feature vector C) stored by the comparison ciphertext storage unit (encrypted data storage unit 312) of the similarity degree calculation apparatus.

Using the processing device (911) of the encryption apparatus (certification apparatus 101; or terminal apparatus 111), the target dual encryption text calculation unit (encrypted data embedding unit 217) of the encryption apparatus calculates the target dual encryption text (first response R′) including encrypted information on the product of the component of the target data and the corresponding component of the comparison data, by the second encryption transformation using the temporary public key.

In the similarity degree calculation system (biometric authentication system 100; or image search system 110) described above,

the encryption transformation is transformation for transforming an integer (integer not less than 0 and less than q; or integer not less than 0 and less than N) into a cirphertext (vector in the vector space V; element of the finite group G; or integer not less than 0 and less than N²). An arithmetic operation (addition in the vector space V; multiplication on the finite group G; or multiplication of integers modulo N′) for combining and transforming a plurality of ciphertexts into a different ciphertext may be performed for the ciphertext, and a ciphertext obtained by combining a ciphertext (E(x1)) resulting from transformation of an arbitrary first integer (x1) and a ciphertext resulting from transformation of an arbitrary second integer (x2) by the arithmetic operation for the ciphertext is a ciphertext (E(x1+x2)) resulting from transformation of a sum (x1+x2) of the first integer and the second integer.

The target data (feature vector b′) is a T-dimensional vector (T being an integer not less than 1) having components of integers.

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores the public key (pk) corresponding to the secret key (sk) stored by the decryption apparatus (103).

Using the processing device (911) of the similarity degree calculation apparatus, the temporary public key generation unit (random number generation unit 303; and encrypted random number generation unit 304) of the similarity degree calculation apparatus randomly generates a T-dimensional vector having a component of an integer (R_{1, i}), and sets the generated T-dimensional vector to the temporary secret key, and calculates a T-dimensional vector having a component of a ciphertext (Rᵢ) obtained by transforming each component of the temporary secret key by the encryption transformation using the public key, based on the public key stored by the public key storage unit of the similarity degree calculation apparatus and the generated temporary secret key, and sets the calculated T-dimensional vector to the temporary public key (first challenge R).

Using the processing device (911) of the encryption apparatus, the target dual encryption text calculation unit (encrypted data embedding unit 217) of the encryption apparatus (certification apparatus 101; or terminal apparatus 111) randomly generates a T-dimensional vector having a component of a ciphertext (oᵢ) obtained by transforming 0 by the encryption transformation using the public key, based on the public key stored by the public key storage unit (212) of the encryption apparatus, and sets the generated T-dimensional vector to a zero ciphertext (encrypted zero vector O), and calculates a T-dimensional vector having a component of a cirphetext obtained by combining b′ᵢ pieces of each component of the temporary public key (b′ᵢ being the integer indicating the corresponding component of the target data) and the corresponding component of the zero ciphertext by the arithmetic operation for the ciphertext, based on the target data acquired by the target data acquisition unit (feature vector formation unit 214) of the encryption apparatus, the temporary public key acquired by the temporary public key acquisition unit (first challenge receiving unit 211) of the encryption apparatus, and the generated zero ciphertext, and sets the calculated T-dimensional vector to the target dual encryption text (first response R′).

The target ciphertext acquisition unit (encrypted data extraction unit 305) of the similarity degree calculation apparatus includes a temporary decryption key calculation unit (inverse number calculation unit 351) and a target ciphertext calculation unit (scalar multiplication calculation unit 352).

Using the processing device of the similarity degree calculation apparatus, the temporary decryption key calculation unit of the similarity degree calculation apparatus calculates a T-dimensional vector having a component of an inverse number (κᵢ) of each component of the temporary secret key, based on the temporary secret key generated by the temporary secret key generation unit of the similarity degree calculation apparatus, and sets the calculated T-dimensional vector to a temporary decryption key.

Using the processing device of the similarity degree calculation apparatus, the target ciphertext calculation unit of the similarity degree calculation apparatus calculates a T-dimensional vector having a component of a ciphertext obtained by combining Rᵢ⁻¹ pieces of each component (R′ᵢ) of the target dual encryption text (Rᵢ⁻¹ being the inverse number indicating the corresponding component of the temporary decryption key), based on the target dual encryption text acquired by the target dual encryption text acquisition unit (first response receiving unit 331) of the similarity degree calculation apparatus and the temporary decryption key calculated by the temporary decryption key calculation unit of the similarity degree calculation apparatus, and sets the calculated T-dimensional vector to the target ciphertext (encrypted feature vector C′).

In the similarity degree calculation system (biometric authentication system 100; or image search system 110),

the encryption transformation is transformation for transforming an integer (integer not less than 0 and less than q; or integer not less than 0 and less than N) into a cirphertext (vector in the vector space V; element of the finite group G; or integer not less than 0 and less than N²). An arithmetic operation (addition in the vector space V; multiplication on the finite group G; or multiplication of integers modulo N²) for combining and transforming a plurality of ciphertexts into a different ciphertext may be performed for the ciphertext. A ciphertext obtained by combining a ciphertext (E(x1)) resulting from transformation of an arbitrary first integer (x1) and a ciphertext (E(x2)) resulting from transformation of an arbitrary second integer (x2) using the arithmetic operation for the ciphertext is a ciphertext (E(x1+x2)) resulting from transformation of a sum (x1+x2) of the first integer and the second integer.

Each of the comparison data (feature vector b) and the target data (feature vector b′) is a T-dimensional vector (T being an integer not less than 1) having each component (bᵢ, b′ᵢ) of an integer.

The comparison ciphertext (encrypted feature vector C) is a T-dimensional vector having a component of a ciphertext (cᵢ) obtained by transforming each component of the comparison data by the encryption transformation using the public key (pk).

The similarity degree calculation apparatus (authentication apparatus 102; or search apparatus 112) further includes a public key storage unit (302).

Using the storage device (914) of the similarity degree calculation apparatus, the public key storage unit of the similarity degree calculation apparatus stores the public key (pk) corresponding to the secret key (sk) stored by the decryption apparatus (103).

Using the processing device (911) of the similarity degree calculation apparatus, the temporary public key generation unit (random number generation unit 303; and encrypted random number generation unit 304) of the similarity degree calculation apparatus randomly generates a T-dimensional vector having a components of an integer (R_{1, i}), and sets the generated T-dimensional vector to the temporary secret key, and randomly generates a T-dimensional vector having a component of a ciphertext (o′ᵢ) obtained by transforming 0 by the encryption transformation using the public key and sets the calculated T-dimensional vector to a zero ciphertext (encrypted zero vector O′), based on the public key stored by the public key storage unit of the similarity degree calculation apparatus, and calculates a T-dimensional vector having a component of a ciphertext obtained by combining Rᵢ pieces of each component of the comparison ciphertext (Rᵢ being an integer indicating a corresponding component of the temporary secret key) and the corresponding component of the zero ciphertext, based on the comparison ciphertext stored by the comparison ciphertext storage unit (encrypted data storage unit 312) of the similarity degree calculation apparatus, the generated temporary secret key, and the generated zero ciphertext, and sets the generated T-dimensional vector to the temporary public key (first challenge R).

Using the processing device (911) of the encryption apparatus (certification apparatus 101; or terminal apparatus 111), the target dual encryption text calculation unit (encrypted data embedding unit 217) of the encryption apparatus randomly generates a T-dimensional vector having a component of a ciphertext (oᵢ) obtained by transforming 0 by the encryption transformation using the public key, based on the public key stored by the public key storage unit (212) of the encryption apparatus, and set the generated T-dimensional vector to a zero ciphertext (encrypted zero vector O), and then calculates a T-dimensional vector having a component of a cirphetext obtained by combining b′ᵢ pieces of each component of the temporary public key (b′ᵢ being the integer indicating the corresponding component of the target data) and the corresponding component of the zero ciphertext by the arithmetic operation for the ciphertext, based on the target data acquired by the target data acquisition unit (feature vector formation unit 214) of the encryption apparatus, the temporary public key acquired by the temporary public key acquisition unit (first challenge receiving unit 211) of the encryption apparatus, and the generated zero ciphertext, and sets the calculated T-dimensional vector to the target dual encryption text (first response R′).

The target ciphertext acquisition unit (encrypted data extraction unit 305) of the similarity degree calculation apparatus includes a temporary decryption key calculation unit (inverse number calculation unit 351) and a target ciphertext calculation unit (exponentiation calculation unit 353).

Using the processing device of the similarity degree calculation apparatus, the temporary decryption key calculation unit of the similarity degree calculation apparatus calculates a T-dimensional vector having a component of an inverse number (κᵢ) of each component of the temporary secret key, based on the temporary secret key generated by the temporary secret key generation unit of the similarity degree calculation apparatus, and sets the calculated T-dimensional vector to a temporary decryption key.

Using the processing device of the similarity degree calculation apparatus, the target ciphertext calculation unit of the similarity degree calculation apparatus calculates a T-dimensional vector having a component of a ciphertext obtained by combining Rᵢ⁻¹ pieces of each component of the target dual encryption text (Rᵢ⁻¹ being the inverse number indicating the corresponding component of the temporary decryption key) by the arithmetic operation for the ciphertext, based on the target dual encryption text acquired by the target dual encryption text acquisition unit (first challenge transmitting unit 311) of the similarity degree calculation apparatus and the temporary decryption key calculated by the temporary decryption key calculation unit of the similarity degree calculation apparatus, and sets the calculated T-dimensional vector to the target ciphertext (encrypted feature vector C′).

In the similarity degree calculation system (biometric authentication system 100; or image search system 110) described above,

The interim similarity degree ciphertext calculation unit (encrypted random similarity degree calculation unit 314) of the similarity degree calculation apparatus (authentication apparatus 102; or search apparatus 112) includes a random number plaintext generation unit (encryption key generation unit 366) and a ciphertext calculation unit (integer combining unit 386).

Using the processing device (911) of the similarity degree calculation apparatus, the random number plaintext generation unit of the similarity degree calculation apparatus randomly generates a T-dimensional vector having a component of an integer (t_{1, i}) and sets the generated T-dimensional vector to a random number plaintext (disturbance vector T).

Using the processing device of the similarity degree calculation apparatus, the temporary key generation unit (random number storage unit 322) of the similarity degree calculation apparatus calculates a summation (Σᵢ[t_{1, i}]) of components of the random number plaintext generated by the random number generation unit of the similarity degree calculation apparatus, and sets the calculated summation to the temporary key.

Using the processing device of the similarity degree calculation apparatus, the ciphertext calculation unit of the similarity degree calculation apparatus calculates a T-dimensional vector having a component of a ciphertext obtained by combining each component of the target ciphertext and the corresponding component of the random number plaintext by the arithmetic operation for the ciphertext, based on the target ciphertext (encrypted feature vector C′) acquired by the target ciphertext acquisition unit (encrypted data extraction unit 305) of the similarity degree calculation apparatus and the random number plaintext generated by the random number plaintext generation unit of the similarity degree calculation apparatus, and sets the calculated T-dimensional vector to the interim similarity degree ciphertext (second challenge Ĉ).

In the similarity degree calculation system (biometric authentication system 100; or image search system 110) described above,

using the processing device (911) of the similarity degree calculation apparatus (authentication apparatus 102; or search apparatus 112), the temporary key generation unit (random number generation unit 303) of the similarity degree calculation apparatus randomly generates an integer (s₁), and sets the generated integer to the temporary key.

The interim similarity degree ciphertext calculation unit (encrypted random similarity degree calculation unit 314) of the similarity degree calculation apparatus includes a first ciphertext calculation unit (rearrangement unit 385) and a second ciphertext calculation unit (encryption key generation unit 366).

Using the processing device of the similarity degree calculation apparatus, the first ciphertext calculation unit of the similarity degree calculation apparatus calculates a T-dimensional vector with a sequence of the components of the target ciphertext (encrypted feature vector C′) randomly rearranged, based on the target ciphertext acquired by the target ciphertext acquisition unit (encrypted data extraction unit 305) of the similarity degree calculation apparatus, and sets the calculated T-dimensional vector to a first interim similarity degree ciphertext.

Using the processing device of the similarity degree calculation apparatus, the second ciphertext calculation unit of the similarity degree calculation apparatus calculates a ciphertext obtained by transforming the temporary key by the encryption transformation using the public key, based on the public key (pk) stored by the public key storage unit (302) of the similarity degree calculation apparatus and the temporary key generated by the temporary key generation unit of the similarity degree calculation apparatus, and sets the calculated ciphertext to a second interim similarity degree ciphertext.

Using the processing device of the similarity degree calculation apparatus, the interim similarity degree ciphertext notification unit (second challenge transmitting unit 321) of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus (103).

In the similarity degree calculation system (biometric authentication system 100; or image search system 110) described above,

using the processing device (911) of the decryption apparatus, the interim similarity degree decrypted text calculation unit (decryption unit 404) of the decryption apparatus (103) calculates a difference or a sum between the summation of the integers obtained by decrypting the T components of the first interim similarity degree ciphertext and the integer obtained by decrypting the second interim similarity degree ciphertext, or calculates an element obtained by combining z pieces of predetermined elements in a predetermined finite group (z being is the difference or the sum between the summation of the integers obtained by decrypting the T components of the first interim similarity degree ciphertext and the integer obtained by decrypting the second interim similarity degree ciphertext) by a group arithmetic operation on the predetermined finite group, and sets the calculated difference or the calculated sum or the calculated element to the interim similarity degree decrypted text (second response Z).

In the similarity degree calculation system (biometric authentication system 100; or image search system 110) described above,

using the processing device (911) of the similarity degree calculation apparatus (authentication apparatus 102; or search apparatus 112), the temporary key generation unit (random number generation unit 303) of the similarity degree calculation apparatus randomly generates an integer (s₁), and sets the generated integer to the temporal key.

Using the processing device of the similarity degree calculation apparatus, the interim similarity degree ciphertext calculation unit (encrypted random similarity degree calculation unit 314) of the similarity degree calculation apparatus calculates a ciphertext by combining a ciphertext obtained by transformation of the temporary key by the encryption transformation using the public key (pk) and the T components of the target ciphertext by the encryption transformation using the public key, using the arithmetic operation for the ciphertext, based on the public key stored by the public key storage unit (302) of the encryption apparatus, the target ciphertext (encrypted feature vector C′) acquired by the target ciphertext acquisition unit (encrypted data extraction unit 305) of the similarity degree calculation apparatus, and the temporary key generated by the temporary key generation unit of the similarity degree calculation apparatus, and sets the calculated ciphertext to the interim similarity degree ciphertext (second challenge Ĉ).

In the similarity degree calculation system (biometric authentication system 100; or image search system 110) described above,

using the processing device (911) of the decryption apparatus (103), the interim similarity degree decrypted text calculation unit (decryption unit 404) of the decryption apparatus calculates an integer obtained by decrypting the interim similarity degree ciphertext (second challenge Ĉ), or calculates an element by combining z pieces of predetermined elements (z being the integer obtained by decrypting the interim similarity degree ciphertext) in a predetermined finite group by a group arithmetic operation on the predetermined finite group, based on the interim similarity degree ciphertext acquired by the interim similarity degree ciphertext acquisition unit (second challenge receiving unit 402) of the decryption apparatus, and sets the calculated integer or the calculated element to the interim similarity degree decrypted text (second response Z).

In the similarity degree calculation system (biometric authentication system 100; or image search system 110) described above,

the interim similarity degree decrypted text (second response Z) is an integer.

Using the processing device (911) of the similarity degree calculation apparatus (authentication apparatus 102; or search apparatus 112), the temporary key generation unit (random number generation unit 303) of the similarity degree calculation apparatus randomly generates an integer (u₁; or s₁), and sets the generated integer to the temporary key.

Using the processing device of the similarity degree calculation apparatus, the similarity degree calculation unit (plaintext similarity degree extraction unit 315) of the similarity degree calculation apparatus calculates a sum or a difference between the temporary key and the interim similarity degree decrypted text, based on the temporary key generated by the temporary key generation unit of the similarity degree calculation apparatus and the interim similarity degree decrypted text acquired by the interim similarity degree decrypted text acquisition unit (second response receiving unit 341) of the similarity degree calculation apparatus, and sets the calculated sum or the calculated difference to the similarity degree (d).

In the similarity degree calculation system (biometric authentication system 100; or image search system 110) described above,

the interim similarity degree decrypted text is an element in a predetermined finite group (G_{T}).

Using the processing device (911) of the similarity degree calculation apparatus, the temporary key generation unit (random number generation unit 303) of the similarity degree calculation apparatus randomly generates an integer (u₁; or s₁), and sets the generated integer to the temporary key.

The similarity degree calculation unit (plaintext similarity degree extraction unit 315) of the similarity degree calculation apparatus includes a similarity degree decrypted text calculation unit (element combining unit 372) and a discrete logarithm calculation unit (373).

Using the processing device of the similarity degree calculation apparatus, the similarity degree decrypted text calculation unit of the similarity degree calculation apparatus calculates an element by combining the interim similarity degree decrypted text and u pieces of predetermined elements (e(b₁, b₁); or π) (u being the integer that is the temporary key) in the predetermined finite group by a group arithmetic operation on the predetermined finite group, based on the temporary key generated by the temporary key generation unit of the similarity degree calculation apparatus and the interim similarity degree decrypted text acquired by the interim similarity degree decrypted text acquisition unit (second response receiving unit 341) of the similarity degree calculation apparatus, and sets the calculated element to a similarity degree decrypted text (decrypted similarity degree element Z′).

Using the processing device of the similarity degree calculation apparatus, the discrete logarithm calculation unit of the similarity degree calculation apparatus calculates a number of the predetermined elements to be combined to be equal to the similarity degree decrypted text, by the group arithmetic operation on the predetermined finite group, based on the similarity degree decrypted text calculated by the similarity degree decrypted text of the similarity degree calculation apparatus, and sets the calculated number of the predetermine elements to the similarity degree (d).

In the similarity degree calculation system (biometric authentication system 100; or image search system 110) described above,

using the processing device (911) of the similarity degree calculation apparatus (authentication apparatus 102; or search apparatus 112), the discrete logarithm calculation unit (373) of the similarity degree calculation apparatus calculates the similarity degree (d) when the similarity degree is an integer within a predetermined range, and determines that the similarity degree is outside the predetermined range when the similarity degree is outside the predetermined range.

The similarity degree calculation system (biometric authentication system 100; or image search system 110) described above further includes a registration apparatus (104).

The registration apparatus includes a storage device (914) that stores data, a processing device (911) that processes the data, a public key storage unit (202), a comparison data acquisition unit (feature vector formation unit 204), a comparison ciphertext calculation unit (encrypted data generation unit 206), and a comparison ciphertext notification unit (encrypted data transmitting unit 201).

Using the storage device of the registration apparatus, the public key storage unit of the registration apparatus stores the public key (pk) corresponding to the secret key (sk) stored by the decryption apparatus (103).

Using the processing device of the registration apparatus, the comparison data acquisition unit of the registration apparatus acquires the comparison data.

Using the processing device of the registration apparatus, the comparison ciphertext calculation unit of the registration apparatus transforms the comparison data by the encryption transformation using the public key, thereby calculating the comparison ciphertext (encrypted feature vector C), based on the public key stored by the public key storage unit of the registration apparatus and the comparison data acquired by the comparison data acquisition unit of the registration apparatus.

Using the processing device of the registration apparatus, the comparison ciphertext notification unit of the registration apparatus notifies the comparison ciphertext calculated by the comparison ciphertext calculation unit of the registration apparatus to the similarity degree calculation apparatus (authentication apparatus 102; or search apparatus 112).

The similarity degree calculation apparatus' further includes a comparison ciphertext acquisition unit (encrypted data receiving unit 301).

Using the processing device (911) of the similarity degree calculation apparatus, the comparison ciphertext acquisition unit of the similarity degree calculation apparatus acquires the comparison ciphertext notified from the registration apparatus.

Using the storage device (914) of the similarity degree calculation apparatus, the comparison ciphertext storage unit (encrypted data storage unit 312) of the similarity degree calculation apparatus stores the comparison ciphertext acquired by the comparison ciphertext acquisition unit of the similarity degree calculation apparatus.

According to the similarity degree calculation apparatus, the similarity degree calculation system, the computer program, and the similarity degree calculation method described above, a similarity degree between data may be calculated with the data kept encrypted, and leakage of information on the original data and leakage of information to be used for spoofing during the course of the calculation of the similarity degree may also be prevented.

### DESCRIPTION OF REFERENCE SIGNS

100: biometric authentication system, 101: certification apparatus, 102: authentication apparatus, 103: decryption apparatus, 104: registration apparatus, 110: image search system, 111: terminal apparatus, 112: search apparatus, 201, 222: encrypted data transmitting unit, 202, 212, 302, 403: public key storage unit, 203, 213: biometric information extraction unit, 204, 214: feature vector formation unit, 205, 215, 303: random number generation unit, 206, 216: encrypted data generation unit, 208, 218, 308: public key receiving unit, 209, 219: image input unit, 211: first challenge receiving unit, 217: encrypted data embedding unit, 221: first response transmitting unit, 223: result receiving unit, 224: result outputting unit, 226: image encryption unit, 228: encrypted image transmitting unit, 231, 352, 364: scalar multiplication calculation unit, 232, 332: zero generation unit, 233, 363: vector combining unit, 234, 353, 384, 334: exponentiation calculation unit, 235, 370, 372, 475: element combining unit, 236, 336, 386, 485: integer combining unit, 301, 325: encrypted data receiving unit, 304: encrypted random number generation unit, 305: encrypted data extraction unit, 306: determination unit, 311: first challenge transmitting unit, 312: encrypted data storage unit, 314: encrypted random similarity degree calculation unit, 315: plaintext similarity degree extraction unit, 321: second challenge transmitting unit, 322: random number storage unit, 323: result transmitting unit, 331: first response receiving unit, 341: second response receiving unit, 351: inverse number calculation unit, 361: difference calculation unit, 362: disturbance vector generation unit, 365: square summation calculation unit, 366: encryption key generation unit, 367: vector summation unit, 368, 381, 382, 473: square calculation unit, 371, 474: group conversion unit, 373: discrete logarithm calculation unit, 383: product calculation unit, 385: rearrangement unit, 401: key generation unit, 402: second challenge receiving unit, 404: decryption unit, 408: public key transmitting unit, 412: second response transmitting unit, 413: secret key storage unit, 421, 431: group determination unit, 422: canonical base setting unit, 423: random number generation unit, 424: determinant calculation unit, 425: regular matrix setting unit, 426: random base calculation unit, 432: generator element selection unit, 433: generator element exponentiation unit, 434: base calculation unit, 441: prime number determination unit, 442: product calculation unit, 443: common multiple calculation unit, 471: inverse matrix calculation unit, 472: vector decomposition unit, 481: inverse number calculation unit, 482: decrypted integer calculation unit, 911: processing device, 912: input device, 913: output device, 914: storage device, A: canonical base, B: random base, b, b′: feature vector, C, C′: encrypted feature vector, Ĉ: second challenge, ΔC: encrypted difference vector, ΔC′: encrypted square vector, d: similarity degree, d₀: threshold value, F_{q}: finite field, G, G_{T}: finite group, g: generator element, O, O′: encrypted zero vector, pk: public key, R: first challenge, R′: first response, [symbol] [symbol] : vector, [symbol] [symbol] ′: exponentiation vector, S500: setup process, S501: key generation step, S502: public key notification step, S503, S504, S505: public key acquisition step, S511, S521: group determination step, S512: canonical base setting step, S513: matrix generation step, S514: regular matrix determination step, S515: random base calculation step, S522: generator element selection step, S523: generator element exponentiation step, S524: base calculation step, S531: prime number determination step, S532, S754: product calculation step, S533: common multiple calculation step, S540: vector decomposition process, S541, S561: inverse matrix calculation step, S542: first initialization step, S543: first repetition step, S544: second initialization step, S545: second repetition step, S546: third initialization step, S547: third repetition step, S548: factor summation step, S549: map calculation step, S550: scalar multiplication step, S551, S747, S751: vector summation step, S560, S610, S660, S729, S730, S740: initialization step, S561a, S690, S732: inverse number calculation step, S562, S611, S661, S721, S731, S741: repetition step, S563, S566: vector decomposition step, S563a, S566a: decrypted integer calculation step, S564, S753: square calculation step, S565, S665a, S692: element combining step, S565a, S665b, S692a, S726, S760: integer combining step, S567, S691: group conversion step, S571, S662a, S724, S733a, S752a, S755: exponentiation calculation step, S600: registration process, S601, S705: biometric information extraction step, S602, S706: feature vector generation step, S603: feature vector encryption step, S604: encrypted biometric information notification step, S605: encrypted biometric information acquisition step, S612, S663, S722, S743, S749, S757, S758: random number generation step, S613, S723: vector calculation step, S613a, S723a: element calculation step, S613b, S723b: integer calculation step, S662, S733, S746: scalar multiplication step, S664, S725: zero generation step, S665, S745: vector combining step, S693: discrete logarithm calculation step, S700: authentication process, S701: first challenge generation step, S702, S713: random number storage step, S703: first challenge notification step, S704: first challenge acquisition step, S707: first response generation step, S708: first response notification step, S709: first response acquisition step, S710: encrypted biometric information extraction step, S711: encrypted biometric information reading step, S712: second challenge generation step, S714: second challenge notification step, S715: second challenge acquisition step, S716: second response generation step, S717: second response notification step, S718: second response acquisition step, S719: plaintext similarity degree calculation step, S720: authentication determination step, S742, S742a, S742b: difference calculation step, S744: disturbance vector generation step, S748: square summation step, S748a: element summation step, S750: encryption key generation step, S752: encryption key generation step, S759: second challenge setting step, sk: secret key, T: disturbance vector, [symbol] : decryption key, [symbol] [symbol] [symbol] : encryption key [symbol] [symbol] [symbol] ₁, [symbol] [symbol] [symbol] ₂: exponentiation element, V: vector space, [symbol] : inverse element, X: regular matrix, X⁻¹: inverse matrix, Z: second response, Z′: decrypted similarity degree element, [symbol] : first encrypted square vector, [symbol] ′: second encrypted square vector

1: A similarity degree calculation apparatus that calculates a similarity degree between comparison data and target data, the similarity degree calculation apparatus including:
a storage device that stores data, a processing device that processes the data, a comparison ciphertext storage unit, a target ciphertext acquisition unit, a temporary key generation unit, an interim similarity degree ciphertext calculation unit, an interim similarity degree ciphertext notification unit, an interim similarity degree decrypted text acquisition unit, and a similarity degree calculation unit;
using the storage device, the comparison ciphertext storage unit storing a comparison ciphertext obtained by transforming the comparison data by encryption transformation using a public key corresponding to a secret key stored by a decryption apparatus;
using the processing device, the target ciphertext acquisition unit acquiring a target ciphertext obtained by transforming the target data by the encryption transformation using the public key;
using the processing device, the temporary key generation unit generating a temporary key;
using the processing device, based on the comparison ciphertext stored by the comparison ciphertext storage unit, the target ciphertext acquired by the target ciphertext acquisition unit, and the temporary key generated by the temporary key generation unit, the interim similarity degree ciphertext calculation unit performing calculation for calculating the similarity degree in a first stage with the comparison ciphertext and the target ciphertext kept encrypted, and calculating an interim similarity degree ciphertext by encrypting a result of the calculation with the temporary key;
using the processing device, the interim similarity degree ciphertext notification unit notifying to the decryption apparatus the interim similarity degree ciphertext calculated by the interim similarity degree ciphertext calculation unit;
using the processing device, the interim similarity degree decrypted text acquisition unit acquiring an interim similarity degree decrypted text calculated and notified by the decryption apparatus, based on the interim similarity degree ciphertext notified by the interim similarity degree ciphertext notification unit; and
using the processing device, the similarity degree calculation unit decrypting the interim similarity degree decrypted text with the temporary key, based on the temporary key generated by the temporary key generation unit and the interim similarity degree decrypted text acquired by the interim similarity degree decrypted text acquisition unit, thereby calculating the similarity degree between the comparison data and the target data.

2: The similarity degree calculation apparatus according to claim 1, wherein
the similarity degree calculation apparatus further includes a temporary secret key generation unit and a target dual encryption text acquisition unit;
using the processing device, the temporary key generation unit generates a temporary secret key and a temporary public key corresponding to the temporary secret key;
using the processing device, the target dual encryption text acquisition unit acquires a target dual encryption text encrypted with the temporary public key generated by the temporary secret key generation unit; and
using the processing device, the target ciphertext acquisition unit decrypts the target dual encryption text with the temporary secret key, based on the temporary secret key stored by the temporary secret key storage unit and the target dual encryption text acquired by the target dual encryption text acquisition unit, thereby acquiring the target ciphertext obtained by transforming the target data by the encryption transformation using the public key.

3: A similarity degree calculation system including the similarity degree calculation apparatus according to claim 1 and a decryption apparatus, wherein
the decryption apparatus includes a storage unit that stores data, a processing device that processes the data, a secret key storage unit, an interim similarity degree ciphertext acquisition unit, an interim similarity degree decrypted text calculation unit, and an interim similarity degree decrypted text notification unit;
using the storage device of the decryption apparatus, the secret key storage unit of the decryption apparatus stores the secret key;
using the processing device of the decryption apparatus, the interim similarity degree ciphertext acquisition unit of the decryption apparatus acquires the interim similarity degree ciphertext notified from the similarity degree calculation apparatus;
using the processing device of the decryption apparatus, the interim similarity degree decrypted text calculation unit of the decryption apparatus decrypts the interim similarity degree ciphertext with the secret key, based on the secret key stored by the secret key storage unit of the decryption apparatus and the interim similarity degree ciphertext acquired by the interim similarity degree ciphertext acquisition unit of the decryption apparatus, and performs calculation for calculating the similarity degree in a second stage with a result of the decryption kept encrypted with the temporary key, thereby calculating the interim similarity degree decrypted text; and
using the processing device of the decryption apparatus, the interim similarity degree decrypted text notification unit of the decryption apparatus notifies the interim similarity degree decrypted text calculated by the interim similarity degree decrypted text calculation unit of the decryption apparatus to the similarity degree calculation apparatus.

4: The similarity degree calculation system according to claim 3, wherein
each of the comparison data and the target data is a T-dimensional vector (T being an integer not less than 1) having components of integers;
using the processing device of the similarity degree calculation apparatus, the interim similarity degree ciphertext calculation unit of the similarity degree calculation apparatus calculates a difference or a product of the corresponding components of the comparison data and the target data, with the comparison ciphertext and the target ciphertext kept encrypted;
using the processing device of the decryption apparatus, the interim similarity degree ciphertext calculation unit of the decryption apparatus decrypts the interim similarity degree ciphertext with the secret key, and calculates the similarity degree, with the result of the decryption kept encrypted with the temporary key; and
using the processing device of the similarity degree calculation apparatus, the similarity degree calculation unit of the similarity degree calculation apparatus decrypts the interim similarity degree decrypted text, thereby obtaining the similarity degree.

5: The similarity degree calculation system according to claim 3, wherein
the encryption transformation is transformation for transforming an integer into a ciphertext, an arithmetic operation for combining and transforming a plurality of ciphertexts into a different ciphertext may be calculated for the ciphertext, and a ciphertext obtained by combining a ciphertext resulting from transformation of an arbitrary first integer and a ciphertext resulting from transformation of an arbitrary second integer by the arithmetic operation for the ciphertext is a ciphertext resulting from transformation of a sum of the first integer and the second integer.

6: The similarity degree calculation system according to claim 5, wherein
each of the comparison data and the target data is a T-dimensional vector (T being an integer not less than 1) having each component of an integer;
the comparison ciphertext is a T-dimensional vector having a component of a ciphertext obtained by transforming each component of the comparison data by the encryption transformation using the public key;
the target ciphertext is a T-dimensional vector having a component of a ciphertext obtained by transforming each component of the target data by the encryption transformation using the public key;
the similarity degree calculation apparatus further includes a public key storage unit;
using the storage device of the similarity degree calculation apparatus, the public key storage unit of the similarity degree calculation apparatus stores a public key corresponding to the secret key stored by the decryption apparatus;
using the processing device of the similarity degree calculation apparatus, the temporary key generation unit of the similarity degree calculation apparatus randomly generates an integer, and sets the generated integer to the temporary key;
the interim similarity degree ciphertext calculation unit of the similarity degree calculation apparatus includes a random number plaintext generation unit, a first ciphertext calculation unit, and a second ciphertext calculation unit;
using the processing device of the similarity degree calculation apparatus, the random number plaintext generation unit of the similarity degree calculation apparatus randomly generates a T-dimensional vector having a component of an integer, and sets the generated T-dimensional vector to a random number plaintext;
using the processing device of the similarity degree calculation apparatus, the first ciphertext calculation unit of the similarity degree calculation apparatus calculates a first interim similarity degree ciphertext using the arithmetic operation for the ciphertext, based on the comparison ciphertext stored by the comparison ciphertext storage unit of the similarity degree calculation apparatus, the target ciphertext acquired by the target ciphertext acquisition unit of the similarity degree calculation apparatus, and the random number plaintext generated by the random number plaintext generation unit of the similarity degree calculation apparatus, the first interim similarity degree ciphertext being a T-dimensional vector having a component of a ciphertext obtained by transforming a sum of a difference between each component of the comparison data and the corresponding component of the target data and the corresponding component of the random number plaintext by the encryption transformation using the public key;
using the processing device of the similarity degree calculation apparatus, the second ciphertext calculation unit of the similarity degree calculation apparatus calculates a second interim similarity degree ciphertext using the arithmetic operation for the ciphertext, based on the comparison ciphertext stored by the comparison ciphertext storage unit of the similarity degree calculation apparatus, the target ciphertext acquired by the target ciphertext acquisition unit of the similarity degree calculation apparatus, the temporary key generated by the temporary key generation unit of the similarity degree calculation apparatus, and the random number plaintext generated by the random number plaintext generation unit of the similarity degree calculation apparatus, the second interim similarity degree ciphertext being a ciphertext obtained by transforming a sum of a correction value and the temporary key by the encryption transformation using the public key, the correction value being an integer obtained by summating, for all of the components, sums of squares of the respective components of the random number plaintext and twice products of the corresponding components of the random number plaintext and differences between the respective components of the comparison data and the corresponding components of the target data; and
using the processing device of the similarity degree calculation apparatus, the interim similarity degree ciphertext notification unit of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus.

7. (canceled)

8: The similarity degree calculation system according to claim 5, wherein
each of the comparison data and the target data is a T-dimensional vector (T being an integer not less than 1) having a component of an integer;
the comparison ciphertext is a T-dimensional vector having a component of a ciphertext obtained by transforming each component of the comparison data by the encryption transformation using the public key;
the target ciphertext is a T-dimensional vector having a component of a ciphertext obtained by transforming each component of the target data by the encryption transformation using the public key;
the similarity degree calculation apparatus further includes a public key storage unit;
using the storage device of the similarity degree calculation apparatus, the public key storage unit of the similarity degree calculation apparatus stores the public key corresponding to the secret key stored by the decryption apparatus;
using the processing device of the similarity degree calculation apparatus, the temporary key generation unit of the similarity degree calculation apparatus randomly generates an integer, and sets the generated integer to the temporary key;
the interim similarity degree ciphertext calculation unit of the similarity degree calculation apparatus includes a first ciphertext calculation unit and a second ciphertext calculation unit;
using the processing device of the similarity degree calculation apparatus, the first ciphertext calculation unit of the similarity degree calculation apparatus calculates a first interim similarity degree ciphertext using the arithmetic operation for the ciphertext, based on the comparison ciphertext stored by the comparison ciphertext storage unit of the similarity degree calculation apparatus and the target ciphertext acquired by the target ciphertext acquisition unit of the similarity degree calculation apparatus, the first interim similarity degree ciphertext being a T-dimensional vector having a component of a ciphertext obtained by transforming a difference between each component of the comparison data and the corresponding component of the target data by the encryption transformation using the public key;
using the processing device of the similarity degree calculation apparatus, the second ciphertext calculation unit of the similarity degree calculation apparatus sets a ciphertext obtained by transformation of the temporary key by the encryption transformation using the public key to a second interim similarity degree ciphertext, based on the public key stored by the public key storage unit of the similarity degree calculation apparatus and the temporary key generated by the temporary key generation unit of the similarity degree calculation apparatus; and
using the processing device of the similarity degree calculation apparatus, the interim similarity degree ciphertext notification unit of the similarity degree calculation apparatus notifies the first interim similarity degree ciphertext calculated by the first ciphertext calculation unit of the similarity degree calculation apparatus and the second interim similarity degree ciphertext calculated by the second ciphertext calculation unit of the similarity degree calculation apparatus to the decryption apparatus.

9: The similarity degree calculation system according to claim 8, wherein
using the processing device of the similarity degree calculation apparatus, the first ciphertext calculation unit of the similarity degree calculation apparatus sets, as the first interim similarity degree ciphertext, the T-dimensional vector having components of a ciphertext randomly selected from among ciphertexts obtained by transforming the difference of each component of the comparison data from the corresponding component of the target data by the encryption transformation using the public key and ciphertexts obtained by transforming the difference of each component of the target data from the corresponding component of the comparison data by the encryption transformation using the public key, the T-dimensional vector having a sequence of the components randomly rearranged.

10: The similarity degree calculation system according to claim 6, wherein
using the processing device of the decryption apparatus, the interim similarity degree decrypted text calculation unit of the decryption apparatus calculates a difference or a sum between a summation of squares of the integers obtained by decrypting the T components of the first interim similarity degree ciphertext and the integer obtained by decrypting the second interim similarity degree ciphertext, or calculates an element obtained by combining z pieces of predetermined elements (z being the difference or the sum between the summation of squares of the integers obtained by decrypting the T components of the first interim similarity degree ciphertext and the integer obtained by decrypting the second interim similarity degree ciphertext) in a predetermined finite group by a group arithmetic operation on the predetermined finite group, and sets the calculated difference, the calculated sum, or the calculated element to the interim similarity degree decrypted text.

11: The similarity degree calculation system according to claim 5, wherein
each of the comparison data and the target data is a T-dimensional vector (T being an integer not less than 1) having each component of an integer;
the comparison ciphertext is a T-dimensional vector having a component of a ciphertext obtained by transforming each component of the comparison data by the encryption transformation using the public key;
the target ciphertext is a T-dimensional vector having a component of a ciphertext obtained by transforming each component of the target data by the encryption transformation using the public key;
the similarity degree calculation apparatus further includes a public key storage unit;
using the storage device of the similarity degree calculation apparatus, the public key storage unit of the similarity degree calculation apparatus stores the public key corresponding to the secret key stored by the decryption apparatus;
using the processing device of the similarity degree calculation apparatus, the temporary key generation unit of the similarity degree calculation apparatus randomly generates an integer, and sets the generated integer to the temporary key; and
using the processing device of the similarity degree calculation apparatus, the interim similarity degree ciphertext calculation unit of the similarity degree calculation apparatus calculates the interim similarity degree ciphertext using the arithmetic operation for the ciphertext, based on the comparison ciphertext stored by the comparison ciphertext storage unit of the similarity degree calculation apparatus and the target ciphertext acquired by the target ciphertext acquisition unit of the similarity degree calculation apparatus, and the temporary key generated by the temporary key generation unit of the similarity degree calculation apparatus, the interim similarity degree ciphertext being a ciphertext obtained by transforming a sum or a difference between a summation value and the temporary key by the encryption transformation using the public key, and the summation value is an integer obtained by summating a square of a difference between each component of the comparison data and the corresponding component of the target data or by summating a product of each component of the comparison data and the corresponding component of the target data, for all the components.

12-14. (canceled)

15: The similarity degree calculation system according to claim 3, wherein
the similarity degree calculation system further includes an encryption apparatus;
the encryption apparatus includes a storage device that stores data, a processing device that processes the data, a public key storage unit, a target data acquisition unit, a temporary public key acquisition unit, a target dual encryption text calculation unit, and a target dual encryption text notification unit;
using the storage device of the encryption apparatus, the public key storage unit of the encryption apparatus stores the public key corresponding to the secret key stored by the decryption apparatus;
using the processing device of the encryption apparatus, the target data acquisition unit of the encryption apparatus acquires the target data;
using the processing device of the encryption apparatus, the temporary public key acquisition unit of the encryption apparatus acquires a temporary public key notified from the similarity degree calculation apparatus;
using the processing device of the encryption apparatus, the target dual encryption text calculation unit of the encryption apparatus transforms the target data by second encryption transformation using the public key and the temporary public key, thereby calculating a target dual encryption text, based on the public key stored by the public key storage unit of the encryption apparatus, the target data acquired by the target data acquisition unit of the encryption apparatus, and the temporary public key acquired by the temporary public key acquisition unit of the encryption apparatus;
using the processing device of the encryption apparatus, the target dual encryption text notification unit of the encryption apparatus notifies the target dual encryption text calculated by the target dual encryption text calculation unit of the encryption apparatus to the similarity degree calculation apparatus;
the similarity degree calculation apparatus further includes a temporary secret key generation unit, a temporary public key notification unit, and a target dual encryption text acquisition unit;
using the processing device of the similarity degree calculation apparatus, the temporary secret key generation unit of the similarity degree calculation apparatus generates a temporary secret key and a temporary public key corresponding to the temporary secret key;
using the processing device of the similarity degree calculation apparatus, the temporary public key notification unit of the similarity degree calculation apparatus notifies the temporary public key generated by the temporary secret key generation unit of the similarity degree calculation apparatus to the encryption apparatus;
using the processing device of the similarity degree calculation apparatus, the target dual encryption text acquisition unit of the similarity degree calculation apparatus acquires the target dual encryption text notified from the encryption apparatus; and
using the processing device of the similarity degree calculation apparatus, the target ciphertext acquisition unit of the similarity degree calculation apparatus transforms the target dual encryption text by second decryption transformation using the temporary secret key, based on the temporary secret key generated by the temporary secret key generation unit of the similarity degree calculation apparatus and the target dual encryption text acquired by the target dual encryption text acquisition unit of the similarity degree calculation apparatus, thereby calculating the target ciphertext obtained by transforming the target data by the encryption transformation using the public key.

16. (canceled)

17: The similarity degree calculation system according to claim 15, wherein
the encryption transformation is transformation for transforming an integer to a ciphertext, an arithmetic operation for combining and transforming a plurality of ciphertexts into a different ciphertext may be calculated for the ciphertext, and a ciphertext obtained by combining a ciphertext resulting from transformation of an arbitrary first integer and a ciphertext resulting from transformation of an arbitrary second integer by the arithmetic operation for the ciphertext is a ciphertext resulting from transformation of a sum of the first integer and the second integer;
the target data is a T-dimensional vector (T being an integer not less than 1) having components of integers;
the similarity degree calculation apparatus further includes a public key storage unit;
using the storage device of the similarity degree calculation apparatus, the public key storage unit of the similarity degree calculation apparatus stores the public key corresponding to the secret key stored by the decryption apparatus;
using the processing device of the similarity degree calculation apparatus, the temporary public key generation unit of the similarity degree calculation apparatus randomly generates a T-dimensional vector having a component of an integer, and sets the generated T-dimensional vector to the temporary secret key, and calculates a T-dimensional vector having a component of a ciphertext obtained by transforming each component of the temporary secret key by the encryption transformation using the public key, based on the public key stored by the public key storage unit of the similarity degree calculation apparatus and the generated temporary secret key, and sets the calculated T-dimensional vector to the temporary public key;
using the processing device of the encryption apparatus, the target dual encryption text calculation unit of the encryption apparatus randomly generates a T-dimensional vector having a component of a ciphertext obtained by transforming 0 by the encryption transformation using the public key, based on the public key stored by the public key storage unit of the encryption apparatus, and sets the generated T-dimensional vector to a zero ciphertext, and calculates a T-dimensional vector having a component of a cirphetext obtained by combining b′ᵢ pieces of each component of the temporary public key (b′ᵢ being the integer indicating the corresponding component of the target data) and the corresponding component of the zero ciphertext by the arithmetic operation for the ciphertext, based on the target data acquired by the target data acquisition unit of the encryption apparatus, the temporary public key acquired by the temporary public key acquisition unit of the encryption apparatus, and the generated zero ciphertext, and sets the calculated T-dimensional vector to the target dual encryption text;
the target ciphertext acquisition unit of the similarity degree calculation apparatus includes a temporary decryption key calculation unit and a target ciphertext calculation unit;
using the processing device of the similarity degree calculation apparatus, the temporary decryption key calculation unit of the similarity degree calculation apparatus calculates a T-dimensional vector having a component of an inverse number of each component of the temporary secret key, based on the temporary secret key generated by the temporary secret key generation unit of the similarity degree calculation apparatus, and sets the calculated T-dimensional vector to a temporary decryption key; and
using the processing device of the similarity degree calculation apparatus, the target ciphertext calculation unit of the similarity degree calculation apparatus calculates a T-dimensional vector having a component of a ciphertext obtained by combining Rᵢ⁻¹ pieces of each component of the target dual encryption text (Rᵢ⁻¹ being the inverse number indicating the corresponding component of the temporary decryption key), based on the target dual encryption text acquired by the target dual encryption text acquisition unit of the similarity degree calculation apparatus and the temporary decryption key calculated by the temporary decryption key calculation unit of the similarity degree calculation apparatus, and sets the calculated T-dimensional vector to the target ciphertext.

18-22. (canceled)

23: The similarity degree calculation system according to claim 11, wherein
using the processing device of the decryption apparatus, the interim similarity degree decrypted text calculation unit of the decryption apparatus calculates an integer obtained by decrypting the interim similarity degree ciphertext, or calculates an element by combining z pieces of predetermined elements (z being the integer obtained by decrypting the interim similarity degree ciphertext) in a predetermined finite group by a group arithmetic operation in the predetermined finite group, based on the interim similarity degree ciphertext acquired by the interim similarity degree ciphertext acquisition unit of the decryption apparatus, and sets the calculated integer or the calculated element to the interim similarity degree decrypted text.

24: The similarity degree calculation system according to claim 3, wherein
the interim similarity degree decrypted text is an integer;
using the processing device of the similarity degree calculation apparatus, the temporary key generation unit of the similarity degree calculation apparatus randomly generates an integer, and sets the generated integer to the temporary key; and
using the processing device of the similarity degree calculation apparatus, the similarity degree calculation unit of the similarity degree calculation apparatus calculates a sum or a difference between the temporary key and the interim similarity degree decrypted text, based on the temporary key generated by the temporary key generation unit of the similarity degree calculation apparatus and the interim similarity degree decrypted text acquired by the interim similarity degree decrypted text acquisition unit of the similarity degree calculation apparatus, and sets the calculated sum or the calculated difference to the similarity degree.

25: The similarity degree calculation system according to claim 3, wherein
the interim similarity degree decrypted text is an element in a predetermined finite group;
using the processing device of the similarity degree calculation apparatus, the temporary key generation unit of the similarity degree calculation apparatus randomly generates an integer, and sets the generated integer to the temporary key;
the similarity degree calculation unit of the similarity degree calculation apparatus includes a similarity degree decrypted text calculation unit and a discrete logarithm calculation unit;
using the processing device of the similarity degree calculation apparatus, the similarity degree decrypted text calculation unit of the similarity degree calculation apparatus calculates an element by combining the interim similarity degree decrypted text and u pieces of predetermined elements (u being the integer of the temporary key) in the predetermined finite group by a group arithmetic operation on the predetermined finite group, based on the temporary key generated by the temporary key generation unit of the similarity degree calculation apparatus and the interim similarity degree decrypted text acquired by the interim similarity degree decrypted text acquisition unit of the similarity degree calculation apparatus, and sets the calculated element to a similarity degree decrypted text; and
using the processing device of the similarity degree calculation apparatus, the discrete logarithm calculation unit of the similarity degree calculation apparatus calculates a number of the predetermined elements to be combined to be equal to the similarity degree decrypted text, by the group arithmetic operation in the predetermined finite group, based on the similarity degree decrypted text calculated by the similarity degree decrypted text calculation unit of the similarity degree calculation apparatus, and sets the number of the predetermine elements to the similarity degree.

26: The similarity degree calculation system according to claim 25, wherein
using the processing device of the similarity degree calculation apparatus, the discrete logarithm calculation unit of the similarity degree calculation apparatus calculates the similarity degree when the similarity degree is an integer within a predetermined range, and determines that the similarity degree is outside the predetermined range when the similarity degree is outside the predetermined range.

27: The similarity degree calculation system according to claim 3, wherein
the similarity degree calculation system further includes a registration apparatus;
the registration apparatus includes a storage device that stores data, a processing device that processes the data, a public key storage unit, a comparison data acquisition unit, a comparison ciphertext calculation unit, and a comparison ciphertext notification unit;
using the storage device of the registration apparatus, the public key storage unit of the registration apparatus stores the public key corresponding to the secret key stored by the decryption apparatus;
using the processing device of the registration apparatus, the comparison data acquisition unit of the registration apparatus acquires the comparison data;
using the processing device of the registration apparatus, the comparison ciphertext calculation unit of the registration apparatus transforms the comparison data by the encryption transformation using the public key to calculate the comparison ciphertext, based on the public key stored by the public key storage unit of the registration apparatus and the comparison data acquired by the comparison data acquisition unit of the registration apparatus;
using the processing device of the registration apparatus, the comparison ciphertext notification unit of the registration apparatus notifies the comparison ciphertext calculated by the comparison ciphertext calculation unit of the registration apparatus to the similarity degree calculation apparatus;
the similarity degree calculation apparatus further includes a comparison ciphertext acquisition unit;
using the processing device of the similarity degree calculation apparatus, the comparison ciphertext acquisition unit of the similarity degree calculation apparatus acquires the comparison ciphertext notified from the registration apparatus; and
using the storage device of the similarity degree calculation apparatus, the comparison ciphertext storage unit of the similarity degree calculation apparatus stores the comparison ciphertext acquired by the comparison ciphertext acquisition unit of the similarity degree calculation apparatus.

28: A non-transitory computer readable medium including computer executable instructions executed by a computer including a storage device that stores data and a processing device that processes the data, thereby causing the computer to function as the similarity degree calculation apparatus according to claim 1.

29: A similarity degree calculation method of calculating a similarity degree between comparison data and target data by a similarity degree calculation system including a similarity degree calculation apparatus and a decryption apparatus,
each of the similarity degree calculation apparatus and the decryption apparatus including a storage device that stores data and a processing device that processes the data, the similarity degree calculation method comprising:
storing a secret key by the storage device of the decryption apparatus;
storing by the storage device of the similarity degree calculation apparatus a comparison ciphertext obtained by transforming the comparison data by encryption transformation using a public key corresponding to the secret key stored by the decryption apparatus;
acquiring by the processing device of the similarity degree calculation apparatus a target ciphertext obtained by transforming the target data by the encryption transformation using the public key;
generating a temporary key by the processing device of the similarity degree calculation apparatus;
by the processing device of the similarity degree calculation apparatus, performing calculation for calculating the similarity degree in a first stage with the comparison cirphertext and the target ciphertext kept encrypted, based on the comparison ciphertext stored by the storage device of the similarity degree calculation apparatus, the target ciphertext acquired by the processing device of the similarity degree calculation apparatus, and the temporary key generated by the processing device of the similarity degree calculation apparatus, thereby calculating an interim similarity degree ciphertext obtained by encrypting a result of the calculation by the temporary key;
by the processing device of the similarity degree calculation apparatus, notifying to the decryption apparatus the interim similarity degree ciphertext calculated by the processing device of the interim similarity degree ciphertext calculation apparatus;
by the processing device of the decryption apparatus, acquiring the interim similarity degree ciphertext notified from the similarity degree calculation apparatus;
by the processing device of the decryption apparatus, decrypting the interim similarity degree ciphertext with the secret key, based on the secret key stored by the storage device of the decryption apparatus and the interim similarity degree ciphertext acquired by the processing device of the decryption apparatus, performing calculation for calculating the similarity degree in a second stage with a result of the decryption kept encrypted with the temporary key, thereby calculating the interim similarity degree decrypted text;
by the processing device of the decryption apparatus, notifying the interim similarity degree decrypted text calculated by the processing device of the decryption apparatus to the similarity degree calculation apparatus;
by the processing device of the similarity degree calculation apparatus, acquiring the interim similarity degree decrypted text notified from the decryption apparatus; and
by the processing device of the similarity degree calculation apparatus, decrypting the interim similarity degree decrypted text with the temporary key, based on the temporary key generated by the processing device of the similarity degree calculation apparatus and the interim similarity degree decrypted text acquired by the processing device of the similarity degree calculation apparatus, thereby calculating the similarity degree between the comparison data and the target data.
